(19) United States
(12) Patent Application Publication
(10) Pub. No.: US 2010/0103352 A1
(43) Pub. Date: Apr. 29, 2010

(54) OPTICAL FILM, POLARIZING PLATE, LIQUID CRYSTAL DISPLAY AND ULTRAVIOLET ABSORBING POLYMER

(76) Inventors: Takayuki Suzuki, Tokyo (JP); Ryohei Iwamoto, Tokyo (JP); Satomi Kawabe, Tokyo (JP); Takatugu Suzuki, Tokyo (JP); Issei Nakahara, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/450,492

(22) PCT Filed: Mar. 28, 2008
(86) PCT No.: PCT/JP2008/056090

§ 371 Date: Sep. 28, 2009

(30) Foreign Application Priority Data
Aug. 20, 2007 (JP) 2007-213483
Oct. 10, 2007 (JP) 2007-102536

(51) Int. Cl. G02F 1/1335; C08F 26/06; F21V 9/06; G02B 5/30

(52) U.S. Cl. 349/96; 526/259; 252/589; 359/500

(57) ABSTRACT

Disclosed is an optical film which is characterized by containing an ultraviolet absorbing polymer which is derived from at least two monomers, namely an ethylenically unsaturated monomer having a partial structure represented by Formula (A) below in a molecule, and a monomer represented by Formula (B) below:

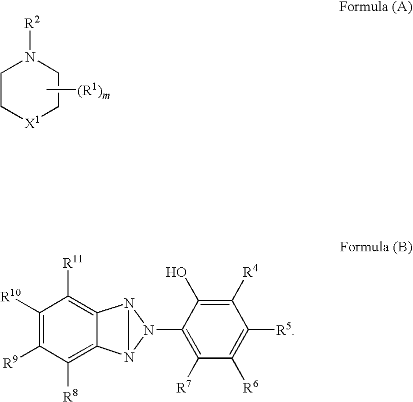

### FIELD OF THE INVENTION

The present invention relates to an optical film, a polarizing plate, a liquid crystal display and an ultraviolet absorbing polymer, and, in more detail, relates to an optical film containing the ultraviolet absorbing polymer, as well as a polarizing plate and a liquid crystal display employing thereof.

### BACKGROUND OF THE INVENTION

Liquid crystal displays (LCD) have been widely used as displaying devices such as a word processor, a personal computer, a television set, a monitor and a portable information terminal because a liquid crystal display can be driven at a low voltage with low electric consumption while being able to be directly connected to an IC circuit and specifically because a thin display device can be fabricated. The basic constitution of an LCD is, for example, a liquid crystal cell having polarizing plates on both surfaces thereof.

By the way, a polarizing plate only transmits the light of a specific polarization plane. Consequently, the LCD carries important role to visualize the variation of the orientation of liquid crystals due to electric field. Namely, the property of an LCD is largely influenced by the property of the polarizing plate.

The polarizer of a polarizing plate is prepared by adsorbing iodine to a polymer film followed by stretching the polymer film. Namely, a solution called H ink containing a dichromatic substance such as iodine is adsorbed to a polyvinyl alcohol film in a wet system and then the film is uniaxially stretched for orienting the dichromatic substance in one direction. As a protective film of a polarizing plate, resins such as cellulose ester, polycarbonate, polyolefine are generally used. Of these, a film utilizing a cellulose ester resin is employed with an overwhelming majority due to excellent optical and physical properties as a polarizing plate protective film.

The optical film utilized in the abovementioned field has had problems that, when the optical film is exposed to light including ultraviolet rays, the optical film is decomposed to cause degradation of mechanical strength, and, simultaneously, transparency of the optical film is lowered due to discoloration. Accordingly, in an optical film for which high transparency is desired, deterioration due to ultraviolet rays has been avoided by preliminary incorporating an ultraviolet absorber, for example, a benzotriazole compound, a benzophenone compound, a cyanoacrylate compound and a salicylic acid compound. However, many of these conventional ultraviolet absorbers have had the following problems: since the solubility in the optical film is low, the ultraviolet absorber tends to bleed out or deposit on the film, or the transparency of the film is lowed due to the increase of haze; and the addition amount is reduced in order to avoid coloration, deterioration or evaporation which occur in the thermal processing stage, whereby ultraviolet absorbing function is lowered. Another problem has been the contamination of the production facilities due to the evaporation of the ultraviolet absorbers.

Proposals to avoid the above drawbacks have been disclosed (refer to Patent Documents 1, 2 and 3), in which an ultraviolet absorbing polymer is prepared by introducing a polymerizable group in an ultraviolet absorber, followed by conduction polymerization or copolymerization. The ultraviolet absorbing polymers disclosed in the patent documents may be somewhat effective to avoid bleeding out, deposition and evaporation described above, however, compatibility with the resin is not fully enough, whereby sufficient transparency may not be obtained, the optical film may be colored in yellow, or ultraviolet absorbing function may be deteriorated when stored for a long period. Thus, there have still been problems for the practical use.

With respect to the method of producing a cellulose ester film, since the currently applied method of producing the film is a casting method using a halogen-containing solvent, the cost required to recover the solvent is an extremely large negative factor. Further, the halogen-containing solvent also has a problem of a large environmental load. In recent years, as a method of producing a cellulose ester film for an application to a polarizing plate protective film, a melt casting method has been carried out, for example, as disclosed in Patent Document 4. However, cellulose ester is a polymer having a very high viscosity at molten state and a high glass transition temperature. Accordingly, when cellulose ester is melted and cast extruded from a die to cast on a cooling drum or on a cooling belt, it is difficult to level the cellulose ester film. Also, since the melt solidifies in a short time after extruded, it is known that there have been problems that flatness and dimensional stability which are physical properties of the film, and uniformity in birefringence, specifically, uniformity in birefringence in the lateral direction of the film which is an important factor as an optical film, are inferior to those of a film obtained via a solution casting method. Further, since the combination of raw materials which can be used for melt kneading is different from the combination of raw materials in the conventional solution casting film forming method using a solvent, new problems have arisen that the material becomes clouded when melt-kneaded. The improvement of these problems is desired because, these problems result in deterioration of contrast or occurrence of display unevenness, when installed in a large screen liquid crystal display of 15 inches size or more. Also, since the melt casting film forming method belongs to a high temperature process of 150° C. or more, coloration of the film in the film forming process is also existing, which is another big problem for a cellulose ester film. Specifically, coloration in the edge portion in the lateral direction of the film has been difficult so far to overcome. When a wide cellulose ester film is formed, the edge of the film (also referred to as an ear portion) generated in the knurling process in which knurling is provided on both edge portions of the film or in a slitting process to adjust the width of the film of the original roll in a prescribed width, is effectively used as a recycling material. However, when coloration at the edge of the film is remarkable, the slit edge cannot be recycled and must be abandoned to use. Accordingly, coloration at the edge portion of the film is specifically desired to be improved.

Meanwhile, in order to prevent thermal degradation of a cellulose ester film when it is formed into a film via a melt casting method, a technique to incorporate a phenol anti-degradation agent, a thioether compound, or a phosphorus-containing compound into cellulose ester has been disclosed (for example, refer to Patent Document 5).

However, the improvement in dimensional stability, uniformity in birefringence, coloration, and kneading property with a cellulose ester resin have not been fully sufficient so far, even when any of known techniques are employed.

Patent Document 1 Japanese Patent Application Publication Open to Public Inspection (hereafter referred to as JP-A) No. 6-73367

Patent Document 2 JP-A No. 2003-113317

Patent Document 3 JP-A No. 2006-113175

Patent Document 4 JP-A No. 2000-352620

Patent Document 5 JP-A No. 2006-241428

### DISCLOSURE OF THE INVENTION

An object of the present invention is to provide an optical film exhibiting an ultraviolet absorbing property which is sufficient as an optical film, an excellent dimensional stability, an excellent optical property such as a small variation in the values of retardation in the film thickness direction, and reduced coloration at the edge portion in the lateral direction of the optical film; a polarizing plate employing the optical film; and a liquid crystal display, as well as an ultraviolet absorbing polymer exhibiting an excellent kneading property with a resin.

One of the aspects to achieve the above object is an optical film comprising an ultraviolet absorbing polymer derived from at least two kinds of monomers comprising:

an ethylenically unsaturated monomer having a substructure represented by Formula (A) in the molecule; and

a monomer represented by Formula (B):

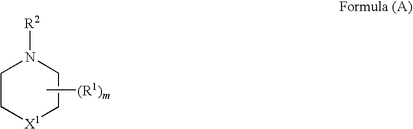

wherein
R¹ represents a hydrogen atom, an oxygen atom, a halogen atom, an aliphatic group which may have a substituent, an aromatic group which may have a substituent, or a heterocycle group which may have a substituent;
m represents an integer of 0-8, wherein, when m is 2-8, R¹ may be the same or may be different;
R² represents a group having an ethylenically unsaturated bond as a substructure;_{—} and
X¹ represents an oxygen atom or a sulfur atom,

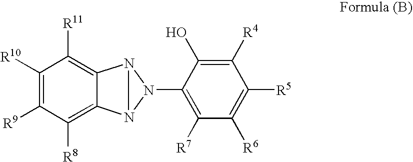

wherein
R⁴-R¹¹ each represent a hydrogen atom, a halogen atom, an aliphatic group which may have a substituent, an aromatic group which may have a substituent, or a heterocycle group which may have a substituent, provided that one of the groups represented by R⁴-R¹¹ has an ethylenically unsaturated bond as a substructure.

### BRIEF DESCRIPTION OF THE DRAWINGS

FIG. 1 is a schematic flow sheet illustrating one of the embodiments of the method of producing an optical film of the present invention.

FIG. 2 is an enlarged flow sheet of a principal portion of the production apparatus of FIG. 1.

FIG. 3a is a schematic view of one example of the principal portion of a casting die.

FIG. 3b is across-sectional view illustrating one example of the principal portion of a casting die.

FIG. 4 is a cross-sectional view of the first embodiment of a pressure rotary member.

FIG. 5 is a cross-sectional view in a plane perpendicular to the rotary shaft of the second embodiment of a pressure rotary member.

FIG. 6 is a cross-sectional view in a plane of the rotary shaft of the 2nd embodiment of a pressure rotary member.

FIG. 7 is a schematic exploded perspective view showing the construction of a liquid crystal display.

### BEST MODE TO CARRY OUT THE INVENTION

The above object of the present invention is achieved by following structures.
1. An optical film comprising an ultraviolet absorbing polymer derived from at least two kinds of monomers comprising:

an ethylenically unsaturated monomer having a substructure represented by Formula (A) in the molecule; and

a monomer represented by Formula (B):

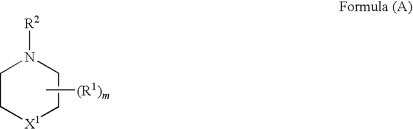

wherein
R¹ represents a hydrogen atom, an oxygen atom, a halogen atom, an aliphatic group which may have a substituent, an aromatic group which may have a substituent, or a heterocycle group which may have a substituent;
m represents an integer of 0-8, wherein, when m is 2-8, R¹ may be the same or may be different;
R² represents a group having an ethylenically unsaturated bond as a substructure; and
X¹ represents an oxygen atom or a sulfur atom,

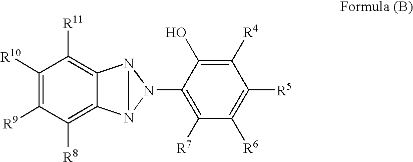

wherein
R⁴-R¹¹ each represent a hydrogen atom, a halogen atom, an aliphatic group which may have a substituent, an aromatic group which may have a substituent, or a heterocycle group which may have a substituent, provided that one of the groups represented by R⁴-R¹¹ has an ethylenically unsaturated bond as a substructure.
2. An optical film comprising an ultraviolet absorbing polymer derived from at least three kinds of monomers comprising:

an ethylenically unsaturated monomer having a substructure represented by above Formula (A) in the molecule;

a monomer represented by above Formula (B); and

a monomer represented by Formula (C):

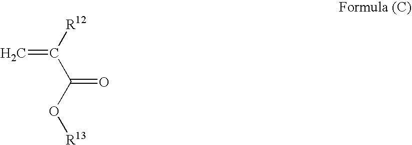

wherein
R¹² represents a hydrogen atom or an alkyl group; and
R¹³ represents an alkyl group which may have a substituent.
3. The optical film of Item 1 or 2, wherein the monomer represented by Formula (B) comprises at least a monomer represented by Formula (D) and a monomer represented by Formula (E):

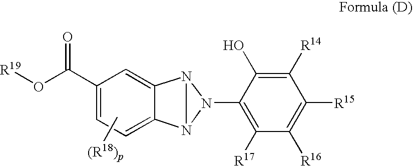

wherein
R¹⁴-R¹⁸ each represent a hydrogen atom, a halogen atom, an aliphatic group which may have a substituent, an aromatic group which may have a substituent, or a heterocycle group which may have a substituent;
p represents an integer of 0-3; and
R¹⁹ represents a group having an ethylenically unsaturated bond as a substructure,

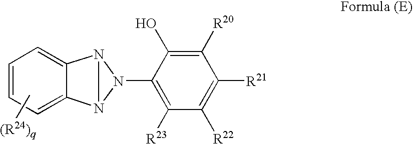

wherein
R²⁰-R²⁴ each represent a hydrogen atom, a halogen atom, an aliphatic group which may have a substituent, an aromatic group which may have a substituent, or a heterocycle group which may have a substituent; and
q represents an integer of 0-4,
wherein one of the groups represented by R²⁰-R²³ has an ethylenically unsaturated bond as a substructure.
4. The optical film of any one on Items 1 to 3, wherein the ethylenically unsaturated monomer having a substructure represented by Formula (A) in the molecule is N-acryloyl morpholine.
5. The optical film of any one on Items 1 to 4, wherein a content ratio of the ethylenically unsaturated monomer having a substructure represented by Formula (A) in the molecule is 65% by mass or less based on the mass of the whole polymer.
6. The optical film of any one on Items 1 to 5, wherein a weight average molecular weight of the ultraviolet absorbing polymer is 1000-70000.
7. The optical film of any one on Items 1 to 6, wherein the optical film comprises a cellulose ester.
8. The optical film of any one on Items 1 to 7, wherein the optical film comprises at least one of a carbon radical scavenger, a phenol compound and a phosphorus-containing compound.
9. The optical film of Item 7 or 8, wherein the cellulose ester meets acyl substitution degrees represented by following Conditions (1) to (3):

2.4≦A+B<3.0 Condition (1)

0≦A≦2.4 Condition (2)

0.1≦B<3.0 Condition (3)

wherein A represents an acetyl substitution degree, and B represents a sum of substitution degrees by acyl groups having 3 to 5 carbon atoms.
10. The optical film of Item 8 or 9, wherein the carbon radical scavenger is represented by Formula (1):

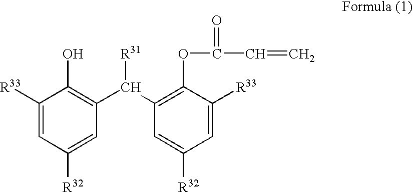

wherein R³¹ represents a hydrogen atom or an alkyl group having 1-10 carbon atoms, and R³² and R³³ each independently represent an alkyl group having 1-8 carbon atoms.
11. The optical film of Item 8 or 9, wherein the carbon radical scavenger is represented by Formula (2):

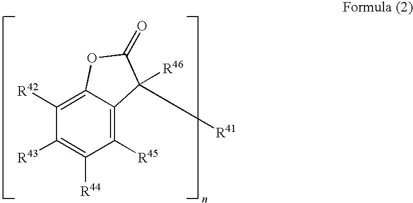

wherein
R⁴² to R⁴⁶ each independently represent a hydrogen atom, an aliphatic group which may have a substituent, an aromatic group which may have a substituent, or a heterocycle group which may have a substituent; and
n represents 1 or 2,
wherein,
   when n is 1, R⁴¹ represents an aliphatic group which may have a substituent, an aromatic group which may have a substituent, or a heterocycle group which may have a substituent, and, when n is 2, R⁴¹ represents a divalent linkage group.
12. The optical film of any one on Items 8 to 11, wherein the phosphorus-containing compound is a phosphonite compound represented by Formula (3) or (4):

R⁵¹P(OR⁵²)₂ Formula (3)

wherein
R⁵¹ represents a phenyl group which may have a substituent or a thienyl group which may have a substituent; and
R⁵² represents an alkyl group which may have a substituent, a phenyl group which may have a substituent, or a thienyl group which may have a substituent, provided that a plurality of R⁵² may be combined with each other to form a ring,

(R⁵⁴O)₂PR⁵³—R⁵³P(OR⁵⁴)₂ Formula (4)

wherein
R⁵³ represents a phenylene group which may have a substituent or a thienylene group which may have a substituent; and

1R⁵⁴ represents an alkyl group which may have a substituent, a phenyl group which may have a substituent, or a thienyl group which may have a substituent, provided that a plurality of R⁵⁴ may be combined with each other to form a ring.
13. The optical film of Item 12, wherein R⁵⁴ is a substituted phenyl group having a substituent of which sum of carbon number is 9 to 14 per one phenyl group, wherein the phenyl group may have a plurality of substituents as far as a sum of carbon numbers per one phenyl group is 9-14.
14. The optical film of Item 12, wherein the phosphonite compound represented by Formula (4) is tetrakis(2,4-di-t-butyl-5-methylphenyl)-4,4′-biphenylenediphosphonite.
15. A polarizing plate employing the optical film of any one of Items 1 to 14.
16. A liquid crystal display employing the optical film of any one of claims 1 to 14 or a polarizing plate of Item 15.
17. An ultraviolet absorbing polymer derived from at least three kinds of monomers comprising:

an ethylenically unsaturated monomer having a substructure represented by above Formula (A) in the molecule;

a monomer represented by above Formula (B); and

a monomer represented by above Formula (C):
18. The ultraviolet absorbing polymer of Item 17, wherein the monomer represented by Formula (B) is at least the monomer represented by Formula (D) or (E).
19. The ultraviolet absorbing polymer of Item 17 or 18, wherein the ethylenically unsaturated monomer having a substructure represented by Formula (A) is N-acryloyl morpholine.

Best modes to carry out the present invention will now be explained below, however, the present invention is not limited thereto.

### (Optical Film)

The optical film of the present invention will be described.

In the present invention, the optical film means a functional film used for various display devices such as a liquid crystal display, a plasma display and an organic EL display, and more in detail, includes a polarizing plate protect film, a retardation film, an anti-reflection film, a brightness enhancing film, a hard-coat film, an anti-glare film, an anti-static film and an optical compensation film such as for expanding a viewing angle.

Resins used for a resin film as a substrate of the optical film of the present invention includes cellulose ester resins, polycarbonate resins, polystyrene resins, polysulfone resins, polyester resins, polyallylate resin, acryl resins, olefin resins (such as norbornane resins, cyclic olefin resins cyclic conjugate diene resins and vinyl alicyclic hydrocarbon resins). Cellulose ester resins, polycarbonate resins and monocyclic olefin resins are preferable among them, and the cellulose ester resins are specifically preferable.

These resins may be used in combination together, for example, cellulose ether resins, polyvinyl resins (including polyvinyl acetate resin and polyvinyl alcohol resins), cyclic olefin resins, polyester resins (aromatic polyesters, aliphatic polyesters or copolymers thereof), aryl resins (including copolymers) may be incorporated in addition to cellulose ester resins. Content, of the resins other than cellulose ester resin is preferably 0.1-30% by weight.

The optical film related to the present invention is used for preferably a polarizing plate protect film, a retardation film, and an optical compensation film, and specifically preferably used for a polarizing plate protect film.

As one of the best modes of the present invention, examples of cellulose ester will be explained in detail, however, the present invention is not limited thereto.

There are mainly two methods to manufacture a cellulose ester optical film. A solution casting method which is one of the two methods is a method in which a solution prepared by dissolving a cellulose ester in a solvent is cast and dried by evaporating the solvent. In this process, the solvent remaining in the film has to be removed. Therefore, the investment in the manufacturing line and the manufacturing cost caused by the drying line, drying energy and recovering and recycling of the evaporated solvent are massively raised, and the reduction of such the cost becomes an important subject. In contrast, the load for drying and the load for the equipment are not necessary in a melt casting method because the solvent to be used to prepare the cellulose ester solution for the solution casting is not needed in the film formation by the melt casting method. Accordingly, in the present invention, a melt casting method is specifically preferably employed rather than a solution casting method.

In view of the foregoing problems, the present inventors, have found that a polymer derived from a monomer having a specific benzotriazole structure and a monomer having a specific structure exhibits a specifically higher compatibility with the cellulose ester, and, when the cellulose ester is melt cast, the obtained film exhibits low haze, excellent dimensional stability which is amazing and excellent retardation uniformity, in addition to low coloring at the lateral edges of the film. Further, it was found that, by melt casting a film while mixing at least one compound selected from the group consisting of a carbon radical scavenger, a phenol compound and a phosphorus-containing compound in the melt, the dimensional stability and the retardation uniformity are further improve, and, simultaneously, the coloration at the lateral edges of the film can be reduced. Thus, it was found that a cellulose ester optical film having a property equal to or more than that of a cellulose ester optical film produced by a solution casting method can be obtained by a melt casting method due to the above mentioned effects.

The various compounds used in the present invention will be explained in detail.
(Ultraviolet absorbing polymer derived from at least two kinds of monomers comprising an ethylenically unsaturated monomer having a substructure represented by Formula (A) in the molecule and a monomer represented by Formula (B))

The optical film of the present invention contains at least one ultraviolet absorbing polymer containing at least two kinds of monomers comprising an ethylenically unsaturated monomer having a substructure represented by Formula (A) in the molecule and a monomer represented by Formula (B). The abovementioned ultraviolet absorbing polymer is a nonionic polymer.

In Formula (A), R¹ represents a hydrogen atom, an oxygen atom, a halogen atom, an aliphatic group which may have a substituent, an aromatic group which may have a substituent, or a heterocycle group which may have a substituent; m represents an integer of 0-8, wherein, when m is 2-8, R¹ may be the same or may be different; R² represents a group having an ethylenically unsaturated bond as a substructure; and X¹ represents an oxygen atom or a sulfur atom.

The group represented by R¹ is not specifically limited. Examples of a group represented by R¹ include an alkyl group (such as a methyl group, an ethyl group, a propyl group, an isopropyl group, a t-butyl group, a pentyl group, a hexyl group, an octyl group, a dodecyl group and trifluoromethyl group), a cycloalkyl group (such as a cyclopentyl group and a cyclohexyl group), an aryl group (such as a phenyl group and a naphthyl group), an acylamino group (such as an acetylamino group and a benzoylamino group), an alkylthio group (such as a methylthio group and an ethylthio group), an arylthio group (such as a phenylthio group and a naphthylthio group), an alkenyl group (such as a vinyl group, a 2-propenyl group, a 3-butenyl group, a 1-methyl-3-propenyl group, a 3-pentenyl group, a 1-methyl-3-butenyl group, a 4-hexenyl group and a cyclohexenyl group), a halogen atom (such as a fluorine atom, a chlorine atom, a bromine atom and an iodine atom), an alkynyl group (such as a propargyl group), a heterocyclic group (such as a pyridyl group, a thiazolyl group, an oxazolyl group and an imidazolyl group), an alkylsulfonyl group (such as a methylsulfonyl group and an ethylsulfonyl group), an arylsulfonyl group (such as a phenylsulfonyl group and a naphthylsulfonyl group), an alkylsulfinyl group (such as a methylsulfinyl group), an arylsulfinyl group (such as a phenylsulfinyl group), a phosphono group, an acyl group (such as an acetyl group, a pivaloyl group and a benzoyl group), a carbamoyl group (such as an aminocarbonyl group, a methylaminocarbonyl group, a dimethylaminocarbonyl group, a butylaminocarbonyl group, a cyclohexylaminocarbonyl group, a phenylaminocarbonyl group and a 2-pyridylaminocarbonyl group), a sulfamoyl group (such as an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group and a 2-pyridylaminosulfonyl group), a sulfonamide group (such as a methanesulfonamide group and a benzenesulfonamido group), a cyano group, an alkoxy group (such as a methoxy group, an ethoxy group and a propoxy group), an aryloxy group (such as a phenoxy group and a naphthyloxy group), a heterocyclicoxy group, a siloxy group, an acyloxy group (such as an acetyloxy group and a benzoyloxy group), a sulfonic acid group, a salt of sulfonic acid, an aminocarbonyloxy group, an amino group (such as an amino group, an ethylamino group, a dimethylamino group, a butylamino group, a cyclopentylamino group, a 2-ethylhexylamino group and a dodecylamino group), an anilino group (such as a phenylamino group, a chlorophenylamino group, a toluidino group, an anisidino group, a naphthylamino group and a 2-pyridylamino group), an imido group, a ureido group (such as a methylureido group, an ethylureido group, a pentylureido group, a cyclohexylureido group, an octylureido group, a dodecylureido group, a phenylureido group, a naphthylureido group and a 2-pyridylaminoureido group), an alkoxycarbonylamino group (such as a methoxycarbonylamino group and a phenoxycarbonylamino group), an alkoxycarbonyl group (such as methoxycarbonyl group, ethoxycarbonyl group and phenoxycarbonyl group), an aryloxycarbonyl group (such as a phenoxycarbonyl group), a heterocyclicthio group, a thioureido group, a carboxyl group, a salt of carboxylic acid, a hydroxyl group, a mercapto group and a nitro group. These groups may be further substituted by a similar substituent.

R² has an ethylenically unsaturated bond. Specific examples of an etylenically unsaturated bond include a vinyl group, an allyl group, an acryloyl group, a methacryloyl group, a styryl group, an acrylamide group, a methacrylamide group, a vinyl cyanide group, a 2-cyanoacryloxy group, a 1,2-epoxy group, a vinylbenzyl group, and a vinylether group. Of these, preferable are a vinyl group, an acryloyl group, a methacryloyl group and a methacrylamide group.

Examples of an ethylenically unsaturated monomer having a substructure represented by Formula (A) employed in the present invention will be shown below, however, the present invention is not limited thereto.

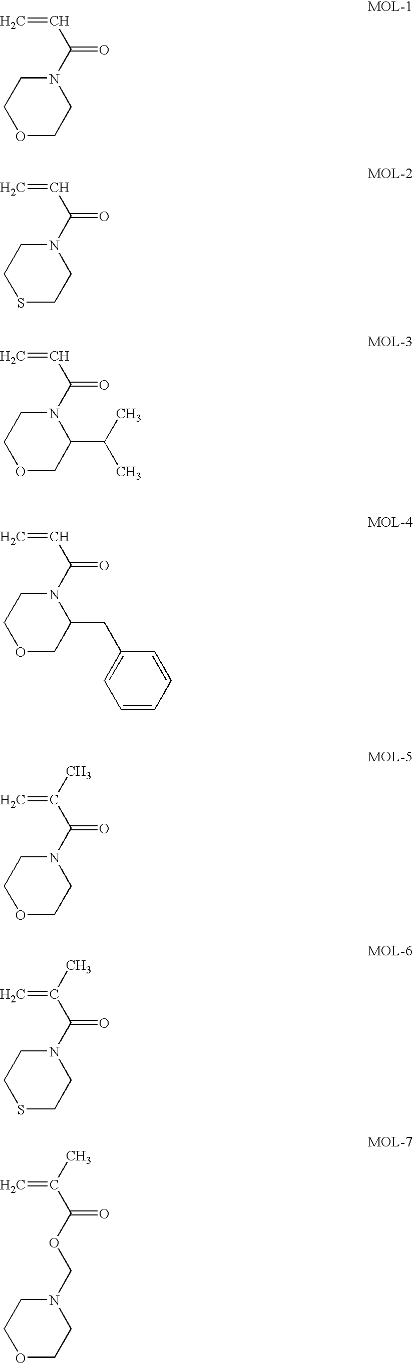

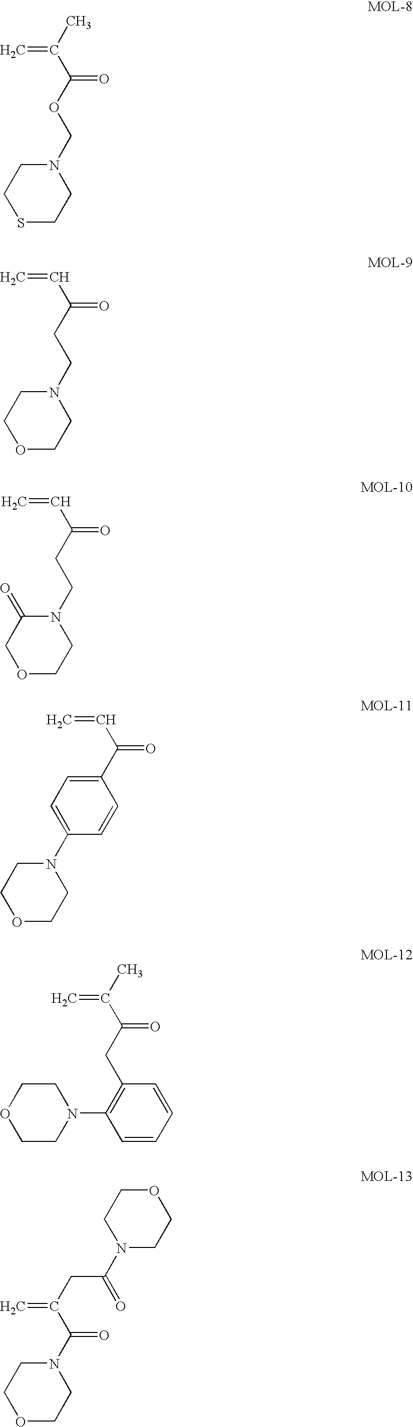

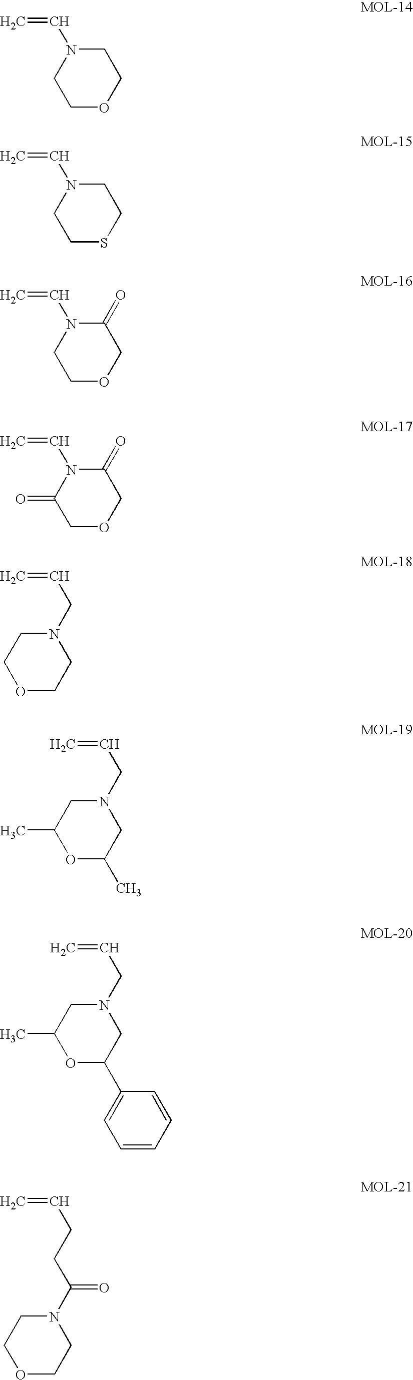

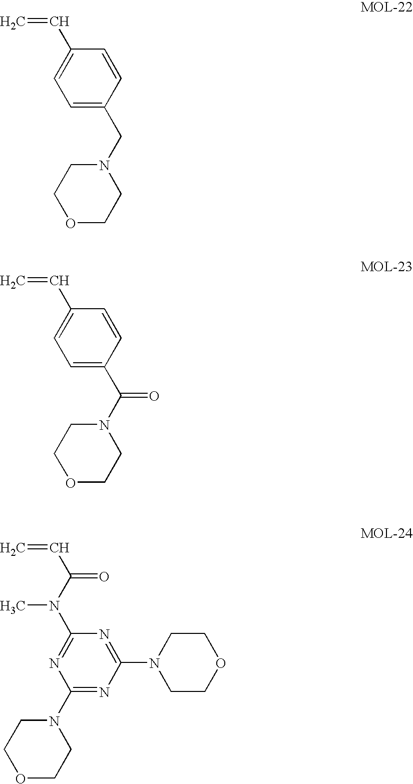

The ethylenically unsaturated monomer having a substructure represented by Formula (A) in the molecule may be used alone or in combination of two or more kinds. As the ethylenically unsaturated monomer having a substructure represented by Formula (A) in the molecule, specifically preferable is N-acryloyl morpholine.

The ethylenically unsaturated monomer having a substructure represented by Formula (A) in the molecule are commercially available in the market or may be synthesized by referring to known documents in the art.

In Formula (B), R⁴-R¹¹ each represent a hydrogen atom, a halogen atom, an aliphatic group which may have a substituent, an aromatic group which may have a substituent, or a heterocycle group which may have a substituent, provided that one of the groups represented by R⁴-R¹¹ has an ethylenically unsaturated bond as a substructure.

Examples of a halogen atom include a fluorine atom, a chlorine atom, a bromine atom, and an iodine atom. Of these, preferable is a fluorine atom or a chlorine atom. Examples of an aliphatic group which may have a substituent, an aromatic group which may have a substituent, or a heterocycle group which may have a substituent include alkyl groups (for example, a methyl group, an ethyl group, an isopropyl group, a hydroxyethyl group, a methoxymethyl group, a trifluoromethyl group, and a t-butyl group); alkenyl groups (for example, a vinyl group, an allyl group, and a 3-butene-1-yl group); aryl groups (for example, a phenyl group, a naphthyl group, a p-tolyl group, and a p-chlorophenyl group); heterocycle groups (for example, a pyridyl group, a benzimidazolyl group, a benzothiazolyl group, and a benzoxazolyl group); alkoxy groups (for example, a methoxy group, an ethoxy group, an isopropoxy group, and a n-butoxy group); aryloxy groups (for example, a phenoxy group); heterocycleoxy groups (for example, a 1-phenyltetrazole-5-oxy group, and a 2-tetrahydropyranyloxy group); acyloxy groups (for example, an acetoxy group, a pivaloyloxy group, and a benzoyloxy group); acyl groups (for example, an acetyl group, a propanoyl group, and a butyroyl group); alkoxycarbonyl groups (for example, a methoxycarbonyl group, and an ethoxycarbonyl group); aryloxycarbonyl groups (for example, a phenoxycarbonyl group); carbamoyl groups (for example, a methylcarbamoyl group, an ethylcarbamoyl group, and a dimethylcarbamoyl group); amino groups, alkylamino groups (for example, a methylamino group, an ethylamino group, and a diethylamino group); anilino groups (for example, an anilino group, and a N-methylanilino group); acylamino groups (for example, an acetylamino group, and a propionylamino group); hydroxyl groups, cyano groups, nitro groups, sulfonamide groups (for example, a methanesulfonamide group, and a benzenesulfonamide group); sulfamoylamino groups (for example, a dimethylsulfamoylamino group); sulfonyl groups (for example, a methanesulfonyl group, a butanesulfonyl group, and a phenylsulfonyl group); sulfamoyl groups (for example, an ethylsulfamoyl group, and a dimethylsulfamoyl group); sulfonylamino groups (for example, a methanesulfonylamino group, and a benzenesulfonylamino group); ureido groups (for example, a 3-methylureido group, a 3,3-dimethylureido group, and a 1,3-dimethylureido group); imide groups (for example, a phthalimide group); silyl groups (for example, a trimethylsilyl group, a triethylsilyl group, and a t-butyldimethylsilyl group); alkylthio groups (for example, a methylthio group, an ethylthio group, and an n-butylthio group); and arylthio groups (for example, a phenylthio group). Of these, preferable are alkyl groups and aryl groups. When each group represented by R₅ to R₉ can be further substituted, the above group may be further substituted. As a substituent, the groups described for R1 may be cited. And neighboring groups of R⁴-R⁷ and R⁸-R¹¹ may be combined to form a 5 to 7-membered ring.

One of the groups represented by R⁴-R¹¹ has an ethylenically unsaturated bond as a substructure. Specific examples of an etylenically unsaturated bond include a vinyl group, an allyl group, an acryloyl group, a methacryloyl group, a styryl group, an acrylamide group, a methacrylamide group, a vinyl cyanide group, a 2-cyanoacryloxy group, a 1,2-epoxy group, a vinylbenzyl group, and a vinylether group. Of these, preferable are a vinyl group, an acryloyl group, a methacryloyl group and a methacrylamide group. The term of “having an ethylenically unsaturated bond as a substructure” means that the above described ethylenically unsaturated bond is bonded directly or through a divalent or more valent bonding group. The divalent or more valent bonding group includes an alkylene group (such as methylene, 1,2-ethylene, 1,3-propyrene, 1,4-butyrene, and cyclohexane-1,4-diyl), an alkenylene group (such as ethane-1,2-diyl, and butadiene-1,4-diyl), an alkynylene group (such as ethyne-1,2-diyl, and butane-1,3-diyn-1,4-diyl), a bonding group derived from a compound containing at least one of aromatic group, (such as substituted or non substituted benzene, a condensed polycyclic hydrocarbon, an aromatic heterocycle, an aromatic hydrocarbon cycle assemble, an aromatic heterocycle assemble and a heteroatom linkage group (such as atoms of oxygen, sulfur, nitrogen, silicon and phosphorus). Of these, preferable are an alkylene group and a heteroatom linkage group. These groups may be combined to form a composite group.

Preferable examples of a monomer represented by Formula (B) will be exemplified below, however, the present invention is not limited thereto.

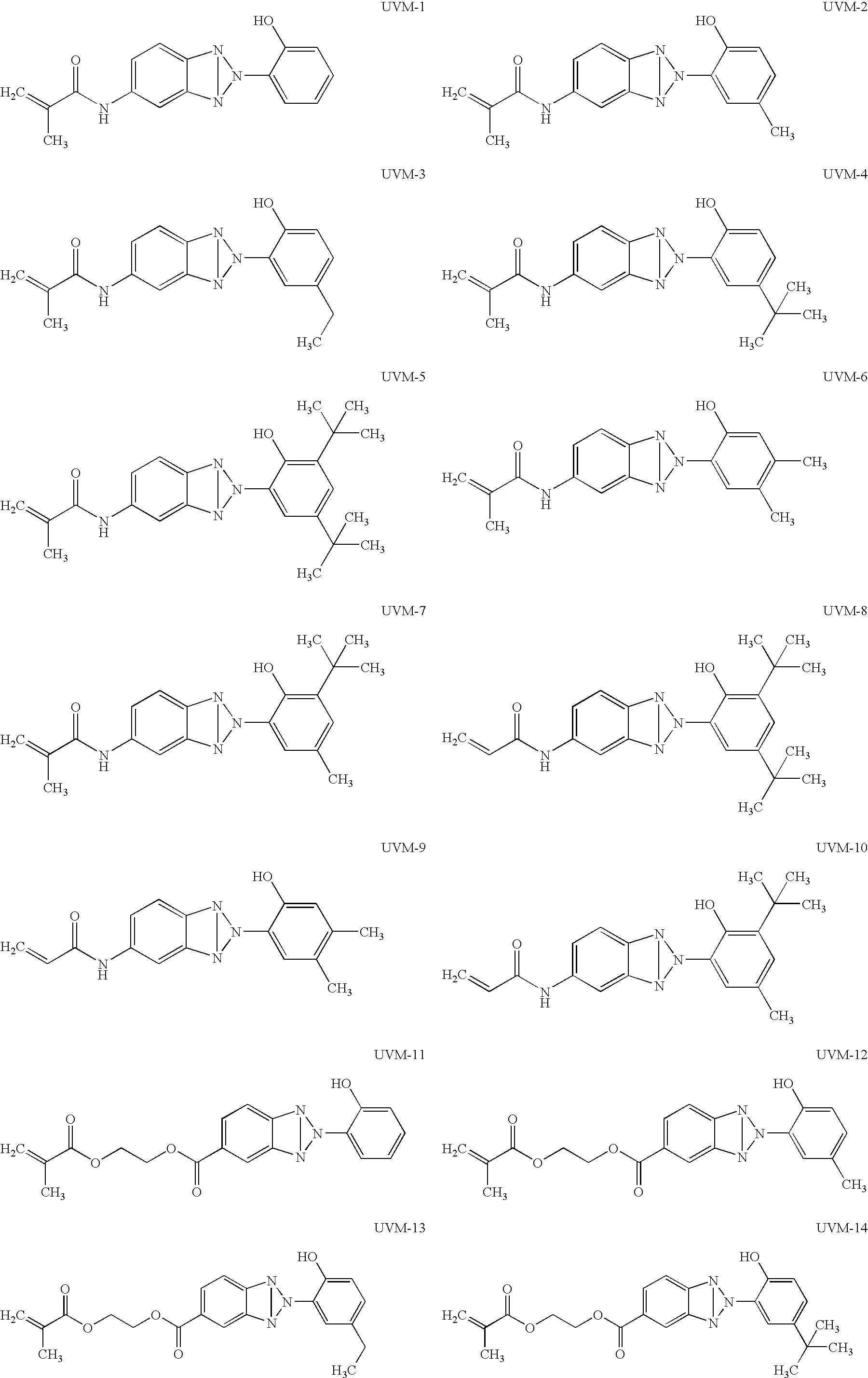

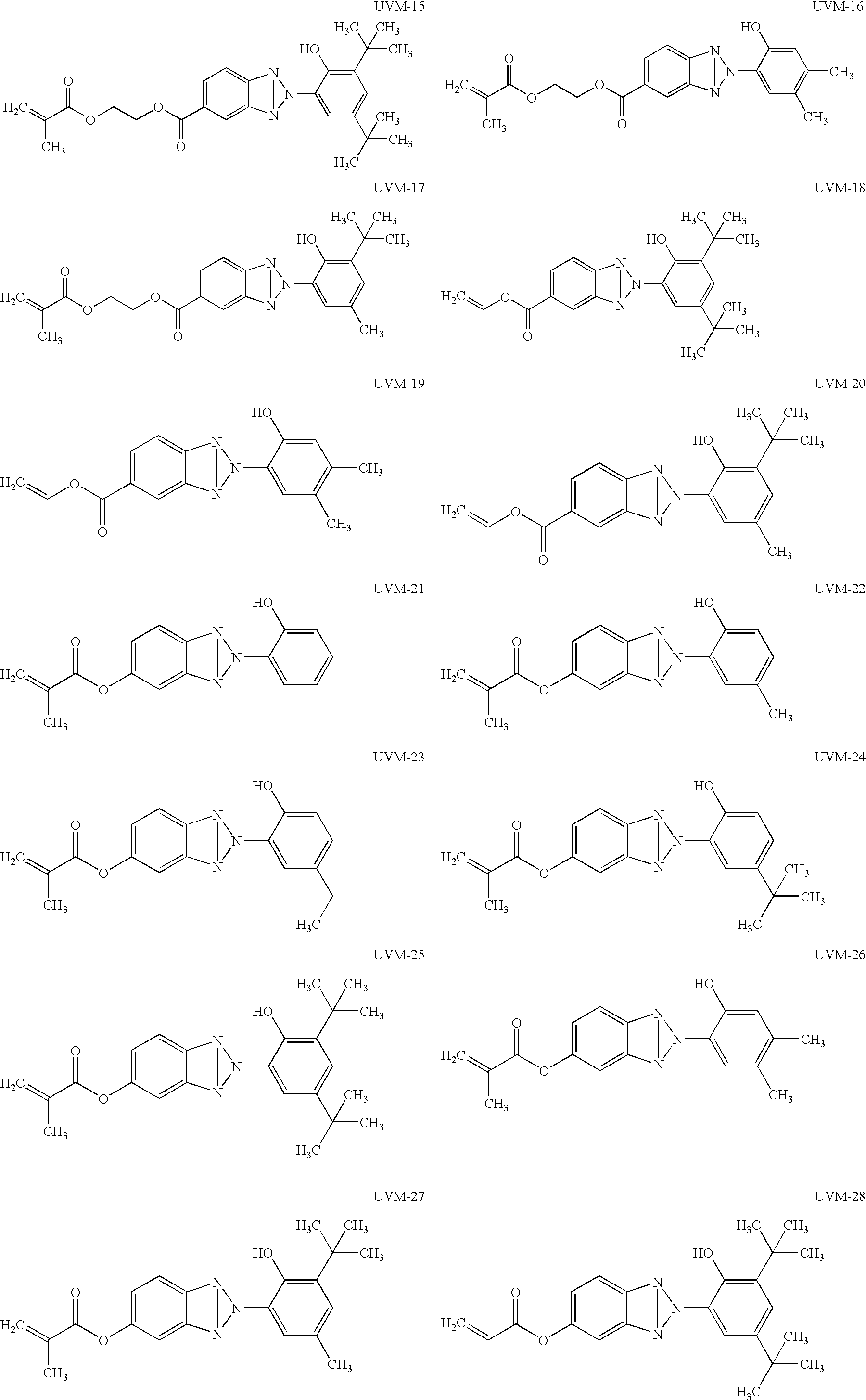

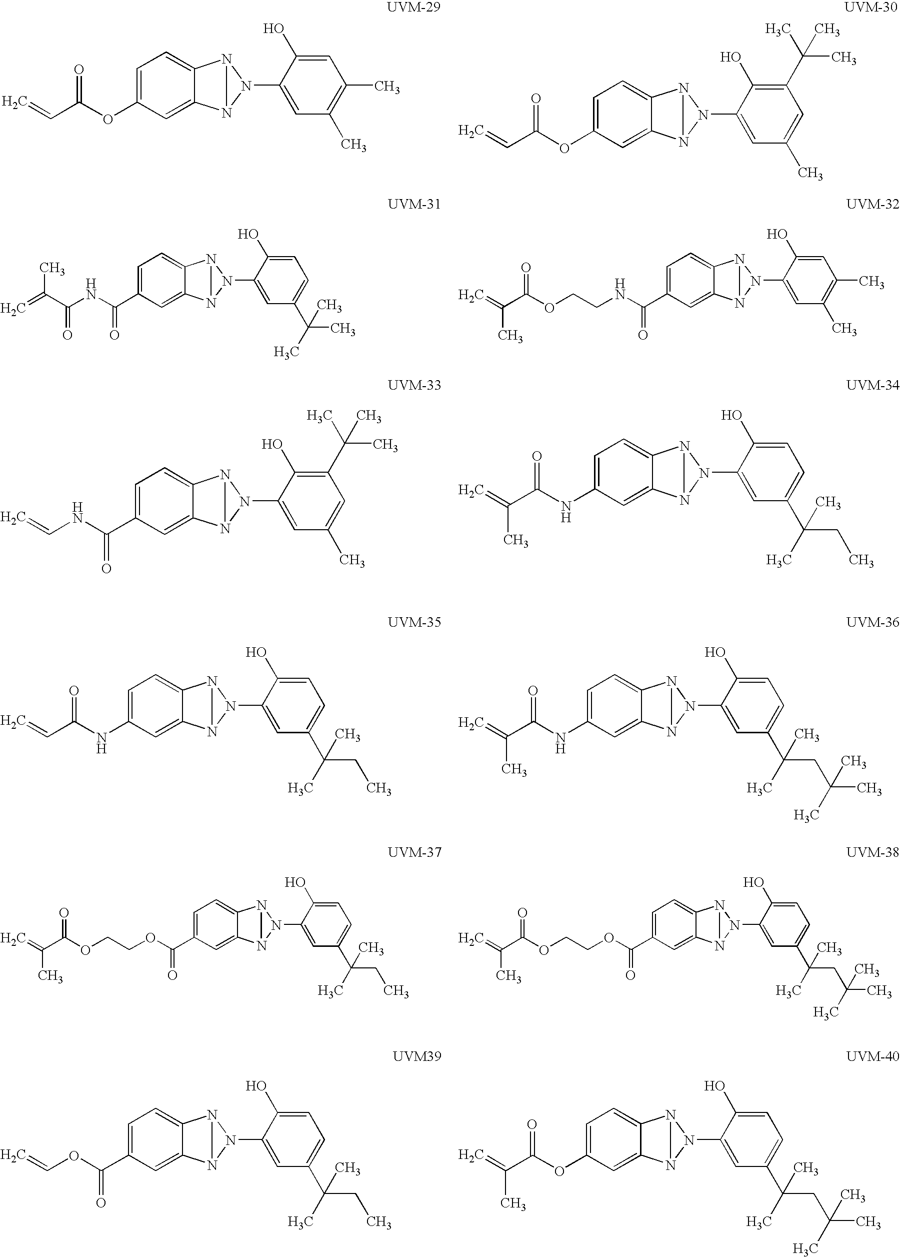

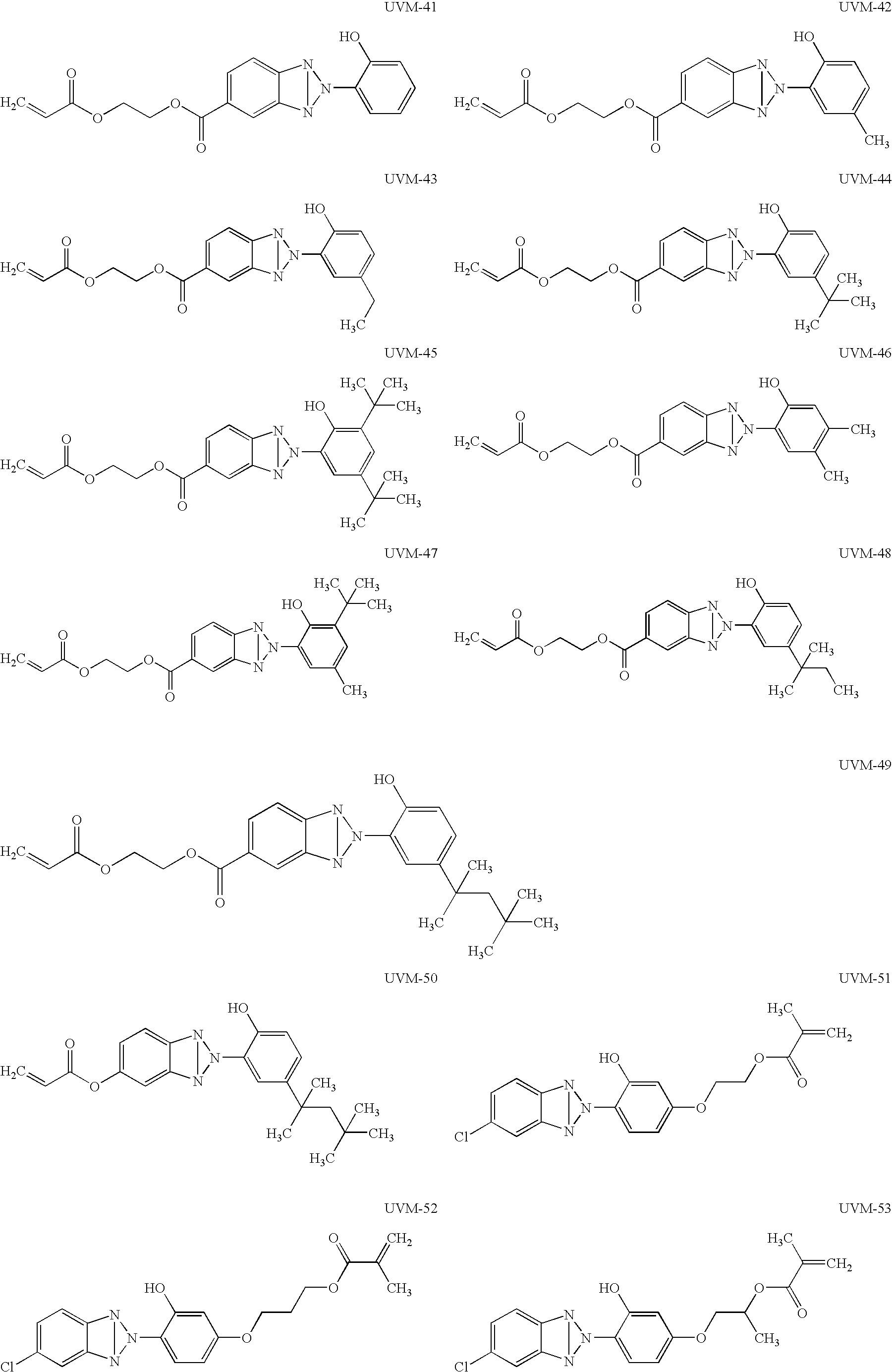

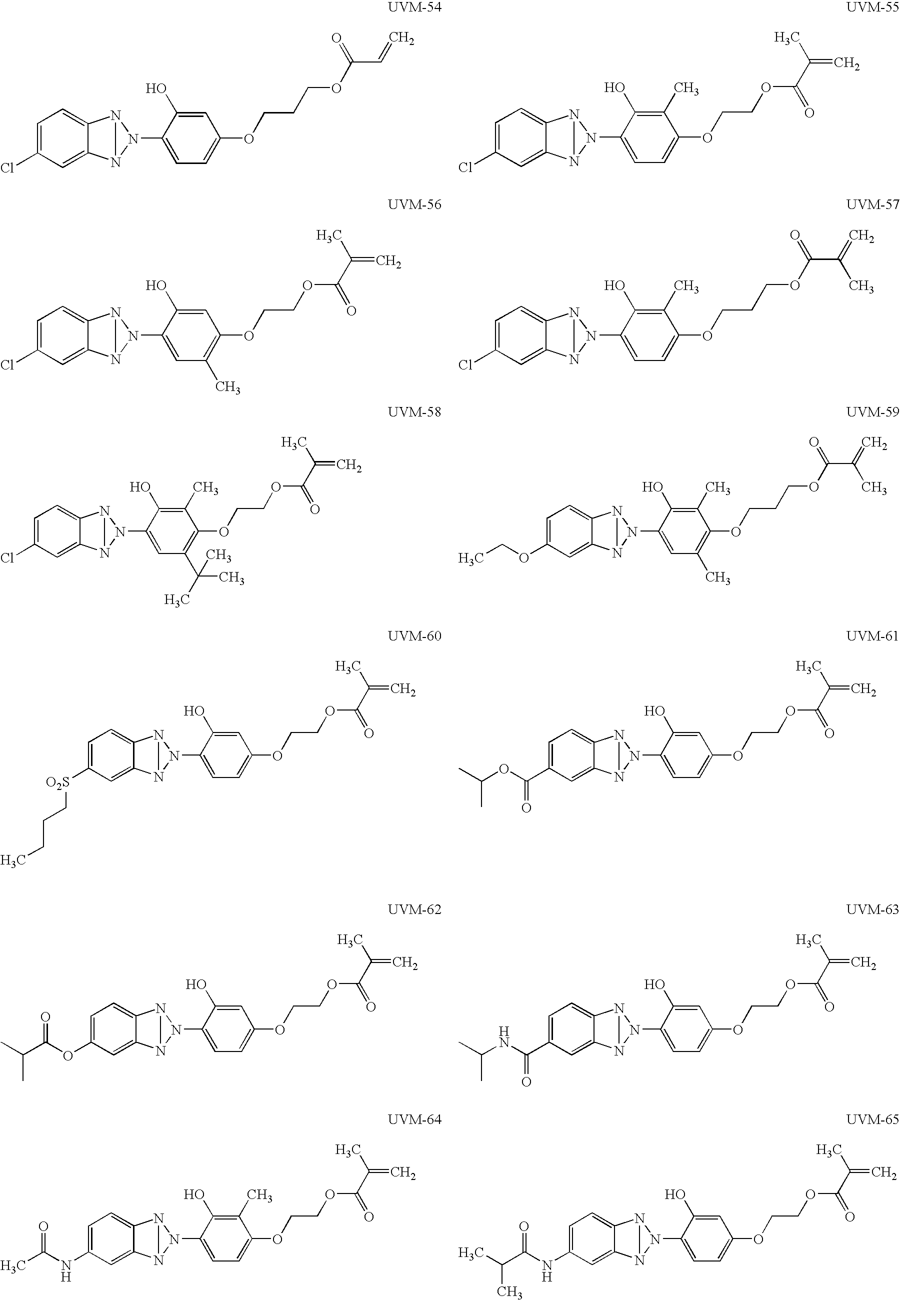

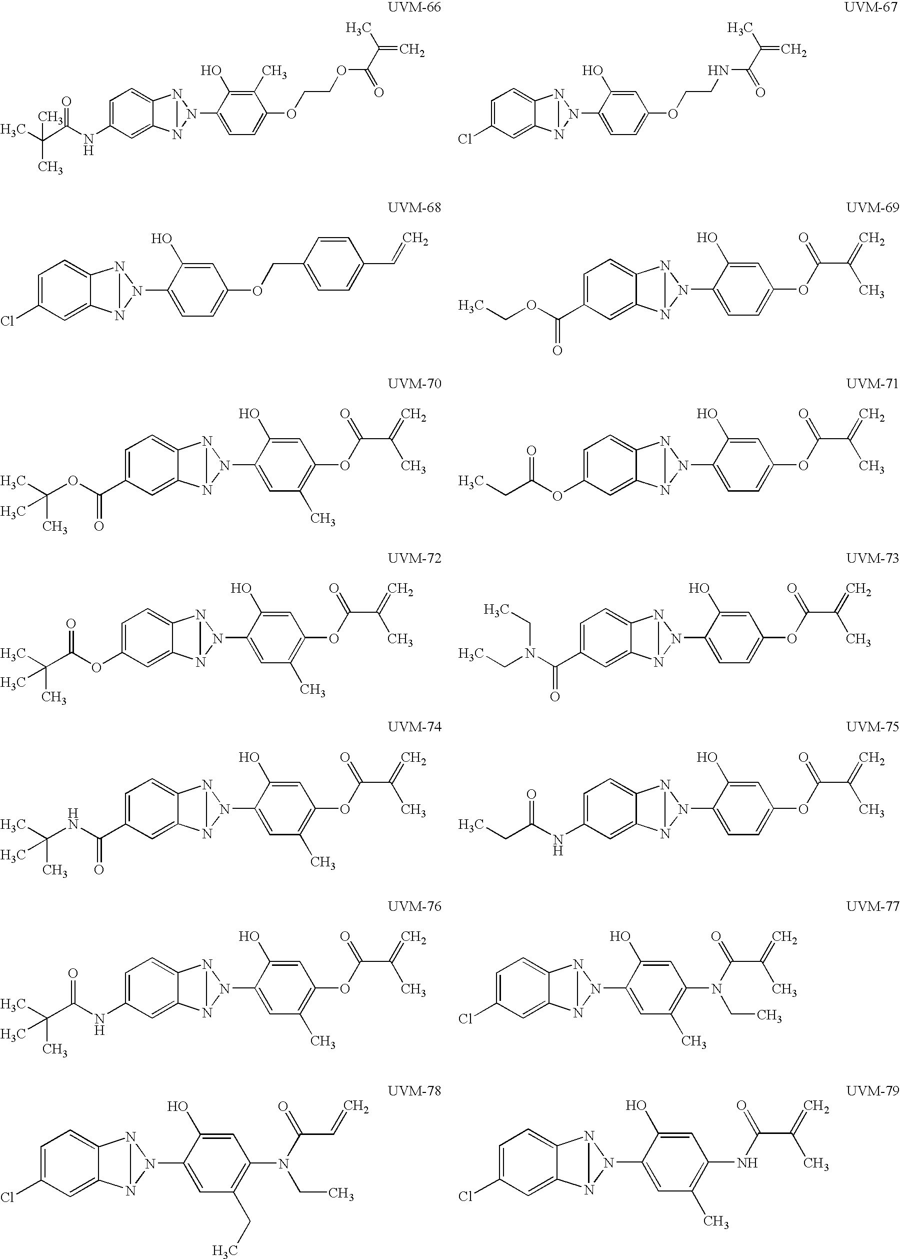

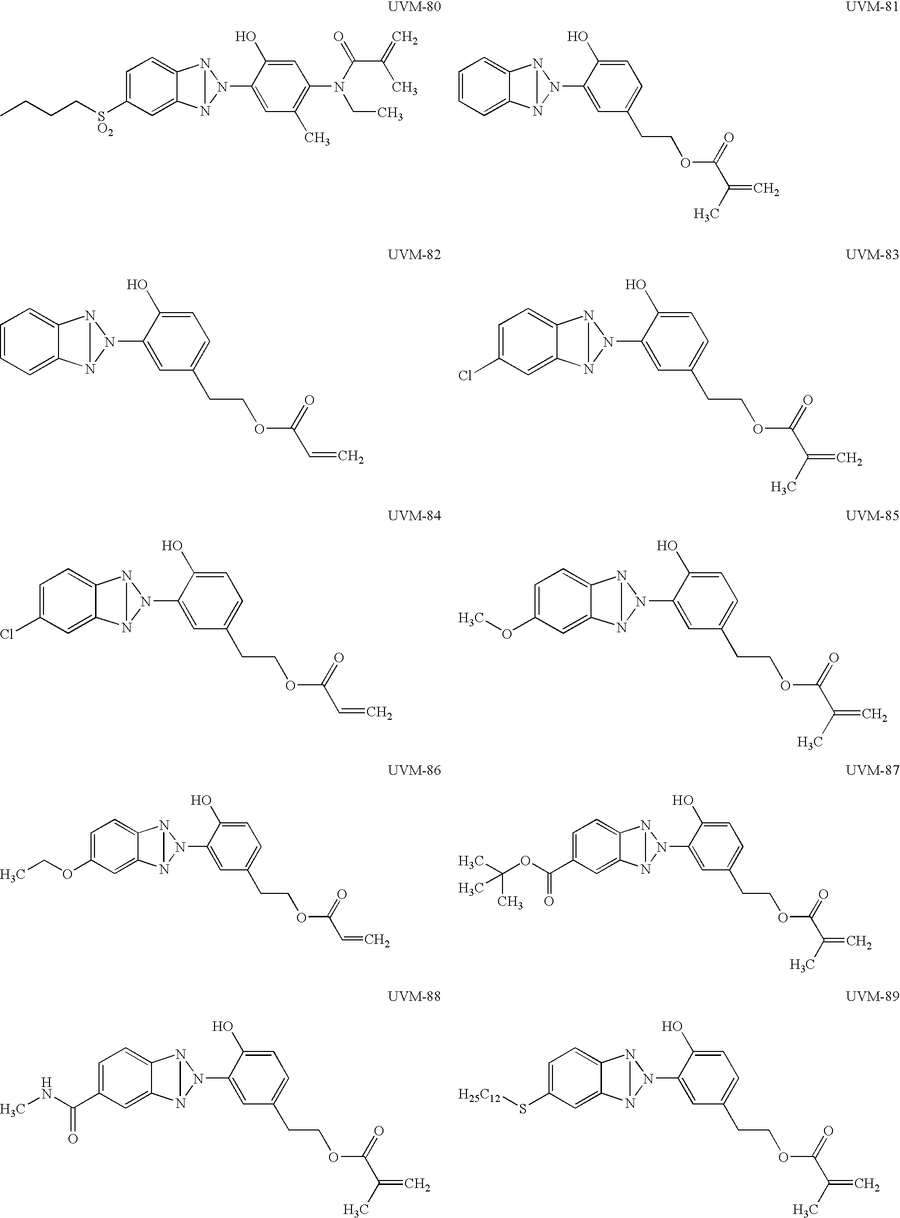

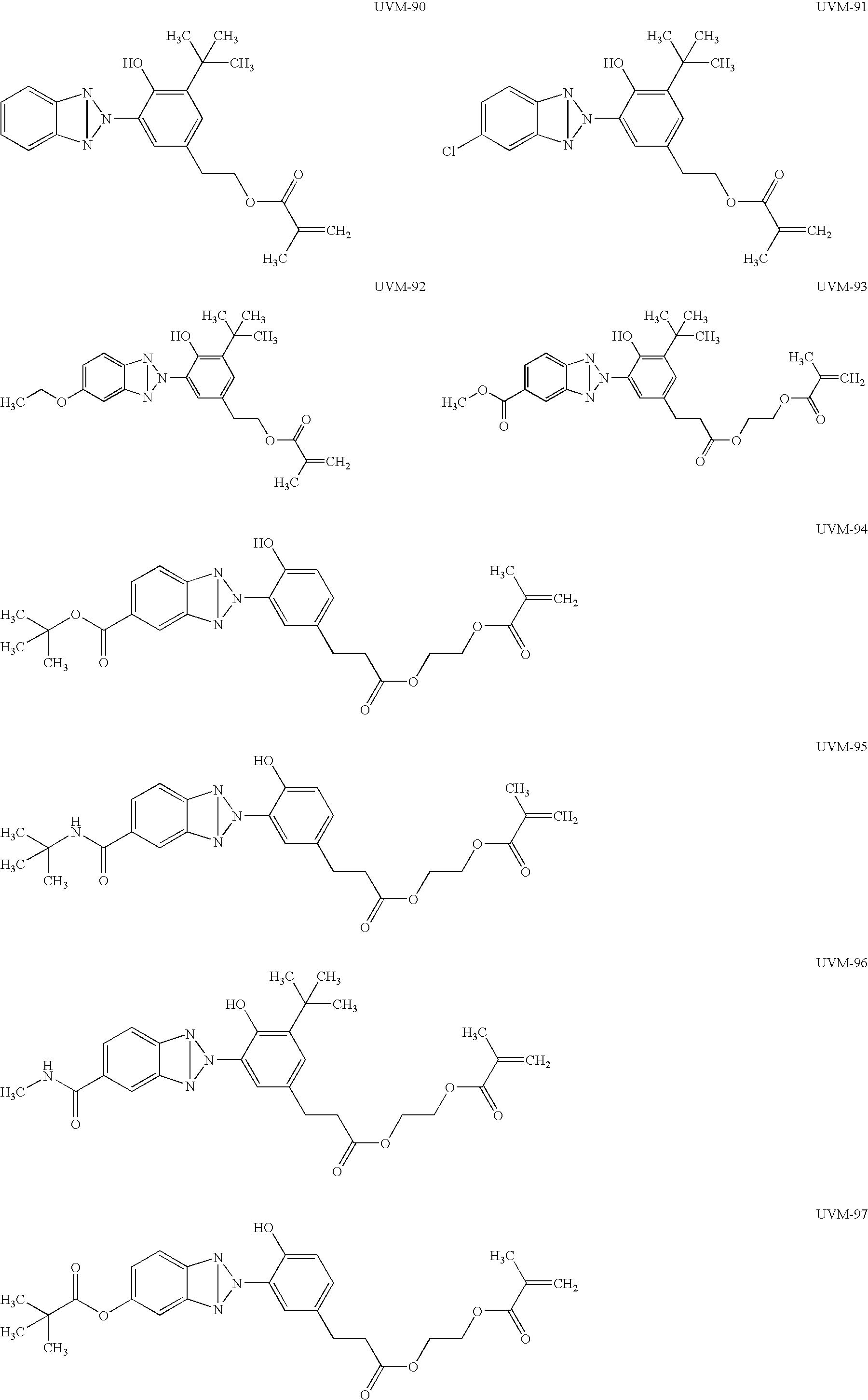

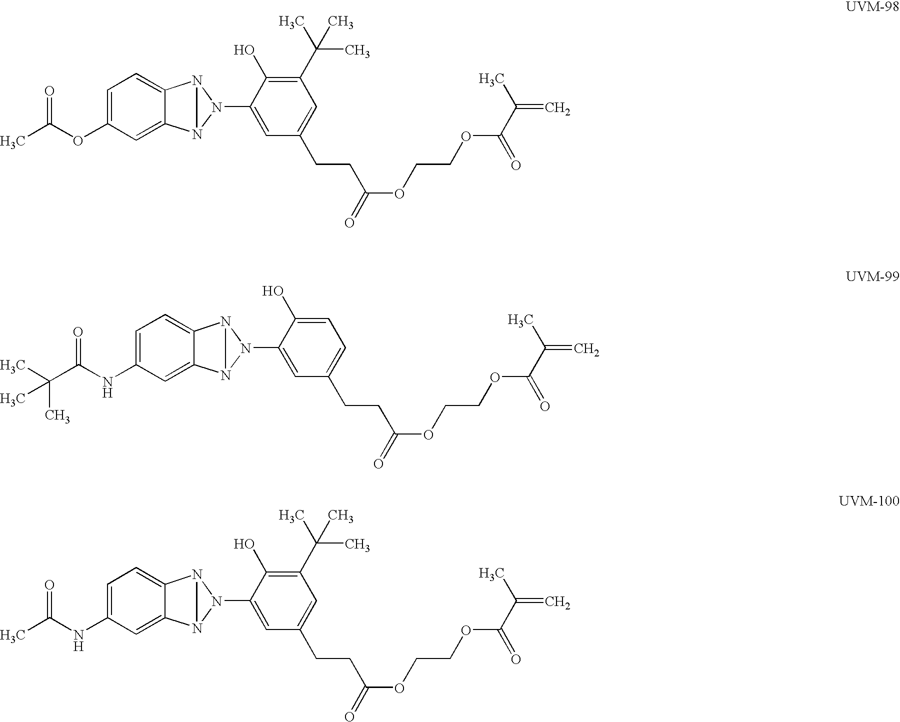

The ethylenically unsaturated monomer represented by abovementioned Formula (B) may be used alone or in combination of two kinds or more. Also, it is preferable to use in combination of two kinds or more of Formula (D) and Formula (E). In Formula (D), R¹⁴-R¹⁸ each represent a hydrogen atom, an aliphatic group which may have a substituent, an aromatic group which may have a substituent, or a heterocycle group which may have a substituent; p represents an integer of 0-3; and R¹⁹ represents a group having an ethylenically unsaturated bond as a substructure. In Formula (E), R²⁰-R²⁴ each represent a hydrogen atom, a halogen atom, an aliphatic group which may have a substituent, an aromatic group which may have a substituent, or a heterocycle group which may have a substituent; and q represents an integer of 0-4, wherein one of the groups represented by R²⁰-R²³ has an ethylenically unsaturated bond as a substructure. As examples of an aliphatic group which may have a substituent, an aromatic group which may have a substituent, a heterocycle group which may have a substituent and a group having an ethylenically unsaturated bond as a substructure, the same groups described for Formula (B) may also be cited.

The monomer represented by Formula (B) and the intermediate thereof used in the present invention can be synthesized with referring to a well-known bibliography. For example, U.S. Pat. Nos. 3,072,585, 3,159,646, 3,399,173, 3,761,272, 4,028,331 and 5,683,861; European Patent No. 86,300,416; JP-A Nos. 63-227575 and 63-185969; Polymer Bulletin, V. 20(2), 169-176; and Chemical Abstracts, V. 109, No. 191389.

The optical film of the present invention preferably contains at least one ultraviolet absorbing polymer derived from at least three kinds of monomers of an ethylenically unsaturated monomer having a substructure represented by Formula (A) in the molecule; a monomer represented by Formula (B); and a monomer represented by Formula (C).

In Formula (C), R¹² represents a hydrogen atom or an alkyl group; and R¹³ represents an alkyl group which may have a substituent. Examples of an alkyl group include a methyl group, an ethyl group, a propyl group, an isopropyl group, an n-butyl group, an isobutyl group, a t-butylgroup, an amyl group, an isoamyl group and a hexyl group. These may be substituted or unsubstituted. As examples of the substituent, the same groups described for Formula (B) may also be cited. The monomer represented by Formula (C) may be used alone or in combination of two or more kinds. The monomer represented by Formula (C) can be obtained from the market or may be synthesized by referring to known documents in the art.

The ultraviolet ray absorbing polymer contained in the optical film according to the present invention may be a copolymer with another polymerizable monomer. Examples of another polymerizable monomer capable of copolymerization includes: a styrene derivative (such as styrene, α-methylstyrene, o-methylstyrene, m-methylstyrene, p-methylstyrene and vinyl naphthalene), an acrylate derivative (such as methyl acrylate, ethyl acrylate, propyl acrylate, butyl acrylate, i-butyl acrylate, t-butyl acrylate, octyl acrylate, cyclohexyl acrylate, and benzyl acrylate), a methacrylate derivative (such as methyl methacrylate, ethyl methacrylate, propyl methacrylate, butyl methacrylate, butyl methacrylate, t-butyl methacrylate, octyl methacrylate, cyclohexyl methacrylate, and benzyl methacrylate), an alkyl vinylether (such as methyl vinylether, ethyl vinylether, and butyl vinylether), an alkyl vinylester (such as vinyl formate, vinyl acetate, vinyl butylate, vinyl caproate, and vinyl stearate), crotonic acid, maleic acid, fumaric acid, itaconic acid, acrylonitrile, methacrylonitrile, vinyl chloride, vinylidene chloride, acrylamide, and methacrylamide. Preferable examples include methylacrylate, methylmethacrylate and vinyl acetate. Specifically preferable is an ultraviolet absorbing polymer derived from at least four kinds of monomers of an ethylenically unsaturated monomer having a substructure represented by Formula (A) in the molecule, a monomer represented by Formula (D), a monomer represented by Formula (E) and a monomer represented by Formula (C).

The weight average molecular weight of the ultraviolet absorbing polymer of the present invention is preferably 1000-70000, more preferably 2000-50000 and further more preferably 5000-30000. When the weight average molecular weight is less than 1000, the ultraviolet absorbing polymer may bleed out to the film surface, and when it is larger than 70000, compatibility with the resin may be lost.

The content of a low molecular weight component in the ultraviolet absorbing polymer of the present invention is preferably small. The content of a low molecular weight component of less than 1000 is preferably 5% by mass or less and more preferably 1% by mass or less. The ratio of weight average molecular weight Mw/number average molecular weight Mn of the ultraviolet absorbing polymer of the present invention is preferably 1.5-4.0 and more preferably 1.5-3.0.

The method of polymerizing the ultraviolet absorbing polymer of the present invention is not specifically limited, and known methods can be widely employed, examples of which include a radical polymerization, an anionic polymerization, and a cationic polymerization. As an initiator used for the radical polymerization, for example, an azo compound and a peroxide are cited, examples of which include azobis isobutyronitrile (AIBN), an azobis isobutyric acid diester derivative, peroxy benzoyl and dilauroyl peroxide. Solvents used in the polymerization are not particularly limited and examples thereof include an aromatic hydrocarbon solvent such as toluene and chlorobenzene, a halogenated hydrocarbon solvent such as dichloroethane and chloroform, an ether solvent such as tetrahydrofuran and dioxane, an amide solvent such as dimethyl formamide, an alcohol solvent such as methanol, an ester solvent such as methyl acetate and ethyl acetate, a ketone solvent such as acetone, cyclohexane and methylethyl ketone, and an aqueous solvent. By selecting a solvent, a solution polymerization carried out in a homogenous system, a precipitation polymerization in which produced polymer precipitates and an emulsion polymerization carried out in a micelle state can also be conducted.

The weight average molecular weight of the ultraviolet absorbing polymer of the present invention can be controlled according to a known method of controlling the molecular weight. As such a molecular weight control method, a method to use a chain transfer agent, for example, carbon tetrachloride, lauryl mercaptan or octylthioglycolate may be cited. The polymerization temperature is usually from an ambient temperature to 130° C. and more preferably 50° C. to 110° C.

The using ratio of abovementioned monomers is suitably selected in view of the effects on the compatibility of the ultraviolet absorbing polymer with other polymers, as well as the transparency and the mechanical strength of the optical film.

The content of an ethylenically unsaturated monomer having a substructure represented by Formula (A) in the molecule in the ultraviolet absorbing polymer of the present invention is preferably 10-90% by mass and more preferably 30-65% by mass based of the total mass. The content of a monomer represented by Formula (B) in the ultraviolet absorbing polymer of the present invention is preferably 1-70% by mass and more preferably 5-50% by mass based of the total mass. The content of a monomer represented by Formula (C) in the ultraviolet absorbing polymer of the present invention is preferably 1-70% by mass and more preferably 1-50% by mass based of the total mass.

The content of the ultraviolet absorbing polymer of the present invention based on the mass of the resin which forms the optical film is preferably 0.1-50% by mass and more preferably 0.5-30% by mass. The haze of the formed optical film is not specifically limited if it is 1.0 or less, however, the haze of the formed optical film is preferably 0.5 or less and more preferably 0.3 or less.

As mentioned above, preferable is an optical film exhibiting an excellent ultraviolet absorbing function at wavelengths of 380 nm or less in view of avoiding deterioration of the liquid crystals, while exhibiting only limited visible ray absorption at wavelengths of 400 nm or more. Specifically, in the present invention, the light transmittance at a wavelength of 380 nm is preferably 8% or less, more preferably 4% or less and still more preferably 1% or less.

### (Carbon Radical Scavenger)

The carbon radical scavenger has a group which promptly reacts with carbon radicals (for example, an unsaturated group such as a double bond or a triple bond), while avoiding a subsequent reaction such as polymerization after the compound reacted with carbon radicals, to form a stable compound. As a carbon radical scavenger, a group which promptly reacts with carbon radicals (for example, an unsaturated group such as a (meth)acryloyl group or an aryl group), and a compound which has a function to prohibit radical polymerization such as a phenol compound or a lactone compound, are preferable. Specifically, a compound represented by Formula (1) or (2) is preferable.

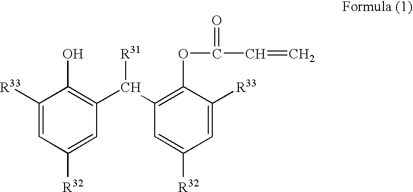

In Formula (1), R³¹ represents a hydrogen atom or an alkyl group having 1-10 carbon atoms, preferably a hydrogen atom or an alkyl group having 1-4 carbon atoms, and specifically preferably a hydrogen atom of a methyl group. R³² and R³³ each independently represent an alkyl group having 1-8 carbon atoms, which may be of a straight chain, branched structure or a ring structure. R³² and R³³ preferably have a structure represented by “*—C(CH₃)₂—R′” containing a quaternary carbon atom (* represents a linkage position to an aromatic ring, R′ represents an alkyl group having 1-5 carbon atoms). R³² is more preferably a tert-butyl group, a tert-amyl group or a tert-octyl group. R³³ is more preferably a tert-butyl, tert-amyl group. Commercially available compound represented by Formula (1) include Sumilizer GM, Sumilizer GS (both are trade names produced by Sumitomo Chemical Co., Ltd.). Specific examples of the compounds represented by Formula (2) will be shown below (I-1 to I-18), however, the present invention in not limited thereto.

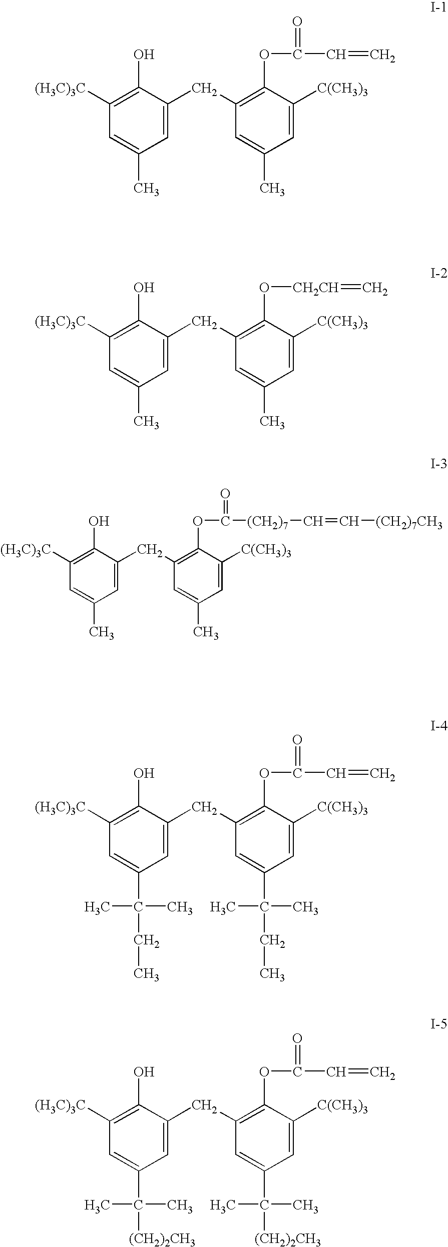

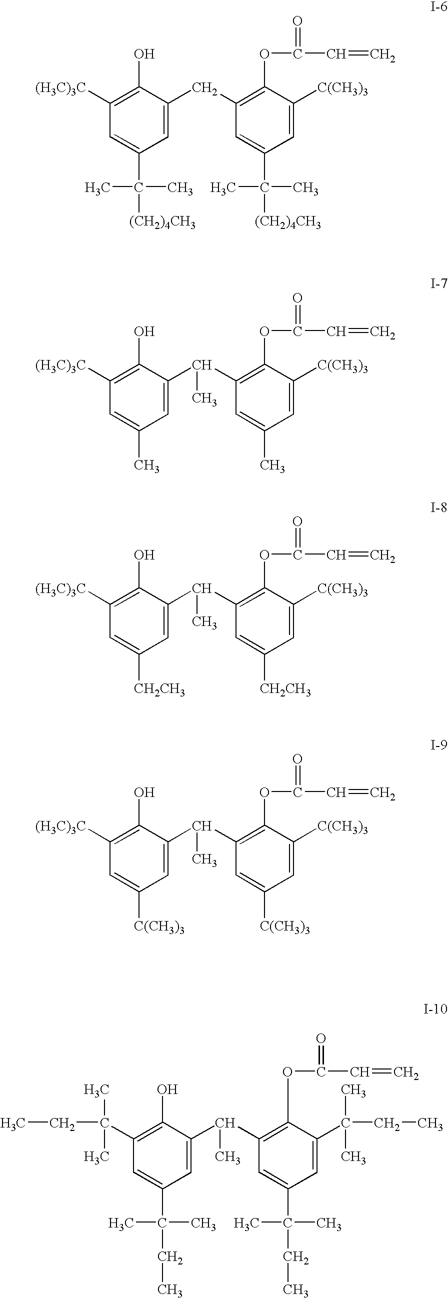

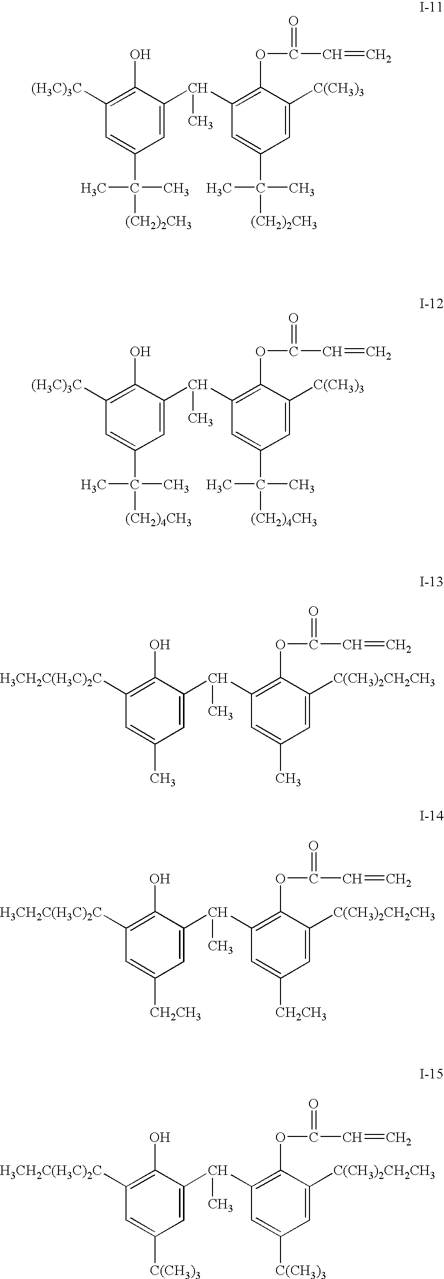

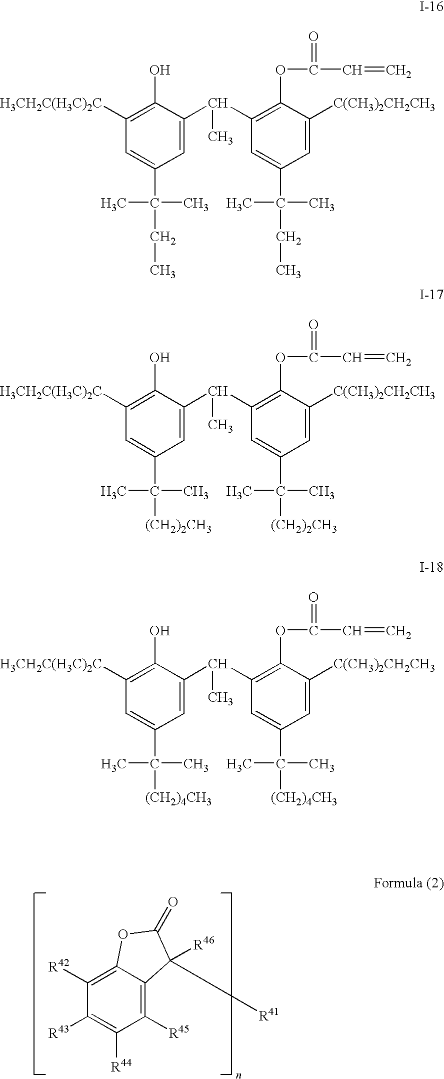

In Formula (2), R⁴²-R⁴⁶ each independently represent a hydrogen atom or a substituent. A substituent represented by R⁴²-R⁴⁶ is not specifically limited, however, examples of which include an alkyl group (such as a methyl group, an ethyl group, a propyl group, an isopropyl group, a t-butyl group, a pentyl group, a hexyl group, an octyl group, a dodecyl group and trifluoromethyl group), a cycloalkyl group (such as a cyclopentyl group and a cyclohexyl group), an aryl group (such as a phenyl group and a naphthyl group), an acylamino group (such as an acetylamino group and a benzoylamino group), an alkylthio group (such as a methylthio group and an ethylthio group), an arylthio group (such as a phenylthio group and a naphthylthio group), an alkenyl group (such as a vinyl group, a 2-propenyl group, a 3-butenyl group, a 1-methyl-3-propenyl group, a 3-pentenyl group, a 1-methyl-3-butenyl group, a 4-hexenyl group and a cyclohexenyl group), a halogen atom (such as a fluorine atom, a chlorine atom, a bromine atom and an iodine atom), an alkynyl group (such as a propargyl group), a heterocyclic group (such as a pyridyl group, a thiazolyl group, an oxazolyl group and an imidazolyl group), an alkylsulfonyl group (such as a methylsulfonyl group and an ethylsulfonyl group), an arylsulfonyl group (such as a phenylsulfonyl group and a naphthylsulfonyl group), an alkylsulfinyl group (such as a methylsulfinyl group), an arylsulfinyl group (such as a phenylsulfinyl group), a phosphono group, an acyl group (such as an acetyl group, a pivaloyl group and a benzoyl group), a carbamoyl group (such as an aminocarbonyl group, a methylaminocarbonyl group, a dimethylaminocarbonyl group, a butylaminocarbonyl group, a cyclohexylaminocarbonyl group, a phenylaminocarbonyl group and a 2-pyridylaminocarbonyl group), a sulfamoyl group (such as an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group and a 2-pyridylaminosulfonyl group), a sulfonamide group (such as a methanesulfonamide group and a benzenesulfonamido group), a cyano group, an alkoxy group (such as a methoxy group, an ethoxy group and a propoxy group), an aryloxy group (such as a phenoxy group and a naphthyloxy group), a heterocyclicoxy group, a siloxy group, an acyloxy group (such as an acetyloxy group and a benzoyloxy group), a sulfonic acid group, a salt of sulfonic acid, an aminocarbonyloxy group, an amino group (such as an amino group, an ethylamino group, a dimethylamino group, a butylamino group, a cyclopentylamino group, a 2-ethylhexylamino group and a dodecylamino group), an anilino group (such as a phenylamino group, a chlorophenylamino group, a toluidino group, an anisidino group, a naphthylamino group and a 2-pyridylamino group), an imido group, a ureido group (such as a methylureido group, an ethylureido group, a pentylureido group, a cyclohexylureido group, an octylureido group, a dodecylureido group, a phenylureido group, a naphthylureido group and a 2-pyridylureido group), an alkoxycarbonylamino group (such as a methoxycarbonylamino group and a phenoxycarbonylamino group), an alkoxycarbonyl group (such as methoxycarbonyl group, ethoxycarbonyl group and phenoxycarbonyl group), an aryloxycarbonyl group (such as a phenoxycarbonyl group), a heterocyclicthio group, a thioureido group, a carboxyl group, a salt of carboxylic acid, a hydroxyl group, a mercapto group and a nitro group. These groups may be further substituted by a similar substituent.

In above Formula (2), n represents 1 or 2.

In above Formula (2), when n is 1, R⁴¹ represents a substituent, and when n is 2, R⁴¹ represents a divalent linkage group. When R⁴¹ represents a substituent, as the substituent, the same substituents as those represented by R⁴²-R⁴⁵ may be cited.

When R⁴¹ represents a divalent linkage group, examples of a divalent linkage group include an alkylene group which may have a substituent, an arylene group which may have a substituent, an oxygen atom, a nitrogen atom, a sulfur atom or a combination thereof.

In above Formula (2), n is preferably 1.

Next, examples of a compound represented by Formula (2), in the present invention, will be shown, however, the present invention is not limited thereto.

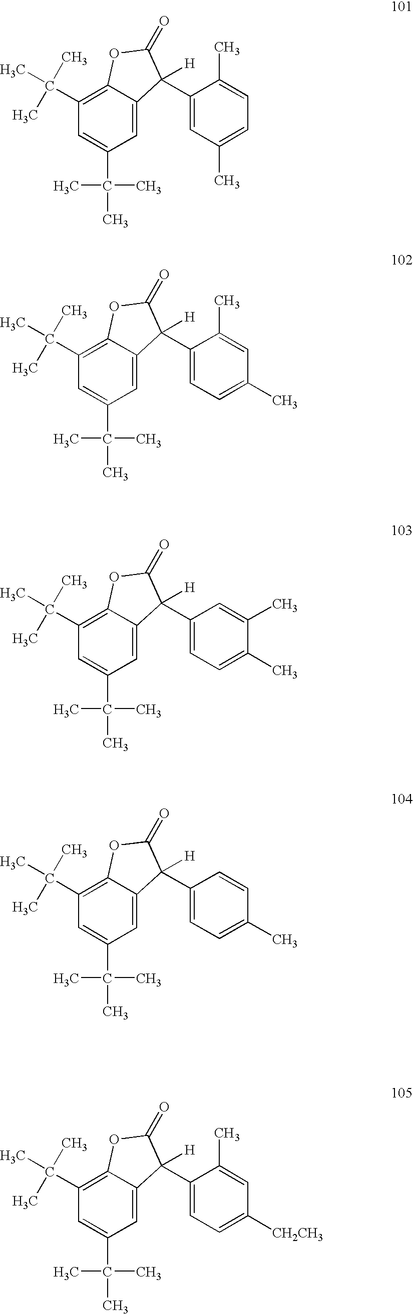

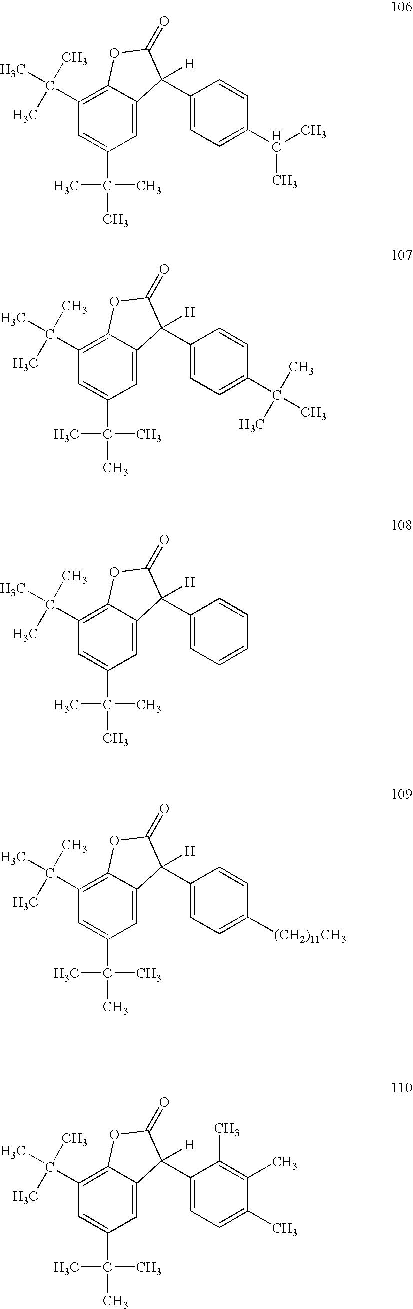

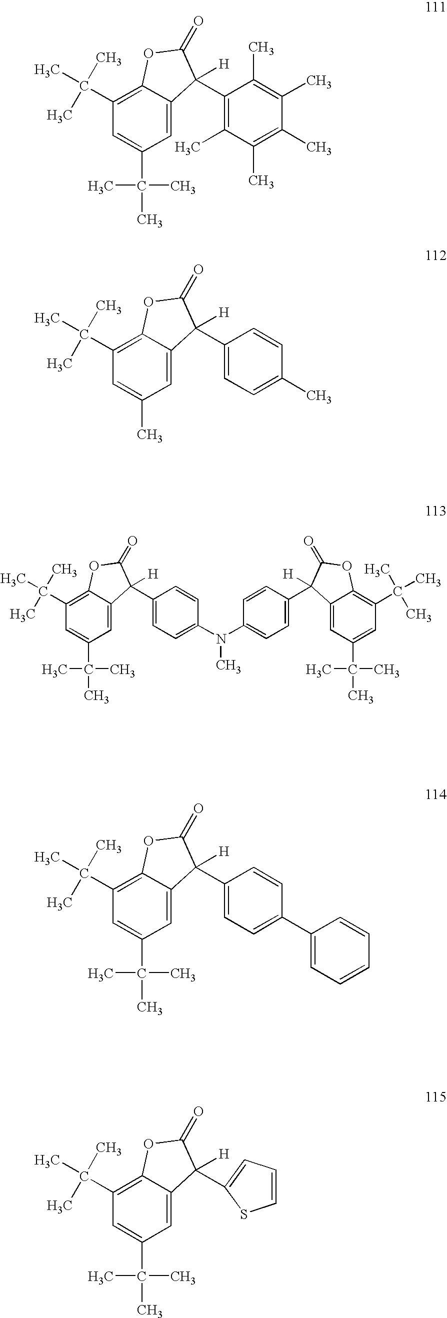

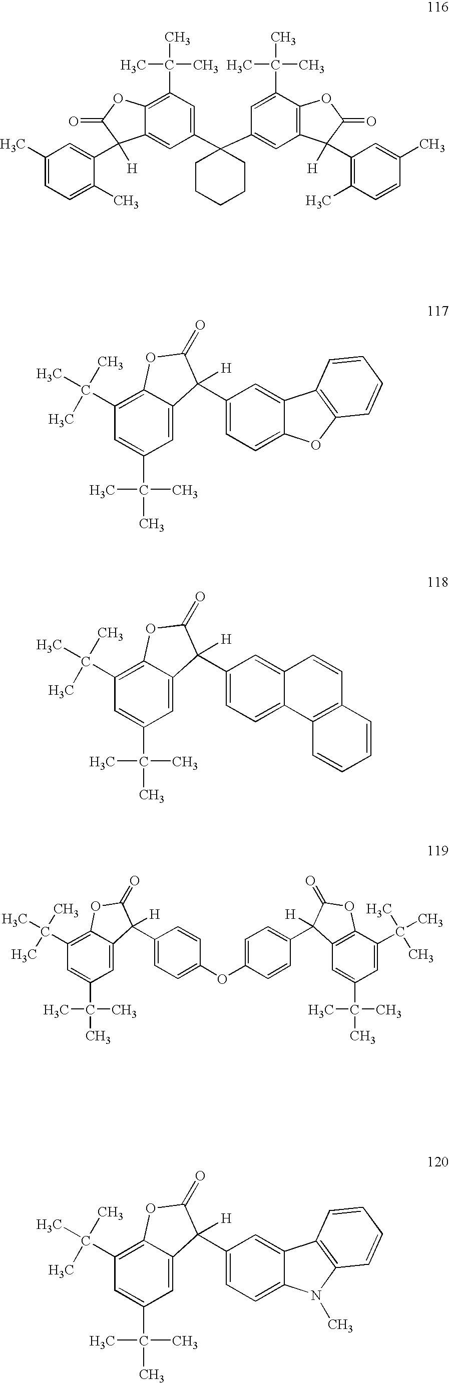

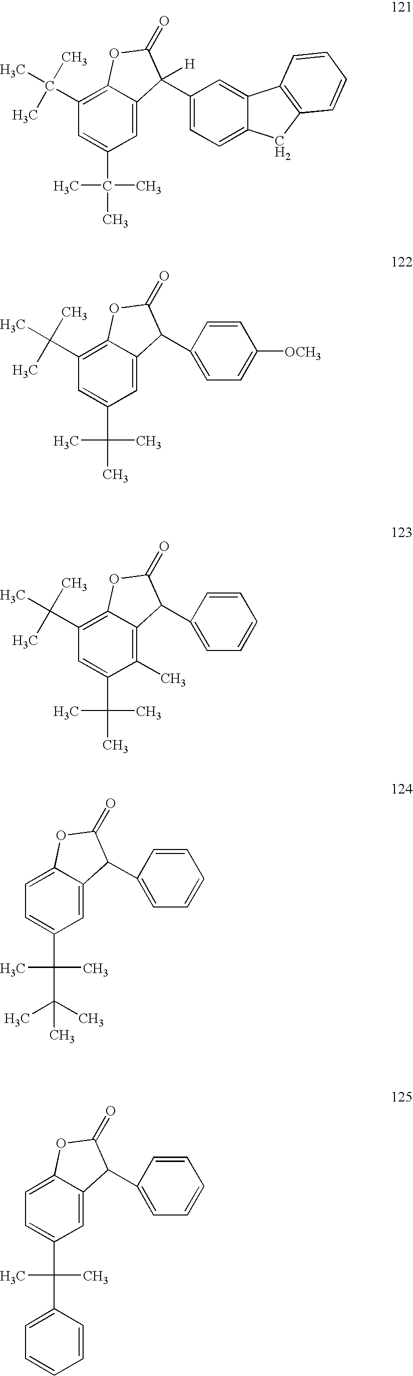

The above carbon radical scavenger may be used alone or in combination of two or more kinds. The addition amount of the carbon radical scavenger may be arbitrary selected within the range where the effect of the present invention is not lost, however, the addition amount is usually 0.001-10.0 mass parts, preferably 0.01-5.0 mass parts and further preferably 0.1-1.0 mass parts, in 100 mass parts of cellulose ester.

### (Phenol Compound)

As a phenol compound used in the present invention is preferably a 2,6-dialkylphenol derivative, for example, disclosed in U.S. Pat. No. 4,839,405, columns 12 to 14. Such the compounds include ones represented by Formula (5).

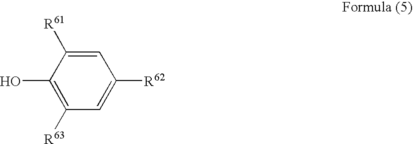

In the above formula, R⁶¹, R⁶² and R⁶³ are each a substituted or unsubstituted alkyl group. Concrete examples of a phenol compound include n-octadecyl 3-(3,5-di-t-butyl-4-hydroxyphenyl)propionate, n-octadecyl 3-(3,5-di-t-butyl-4-hydroxyphenyl)acetate, n-octadecyl 3,5-di t-butyl-4-hydroxybenzoate, n-hexyl 3,5-di-t-butyl-4-hydroxyphenylbenzoate, n-dodecyl 3,5-di-t-butyl-4-hydroxyphenylbenzoate, neododecyl 3-(dodecyl β-(3,5-di-t-butyl-4-hydroxyphenyl)propionate, ethyl α-(4-hydroxy-3,5-di-t-butylphenyl)isobutylate, octadecyl α-(4-hydroxy-3,5-di-t-butylphenyl)isobutylate, octadecyl α-(4-hydroxy-3,5-di-t-butyl-4-hydroxyphenyl)propionate, 2-(n-octyl)ethyl 3,5-di-t-butyl-e-hydroxybenzoate, 2-(n-octyl)ethyl 3,5-di-t-butyl-4-hydroxyphenylacetate, 2-(n-octadecylthio)ethyl 3,5-di-t-butyl-4-hydroxyphenyl-acetate, 2-(n-octadecylthio)ethyl 3,5-di-t-butyl-4-hydroxybenzoate, 2-(2-hydroxyethylthio)ethyl 3,5-di-t-butyl-4-hydroxybenzoate, diethylglycol bis-(3,5-di-t-butyl-4-hydroxyphenyl)propionate, 2-(n-octadecylthio)ethyl 3-(3,5-di-t-butyl-4-hydroxyphenyl)propionate, stearylamido N,N-bis[ethylene 3-(3,5-di-t-butyl-4-hydroxyphenyl)-propionate], n-butylimino N,N-bis-[ethylene 3-(3,5-di-t-butyl-4-hydroxyphenyl)propionate], 2-(2-stearoylo-xyethylthio)ethyl 3,5-di-t-butyl-4-hydroxybenzoate, 2-(2-stearoylo-xyethylthio)ethyl 7-(3-methyl-5-t-butyl-4-hydroxyphenyl)heptanoate, 1,2-propylene glycol bis-[3-(3,5-di-t-butyl-4-hydroxyphenyl)propionate], ethylene glycol bis-[3-(3,5-di-t-butyl-4-hydroxyphenyl)-propionate], neopentyl glycol bis-[3-(3,5-di-t-butyl-4-hydroxyphenyl)propionate], ethylene glycol bis-(3,5-di-t-butyl-4-hydroxyphenylacetate), glycerol 1-n-octadecanoate-2,3-bis-(3,5-di-t-butyl-4-hdyroxyphenylacetate), pentaerythrytol tetrakis[3-(3,5-di-t-butyl-4′-hydroxyphenyl)propionate], 1,1,1-trimethylolethane tris[3-(3,5-di-t-butyl-hydroxyphenyl)propionate], sorbitol hexa-[3-(3,5-di-t-butyl-hydroxyphenyl)propionate], 2-hydroxyethyl 7-(3,5-di-t-butyl-hydroxyphenyl)propionate, 2-stearoyloxyethyl 7-(3,5-di-t-butyl-hydroxyphenyl)-heptanoate, 1,6-n-hexanediol bis-[(3,5-di-t-butyl-4-hydroxyphenyl)propionate] and pentaerythrytol tetrakis(3,5-di-t-butyl-4-hydroxycinnamate). The above-described phenol compound is, for example, available on the market under the commercial name of Irganox 1076 and Irganox 1010 of Ciba Specialty Chemicals.

The above phenol compound may be used alone or in combination of two or more kinds. The addition amount of the phenol compound may be arbitrary selected within the range where the effect of the present invention is not lost, however, the addition amount is usually 0.001-10.0 mass parts, preferably 0.01-5.0 mass parts and further preferably 0.2-2.0 mass parts, in 100 mass parts of cellulose ester.

### (Phosphorus-Containing Compound)

As a phosphorus-containing compound used in the present invention, compounds known so far may be employed, however, preferable is a compound selected from the group of phosphites (phosphite), phosphonites (phosphonite) and tertially phosphanes (phosphane). Of these, preferably used are those disclosed in, for example, JP-A No. 2002-138188, JP-A No. 2005-344044 paragraph numbers 0022-0027, JP-A No. 2004-182979 paragraph numbers 0023-0039, JP-A No. 10-306175, JP-A No. 1-254744, JP-A No. 2-270892, JP-A No. 5-202078, JP-A No. 5-178870, Japanese Translation of PCT International Application Publication No. 2004-504435, Japanese Translation of PCT International Application Publication No. 2004-530759 and Japanese patent Application No. 2005-353229. Further more preferable phosphorus-containing compounds include phosphonite compounds represented by above Formulas (3) and (4).

In above Formula (3), R⁵¹ represents a phenylene group which may have a substituent or a thienylene group which may have a substituent; and R⁵² represents an alkyl group which may have a substituent, a phenyl group which may have a substituent or a thienyl group which may have a substituent. A plurality of R⁵² may be combined with each other to form a ring. R⁵² is preferably a substituted phenyl group of which substituent has a total carbon atom number of 9 to 14, and preferably 9 to 11.

The substituent is not specifically limited, but examples of the substituent include an alkyl group (for example, a methyl group, an ethyl group, a propyl group, an isopropyl group, a t-butyl group, a pentyl group, a hexyl group, an octyl group, a dodecyl group, or a trifluoromethyl group), a cycloalkyl group (for example, a cyclopentyl group or a cyclohexyl group), an aryl group (for example, a phenyl group, or a naphthyl group), an acylamino group (for example, an acetylamino group, or a benzoylamino group), an alkylthio group (for example, a methylthio group, or an ethylthio group), an arylthio group (for example, a phenylthio group or a naphthylthio group), an alkenyl group (for example, a vinyl group, 2-propenyl group, a 3-butenyl group, a 1-methyl-3-propenyl group, a 3-pentenyl group, a 1-methyl-3-butenyl group, a hexenyl group or a cyclohexenyl group), a halogen atom (for example, fluorine, chlorine, bromine, iodine), an alkinyl group (for example, a propargyl group), a heterocyclic group (for example, pyridyl group, a thiazolyl group, an oxazolyl group or an imidazolyl group), an alkylsulfonyl group (for example, a methylsulfonyl group or an ethylsulfonyl group), an arylsulfonyl group (for example, a phenylsulfonyl group or a naphthylsulfonyl group), a sulfinyl group (for example, a methylsulfinyl group), an arylsulfonyl group (a phenylsulfinyl group), a phosphono group, an acyl group (for example, an acetyl group, a pivaloyl group or a benzoyl group), a carbamoyl group (for example, an aminocarbonyl group, a methylaminocarbonyl group, a dimethylaminocarbonyl group, a butylaminocarbonyl group, a cyclohexylaminocarbonyl group, a phenylaminocarbonyl group, or a 2-pyridylaminocarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group or a 2-pyridylaminosulfonyl group), a sulfonamide group (for example, a methanesulfonamide group or a benzene sulfonamide group), a cyano group, an alkoxy group (for example, a methoxy group, an ethoxy group, or a propoxy group), an aryloxy group (for example, a phenoxy group or a naphthyloxy group), a heterocycleoxy group, a silyloxy group, an acyloxy group (for example, an acetyloxy group, or a benzoyloxy group), a sulfonic acid group, a sulfonate group, an aminocarbonyloxy group, an amino group (for example, an amino group, an ethylamino group, a dimethylamino group, a butylaminocarbonyl group, a cyclopentylamino group, a 2-ethylhexylamino group, or a dodecylamino group), an anilino group (for example, a phenylammino group, a chlorophenylammino group, a toluidino group, an anisidino group, a naphthylamino group or a 2-pyridylamino group), an imino group, a ureido group (for example, a methylureido group, an ethylureido group, a pentylureido group, a cyclohexylureido group, an octylureido group, a dodecylureido group, a phenylureido group, a naphthylureido group, or a 2-pyridylureido group), an alkoxycarbonylamino group (for example, a methoxycarbonylamino group or a phenoxycarbonylamino group), an alkoxycarbonyl group (for example, a methoxycarbonyl group or an ethoxycarbonyl group), an aryloxycarbonyl group (for example, a phenoxycarbonyl group), a heterocyclicthio group, a thioureido group, a carboxyl group, a carboxylate group, a hydroxyl group, a mercapto group, and a nitro group. These substituents may further have a substituent as described above.

In above Formula (4), R⁵³ represents a phenylene group which may have a substituent or a thienylene group which may have a substituent; and R⁵⁴ represents an alkyl group which may have a substituent, a phenyl group which may have a substituent or a thienyl group which may have a substituent. A plurality of R⁵⁴ may be combined with each other to form a ring. R⁵⁴ is preferably a substituted phenyl group of which substituent has a total carbon atom number of 9 to 14, and preferably 9 to 11. The substituent is the same as those denoted for R⁵².

Specifically, examples of a phosphonite compound represented by Formula (3) include dialkyl phenylphosphonites such as dimethyl phenylphosphonite and di-t-butyl phenylphosphonite; and di(substituted or unsubstituted phenyl) phenylphosphonite such as diphenyl phenylphosphonite, di(4-pentylphenyl) phenylphosphonite, di(2-t-butylphenyl) phenylphosphonite, di(2-metyl-3-pentylphenyl) phenylphosphonite, di(2-metyhyl-ocylphenyl) phenylphosphonite, di(3-butyl-4-methylphenyl) phenylphosphonite, di(3-hexyl-4-ethylphenyl) phenylphosphonite, di(2,4,6-trimethylphenyl) phenylphosphonite, di(2,3-dimethyl-4-ethylphenyl) phenylphosphonite, di(2,6-diethyl-3-butylphenyl) phenylphosphonite, di(2,3-diproyl-5-butylphenyl) phenylphosphonite, and di(2,4,6-tri-t-butylphenyl) phenylphosphonite.

Examples of a phosphonite compound represented by Formula (4) include tetrakis(2,4-di-t-butylphenyl) 4,4′-biphenylenediphosphonite, tetrakis(2,5-di-t-butylphenyl) 4,4′-biphenylenediphosphonite, tetrakis(3,5-di-t-butylphenyl) 4,4′-biphenylenediphosphonite, tetrakis(2,3,4-trimethylphenyl) 4,4′-biphenylenediphosphonite, tetrakis(2,3-dimethyl-5-ethylphenyl) 4,4′-biphenylenediphosphonite, tetrakis(2,3-dimethyl-4-propylphenyl) 4,4′-biphenylenediphosphonite, tetrakis(2,3-dimethyl-5-t-butylphenyl) 4,4′-biphenylenediphosphonite, tetrakis(2,3-dimethyl-4-t-butylphenyl) 4,4′-biphenylenediphosphonite, tetrakis(2,3-diethyl-5-methylphenyl) 4,4′-biphenylenediphosphonite, tetrakis(2,3-diethyl-4-methylphenyl) 4,4′-biphenylenediphosphonite, tetrakis(2,4,5-triethylphenyl) 4,4′-biphenylenediphosphonite, tetrakis(2,6-diethyl-4-propylphenyl) 4,4′-biphenylenediphosphonite, tetrakis(2,5-diethyl-6-butylphenyl) 4,4′-biphenylenediphosphonite, tetrakis(2,3-diethyl-5-t-butylphenyl) 4,4′-biphenylenediphosphonite, tetrakis(2,5-diethyl-6-t-butylphenyl) 4,4′-biphenylenediphosphonite, tetrakis(2,3-dipropyl-5-methylphenyl) 4,4′-biphenylenediphosphonite, tetrakis(2,6-dipropyl-4-methylphenyl) 4,4′-biphenylenediphosphonite, tetrakis(2,6-dipropyl-5-ethylphenyl) 4,4′-biphenylenediphosphonite, tetrakis(2,3-dipropyl-6-butylphenyl) 4,4′-biphenylenediphosphonite, tetrakis(2,6-dipropyl-5-butylphenyl) 4,4′-biphenylenediphosphonite, tetrakis(2,3-dibutyl-4-methylphenyl) 4,4′-biphenylenediphosphonite, tetrakis(2,5-dibutyl-3-methylphenyl) 4,4′-biphenylenediphosphonite, tetrakis(2,6-dibutyl-4-methylphenyl) 4,4′-biphenylenediphosphonite, tetrakis(2,4-di-t-butyl-3-methylphenyl) 4,4′-biphenylenediphosphonite, tetrakis(2,4-di-t-butyl-5-methylphenyl) 4,4′-biphenylenediphosphonite, tetrakis(2,4-di-t-butyl-6-methylphenyl) 4,4′-biphenylenediphosphonite, tetrakis(2,5-di-t-butyl-3-methylphenyl) 4,4′-biphenylenediphosphonite, tetrakis(2,5-di-t-butyl-4-methylphenyl) 4,4′-biphenylenediphosphonite, tetrakis(2,5-di-t-butyl-6-methylphenyl) 4,4′-biphenylenediphosphonite, tetrakis(2,6-di-t-butyl-3-methylphenyl) 4,4′-biphenylenediphosphonite, tetrakis(2,6-di-t-butyl-4-methylphenyl) 4,4′-biphenylenediphosphonite, tetrakis(2,6-di-t-butyl-5-methylphenyl) 4,4′-biphenylenediphosphonite, tetrakis(2,3-dibutyl-4-ethylphenyl) 4,4′-biphenylenediphosphonite, tetrakis(2,4-dibutyl-3-ethylphenyl) 4,4′-biphenylenediphosphonite, tetrakis(2,5-dibutyl-4-ethylphenyl) 4,4′-biphenylenediphosphonite, tetrakis(2,4-di-t-butyl-3-ethylphenyl) 4,4′-biphenylenediphosphonite, tetrakis(2,4-di-t-butyl-5-ethylphenyl) 4,4′-biphenylenediphosphonite, tetrakis(2,4-di-t-butyl-6-ethylphenyl) 4,4′-biphenylenediphosphonite, tetrakis(2,5-di-t-butyl-3-ethylphenyl) 4,4′-biphenylenediphosphonite, tetrakis(2,5-di-t-butyl-4-ethylphenyl) 4,4′-biphenylenediphosphonite, tetrakis(2,5-di-t-butyl-6-ethylphenyl) 4,4′-biphenylenediphosphonite, tetrakis(2,6-di-t-butyl-3-ethylphenyl) 4,4′-biphenylenediphosphonite, tetrakis(2,6-di-t-butyl-4-ethylphenyl) 4,4′-biphenylenediphosphonite, tetrakis(2,6-di-t-butyl-5-ethylphenyl) 4,4′-biphenylenediphosphonite, tetrakis(2,3,4-tributylphenyl) 4,4′-biphenylenediphosphonite, and tetrakis(2,4,6-tri-t-butylphenyl) 4,4′-biphenylenediphosphonite.

In the invention, the phosphonite compound represented by Formula (4) is preferred. Among these, 4,4′-biphenylenediphosphonites such as tetrakis(2,4-di-t-butylphenyl) 4,4′-biphenylenediphosphonite are preferred, and tetrakis(2,4-di-t-butyl-5-methylphenyl) 4,4′-biphenylenediphosphonite is specifically preferred.

Specifically preferred phosphonite compounds will be shown below.

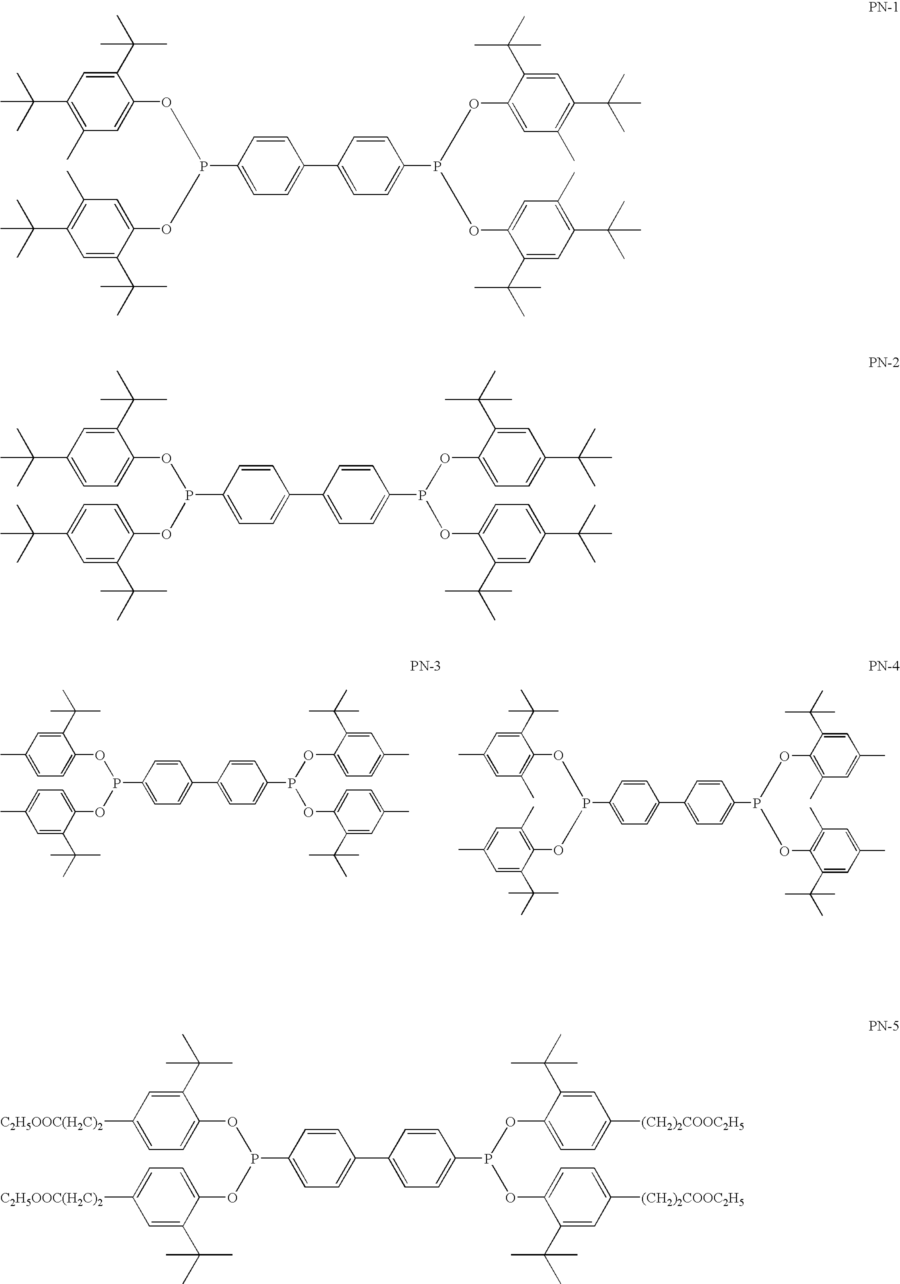

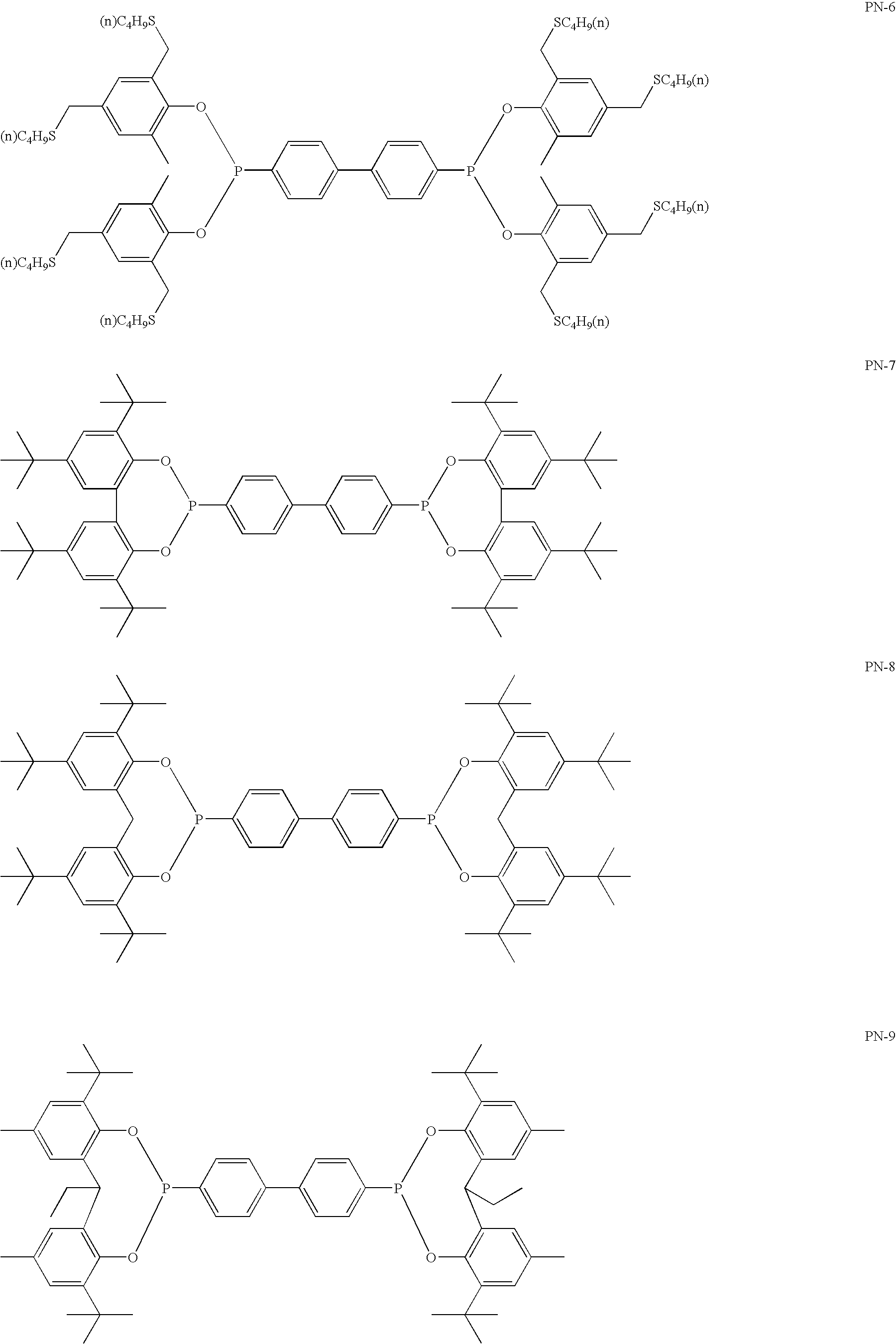

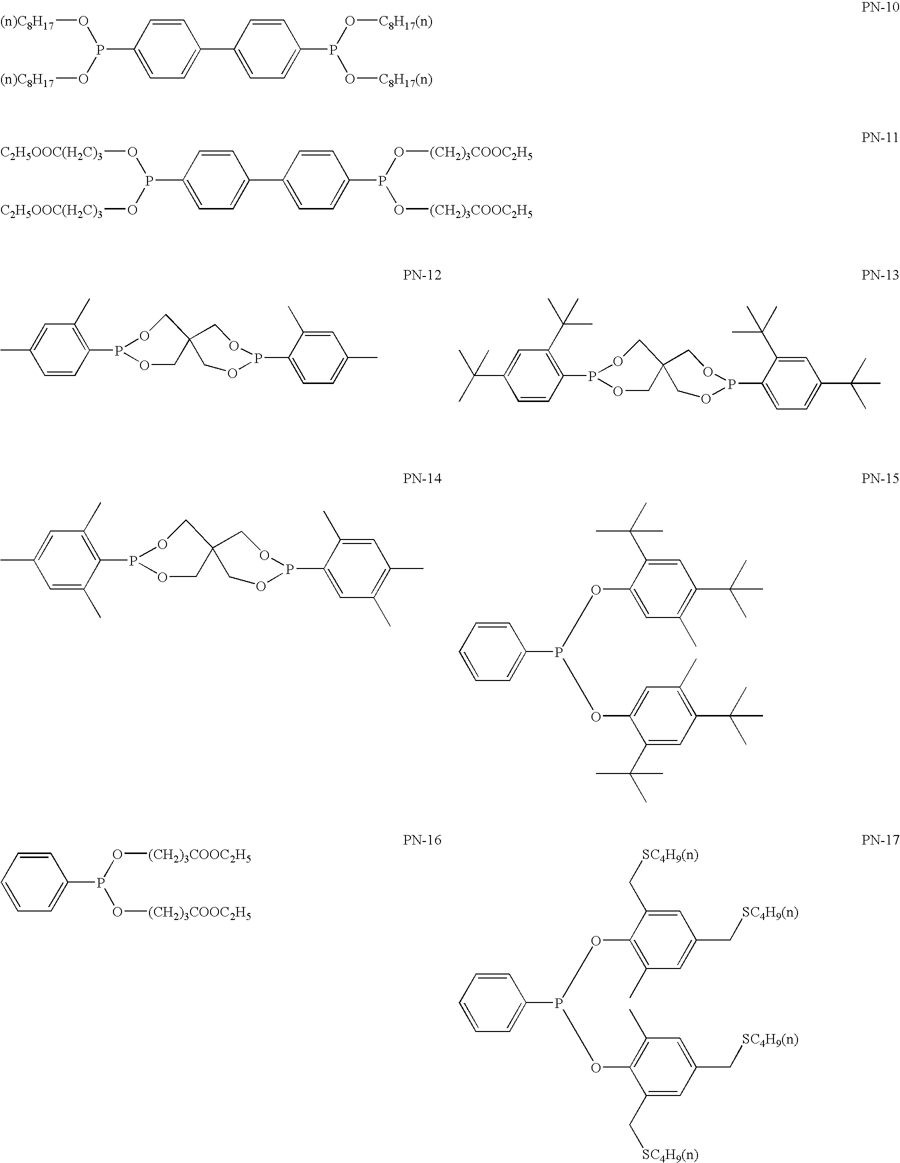

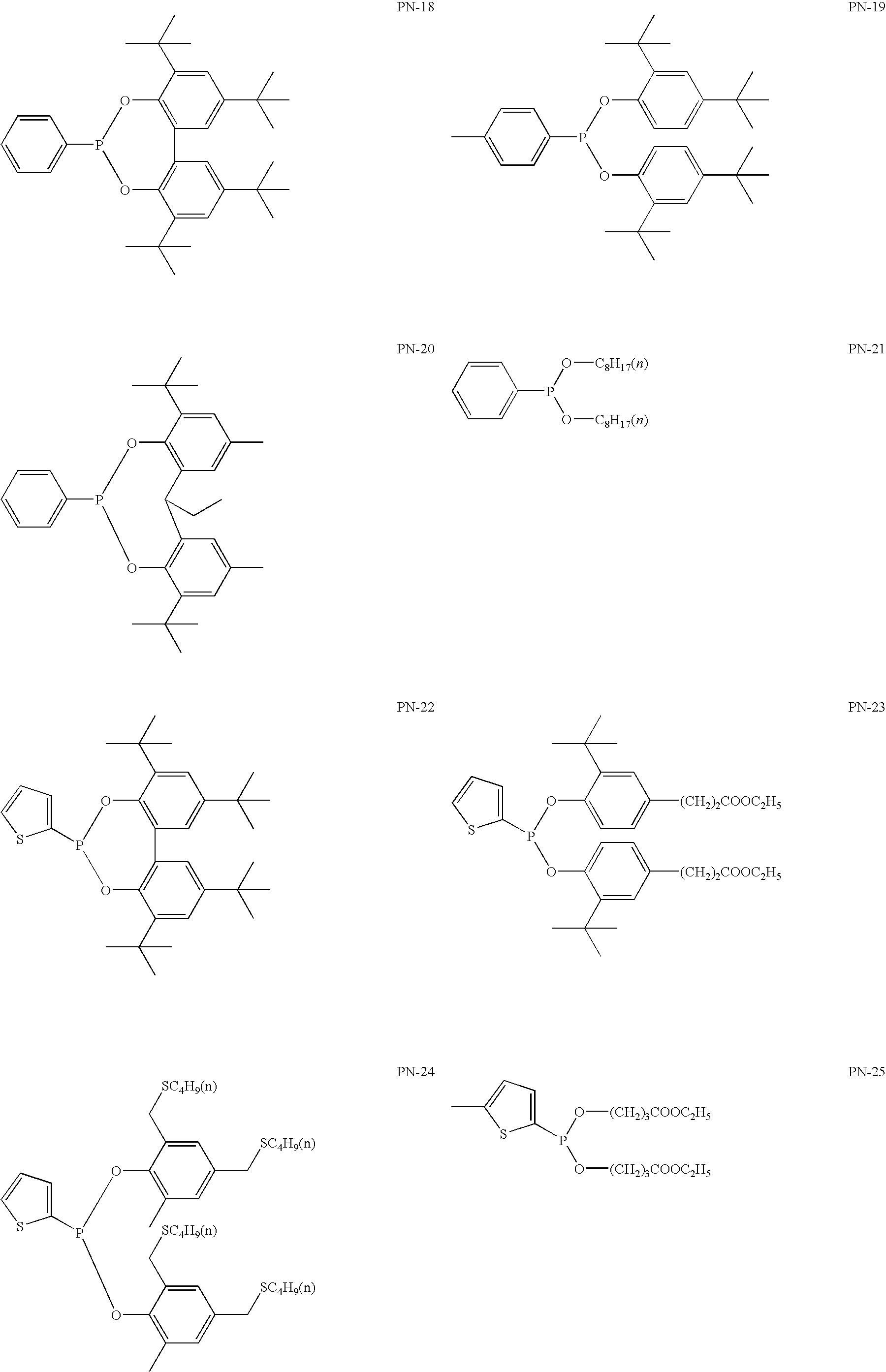

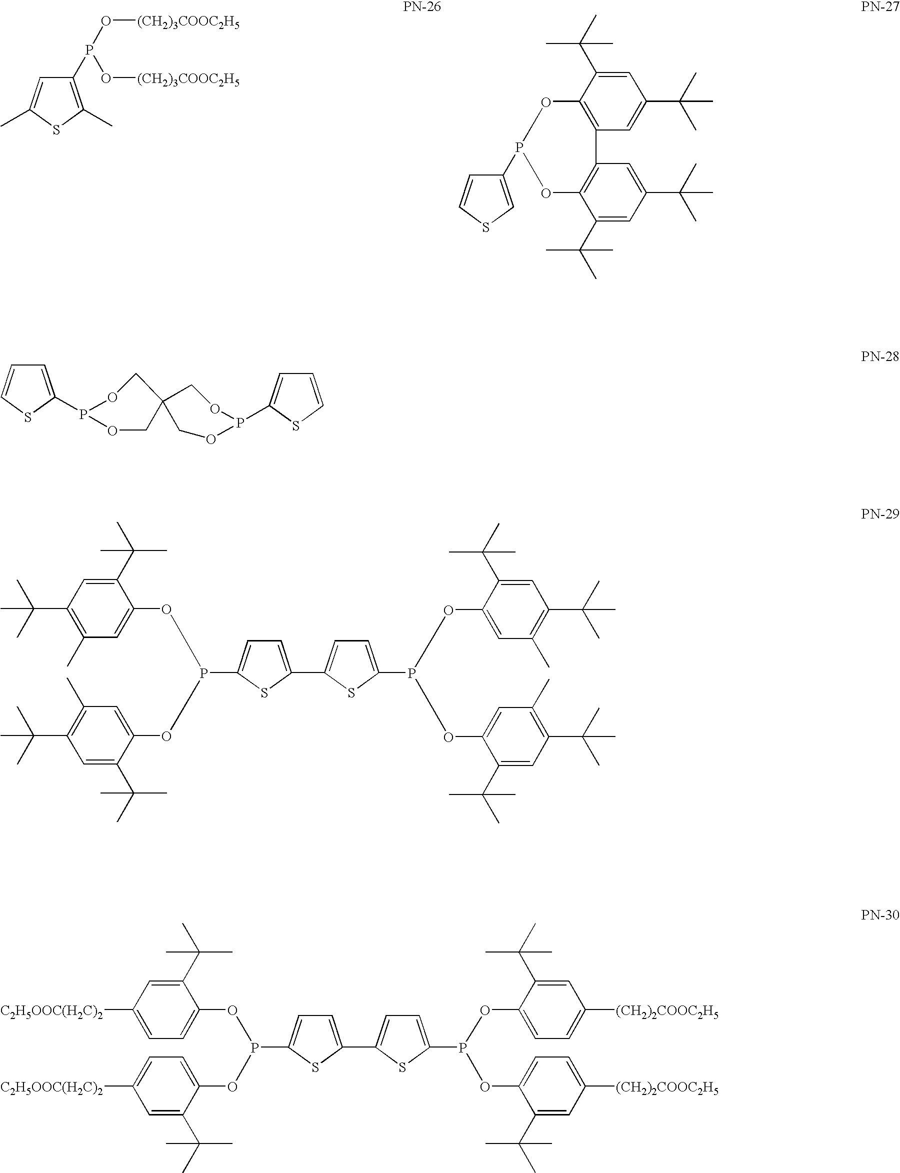

The content of the phosphorus-containing compound is usually 0.001-10.0 mass parts, preferably 0.01-5.0 mass parts and further preferably 0.1-1.0 mass parts, in 100 mass parts of cellulose ester.

The abovementioned carbon radical scavenger, phenol compound and phosphorus-containing compound are preferably used in combination of the three kinds of compounds, and the ranges of the preferable content of each compound are, 0.1-1.0 mass part for carbon radical scavenger, 0.2-2.0 mass parts for phenol compound and 0.1-1.0 mass part for phosphorus-containing compound, in 100 mass parts of cellulose ester. It was found that, when the contents of the three kinds of compounds were in the above ranges, a multiplier effect of the compounds each other was obtained, whereby the property of the optical film was improved.

### (Cellulose Ester)

Cellulose ester which is most preferable as a resin used for the support of the optical film of the present invention will now be explained.

A cellulose ester used for the present invention is a single- or mixed-acid ester of cellulose, the acid including at least one structure of an aliphatic acyl group and a substituted or unsubstituted aromatic acyl group.

In an aromatic acyl group, in cases when the aromatic ring is a benzene ring, examples of a substituent for the benzene ring include a halogen atom, cyano, alkyl group, aryl group, aryloxy group, carbonamido group, sulfonamido group, ureido group, aralkyl group, nitro, alkoxycarbonyl group, aryloxycarbonyl group, aralkyloxycarbonyl group, carbamoyl group, sulfamoyl group, acyloxy group, alkenyl group, alkynyl group, alkylsulfonyl group, arylsulfonyl group, alkyloxysulfonyl group, aryloxysulfonyl group, alkylsulfonyloxy group, and aryloxysulfonyl group, —S—R, —NH—CO—OR, —PH—R, —P(—R)₂, —PH—O—R, —P(—R)(—O—R), —P(—O—R)₂, —PH(═O)—R—P(O)(—R)₂, —PH(═O)—O—R, —P(═O)(—R)(—O—R), —P(═O)(—O—R)₂, —O—PH(═O)—R, —O—PH(═O)(—R)₂—O—PH(═O)—O—R, —O—P(═O)(—R)(—O—R), —O—P(═O)(—O—R)₂, —NH—PH(═O)—R, —NH—P(═O)(—R)(—O—R), —NH—P(═O)(—O—R)₂, —SiH—R, —SiH(—R)₂, —SiH₂(—R)₃, —O—SiH₂—R, —O—SiH(—R)₂ and —O—Si(—R)₃. In the foregoing, “R” is an aliphatic group, an aromatic group or a heterocyclic group. The number of substituents is preferably from 1 to 5, more preferably from 1 to 4, still more preferably from 1 to 3, and further still more preferably 1 or 2. Of these substituents, a halogen atom, cyano, alkyl group, alkoxy group, aryl group, aryloxy group, acyl group, carbonamido group, sulfonamido group and ureido are preferred; a halogen atom, cyano, alkyl group, alkoxy group, aryloxy group, acyl group and carbonamido group are more preferred; a halogen atom, cyano, alkyl group, and aryloxy group are still more preferred; and a halogen atom, alkyl group and alkoxy group are most preferred.

The foregoing halogen atom includes a fluorine atom, chlorine atom, bromine atom and iodine atom.

The alkyl group may also be a cyclic structure or branched structure. The number of carbon atoms of the alkyl group is preferably from 1 to 20, more preferably from 1 to 12, still more preferably from 1 to 6, and most preferably from 1 to 4. Examples of an alkyl group include methyl, ethyl, propyl, isopropyl, butyl, t-butyl, hexyl, cyclohexyl, octyl and 2-ethylhexyl. The alkoxyl group may also be a cyclic structure or a branched structure. The number of carbon atoms of the alkoxyl group is preferably from 1 to 20, more preferably from 1 to 12, still more preferably from 1 to 6, and most preferably from 1 to 4. The alkoxy group may further be substituted by another alkoxy group. Examples of an alkoxy group include methoxy, ethoxy, 2-methoxyethoxy, 2-methoxy-2-ethoxyethoxy, butyloxy, hexyloxy and octyloxy.

The number of carbon atoms of the aryl group is preferably from 6 to 20, and more preferably from 6 to 12. Examples of an aryl group include phenyl and naphthyl. The number of carbon atoms of the aryloxy group is preferably from 6 to 20, and more preferably from 6 to 12. Specific examples of the aryloxy group include phenoxy and naphthoxy. The number of carbon atoms of the acyl group is preferably from 1 to 20, and more preferably from 1 to 12. Specific examples of the acyl group include formyl, acetyl and benzoyl. The number of carbon atoms of the carbonamido group is preferably from 1 to 20, and more preferably from 1 to 12. Specific examples of the carbonamido group include acetoamido and benzamido. The number of carbon atoms of the sulfonamido group is preferably from 1 to 20, and more preferably from 1 to 12. Specific examples of the sulfonamido group methanesulfonamido, benzenesulfonamido and p-toluenesulfonamido. The number of carbon atoms of the ureido group is preferably from 1 to 20, and more preferably from 1 to 12. Specific examples of the ureido group include (unsubstituted) ureido.

The number of carbon atoms of the aralkyl group is preferably from 7 to 20, and more preferably from 7 to 12. Examples of an aralkyl group include benzyl, phenethyl and naphthylmethyl. The number of carbon atoms of the alkoxycarbonyl group is preferably from 1 to 20, and more preferably from 2 to 12. Specific examples of the alkoxycarbonyl group include methoxycarbonyl. The number of carbon atoms of the aryloxycarbonyl group is preferably from 7 to 20, and more preferably from 7 to 12. Specific examples of the aryloxycarbonyl group include phenoxycarbonyl. The number of carbon atoms of the aralkyloxycarbonyl group is preferably from 81 to 20, and more preferably from 8 to 12. Specific examples of the aralkyloxycarbonyl group include benzyloxycarbonyl. The number of carbon atoms of the carbamoyl group is preferably from 1 to 20, and more preferably from 1 to 12. Specific examples of the carbamoyl group include (unsubstituted) carbamoyl and N-methycarbamoyl. The number of carbon atoms of the sulfamoyl group is preferably not more than 20, and more preferably not more than 12. Specific examples of the sulfamoyl group include (unsubstituted) sulfamoyl, and N-methylsulfamoyl. The number of carbon atoms of the acyloxy group is preferably from 1 to 20, and more preferably from 2 to 12. Specific examples of the acyloxy group include acetoxy and benzoyloxy.

The number of carbon atoms of the alkenyl group is preferably from 2 to 20, and more preferably from 2 to 12. Examples of an alkenyl group include vinyl, allyl and isopropenyl. The number of carbon atoms of the alkynyl group is preferably from 2 to 20, and more preferably from 2 to 12. Specific examples of the alkynyl group thienyl. The number of carbon atoms of the alkylsulfonyl group is preferably from 1 to 20, and more preferably from 1 to 12. The number of carbon atoms of the alkyloxysulfonyl group is preferably from 1 to 20, and more preferably from 1 to 12. The number of carbon atoms of the aryloxysulfonyl group is preferably from 6 to 20, and more preferably from 6 to 12. The number of carbon atoms of the alkylsulfonyloxy group is preferably from 1 to 20, and more preferably from 1 to 12. The number of carbon atoms of the aryloxysulfonyl group is preferably from 6 to 20, and more preferably from 6 to 12.

In cases when the cellulose ester relating to the present invention is an aliphatic acid ester of an aliphatic acyl group substituted for the hydroxylic hydrogen atom of a cellulose, the aliphatic acyl group has 2-20 carbon atoms and specific examples thereof include acetyl, propionyl, butyryl, isobutyryl, valeryl, pivaloyl hexanoyl, octanoyl, lauroyl and stearoyl.

In the present invention, the foregoing aliphatic acyl group includes substituted one and examples of a substituent include ones exemplified as a substituent for a benzene ring when the aromatic ring is a benzene ring.

In cases when an esterified substituent of the foregoing cellulose ester is an aromatic ring, the number of substituents substituted for the aromatic ring is 0 or 1-5, preferably 1-3, and more preferably 1 or 2. When the number of substituents substituted for the aromatic ring is 2 or more, such substituents may be the same or different, and may form a condensed polycyclic compound (e.g., naphthalene, indene, indane, phenathrene, quinoline, isoquinoline, chromene, phthalazine, acridine, indole, indoline).

The cellulose ester relating to the present invention has at least one structure selected from a substituted or unsubstituted aliphatic acyl group and a substituted or unsubstituted aromatic acyl group, which may be a single- or mixed-acid ester of a cellulose, or may be a mixture of at least two cellulose esters.

The cellulose ester relating to the present invention is preferably at least one selected from cellulose acetate, cellulose propionate, cellulose butyrate, cellulose pentanate, cellulose acetate propionate, cellulose acetate butyrate, cellulose acetate pentanate, cellulose acetate phthalate and cellulose phthalate.

A glucose unit constituting cellulose via a β-1,4 glycoside bonded has free hydroxyl groups at the 2-, 3- and 6-positions. The cellulose ester relating to the present invention is a polymerized substance (polymer) in which the hydroxyl groups are partially or totally esterified with acyl groups to. The substituting degree means a sum of the ratios at which the 2-, 3- and 6-positions of the repeat unit of the cellulose is esterified. Specifically, when each of the hydroxyl group at the 2-, 3- and 6-positions is 100% esterified, the substitution degree of each position is 1. Accordingly, when the 2-, 3- and 6-positions of cellulose are 1000 esterified, the substitution degree is 3 which is the maximum value. The substitution degree with an acyl group can be determined according to the method prescribed in ASTM-D817.

With regard to the degree of substitution of a mixed acid ester, a further preferable cellulose ester contains an acyl group having 2-5 carbon atoms, and is a cellulose ester resin containing a cellulose ester which simultaneously meets the following Equations (1)-(3), provided that the acetyl substitution degree is designated as A and the substitution degree by an acyl group having 3-5 carbon atoms is designated as B:

2.4≦A+B≦3.0 Equation (1)

0≦A≦2.4 Equation (2)

0.1≦B<3.0 Equation (3)

Of these, cellulose acetate propionate is preferably used, and specifically preferably used is one which meets 1.00≦A≦2.00 and 0.50≦B≦2.00, and more preferably 1.20≦A≦2.00 and 0.70≦B≦1.70. The portion which is not substituted by the acyl group usually exists as a hydroxyl group. These can be synthesized by commonly known methods.

The cellulose ester used in the present invention preferably exhibits a ratio of weight average molecular weight Mw/number average molecular weight Mn of from 1.5 to 5.5, which is specifically preferably 2.0 to 4.0.

The cellulose ester relating to the present invention preferably has a number average molecular weight (Mn) of 50,000-150,000, more preferably has a number average molecular weight of 55,000-120,000, and most preferably has a number average molecular weight of 60,000-100,000.

Mn and Mn/Mw are determined using gel permeation chromatography according to the following manner.

Measurement conditions are as follows:

Solvent: tetrahydrofuran

Apparatus: HLC-8220 GPC (produced by TOSO)

Column: TSKgel SUPER HM-M (produced by TOSO)

Temperature: 40° C.

Sample concentration: 0.1% by mass

Amount of injection: 10 μl

Flow rate: 0.6 ml/min

Calibration curve: standard polystyrene PS-1 (produced by Polymer Laboratories)

There was used a calibration curve prepared by 9 samples of standard polystyrene having Mw=2,560,000−580.

Cellulose as raw material for a cellulose ester used in the present invention may be various kinds of wood pulp or cotton linter and wood pulp may be either from needle trees or leaf trees, but needle trees are preferred. Cotton linter is preferably used in term of peelability at the time film formation. Cellulose esters made from these may be optimally mixed or singly used.

There is usable a ratio of cellulose ester originating in cotton linter: cellulose ester originating wood pulp (needle tree): cellulose ester originating in wood pulp (leaf tree of, for example, 100:0:0, 90:10:0, 85:15:0, 50:50:0, 20:80:0, 10:90:0, 0:100:0, 0:0:100, 80:10:10, 85:0:15 or 40:30:30.

It is possible to prepare a cellulose ester by replacing the hydroxyl group of cellulose raw materials with an acetyl group, an propionyl group, and/or a butyl group in the above ranges, employing acetic anhydride, propionic anhydride, and/or butyric anhydride based on conventional methods. Synthesis methods of such cellulose resins are not specifically limited, and it is possible to synthesize them with reference to, for example, JP-A No. 10-45804 or Published Japanese translation of PCT international Publication No. 6-501040.

Content of alkali earth metal used in the cellulose ester of this invention is preferably 1-50 ppm. It is liable to increase of lip attaching stain, or to break at thermal stretching process or slitting process after thermal stretching at 50 ppm or more. It is also liable to break when the content being less than 1 ppm, the reason of which is not known. Load against washing process so as to make less than 1 ppm is too heavy, and therefore it is not preferable. The content of 1-30 ppm is more preferable. The alkali earth metals means a total amount of calcium and magnesium, that is measured by employing X ray photoelectron spectrometric analysis (XPS).

The amount of the residual sulfuric acid contained in the cellulose ester used in the present invention is 0.1 through 45 ppm in terms of the sulfur element. They are considered to be included as salts. The amount of the residual sulfuric acid contained therein of not less than 45 ppm is not preferable since the deposition on the die lip at the time of heat-melting increases and the film tends to tear off at the time of thermal stretching or slitting subsequent to thermal stretching. The amount of the residual sulfuric acid contained therein should be reduced as much as possible, but when it is to be reduced below 0.1 ppm, the load on the cellulose ester washing process will be excessive and the material tends to be damaged easily. This should be avoided. This may be because an increase in the frequency of washing affects the resin, but the details are not yet clarified. Further, the preferred amount is in the range of 1 through 30 ppm. The amount of the residual sulfuric acid can be measured according to the ASTM-D817 in the similar manner.

The total amount of the free acid in the cellulose ester used in this invention is preferably 1-500 ppm. The deposition on the die lip at the time of heat-melting increases and the film tends to tear off, when excess 500 ppm. It is difficult to make less than 1 ppm by washing. It is more preferable of 1-100 ppm, and it increase resistance to tear. Particularly preferable is 1-70 ppm. The amount of free acid can be measured according to the ASTM-D817.

The amount of the residual acid can be kept within the aforementioned range if the synthesized cellulose ester is washed more carefully than in the case of the solution casting method. Then, when a film is manufactured by the melt casting, the amount of depositions on the lip portion will be reduced so that a film characterized by a high degree of flatness is produced. Such a film will be further characterized by excellent resistance to dimensional changes, mechanical strength, transparency, resistance to moisture permeation, retardation values to be described later. Further, the cellulose ester can be washed using water as well as a poor solvent such as methanol or ethanol. It is also possible to use a mixture between a poor solvent and a good solvent if it is a poor solvent as a result. This will remove the inorganic substance other than residual acid, and low-molecular organic impurities. The cellulose ester is washed preferably in the presence of an antioxidant such as a hindered amine, a hindered phenol and a phosphorus-containing compound (for example, a phosphate and a phosphonite). This will improve the heat resistance and film formation stability of the cellulose ester.

To improve the heat resistance, mechanical property and optical property of the cellulose ester, the cellulose ester is settled again in the poor solvent, subsequent to dissolution of the good solvent of the cellulose ester. This will remove the low molecular weight component and other impurities of the cellulose ester. In this case, similarly to the aforementioned case of washing the cellulose ester, washing is preferably carried out in the presence of an antioxidant.

After the reprecipitation treatment of the cellulose ester, other polymer or low molecular weight compound may be added.

In the present invention, in addition to a cellulose ester resin, a cellulose ether resin, a vinyl resin (including, for example, a polyvinyl acetate resin or a polyvinyl alcohol resin), a cyclic olefin resin, a polyester resin (including, for example, an aromatic polyester, an aliphatic polyester, or a copolymer thereof) and an acrylic resin (including a copolymer), for example, may also be incorporated. The content of a resin other than the cellulose ester is preferably 0.1-30% by mass.

The cellulose ester used in the present invention preferably exhibits less luminescent foreign substance when formed into a film. The luminescent foreign substance is brightening spots of light coming out of a light source when a cellulose ester film is disposed between two perpendicularly disposed polarizing plates (cross Nicol), illuminated by a light source from one side and observed from the other side. Polarizing plates used for evaluation are desirably ones which are constituted of a protective film having no luminescent foreign substance and ones using a glass plate for protection of the polarizing plates. One of the causes for the luminescent foreign substance is assumed to be due to non-esterified or low-esterified cellulose, so that luminescent foreign substance can be removed by using a cellulose ester of reduced luminescent foreign substance (or using a cellulose ester exhibiting a low dispersion in degree of substitution) and by filtering a melted cellulose ester or passing it through a filtration step in at least either the latter stage of cellulose ester synthesis or in the stage of obtaining precipitates.

However, such minute foreign substance may not be completely removed by melting filtration in some occasion. The present inventors have found that occurrence of luminescent foreign substance can be drastically reduced by melt casting a cellulose ester while mixing a polymer having a specific amide structure and at least one selected from the group of a carbon radical scavenger, a phenol compound and a phosphorus-containing compound into the cellulose ester. Although the reason is not fully clear, it can be assumed that a low acylation material has been fully dissolved.

There are tendencies that thinner film results in fewer number of luminescent foreign substance spots per unit area and a lower cellulose ester content of the film forms less luminescent foreign substance. The number of luminescent foreign substance spots having a spot diameter of 0.01 mm or more is preferably not more than 200 spots/cm², more preferably not more than 100 spots/cm², still more preferably not more than 50 spots/cm², and further still more preferably not more than 30 spots/cm², and yet further still more preferably not more than 10 spots/cm², while none is most preferred. The number of luminescent foreign substance spots having a spot diameter of 0.005 to 0.01 mm is also preferably not more than 200 spots/cm², more preferably not more than 100 spots/cm², still more preferably not more than 50 spots/cm², and further still more preferably not more than 30 spots/cm², and yet further still more preferably not more than 10 spots/cm², while none is most preferred.

When removing luminescent foreign substance through melt filtration, filtering a cellulose composition mixed with additives, for example, a plasticizer and an antidegradation agent is preferred in terms of enhanced efficiency for removing luminescent foreign substance rather than filtering a melt of a cellulose ester alone. Reduction can also be achieved through filtration of the solution of a cellulose ester in a solvent in the synthesis process of the cellulose ester. A cellulose ester appropriately mixed with a UV absorber or other additive may also be filtered. A melt of a cellulose ester is filtered preferably at a viscosity of not more than 10000 Pa·s, more preferably not more than 5000 Pa·s, further more preferably not more than 1000 Pa·s and still further more preferably not more than 500 Pa·s. There are preferably used, as a filtering material, commonly known materials such as glass fibers, cellulose fibers, filtration paper and a fluororesin, e.g., tetrafluoroethylene resin. Specifically, ceramics and metals are preferably used. The absolute filtration precision of a filter is preferably not more than 50 μm, more preferably not more than 30 μm, still more preferably not more than 10 μm, and further still more preferably not more than 5 μm. These are optimally combined. A filter material may be the surface type or the depth type one but the depth type is preferred in terms of being reduced tendency to clog.

In another embodiment of the present invention, the raw material of cellulose ester may be dissolved at least once in a solvent or may be subjected to suspension-washing in a solvent, followed by drying to use the cellulose ester. In such a case, the cellulose ester may be dissolved in a solvent together with at least one of a plasticizer, a UV absorber, an antidegradant, an antioxidant and a matting agent. As a solvent, usable is a good solvent used for solution casting such as methylene chloride, methyl acetate, or dioxolane; a poor solvent such as methanol, ethanol or butanol, or a mixed solvent thereof. In the dissolution process, the mixture may be cooled to −20° C. or less, or may be heated to 80° C. or more. When such a cellulose ester is used, each additive can be uniform in the dissolved state, whereby the optical property can be homogeneous.

### (Plasticizer)

The cellulose ester optical film according to the present invention preferably contains at least one ester plasticizer obtained from a polyvalent alcohol and a monovalent carboxylic acid as the plasticizer. Specifically the optical film preferably contains an ester compound having a structure of condensation of an organic acid represented by Formula (6) and an alcohol of tri-valent or more in an amount of 1 to 25% by mass as a plasticizer. Any effect of including the plasticizer is not noticed in an amount of less than 1% by mass. An amount of more than 25% by mass, which tends to cause bleed-out and results in reduced aging stability of the film, is not preferred. More preferably, the optical film contains the foregoing plasticizer in an amount of 3 to 20% by mass and still more preferably in an amount of 5 to 15% by mass.

A plasticizer is in general an additive which is effective for improvement of brittleness or providing flexibility when added to a polymer. In the present invention, addition of a plasticizer results in a lower melting temperature than that of the cellulose ester alone, and at the same temperature, the melt viscosity of the film composition containing a plasticizer is lower than that of the cellulose ester alone. Further, addition achieves enhanced hydrophilicity of cellulose ester so that water vapor permeability of cellulose ester films is lowered, therefore, the plasticizer functions as a agent for preventing moisture permeation.

The melting temperature of the film composition refers to the temperature at which the heated materials exhibit a state of fluidity. In order that a cellulose ester results in melt fluidity, it is necessary to heat the cellulose ester to a temperature which is at least higher than the glass transition temperature. At or above the glass transition temperature, the elastic modulus or viscosity decreases due to heat absorption, whereby fluidity comes into effect. However, at a higher temperature, cellulose ester melts and simultaneously undergoes thermal degradation to result in a decrease in the molecular weight of the cellulose ester, whereby the dynamic characteristics of the resulting film may be adversely affected. Consequently, it is preferable to melt cellulose ester at as low a temperature as possible. Lowering the melting temperature of the film forming materials is achieved by the addition of a plasticizer having a melting point or a glass transition temperature which is equal to or lower than the glass transition temperature of the cellulose ester. The polyvalent alcohol ester plasticizer having a condensation structure of an organic acid represented by the foregoing Formula (6) and a polyvalent alcohol lowers the melting temperature of a cellulose ester and exhibits reduced volatility in the melt film formation process or after production, which is superior in process suitability and results in an cellulose ester film superior in an optical characteristic, dimensional stability and flatness.

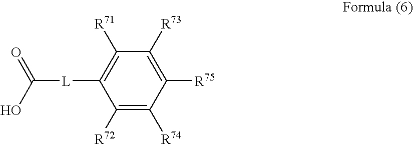

In Formula (6), R⁷¹-R⁷⁵ are each a hydrogen atom, a cycloalkyl group, an aralkyl group, an alkoxy group, a cycloalkyl group, an aryloxy group, an aralkyloxy group, an acyl group, a carbonyloxy group, an oxycarbonyl group, and an oxycarbonyloxy group, and these groups may be sub R₁-R₅ is not a hydrogen atom. L represents a divalent linkage group, including a substituted or unsubstituted alkylene group, an oxygen atom, or a single bond.

The cycloalkyl group represented by R⁷¹-R⁷⁵ is preferably a cycloalkyl group having 3-8 carbon atoms and specific examples thereof include cyclopropyl, cyclopentyl, and cyclohexyl. These groups may be substituted and examples of a preferred substituent include a halogen atom, such as a chlorine atom, a bromine atom, a fluorine atom, a hydroxyl group, an alkyl group, an alkoxy group, a cycloalkoxy group, an aralkyl group (a phenyl group of which may be substituted by an alkyl group, a halogen atom or the like), an alkenyl group such as a vinyl group or an allyl group, a phenyl group (a phenyl group of which may be substituted by an alkyl group, a halogen atom or the like), a phenoxy group (a phenyl group of which may be substituted by an alkyl group, a halogen atom or the like), an acyl group having 2-8 carbon atoms such as an acetyl or propionyl group, and an unsubstituted carbonyloxy group having 2-8 carbon atoms, such as an acetyloxy or propionyloxy group.

The aralkyl group represented by R⁷¹-R⁷⁵ includes, for example, a benzyl group, a phenethyl group and a γ-phenylpropyl group, which may be substituted, and preferred substituents are the same as cited in the foregoing cycloalkyl group.

The alkoxy group represented by R⁷¹-R⁷⁵ includes an alkoxy group having 1-8 carbon atoms. Specific examples thereof include alkoxy groups such as methoxy, ethoxy, n-propoxy, n-butoxy, n-octyloxy, isopropoxy, isobutoxy, 2-ethylhexyloxy, and t-butoxy. These groups may be substituted and examples of a preferred substituent include a halogen atom such as a chlorine atom, bromine atom or a fluorine atom, a hydroxy group, an alkoxy group, a cycloalkoxy group, an aralkyl group (in which a phenyl group may be substituted by an alkyl group or a halogen atom), an alkenyl group, a phenyl group (which may be substituted by an alkyl group, a halogen atom or the like), an aryloxy group [for example, a phenoxy group (in which a phenyl group may be substituted by an alkyl group or a halogen atom)], an acyl group such as an acetyl group or a propionyl group, an unsubstituted acyloxy group having 2-8 carbon atoms, such as acetyloxy group or a propionyloxy group, and an arylcarbonyloxy group such as benzoyloxy group.

The cycloalkoxy group represented by R⁷¹-R⁷⁵ includes an unsubstituted cycloalkoxy group having 1-8 carbon atoms, and specific examples thereof include cyclopropyloxy, cyclopentyloxy and cyclohexyloxy. These groups may be substituted and preferred substituents are the same as cited in the foregoing cycloalkyl group.

The aryloxy group represented by R⁷¹-R⁷⁵ includes a phenoxy group, in which a phenyl group may be substituted by a substituent such as an alkyl group or a halogen atom, as cited in the foregoing cycloalkyl group.

The aralkyloxy group represented by R⁷¹-R⁷⁵ includes a benzyloxy group and a phenethyloxy group, which may be substituted by a substituent and preferred substituents are those as cited in the foregoing cycloalkyl group.

The acyl group represented by R⁷¹-R⁷⁵ includes an unsubstituted acyl group such as an acetyl group or propionyl group (in which a hydrocarbon group of the acyl group include an alkyl group, an alkenyl group and an alkynyl group), which may be substituted by a substituent and preferred substituents are those as cited in the foregoing cycloalkyl group.

The carbonyloxy group represented by R⁷¹-R⁷⁵ includes an unsubstituted an acyloxy group having 2-8 carbon atoms such as an acetyloxy group or propionyloxy group (in which a hydrocarbon group of the acyl group include an alkyl group, an alkenyl group and an alkynyl group) and an aryloxycarbonyl group such as benzoyloxy, which may be substituted by a substituent and preferred substituents are those as cited in the foregoing cycloalkyl group.

The oxycarbonyl group represented by R⁷¹-R⁷⁵ includes an alkoxycarbonyl group such a methoxycarbonyl group, an ethoxycarbonyl group or a propyloxycarbonyl group, and an aryloxycarbonyl group such as a phenoxycarbonyl group, which may be substituted by a substituent and preferred substituents are those as cited in the foregoing cycloalkyl group.

The oxycarbonyloxy group represented by R⁷¹-R⁷⁵ includes an alkoxycarbonyloxy group having 1-8 carbon atoms such as a methoxycarbonyloxy group, which may be substituted by a substituent and preferred substituents are those as cited in the foregoing cycloalkyl group.

Any ones of R⁷¹-R⁷⁵ may be combined with each other to form a ring.

The linkage group represented by L represents a substituted or unsubstituted alkylene group, an oxygen atom, or a single bond. The alkylene group includes a methylene group, an ethylene group and a propylene group, which may be substituted by the same substituents as cited in those for the group represented by R⁷¹-R⁷⁵.

The linkage group represented by L preferably is a bond, which leads to an aromatic carboxylic acid.

In the present invention the organic acid which is substituted for hydroxyl groups of a tri- or more-valent alcohol may be a single acid or plural acids.

A tri- or more-valent alcohol which reacts with the foregoing organic acid represented by Formula (6) to form a polyvalent alcohol ester is preferably an aliphatic polyvalent alcohol having a valence of 3 to 20 and in the present invention, the tri- or more-valent alcohol is preferably represented by the following Formula (7):

R′—(OH)ₘ Formula (7)

wherein R′ is an m-valent organic group, m is a positive integer of 3 or more and OH is an alcoholic hydroxyl group. A polyvalent alcohol having m of 3 or 4 is specifically preferred.

Preferred examples of a polyvalent alcohol, to which the present invention is not limited, include adonitol, arabitol, 1,2,4-butanetriol, 1,2,3-hexanetriol, 1,2,6-hexanetriol, glycerin, diglycerin, erythritol, pentaerythritol, dipentaerythritol, tripentaerythritol, galactitol, glucose, cellobiose, inositol, mannitol, 3-methylpentane-1,3,5-triol, pinacol, sorbitol, trimethylolpropane, trimethylolethane and xylitol. Of these, glycerin, trimethylethane, trimethylolpropane and pentaerythritol are preferred.

An ester formed of an organic acid represented by Formula (6) and a polyvalent alcohol having a valence of 3 or more can be synthesized according to commonly known methods. Although representative synthesis examples are shown in Examples, there are cited, for example, a method in which an organic acid represented by the Formula (6) and a polyvalent alcohol are condensed in the presence of an acid to form an ester; a method in which an organic acid is preliminarily transformed to an acid chloride or an acid anhydride, which is reacted with a polyvalent alcohol; and a method in which a phenyl ester of an organic acid and a polyvalent alcohol are reacted. It is preferred to choose an appropriate method exhibiting high yield according to the targeted ester compound.

A plasticizer of an ester formed of an organic acid represented by the Formula (6) and a polyvalent alcohol having a valence of 3 or more is preferably a compound represented by the following Formula (8):

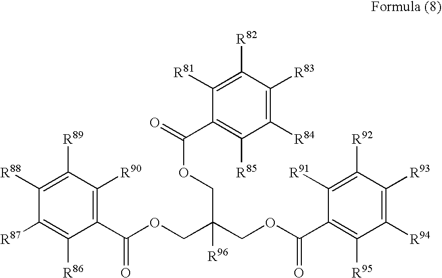

In Formula (8) R⁸¹ through R⁸⁵ are each a hydrogen atom, a cycloalkyl group, an aralkyl group, an alkoxy group, a cycloalkoxy group, an aryloxy group, an aralkyloxy group, an acyl group, a carbonyloxy group and oxycarbonyloxy group, and these groups may further be substituted by a substituent. R⁸⁶ is an alkyl group.

The cycloalkyl group, aralkyl group, alkoxy group, cycloalkoxy group, aryloxy group, aralkyloxy group, acyl group, carbonyloxy group and oxycarbonyloxy group of R⁸¹ through R⁸⁵ are the same as cited in the foregoing R⁷¹-R⁷⁵.

The molecular weight of the thus obtained polyvalent alcohol ester is not specifically limited but preferably from 300 to 1500, and more preferably from 400 to 1000. A larger molecular weight, which is difficult to vaporize, is preferred and a smaller molecule is preferred in terms of moisture permeability and compatibility with a cellulose ester.

Specific examples of a polyvalent alcohol ester relating to the present invention are shown below.

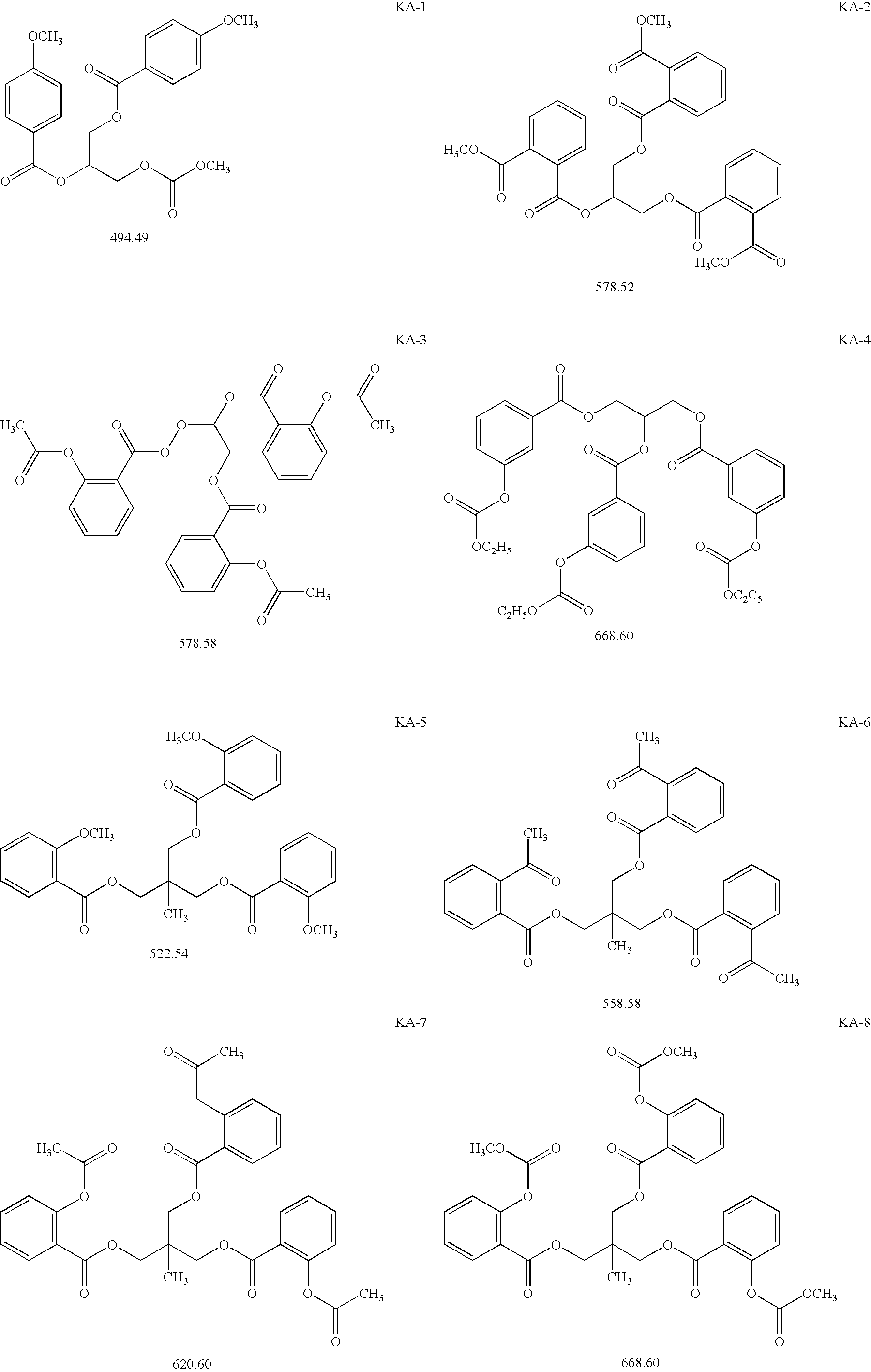

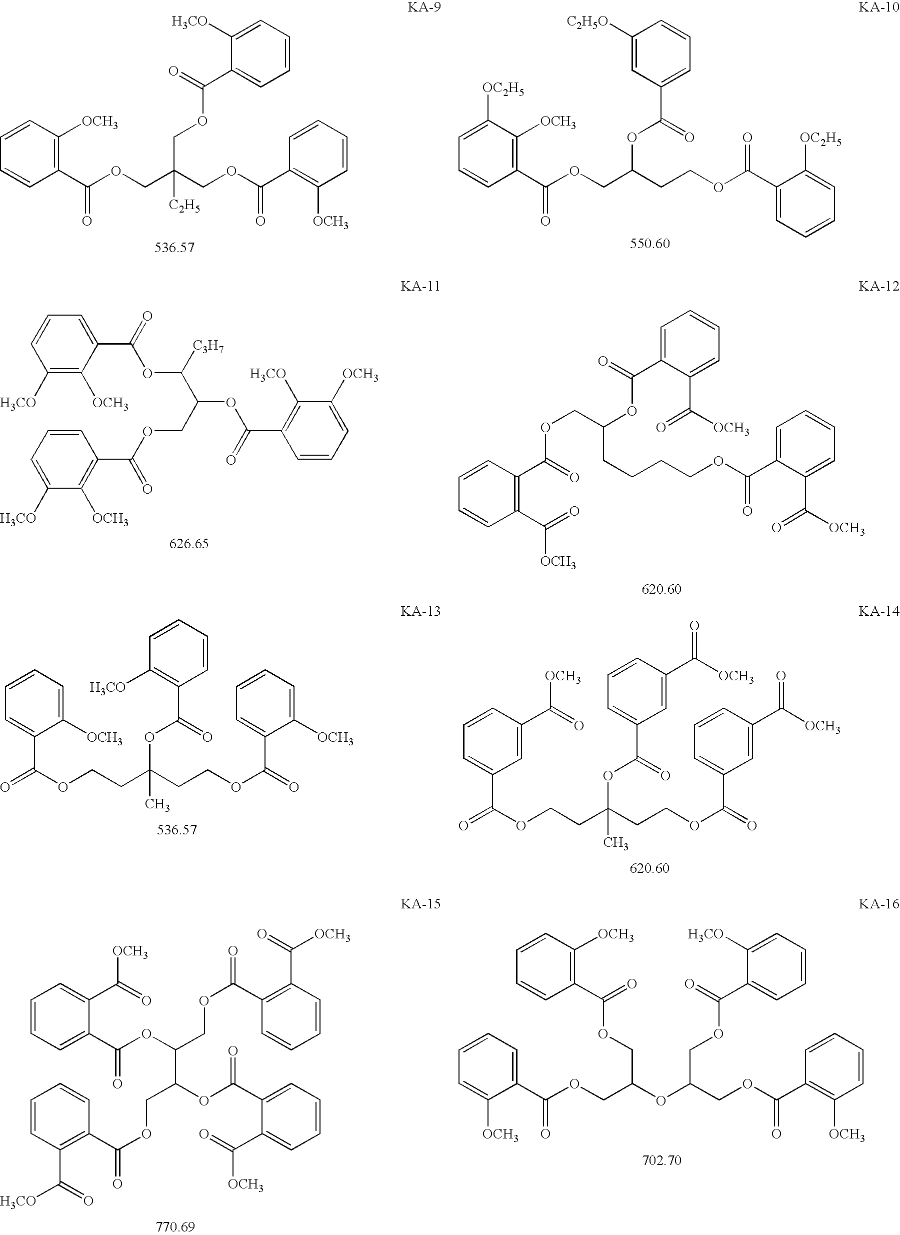

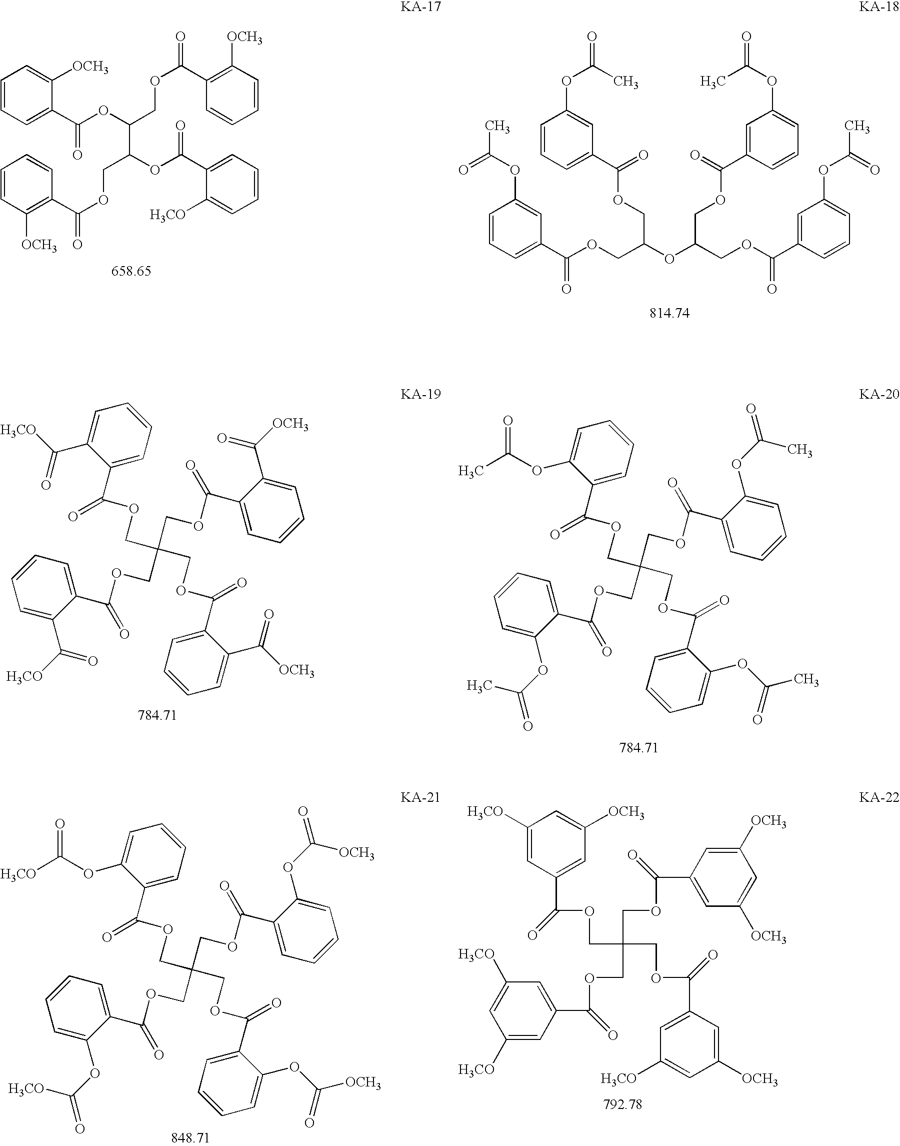

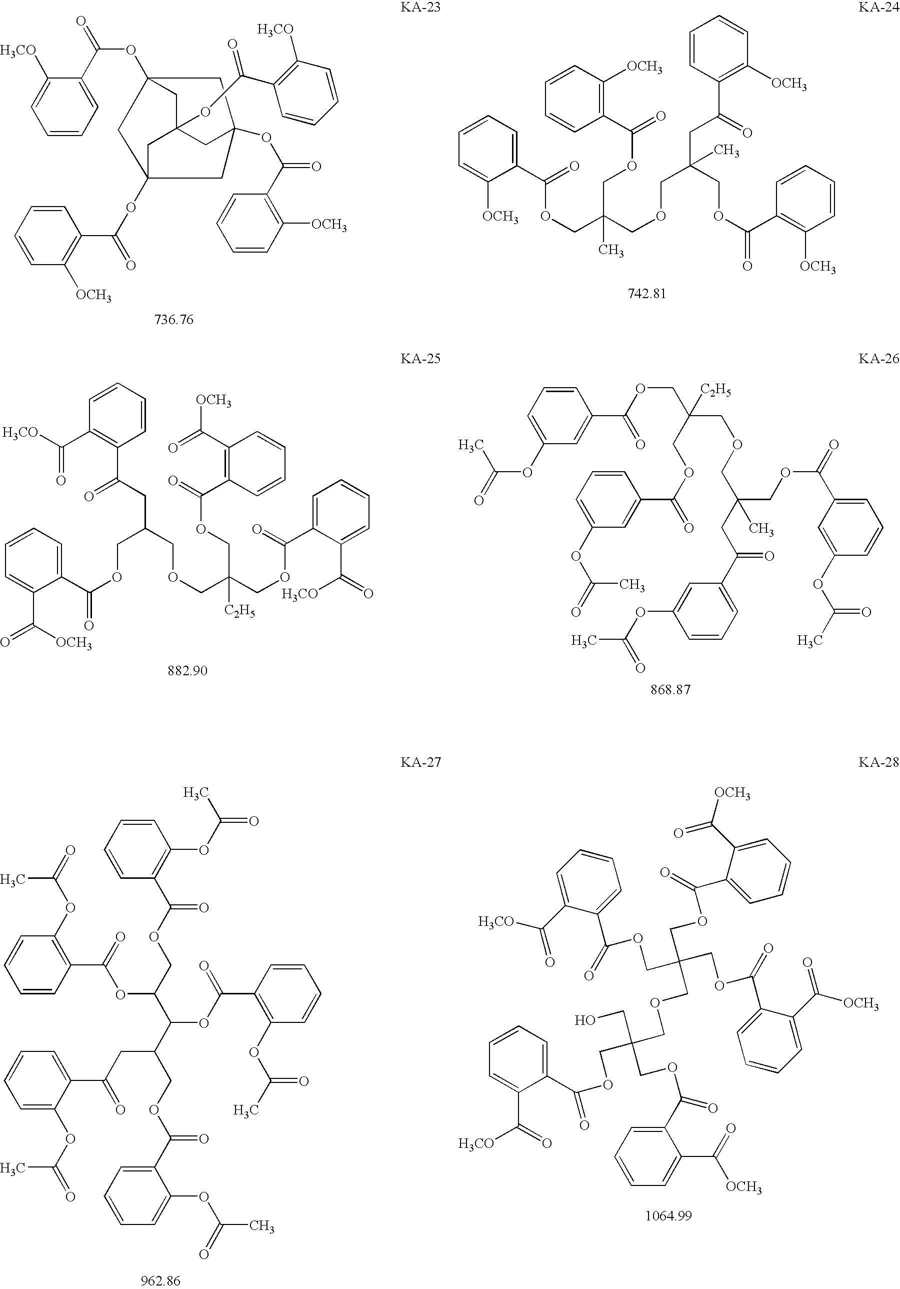

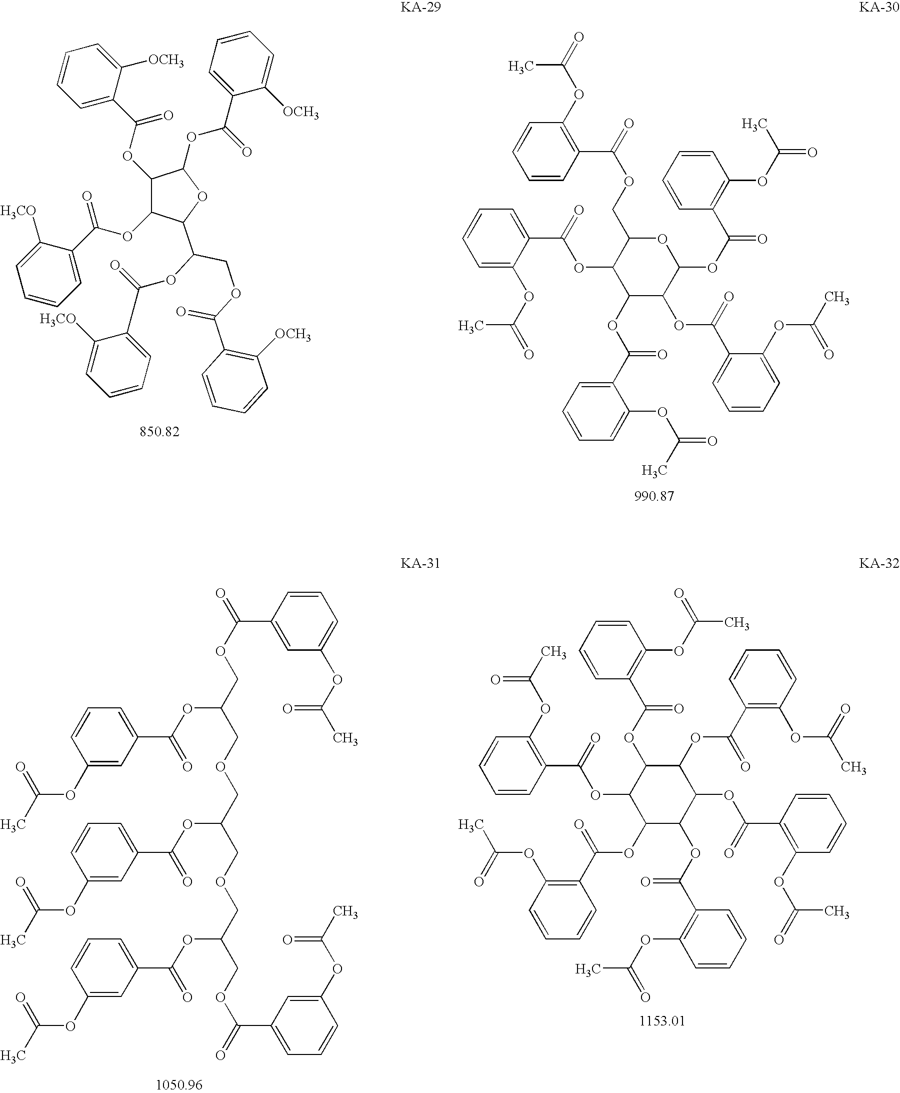

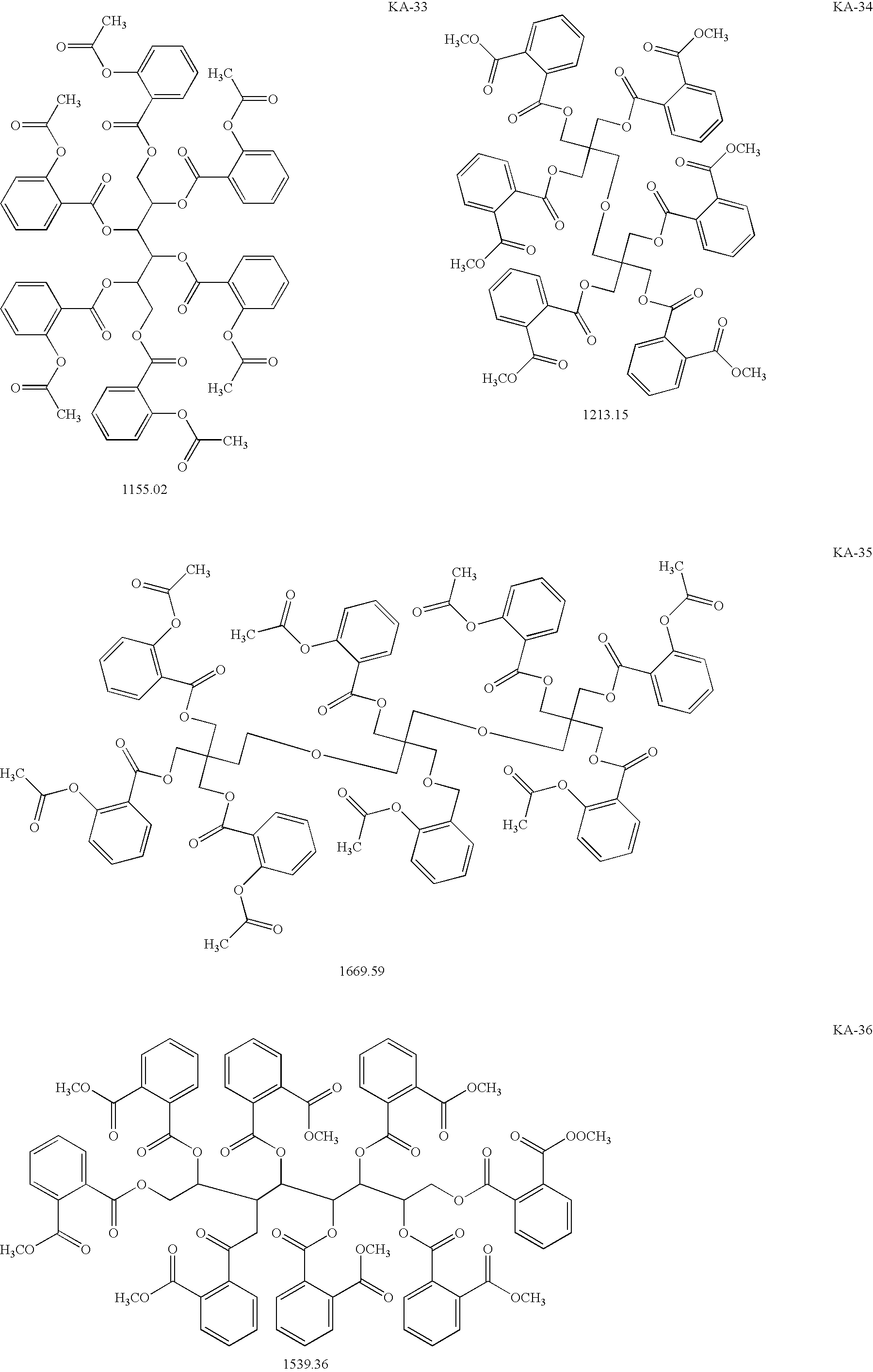

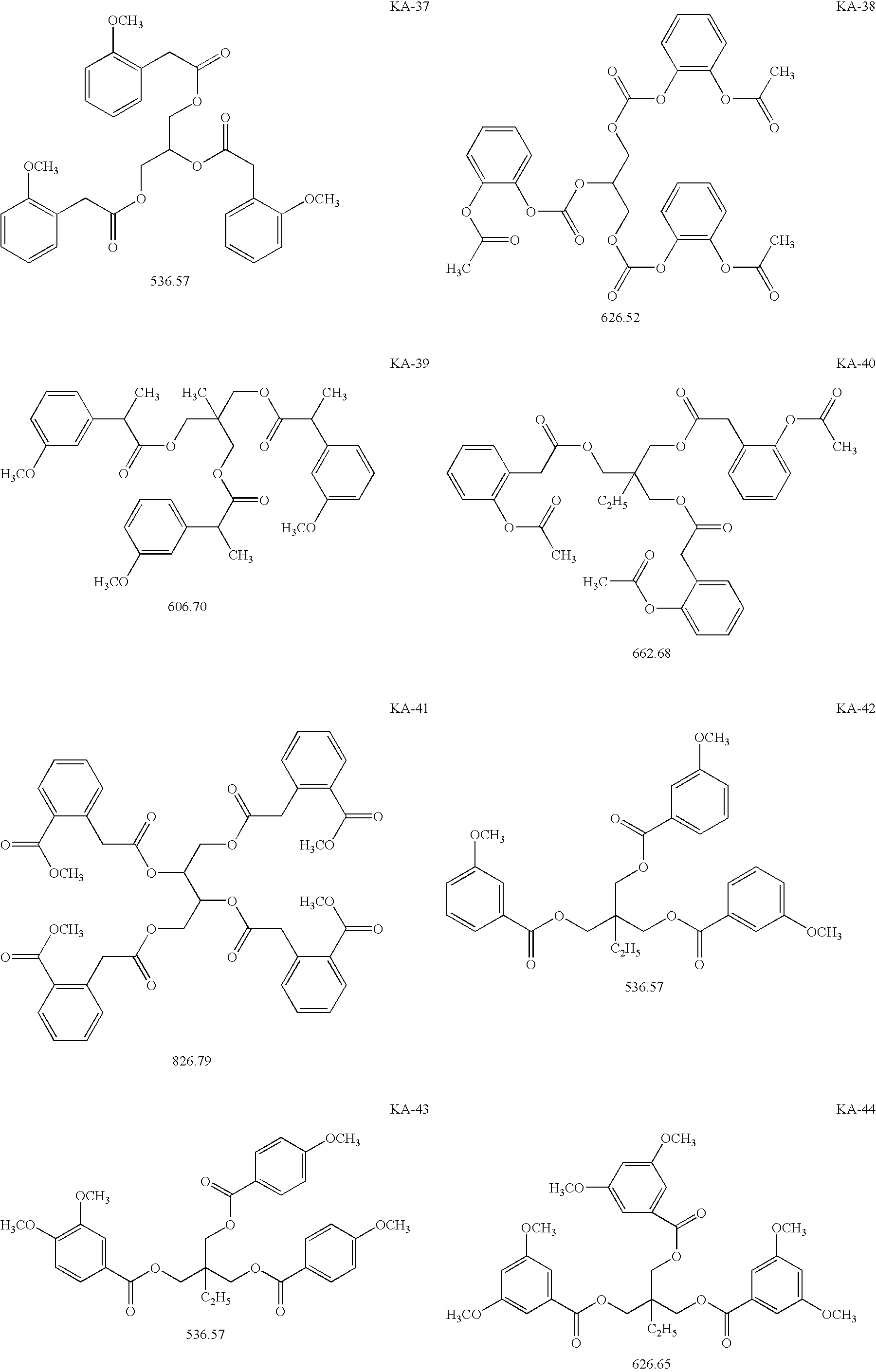

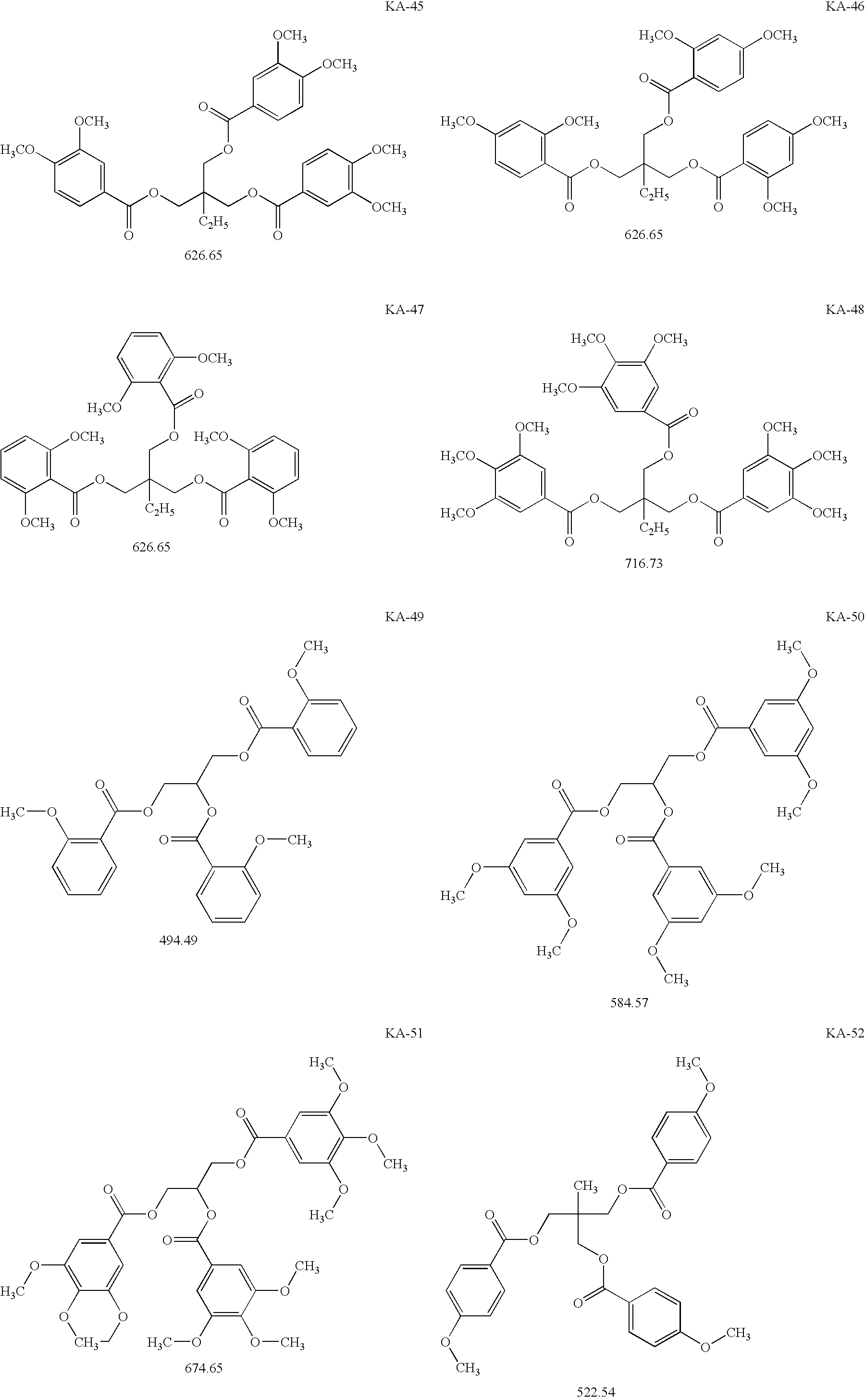

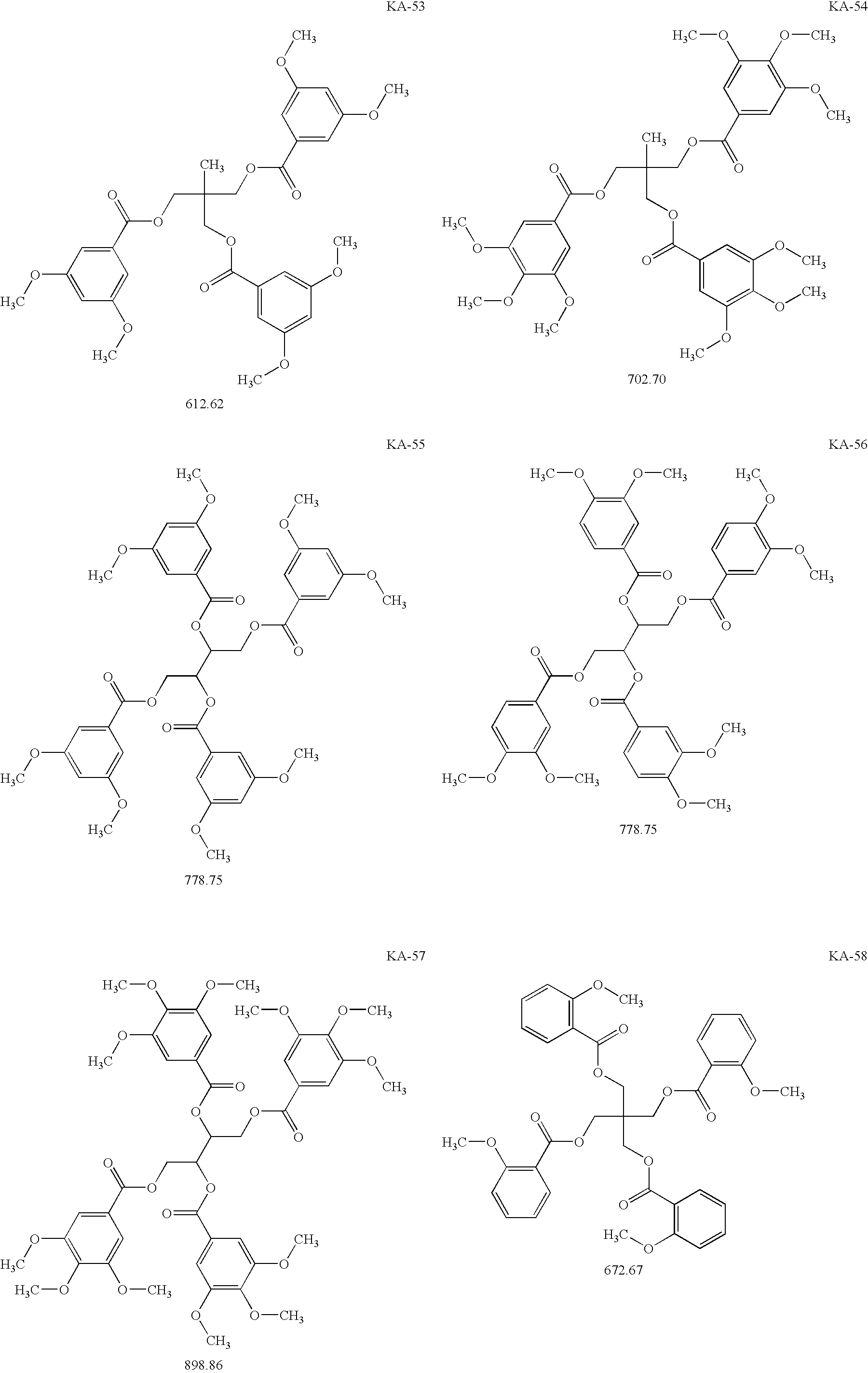

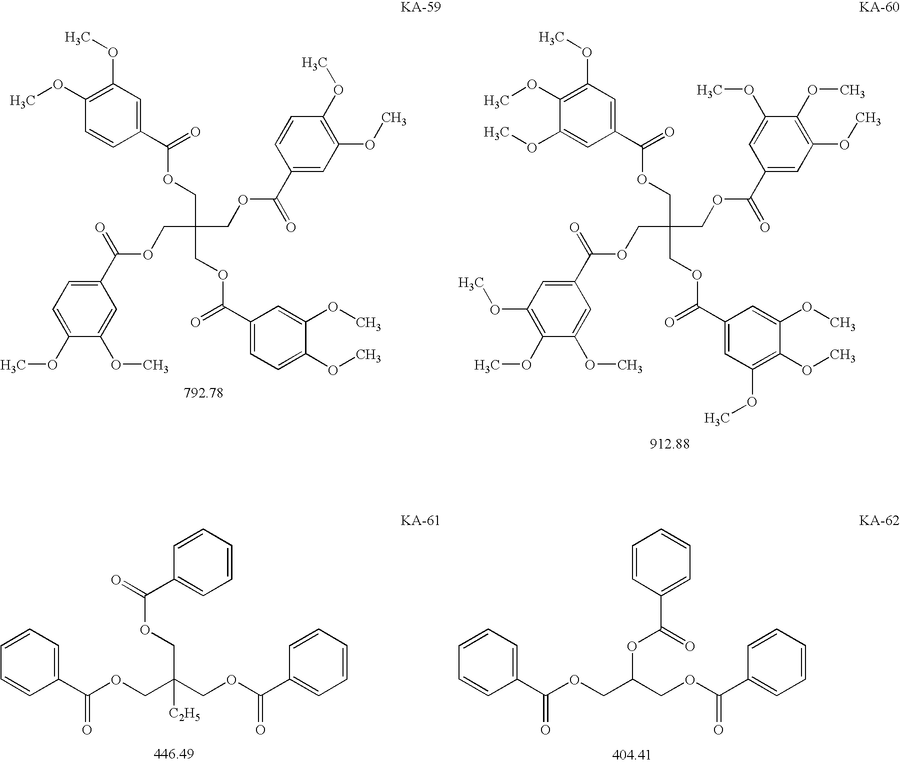

The cellulose ester optical film of the present invention may further be used together with other plasticizers.

The ester compound as a preferred plasticizer of the present invention, which is formed of the foregoing organic acid of Formula (6) and polyvalent alcohol having a valence of 3 or more, is featured in that it exhibits enhanced compatibility with a cellulose ester and can be incorporated at a high ratio, so that no bleed-out occurs even when used with other plasticizers or additives and combined use with other plasticizers or additives are feasible.

When used with other plasticizers, the plasticizer of the Formula (6) is contained preferably in an amount of not less than 50% by mass of all plasticizers, more preferably not less than 70% and still more preferably not less than 80%. The use within such a range provides a definite effect, such as enhanced flatness of melt-cast cellulose ester film, even when used in combination with other plasticizers.

There are cited the following plasticizers as preferred other plasticizers.

Ethylene glycol ester as one of polyvalent alcohol esters:

Specific examples include an ethylene glycol alkyl ester plasticizer such as ethylene glycol diacetate and ethylene glycol dibutyrate; an ethylene glycol cycloalkyl ester plasticizer such as ethylene glycol dicyclopropylcarboxylate and ethylene glycol dicyclohexylcarboxylate; an ethylene glycol aryl ester plasticizer such as ethylene glycol dibenzoate and ethylene glycol di-4-methylbenzoate. These alkylate group, cycloalkylate group and arylate group are each the same or different, and may be substituted. Further, the alkylate group, cycloalkylate group and arylate group may be mixed or substituents may be bonded through a covalent bonding. Further, the ethylene glycol portion may be substituted and the partial structure of ethylene glycol may be a part of a polymer or may be regularly pendent thereto, or may be introduced into a part of the molecular structure of an additive such as an antioxidant, an acid scavenger or an ultraviolet absorber.

Glycerin ester plasticizers as one of polyvalent alcohol esters:

Specific examples include a glycerin alkyl ester such as triacetin, tributyrin, glycerin diacetate caprylate or glycerin oleate propionate; a glycerin cycloalkyl ester such as glycerin cyclopropylcarboxylate, or glycerin tricyclohexylcarboxylate; diglycerin aryl ester such as glycerin tribenzoate or glycerin 4-methylbenzoate; a diglycerin alkyl ester such as diglycerin tetraacetylate, diglycerin tetrapropionate, diglycerin acetate tricaprylate, or diglycerin tetralaurate; a diglycerin cycloalkyl ester such as diglycerin tetracyclobutylcarboxylate or diglycerin tetracyclopentylcarboxylate; and a diglycerin aryl ester such as diglycerin tetrabenzoate or diglycerin 3-methylbenzoate. These alkylate group, cycloalkylcarboxylate group and arylate group may each be the same or different, or may be substituted. The alkylate group, cycloalkylcarboxylate group and arylate group may be mixed or substituents may be bonded through a covalent bonding. Further, the glycerin or diglycerin portion may be substituted and the partial structure of a glycerin ester or diglycerin ester may be a part of a polymer or may be regularly pendent thereto, or may be introduced into a part of the molecular structure of an additive such as an antioxidant, an acid scavenger or an ultraviolet absorber.

Further, as other polyvalent alcohol ester plasticizers are cited those described in JP-A No. 2003-12823, paragraphs 30-33.

Dicarboxylic acid ester plasticizers as one of polyvalent carboxylic acid esters:

Specific examples include an alkyldicarboxylic acid alkyl ester plasticizer such as didodecyl malonate (C1), dioctyl adipate (C4) or dibutyl sebacate (C8); an alkyldicarboxylic acid cycloalkyl ester plasticizer such as dicylopentyl succinate or dicyclohexyl adipate; an alkyldicarboxylic acid aryl ester such as diphenyl succinate or di(4-methyl)phenyl glutarate; a cycloalkyl-di-carboxylic acid alkyl ester plasticizer such as dihexyl-1,4-cyclohexane cicarboxylate or didecylbicyclo[2.2.1]heptane-2,3-dicarboxylate; a cycloalkyldicarboxylic acid cycloalkyl ester plasticizer such as dicycloalkyl-1,2-cyclobutane dicarboxylate or dicyclopropyl-1,2-cyclohexyl dicarboxylate; acycloalkyldicarboxylic acid aryl ester plasticizer such as diphenyl-1,1-cyclopropyl dicarboxylate or di-2-naphthyl-1,4-cyclohexane dicarboxylate; an arylcarboxylic acid alkyl ester plasticizer such as diethyl phthalate, dimethyl phthalate, dioctyl phthalate, dibutyl phthalate or di-2-ethylhexyl phthalate; an aryldicarboxylic acid cycloalkyl ester plasticizer such as cyclopropyl phthalate or dicyclohexyl phthalate; and an aryldicarboxylic acid aryl ester plasticizer such as diphenyl phthalate or di-4-methylphenyl phthalate. These alkoxy group and cycloalkoxy group may each be the same or different, or may be mono-substituted, and these substituents may further be substituted. The alkyl group or cycloalkyl group may be mixed or these substituents may be bonded through a covalent bonding. Further, the aromatic ring of a phthalic acid may be substituted, and may be a polymer such as dimer, trimer, tetramer or the like. Further, the partial structure of a phthalic acid ester may be a part of a polymer or may be regularly pendent thereto, or may be introduced into a part of the molecular structure of an additive such as an antioxidant, an acid scavenger or an ultraviolet absorber.

Specific examples of other polycarboxylic acid ester plasticizers include an alkyl-polycarboxylic acid alkyl ester plasticizer such as tridecyl tricarbarate or tributyl-meso-butane-1,2,3,4-tetracarboxylate; an alkyl-polycarboxylic acid cycloalkyl ester plasticizer such as tricyclohexyl tricarbarate or tricyclopropyl-2-hydroxy-1,2,3-propanetricarboxylate; an alkylpolycarboxylic acid aryl ester plasticizer such as triphenyl-2-hydroxy-1,2,3-propanetricarboxylate or tetra-3-methylphenyltetrahydrofuran-2,3,4,5-tetracarboxylate; a cycloalkyl-polycarboxylic acid alkyl ester plasticizer such as tetrahexyl-1,2,3,4-cyclobutanetetracarboxylic acid or tetrabutyl-1,2,3,4-cyclopentanetetracarboxylic acid; a cycloalkyl-polycarboxylic acid cycloalkyl ester plasticizer such as tetracyclopropyl-1,2,3,4-cyclobutanetetracarboxylic acid or tricyclohexyl-1,3,5-cyclohexyltricarboxylate; a cycloalkyl-polycarboxylic acid aryl ester plasticizer such as triphenyl-1,3,5-cyclohexyltricarboxylate or hexa-4-methylphenyl-1,2,3,4,5,6-cyclohexylhexacarboxylate; an aryl-polycarboxylic acid alkyl ester plasticizer such as tridecylbenzene-1,2,4-tricarboxylate or tetraoctylbenzebe-1,2,4,5-tetracarboxylate; an aryl-polycarboxylic acid cycloalkyl ester plasticizer such as tricyclopentylbenzene-1,3,5-tricarboxylate or tetracyclohexylbenzene-1,2,3,5-tetracarboxylate; and aryl-polycarboxylic acid aryl ester plasticizer such as triphenylbenzene-1,3,5-tetracarboxylate or hexa-4-methylphenylbenzene-1,2,3,4,5,6-hexacarboxylate. These alkoxy group and cycloalkoxy group may each be the same or different, or may be mono-substituted, and these substituents may further be substituted. The alkyl group or cycloalkyl group may be mixed or these substituents may be bonded through a covalent bonding. Further, the aromatic ring of a phthalic acid may be substituted, and may be a polymer such as dimer, trimer, tetramer or the like. Further, the partial structure of a phthalic acid ester may be a part of a polymer or may be regularly pendent thereto, or may be introduced into a part of the molecular structure of an additive such as an antioxidant, an acid scavenger or an ultraviolet absorber.

Of the foregoing ester plasticizers formed of a polycarboxylic acid and a mono-valent alcohol, a dialkylcarboxylic acid alkyl ester is preferred, and specifically including dioctyl adipate and tridecyl tricarbalate.

As other plasticizers usable in the present invention, for example, a phosphoric acid ester plasticizer, a hydrocarbon ester plasticizer and a polymer plasticizer may be cited.

Phosphoric acid ester plasticizers:

Specific examples include a phosphoric acid alkyl ester such as triacetyl phosphate or tributyl phosphate; a phosphoric acid cycloalkyl ester such as tricylopentyl phosphate or tricyclohexyl phosphate; and a phosphoric acid aryl ester such as triphenyl phosphate, tricresyl phosphate, crezylphenyl phosphate, octyldiphenyl phosphate, diphenyl-biphenyl phosphate, trioctyl phosphate, tributyl phosphate, trinaphthyl phosphate, trixylyl phosphate or tris-ortho-biphenyl phosphate. These substituents may be the same or different, and may be substituted. The alkyl group, cycloalkyl group and aryl group may be mixed and substituents may be bonded through a covalent bonding.

There are also cited an alkylenebis(dialkylphosphate) such as ethylenebis(dimethylphosphate) or butylenebis(diethylphosphate); an alkylenebis-(diarylphosphate) such as ethylenbis(diphenylphosphate) or propylenebis(dinaphthylphosphate); an arylenebis(dialkylphosphate) such as phenylenebis-(dibutylphosphate), biphenylenebis(dioctylphosphate), and an arylenebis(diarylphosphate) such as phenylenebis(diphenylphosphate) or naphthylenebis-(ditoluylphosphate). These substituents may be the same or different, and may be substituted. The alkyl group, cycloalkyl group and aryl group may be mixed and substituents may be bonded through a covalent bonding.

Further, the partial structure of a phosphoric acid ester may be a part of a polymer or may be regularly pendent thereto, or may be introduced into a part of the molecular structure of an additive such as an antioxidant, an acid scavenger or an ultraviolet absorber. Of the foregoing compounds, a phosphoric acid aryl ester and an arylenebis(diarylphosphate) are preferred and specifically, triphenyl phosphate and phenylenebis(diphenylphosphate) are preferred.

Carbohydrate ester plasticizer:

A carbohydrate means monosaccharide, disaccharide or trisaccharide in which saccharide is present in a state of pyranose or furanose (6-member ring or 5-member ring). Unlimited examples of a carbohydrate include glucose, saccharose, lactose, cellobiose, mannose, xylose, ribose, galactose, arabinose, fructose, sorbose, cellotriose and raffinose. A carbohydrate ester indicates an ester compound, in which a hydroxyl group of carbohydrate and a carboxylic acid are dehydration condensed, and, more specifically, indicates an aliphatic carboxylic ester or an aromatic carboxylic ester. Aliphatic carboxylic acid includes such as acetic acid and propionic acid, and aromatic carboxylic acid includes such as benzoic acid, toluic acid and anisic acid. A carbohydrate is provided with hydroxyl groups of corresponding number to the type, however, either a part of hydroxyl group and carboxylic acid may react to form an ester compound or the whole hydroxyl group and carboxylic acid may react to form an ester compound. It is preferable that the whole hydroxyl group and carboxylic acid react to form an ester compound in the present invention.

Specific examples of a carbohydrate ester plasticizer preferably include such as glucose pentaacetate, glucose pentapropionate, glucose pentabutyrate, saccharose octaacetate and saccharose octabenzoate. Saccharose octaacetate and saccharose octabenzoate are more preferable among them, and saccharose octabenzoate is particularly preferable.

Specifically, polymeric plasticizers include: an aliphatic hydrocarbon polymer; an alicyclic hydrocarbon polymer; an acryl polymer such as poly(ethyl acrylate), poly(methyl methacrylate) or a copolymer of methyl methacrylate and 2-hydroxyethyl methacrylate (for example, an arbitrary copolymer ratio in the range of 1:99 to 99:1); a vinyl polymer such as poly(vinyl isobutyrate) or poly-N-vinylpyrrolidone; a copolymer of methyl methacrylate and N-vinylpyrrolidone (for example, an arbitrary copolymer ratio in the range of 1:99 to 99:1); a styrene polymer such as polystyrene or poly(4-hydroxystyrene); a copolymer of methyl methacrylate and 4-hydroxystylene (for example, an arbitrary copolymer ratio in the range of 1:99 to 99:1); a polyester such as poly(butylene succinate), poly(ethylene terephthalate) or poly(ethylene naphthylate); a polyether such as polyethylene oxide or polypropylene oxide; a polymamide; a polyurethane and a polyurea. A number average molecular weight is preferably from 1,000 to 500,000 and more preferably from 5,000 to 200,000. A molecular weight of less than 1,000 causes problems in volatility and a molecular weight or ore than 500,000 results in reduced plasticity and adversely affects a mechanical property of cellulose ester film. These polymeric plasticizers may be a homopolymer comprised of a single repeating unit or a copolymer comprised of plural repeating units. Two or more of the foregoing polymers may be used in combination.

The optical film of the present invention is preferably has Yellow Index (YI) of not more than 3.0, more preferably not more than 1.0, because coloration is not advantageous in view of the optical use. Yellow Index can be measured according to JIS K7103.

Similarly to the case of the aforementioned cellulose ester, the plasticizer is preferably treated to remove the impurities such as residual acid, inorganic salt and organic low-molecule compound that have been carried over from the process of manufacturing, or that have occurred during preservation. The plasticizer has more preferably a purity of 99% or more. The amounts of residual acid and water each are preferably 0.01 through 100 ppm. This reduces thermal deterioration in the melt-casting film formation of the cellulose ester, and improves the film formation stability, film optical property and mechanical property.

### (Ultraviolet Absorber)

An ultraviolet absorber may be added into the optical film according to the present invention in order to prevent deterioration of a polarizer or a display device due to ultraviolet rays. The ultraviolet absorber preferably has excellent ultraviolet light absorbance for wavelengths of 370 nm or less in view of preventing deterioration of the polarizer or the display device due to ultraviolet light, and from the viewpoint of the property of liquid crystal display, it is preferable that the absorbance of visible light which has wavelength of 400 nm or more.

Example of such an ultraviolet absorber include: salicylic acid based ultraviolet absorbers (phenyl salicylate and p-tert-butyl salicylate); benzophenone based ultraviolet absorbers (2,4-dihydroxybenzophenone and 2,2′-dihydroxy-4,4′-dimethoxybenzophenone); benzotriazole based ultraviolet absorbers (2-(2′-hydroxy-3′-tert-butyl-5′-methylpheny1)-5-chlorobenzotriazole, 2-(2′-hydroxy-3′,5′-di-tert-butylphenyl)-5-chlorobenzotriazole, 2-(2′-hydroxy-3′-dodecyl-5′-methylphenyl) benzotriazole, 2-(2′-hydroxy-3′-tert-butyl-5′-(2-octyloxycarbonylethyl)-phenyl)-5-chloro benzotriazole, 2-(2′-hydroxy-3′-(1-methyl-1-phenylethyl)-5′-(1,1,3,3,-tetramethylbutyl)-phenyl)benzotriazole, and 2-(2′-hydroxy-3′,5′-di-(1-methyl-1-phenylethyl)-phenyl)benzotriazole); cyano acrylate based ultraviolet absorbers (2′-ethylhexyl-2-cyano-3,3-diphenyl acrylate and ethyl-2-cyano-3-(3′,4′-methylenedioxyphenyl)-acrylate); triazine based ultraviolet absorbers; the compounds disclosed in JP-A Nos. 58-185677 and 59-149350; nickel complex salt compounds; and inorganic powders.

As the ultraviolet absorbers according to the present invention, preferred are the benzotriazole based absorbers and benzophenone based ultraviolet absorbers both of which exhibit high transparency and excellent effects to minimize deterioration of polarizing plates and liquid crystal elements, and specifically preferable are benzotriazole based ultraviolet absorbers exhibiting more suitable light absorbance spectra.

A benzotriazole based ultraviolet absorber which is a conventional ultra violet absorber preferably used together with the ultra violet absorber according to the present invention may be of a “bis” form, examples of which include 6,6′-methylenebis(2-(2H-benz[d][1,2,3]triazole-2-yl))-4-(2,4,4-trimethylpentane-2-yl) phenol and 6,6′-methylenebis(2-(2H-benz[d][1,2,3]triazole-2-yl))-4-(2-hydroxyethyl)phenol.

In the present invention, further, a conventional ultraviolet ray-absorbing polymer may be used in combination. The conventional ultraviolet ray-absorbing polymer is not specifically limited, and examples thereof include a polymer which is prepared by homopolymerizing PUVA-93 (produced by Otsuka Chemical Co., Ltd.) and a polymer which is prepared by copolymerizing RUVA-93 together with another monomer. Specifically listed are PUVA-30M which is prepared by copolymerizing RUVA-93 with methyl methacrylate at a weight ratio of 3:7 (in terms of weight ratio) and PUVA-50M which is prepared by copolymerizing RUVA-93 with methyl methacrylate at a weight ratio of 5:5 (in terms of weight ratio). Further, a polymer disclosed in JP-A No. 2003-113317 may be cited.

Commercially available TINUVIN 109, TINUVIN 171, TINUVIN 360, TINUVIN 900 and TINUVIN 928 (each being manufactured by Chiba Specialty Chemical Co., Ltd.), LA-31 (manufactured by Asahi Denka Co., Ltd.), LUVA-100 (produced by Otuka Kagaku Co., Ltd.) and Sumisorb 250 (produced by Sumitomo Kagaku Co., Ltd.) may also be used.

Examples of the benzophenone based compound include 2,4-dihydroxy benzophenone, 2,2′-dihydroxy-4-methoxy benzophenone, 2-hydroxy-4-methoxy-5-sulfobenzophenone, bis(2-methoxy-4-hydroxy-5-benzoyl phenyl methane), however, are not limited thereto.

In the present invention, the added amount of the ultraviolet absorber is preferably from 0.1 to 20% by mass, more preferably from 0.5 to 10% by mass, and still more preferably from 1 to 5% by weight. Two or more kinds of the ultraviolet absorbents may be used in combination.

### (Particles)

The cellulose ester optical film of the present invention may contain particles such as a matting agent to provide a lubricant property. Such particles include particulate inorganic compounds and particulate organic compounds. Matting agent particles are preferably as fine as possible. Examples of such particles include inorganic particles of metal oxides, metal phosphates, metal silicates and metal carbonates such as silicon dioxide, titanium dioxide, aluminum oxide, zirconium oxide, calcium carbonate, kaolin, talc, calcined calcium silicate, hydrated calcium silicate, aluminum silicate, magnesium silicate, or calcium phosphate; and crosslinked polymer particles. Of these, silicon dioxide, which results in reduced haze of the film is preferred. Particles such as silicon dioxide are often subjected to a surfacetreatment and such particles, which result in reduced haze, are preferred.

Preferred organic materials used for the surface treatment include halosilane, alkoxysilane, silazane, or siloxane. Particles of a larger average particle size results in an enhanced lubricant effect, while those of a smaller average particle size excel in transparency. The average secondary particle size of particles is preferably in the range of 0.05 to 1.0 preferably from 5 to 50 nm, and more preferably from 7 to 14 nm. Incorporation of these particles to the cellulose ester optical film, which results in unevenness on the film surface, is preferably employed.

The content of particles in cellulose ester is preferably from 0.005 to 0.3% by weight, based on cellulose ester.

Examples of silicon dioxide particles include AEROSIL 200, 200V, 300, R972, R972V, R974, R202, R812, OX 50, TT600 and NAX50, each produced by Nippon Aerosil Co., Ltd., and SEAHOSTAR KE-P100 and SEAHOSTAR KE-P30, each produced by Nippon Shokubai Co., Ltd. Of these are preferred AEROSIL 200V, R972, R972V, R974, R202, R812, NAX50, KE-P100 and KE-P30. When two types of the particles are employed in combination, they may be mixed at an optional ratio to use. It is possible to use particles different in the average particle diameter or in materials, for example, AEROSIL 200V and R972V can be used at a weight ratio in the range of 0.1:99.9 to 99.9:0.1.

The presence of particles used as a matting agent in the film may also be employed for enhancement of film strength. The presence of the particles in the film can enhance orientation of the cellulose ester optical film of the present invention.

### (Other Additive)

The cellulose ester optical film can further contain a viscosity reducing agent, a retardation controlling agent, an acid scavenger, a dye or a pigment, in addition to the plasticizer, a ultraviolet absorber or particles described above.

### (Viscosity Reducing Agent)

In the present invention, there may be added a hydrogen bonding solvent to reduce melt viscosity. The hydrogen bonding solvent refers to an organic solvent capable of forming a hydrogen atom-mediated “bond” caused between an electrically negative atom (e.g., oxygen, nitrogen, fluorine, chlorine) and a hydrogen atom covalent-bonded to the electrically negative atom, in other word, it means an organic solvent capable of arranging molecules approaching to each other with a large bonding moment and by containing a bond including hydrogen such as O—H ((oxygen hydrogen bond), N—H (nitrogen hydrogen bond) and F—H (fluorine hydrogen bond), as described in J. N. Israelachibiri, “Intermolecular Force and Surface Force” (translated by Tamotsu Kondou and Hiroyuki Ooshima, published by McGraw-Hill. 1991). The hydrogen bonding solvent is capable of forming a hydrogen bond between celluloses stronger than that between molecules of cellulose resin, the melting temperature of a cellulose resin composition can be lowered by the addition of the hydrogen bonding solvent than the glass transition temperature of a cellulose resin alone in the melt casting method conducted in the present invention. Further, the melting viscosity of a cellulose resin composition containing the hydrogen bonding solvent can be lowered than that of a cellulose resin in the same melting temperature.

Examples of a hydrogen bonding solvent include alcohols such as methanol, ethanol, propanol, isopropanol, n-butanol, sec-butanol, t-butanol, 2-ethyl hexanol, heptanol, octanol, nonanol, dodecanol, ethylene glycol, propylene glycol, hexylene glycol, dipropylene glycol, polyethylene glycol, polypropylene glycol, methyl cellosolve, ethyl cellosolve, butyl cellosolve, hexyl cellosolve, and glycerol; ketones such as acetone and methyl ethyl ketone; carboxylic acids such as formic acid, acetic acid, propionic acid, and butyric acid; ethers such as diethyl ether, tetrahydrofuran, and dioxane; pyrolidone such as N-methylpyrolidone; and amines such as trimethylamine and pyridine. These hydrogen bonding solvents may be used singly or in combination of two or more. Of these, alcohols, ketones, and ethers are preferred, and especially, methanol, ethanol, propanol, isopropanol, octanol, dodecanol, ethylene glycol, glycerol, acetone, and tetrahydrofuran are preferred. Further, water-soluble solvents such as methanol, ethanol, propanol, isopropanol, ethylene glycol, glycerol, acetone, and tetrahydrofuran are specifically preferred. Herein, “water-soluble” means that the solubility in 100 g of water is 10 g or more.

### (Retardation Controlling Agent)

In the cellulose ester optical film of the present invention, a polarizing plate treatment to provide an optical compensation function may be conducted such that a liquid crystal layer is formed on an optical film by forming an orientation layer so as to combine the retardation of the optical film and that of the liquid crystal layer, or a polarizing plate protection film may be made to contain a compound for adjusting the retardation.

As a compound to be added to control the retardation can be employ an aromatic compound containing two or more aromatic rings as a retardation controlling agent, described in European Patent No. 911,656 A2. Two or more of such aromatic compounds may be used. The aromatic ring of such an aromatic compound includes not only an aromatic hydrocarbon ring but also an aromatic heterocycllic ring. An aromatic heterocyclic ring is specifically preferred such an aromatic heterocyclic ring is generally an unsaturated heterocyclic ring. In particular, compounds having 1,3,5-triazine ring are specifically preferred.

### (Acid Scavenger)

An acid scavenger is one which plays a role of trapping acids (protonic acids) remaining in cellulose ester carried-in from the production stage. When melting a cellulose ester, moisture in the polymer and heat accelerate hydrolysis and, for example, cellulose acetate propionate produces acetic acid or propionic acid. Compounds cable of chemically bonding acids are usable, and examples thereof include, for example, compounds containing an epoxy, tertiary amine or ether structure, but are not limited to these.

Specifically, it is preferred to contain epoxy compound as an acid scavenger, disclosed in U.S. Pat. No. 4,137,201. Such epoxy compounds as an acid scavenger are known in the relevant technical field and include diglycidyl ethers of various polyethylene glycols, specifically, diglycidyl ethers of a polyglycol derived by condensation of 8-40 mols of ethylene oxide per mol of polyglycol or glycerol, metal epoxy compounds (for example, those which have been employed in or with the vinyl chloride polymer composition), an epoxydated ether condensation product, a diglycidyl ether of bisphenol A (or 4,4′-dihydroxydiphenyldimethylmethane), an epoxydated unsaturated fatty acid ester (specifically, 2-22 carbons fatty acid 4-2 carbons alkyl ester, e.g., butyl epoxy-stearate), various epoxydated long fatty acid triglyceride (epoxydated vegetable oil typified by, for example, epoxydated soybean oil, or unsaturated natural oil, which are also called an epoxydated natural glyceride or an unsaturated fatty acid, and these fatty acids generally have 12-22 carbon atoms). Specifically preferred compounds are commercially available epoxy group-containing epoxide resin, EPON 815c and an epoxydated ether oligomer condensation product, represented by the following formula (9):

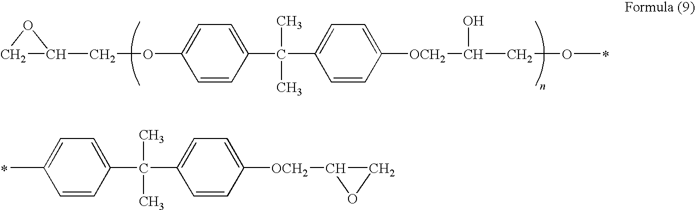

wherein n is 0 to 12. Further, acid scavengers usable in the present invention include those disclosed in JP-A No. 5-194788, paragraph 87 to 105.

Similarly to the afore-mentioned cellulose ester, the acid scavenger used in the present invention preferably removes impurities such as residual acids, inorganic salts and organic low-molecules which were carried-in from the production stage or generated during storage, and the purity thereof is preferably not less than 99%. Residual acids and water are each preferably 0.01 to 100 ppm, whereby thermal deterioration is restrained in melt-casting a cellulose resin, resulting in enhancements of film formation stability and optical and mechanic properties of the film.

The acid scavenger is also referred to as an acid trapping agent, an acid capturing agent or an acid catcher, but in the present invention, but usable in the present invention with no difference due to these designations.

### (Melt Casting Method)

The film constituting material is required to generate very small amount of volatile matter or no volatile matter at all in the melting and film formation process. This is intended to ensure that the foaming occurs at the time of heating and melting to remove or avoid the defect inside the film and poor flatness on the film surface.

When the film forming material is molten, the amount of the volatile matter contained is 1% by weight or less, preferably 0.5% by weight or less, more preferably 0.2% by weight or less, and still more preferably 0.1% by weight or less. A differential thermogravimetric apparatus (differential weight calorimetry (TG/DTA 200 by Seiko Instruments Inc.) is used to get a weight loss on heating from 30° C. through 250° C. The weight loss is defined as an amount of the volatile matter in the present invention.

The moisture and the volatile components represented the aforementioned solvent are preferably removed from the film forming material to be used before film formation or at the time of heating. They can be removed by the conventional method. A heating method, depressurization method, or heating/depressurization method can be used to remove them in air or in nitrogen atmosphere as an inert gas atmosphere. When the known drying method is used, this procedure is carried out in the temperature range wherein the film forming material is not decomposed. This is preferred to ensure good film quality.

Generation of the volatile components can be reduced by the drying step prior to film formation. It is possible to dry the resin independently, or dry the resin and film forming materials by separating into a mixture or compatible substances made of at least one or more types other than the resin. The drying temperature is preferably 100° C. or more. If the material to be dried contains any substance having a glass-transition temperature, and is heated up to a drying temperature higher than that glass-transition temperature, the material will be fused and will become difficult to handle. To avoid this, the drying temperature is preferably kept at a level not exceeding the glass-transition temperature. If a plurality of substances has a glass-transition temperature, the glass-transition temperature of the substance having a lower glass-transition temperature should be used as a standard. This temperature is preferably 100° C. or more through (glass-transition temperature −5) ° C. or less, and more preferably 110° C. or more through (glass-transition temperature −20) ° C. or less. The drying time is preferably 0.5 through 24 hours, more preferably 1 through 18 hours, and still more preferably 1.5 through 12 hours. If the drying temperature is too low, the rate of removing the volatile components will be reduced and much time will be required for drying. The drying process can be divided into two or more steps. For example, the drying process may includes a pre-drying step for storing the material, and a preliminary drying step for the period one week before film formation through the period immediately before film formation.

The melt casting method is classified into a method in which heating and melting are conducted, and as the melt casting method, a melt-extrusion molding method, a press molding method, an inflation method, an injection molding method, a blow molding method, a draw molding method, and the like can be applied. Of these methods, a melt-extrusion molding method is preferred to produce an optical film with excellent mechanical strength and surface accuracy. The film producing method of the present invention will be explained below with reference to the melt extrusion method, however, the present invention is not limited thereto, and the present invention is also applicable to other resin which can be used for a support of an optical film.

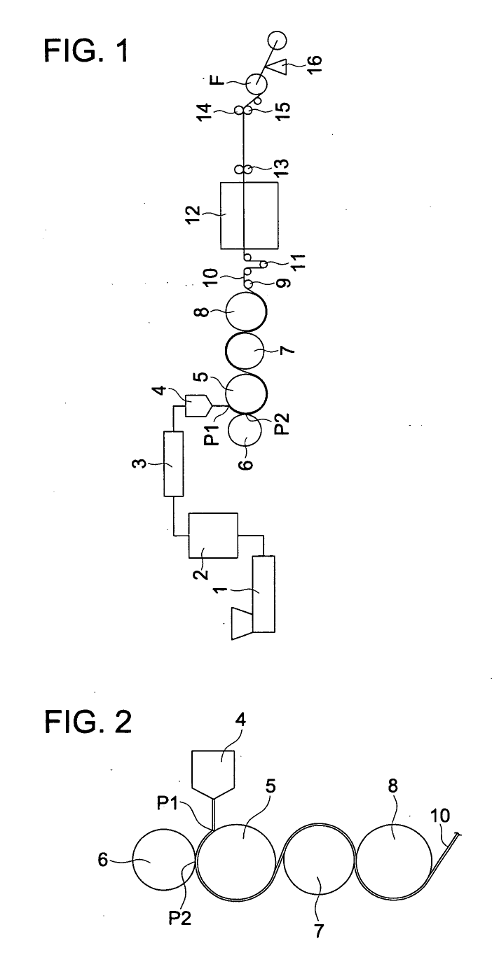

FIG. 1 is a schematic flow sheet showing the overall structure of the apparatus for conducting the cellulose ester optical film producing method of the present invention. FIG. 2 is an enlarged view of the casting die and the cooling roll portions.

In the cellulose ester optical film producing method shown in FIG. 1 and FIG. 2, film materials such as cellulose resin are mixed, and then melt-extruded on a first cooling roll 5 from a casting die 4 using an extruder 1. The extruded mixture is circumscribed on the first cooling roll 5, then on a second cooling roll 7 and a third cooling roll 8 (three cooling rolls in total), sequentially. Thus, the extruded mixture is cooled, solidified and formed into a film 10. Then, the film 10 separated by a separation roll 9 is stretched in the lateral direction, while holding the both sides by a stretching apparatus 12, and is wound by a winding apparatus 16. To correct flatness, a touch roll 6 is provided so as to press the melted film onto the surface of the first cooling roll 5. The touch roll 6 has an elastic surface and a nip is formed between the touch roll 6 and the first cooling roll 5. The details of the touch roll 6 will be described later.

The conditions for the cellulose ester optical film producing method according to the present invention are the same as those used for thermoplastic resins such as other polyesters. The materials used are preferably dried in advance. A vacuum or reduced-pressure drier, or a dehumidified hot air dryer is used to dry the materials until the moisture is reduced to 1000 ppm or less, and preferably 200 ppm or less.

For example, the cellulose ester resin, after dried employing hot air, or under vacuum or reduced pressure, is extruded by the extruder 1 and is melted at a temperature of about 200 to 300° C. The melted resin is filtered through a leaf disk filter 2 to remove foreign substances.

As for the filter used for elimination of a foreign material, a sintered stainless steel fiber filter is preferably used. A sintered stainless steel fiber filter is prepared by compressing intricately entangled stainless steel fiber, followed by sintering each contact point of the compressed stainless steel fiber to unify. The density of the filter can be varied by using different thickness fiber or changing the compression degree, whereby filtration accuracy is controlled. It is preferable to continuously pile a plurality of dense and coarse filters to form a multilayer filter. It is also preferable to increase the filtration accuracy in sequence or to repeat piling a plurality of dense and coarse layers, whereby the filtration life is prolonged and apprehension accuracy is increased.

When the materials are fed from the feed hopper (not illustrated) to the extruder 1, they are preferably placed under a vacuum or reduced-pressure condition, or under insert gas atmosphere to prevent oxidation and decomposition.

When additives such as plasticizer are not mixed in advance, they can be added to the materials and mixed during the process of extrusion. To ensure uniform mixing, a mixer such as a static mixer 3 is preferably utilized.

In the present invention, the cellulose resin and the additives such as a stabilizer to be optionally added are preferably mixed before being melted. It is more preferred that the cellulose resin and additives be mixed at first. A mixer may be used for mixing. Alternatively, mixing may be conducted in the process of preparing the cellulose resin, as described above. As the mixer, a general mixer such as a V-type mixer, a conical screw type mixer, a horizontal cylindrical type mixer, a Henschel mixer or a ribbon mixer can be used.

As described above, after the film forming materials are mixed, the mixture can be directly melted through the extruder 1 to form a film. Alternatively, it is also possible that the film forming materials are palletized and the resultant pellets may be melted through the extruder 1, thereby forming a film. It is possible that when the film forming materials contain a plurality of materials having different melting points, the materials are heated at a temperature at which only the material having a lower melting point is melted, whereby so-called patchy semi-molten materials are produced and placed in the extruder 1, followed by whereby a film formation. When the film forming materials contain a material susceptible to thermal decomposition, a method is preferred which eliminates a pellet production process to reduce the frequency of melting and directly forms a film or which produces patchy semi-molten materials and then forms a film, as described above.

Various types of commercially available extruders can be used as the extruder 1. A melt-knead extruder is preferably utilized. Either a single-screw extruder or a twin-screw extruder can be used. When producing a film directly without forming pellets from the film forming materials, an appropriate degree of mixing is essential. In this sense, a twin-screw extruder is preferably used. A single-screw extruder can be used if the screw is changed into a kneading type screw such as a Madoc screw, Unimelt screw or Dulmage screw, which provides a proper degree of mixing. When pellets or patchy half-melts are used as the film forming materials, both the single screw extruder and twin screw extruder can be used.

In the interior of the extruder 1 and the atmosphere under which the cooling process after extrusion is carried out, oxygen concentration is preferably lowered by incorporation of an inert gas such as nitrogen gas or by reduced pressure.

The preferred melting temperature of film forming materials in the extruder 1 vary according to the viscosity or extrusion amount of the film forming materials as well as the thickness of the film to be produced. Generally, when the glass transition temperature of the film is Tg, the melting temperature is from Tg to Tg+100° C., and preferably from Tg+10° C. to Tg+90° C. The melting temperature is ordinarily from 150 to 300° C., preferably from 180 to 270° C., and more preferably from 200 to 270° C. The melt viscosity at the time of extrusion is from 1 to 10,000 Pa·s, and preferably from 10 to 1,000 Pa·s. The dwell time of the film forming materials in the extruder 1 should be as short as possible. It is within 10 minutes, preferably within 5 minutes, and more preferably within 3 minutes. The dwell time varies according to the type of the extruder and the conditions for extrusion. It can be reduced by adjusting the amount of the material to be supplied, the L/D, the rotational speed of the screw or the depth of the screw groove.

The shape and rotational speed of the screw of the extruder 1 are adequately selected in the context of the viscosity and ejection rate of the film forming materials. In the present invention, the shear rate of the extruder 1 is from 1/sec. to 10,000/sec., preferably 5/sec. to 1,000/sec., and more preferably 10/sec. to 100/sec.

The extruder 1 used in the present invention can be obtained as a plastic molding machine available on the market.

The film forming materials extruded from the extruder 1 is fed to the casting die 4, and extruded as a film from the slit of the casting die 4. The casting die 4 is not specifically limited as far as it can be used to produce a sheet or film. Materials of the casting die 4 include those thermally splayed or plated with hard chromium, chromium carbide, chromium nitride, titanium carbide, titanium carbon nitride, titanium nitride, hard metal or ceramic (tungsten carbide, aluminum oxide, chromium oxide), and then subjected to surface processing, such as buffing, lapping by a whetstone having a count of #1000 or later, planar cutting (in the direction perpendicular to the resin flow) by a diamond whetstone having a count of #1000 or more, electrolytic grinding or electrolytic complex grinding. The preferred material of the lip of the casting die 4 is the same as that used in the casting die 4. The surface accuracy of the lip is preferably 0.5S or less, and more preferably 0.2S or less.

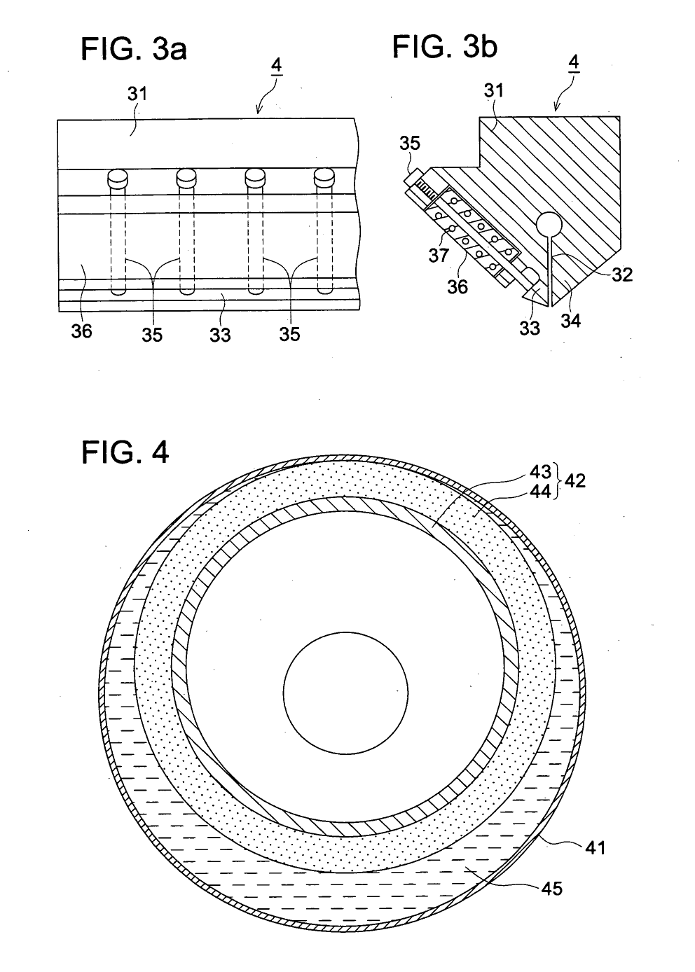

The slit of this casting die 4 is designed so that the gap can be adjusted. This is shown in FIG. 3. FIG. 3a is a schematic view showing one embodiment of a main portion of a casting die. FIG. 3b is a sectional view showing one embodiment of a main portion of a casting die. Of a pair of lips forming the slit 32 of the casting die 4, one is the flexible lip 33, which has lower rigidity and is likely to be deformed, and the other is a stationary lip 34. Many heat bolts 35 are arranged at a predetermined pitch across the casting die 4, namely, along the length of the slit 32. Each heat bolt 5 includes a block 36 containing a recessed type electric heater 37 and a cooling medium passage. Each heat bolt 35 penetrates the block 36 in the vertical direction. The base of the heat bolt 35 is fixed on the die (main body) 31, and the front end is held in engagement with the outer surface of the flexible lip 33. While the block 36 is constantly air-cooled, the input power of the recessed type electric heater 37 is adjusted to increase or decrease the temperature of the block 36. This adjustment causes thermal extension and contraction of the heat bolt 35 and displacement of the flexible lip 33, whereby the film thickness is adjusted. A thickness gauge is provided at a predetermined position downstream the die. The web thickness information detected by this gauge is fed back to the control apparatus. This thickness information is compared with the preset thickness information of the control apparatus, whereby power or on-rate of the heat generating member of the heat bolt is controlled by the signal for correction control amount sent from this apparatus. The heat bolt preferably has a length of from 20 to 40 cm and a diameter of from 7 to 14 mm. A plurality of heat bolts, for example, several tens of heat bolts are arranged preferably at a pitch of 20 to 40 mm. A gap adjusting member mainly made up of a bolt for adjusting the slit gap by manually movement in the axial direction can be provided, instead of the heat bolt. The slit gap adjusted by the gap adjusting member has a diameter of ordinarily from 200 to 3,000 μm, and preferably from 500 through 2000 μm.

The first through third cooling rolls are made of a seamless steel pipe having a thickness of about 20 to 30 mm. The surface thereof is mirror finished. A tube in which a cooled liquid or a heated medium flows is provided in the inside of the rolls. Heat is absorbed from or applied to the film transporting on the roll by the cooled liquid or heated medium flowing within the tube.

The touch roll 6 in contact with the first cooling roll 5 has an elastic surface. The touch roll 6 is deformed along the surface of the first cooling roll 5 by the pressure against the first cooling roll 5, and forms a nip between this roll and the first roll 5. The touch roll 6 is also referred to as a pressure rotary member. As the touch roll, those disclosed in Japanese Patent Nos. 3194904 and 3422798, and Japanese Patent O.P.I. Publication Nos. 2002-36332 and 2002-36333 are preferably used. The touch roll available on the market can be used. Next, the touch roll will be explained in detail.

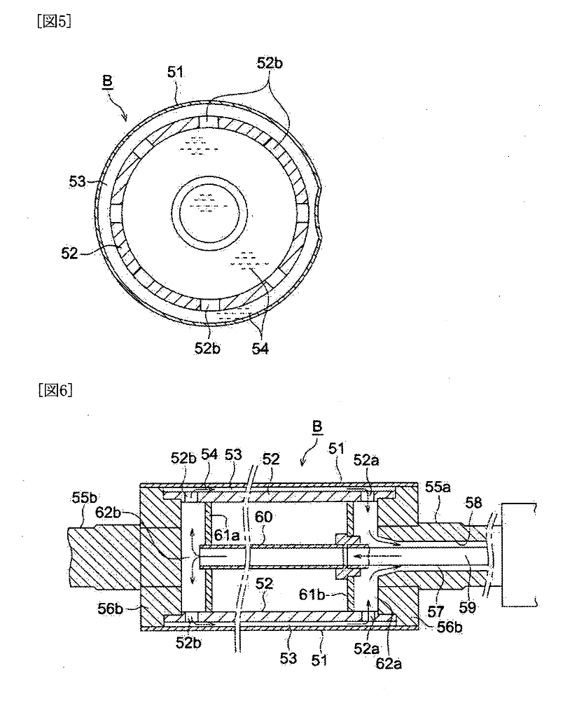

FIG. 4 is a sectional view of one embodiment of a pressure rotary member and shows a cross section of a first embodiment (hereinafter also referred to as a touch roll A) of the touch roll 6. As illustrated, the touch roll A is composed of an elastic roller 42 arranged inside the flexible metallic sleeve 41.

The metallic sleeve 41 is made of a stainless steel having a thickness of 0.3 mm and has flexibility. If the metallic sleeve 41 is too thin, strength will be insufficient. If it is too thick, elasticity will be insufficient. Thus, the thickness of the metallic sleeve 41 is preferably 0.1 to 1.5 mm. The elastic roller 42 is a roll in which a rubber 44 is provided on the surface of the metallic inner roll 43 freely rotatable through a bearing. When the touch roll A is pressed against the first cooling roll 5, the elastic roller 42 presses the metallic sleeve 41 against the first cooling roll 5, and the metallic sleeve 41 and elastic roller 42 are deformed, conforming to the shape of the first cooling roll 5, whereby'a nip is formed between the touch roll and the first cooling roll. The cooled water or heated medium 45 is introduced into a space formed between the elastic roller 42 and the inner wall of the metallic sleeve 41.

FIG. 5 is a cross section of a plane perpendicular to the rotation axis of a second embodiment (hereinafter also referred to as a touch roll B) of a pressure rotary member.

FIG. 6 is a cross section showing one embodiment of a plane containing a rotation axis of a second embodiment (a touch roll B) of a pressure rotary member.

In FIG. 5 and FIG. 6, the touch roll B is composed of an outer sleeve 51 of flexible seamless stainless steel tube (having a thickness of 4 mm), which is flexible, and a metallic inner sleeve 52 with high rigidity arranged coaxially inside the outer sleeve 51. A cooled liquid or heated medium 54 is led into a space 53 formed between the outer sleeve 51 and the inner sleeve 52. To put it in greater details, the touch roll B is formed in such a way that the outer sleeve supporting flanges 56a and 56b are mounted on the rotary shafts 55a and 55b on both ends of the roll, and a thin-walled metallic outer sleeve 51 is mounted between the outer peripheral portions of these outer sleeve supporting flanges 56a and 56b. The fluid supply tube 59 is arranged coaxially inside the fluid outlet port 58 which is formed on the shaft center of the rotary shaft 55a and constitutes a fluid return passage 57. This fluid supply tube 59 is connected and fixed to the fluid shaft sleeve 60 arranged on the shaft center which is arranged inside the thin-walled metallic outer sleeve 51. Inner sleeve supporting flanges 61a and 61b are mounted on both ends of this fluid shaft sleeve 60, respectively. A metallic inner sleeve 52 having a wall thickness of about 15 to 20 mm is mounted in the range from the position between the outer peripheral portions of these inner sleeve supporting flanges 61a and 61b to the outer sleeve supporting flange 56b on the other end. A space 53 of, for example, about 10 mm for transporting a cooled liquid or heated medium is formed between this metallic inner sleeve 52 and thin-walled metallic outer sleeve 51. An outlet 52a and an inlet 52b communicating between the flow space 53 and intermediate passages 62a and 62b outside the inner sleeve supporting flanges 61a and 61b are formed on the metallic inner sleeves 52 close to both ends, respectively.

To provide flexibility, pliability and restoring force close to those of a rubber, the outer sleeve 51 is designed to be thinner as long as a thin cylinder theory of elastic mechanics is applied. The pliability evaluated by the thin cylinder theory is expressed by wall thickness t/roll radius r. The smaller the t/r becomes, the higher the pliability is. The pliability of this touch roll B meets the optimum condition when t/r≦0.03. Normally, a generally used touch roll has a roll diameter R of 200 to 500 mm (roll radius r=R/2), a roll effective width L of 500 to 1,600 mm, and an oblong shape of r/L<1. As shown in FIG. 6, for example, when the roll diameter R is 300 mm and the roll effective width L is 1,200 mm, the suitable range of the wall thickness t is 4.5 (150×0.03) mm or less. When pressure is applied to a molten sheet with a width of 1,300 mm at an average linear pressure of 98 N/cm, the wall thickness of the outer sleeve 51 is 3 mm. Then, the corresponding spring constant of such a sleeve becomes the same as that of a rubber roll of the same shape. The width k of the nip between the outer sleeve 51 and cooling roll in the roll rotation direction is about 9 mm. This gives a value approximate to about 12 mm of the nip width of the rubber roll, showing that pressure can be applied under the similar conditions. The amount of bend at the nip width k is about 0.05 to 0.1 mm.

Herein, t/r≦5 0.03 is assumed. In a general roll having a diameter R of from 200 to 500 mm, when 2 mm≦5 t≦5 mm in particular, sufficient flexibility is obtained and a thickness can be easily reduced through mechanical processing. Thus, the above range of t is very practical range.

The relation 2 mm≦5 t≦5 mm provides the relation 0.008≦t/r≦0.05 for the general roll diameter. In practice, under the condition of t/r≈0.03, the wall thickness is preferably increased in proportion to the roll diameter. For example, t is selected to be within the range of 2 to 3 mm for the roll diameter R of 200, and t is selected to be within the range of 4 to 5 mm for the roll diameter R of 500.

These touch rolls A and B are pressed against the first cooling roll by a pressurizing means not illustrated. The F/W (linear pressure) is set at 10 to 150 N/cm, which is obtained by dividing the force F of the pressurizing means by the width W of the film in the nip in the rotary shaft direction of the first cooling roll 5. According to the present embodiment, a nip is formed between the first cooling roll 5 and the touch rolls A and B in which flatness should be corrected while the film passes through this nip. Thus, the present embodiment ensures more reliable correction of flatness as compared with the case where the touch roll is made of a rigid body and no nip is formed between the touch roll and the first cooling roll, since the film is sandwiched and pressed at a smaller linear pressure for a longer time. That is, if the linear pressure is smaller than 10 N/cm, the die line cannot be removed sufficiently. In contrast, if the linear pressure is greater than 150 N/cm, the film cannot easily pass through the nip, resulting in uneven thickness of the film.

Since the touch rolls A and B having surfaces made of metal exhibits smooth surfaces as compared with touch rolls having surfaces made of rubber, they provide a film having a surface with high smoothness. As materials for the elastic body 44 of the elastic roller 42, ethylene propylene rubber, neoprene rubber, silicone rubber or the like can be used.

In order to remove sufficiently the die line by the touch roll 6, it is important that viscosity of film lie within the appropriate range at the time when the film is pressed by the touch roll 6. Further, it is known that temperature dependency of viscosity of cellulose resin is relatively great. Thus, to adjust viscosity of the cellulose ester optical film to fall within an appropriate range, at the time when the film is pressed by the touch roll 6, it is important to adjust the film temperature to fall within an appropriate range at the time when the film is pressed by the touch roll 6. The present inventor has found that when the glass transition temperature of the cellulose ester optical film is Tg, the temperature T of the film immediately before the film is pressed by the touch roll 6 may any as far as is the relation Tg<T<Tg+110° C. is satisfied. If the film temperature T is lower than Tg, the viscosity of the film will be too high. In contrast, if the film temperature T is higher than Tg+110° C., uniform adhesion between the film surface and roll cannot be achieved, and the die line cannot be corrected. The relation Tg+10° C.<T2<Tg+90° C. is preferably satisfied, and the relation Tg+20° C.<T2<Tg+70° C. is more preferably satisfied. In order to adjust the film temperature to fall within an appropriate range at the time when the film is pressed by the touch roll 6, a length L along the rotating direction of the first cooling roll 5 from a position P1 to the nip P2 between the first cooling roll 5 and the touch roll 6 may be adjusted, the position P1 being a position where the melt extruded from the casting die 4 is in contact with the first cooling roll 5. The surface temperature of the touch roll 6 and the first cooling roll 5 is preferably from 60 to 230° C., and more preferably from 100 to 150° C., and the surface temperature of the second cooling roll 7 is preferably from 30 to 150° C., and more preferably from 60 to 130° C.

In the present invention, the preferred examples of material used for the first roll 5 and second roll 6 include carbon steel, stainless steel and resin. The surface accuracy is preferably higher. The surface roughness is preferably 0.3 S or less, and more preferably 0.01 S or less.

The present inventor has found that when the pressure at the portion from the opening (lip) of the casting die 4 to the first roll 5 is reduced to 70 kPa or less, the above die line is corrected more efficiently. The pressure is preferably reduced to 50 to 70 kPa. There is no restriction to a method in which the pressure at the portion from the opening (lip) of the casting die 4 to the first roll 5 is kept at 70 kPa or less. As one of the methods, there is a method in which the pressure reduction is carried out, the portion from the casting die 4 to the periphery of the roll being covered with a pressure-resistant member. In this case, a vacuum suction machine used is preferably heated by a heater or the like, so that a sublimate is not deposited on the vacuum suction machine. In the present invention, if the suction pressure is too small, the sublimate cannot be sucked effectively. Adequate suction pressure must be applied to prevent this.

In the present invention, the film-shaped cellulose ester resin in the molten state extruded from the T-die 4 is conveyed in contact with the first roll 5 (the first cooling roll), the second cooling roll 7, and the third cooling roll 8, sequentially, and is cooled and solidified, whereby an unstretched cellulose ester resin film 10 is produced.

The unstretched film 10 cooled, solidified and separated from the third cooling roll 8 by the separation roll 9 is passed through a dancer roll (film tension adjusting roll) 11, and is led to the stretching machine 12, wherein the film 10 is stretched in the lateral direction (across the width) in the embodiment of the present invention shown in FIG. 1. This stretching operation orients the molecules in the film.

A known tender or the like can be preferably used to stretch the film across the width. Especially when the film is stretched across the width, the lamination with the polarized film can be preferably realized in the form of a roll. Stretching across the width ensures that the slow axis of the cellulose ester film made of a cellulose ester resin film is found across the width.

The transmission axis of the polarized film also lies across the width normally. If the polarizing plate wherein the transmission axis of the polarized film and the slow axis of the optical film will be parallel to each other is incorporated in a liquid crystal display, the display contrast of the liquid crystal display can be increased, and a wide viewing angle is obtained.

The glass transition temperature Tg of the film forming material can be controlled by changing the types of the materials forming the film or the proportion of the constituent materials. When a retardation film is produced as a cellulose ester optical film, it is preferred that Tg is 120° C. or more, and preferably 135° C. or more. The temperature environment of film is changed in image display mode by temperature rise of the liquid crystal display per se, for example, by temperature rise caused by a light source in the display. In this case, if the Tg of the film is lower than the film working environment temperature, the retardation value resulting from the orientation status of the molecules fixed in the film by stretching and film geometry greatly vary. If the Tg of the film is too high, temperature is raised when the film forming material is formed into a film. This will increase the amount of energy consumed for heating. Further, the material may be decomposed at the time of forming a film, resulting in coloration. Thus, Tg of the film is preferably 250° C. or less.

Known thermal setting, cooling and relaxation processes can be carried out in the stretching process. Appropriate adjustment should be made to obtain the characteristics required for the intended optical film.

The aforementioned stretching process and thermal setting process are carried out as appropriate on a selective basis to provide the phase film function for the purpose of improving the physical properties of the phase film and to increase the viewing angle in the liquid crystal display. When such a stretching process and thermal setting process are included, the heating and pressing process should be performed prior to the stretching process and thermal setting process.

When a retardation film is produced as a cellulose ester optical film, and the functions of the polarizing plate protective film are combined, control of the refractive index is essential. The refractive index control can be carried out by a stretching process. The stretching process is preferred. The stretching process will be explained below.

As stretching, stretching in the longitudinal direction, stretching in the lateral direction or stretching in longitudinal and lateral directions is carried out. The longitudinal stretching can be carried out by roll stretching (stretching in the mechanical direction employing two or more pairs of nip rolls on the outlet side which increases the rotational speed) or fixed end stretching (which gradually increase a transporting speed in the mechanical direction, while holding both ends of the film). The stretching in the lateral direction can be carried out by tenter stretching (stretching the film in the lateral direction (in the direction perpendicular to the mechanical direction) while holding both ends of the film by a chuck.

The stretching in the longitudinal direction and the stratching in the lateral direction may be carried out alone, respectively, or may be carried out in combination (biaxial stretching). When the biaxial stretching is carried out, the stretching in the longitudinal direction and the stretching in the lateral direction may be carried out successively (successive stretching) or simultaneously (simultaneous stretching). The stretching speed in the in the longitudinal direction and in the lateral direction is preferably from 10 to 10000%/minute, more preferably from 20 to 1000%/minute, and still more preferably from 30 to 800%/minute. When a multistep stretching is carried out, the stretching speed implies an average of the stretching speed at each stage. It is preferred that the stretching is followed by relaxing in the longitudinal or lateral direction by 0 to 10%. Further, it is also preferred that the stretching is preferably followed by heat fixed at 150 to 250° C. for 1 to 3 seconds.

In the retardation film stretching process, required retardations Ro and Rt can be controlled by stretching at a magnification of 1.0 to 4.0 in one direction of the cellulose resin film, and at a magnification of 1.01 to 4.0 in the direction in plain of the film perpendicular to that direction. Herein, Ro denotes in-plane retardation and Rt retardation along the thickness.

For example, the film can be successively or simultaneously stretched in the mechanical direction and in the direction in plane normal to the mechanical direction, i.e., in the lateral direction. In this case, too small stretching magnification in at least one direction provides insufficient optical retardation, while too much stretching magnification results in rupture of the film.

Stretching in the direction of two axes perpendicular to each other is an effective method to allow film refractive indexes nx, ny and nz to fall within a predetermined range.

Herein, nx is a refractive index in the mechanical (MD) direction, ny is a refractive index in the lateral (TD) direction, and nz is a refractive index in the thickness direction.

For example, when film is stretched in the melt casting direction, too much contraction in the lateral direction of the film provides too large refractive index in the thickness direction of the film. In this case, improvement can be carried out by restraining the contraction in the lateral direction of the film or by stretching the film in the lateral direction. When the film is stretched in the lateral direction, diversion of refractive index may be produced in the lateral direction. This phenomenon is sometimes found in a tenter method, and is considered to be due to so-called bowing phenomenon, which is caused by the fact that the film center shrinks and the film edges are fixed. In this case also, the bowing phenomenon is restrained by stretching the film in the casting direction, whereby diversion of refractive index in the lateral direction is minimized and improved.

Further, stretching in the two directions crossing at right angles each other can minimize variation of film thickness. Too much variation of film thickness causes unevenness of the optical retardation, resulting in color unevenness of images of a liquid crystal display.

Variation of thickness of cellulose ester film is preferably in the range within preferably ±3%, and more preferably ±1%. In order to meet the requirements described above, stretching in the two directions crossing at right angles each other is effective, wherein finally, the film is stretched in the casting direction at a magnification of preferably from 1.0 to 4.0 and in the lateral direction at a magnification of preferably from 1.01 to 4.0, and is stretched in the casting direction at a magnification of more preferably from 1.0 to 1.5 and in the lateral direction at a magnification of more preferably from 1.05 to 2.0.

The dimensional variation of the optical film of the present invention after a 50 hours treatment under a high temperature-high humidity condition of 80° C. and 90% RH is preferably ±1.0%, more preferably ±0.5%, still more preferably ±0.4%, and specifically preferably ±0.3%.

When the absorption axis of the polarizer is present in the mechanical direction, the transmission axis of the polarizer is found in the lateral direction. To obtain a long-length polarizing plate, the retardation film is preferably stretched so as to obtain a slow axis in the lateral direction.

When cellulose ester providing a positive birefringence to stress is employed, stretching in the lateral direction can give the slow axis to the lateral direction of cellulose ester film. In order to improve display quality, the slow axis is preferably in accordance with the lateral direction of film. In order to obtain an intended retardation value, it is necessary to meet the relationship (stretching magnification in the lateral direction)>(stretching magnification in the casting direction).

After stretching, the end of the film is trimmed off by a slitter 13 to a width predetermined for the product. Then both ends of the film are knurled (embossed) by a knurling apparatus composed of an emboss ring 14 and a back roll 15, and the film is wound by a winder 16. This arrangement prevents sticking or scratching in the cellulose ester film F (master winding). Knurling can be carried out by pressing on the film a metallic ring having a pattern of projections and depressions on the side surface under application of heat and pressure. The both ends of the film, portions gripped by the clips are normally deformed and cannot be used as a film product. They are therefore cut out and are recycled as a material.

It is generally known that, in the melt extrusion method, the residence time of edge side tends to be longer due to the shape of a casting die. Accordingly, it is assumed that the coloration at the edge portion was promoted. However, it was found that, by using the production method according to the present invention, the coloration at the edge portion of the film can be suppressed. In the present invention, yellow index of an edge portion in the lateral direction of the film just after melt extruded Ye and yellow index of a central portion of the film Yc preferably meet following Condition (4). The Ye/Yc value is more preferably 3.0 or less. If the Ye/Yc value is larger than 5.0, the coloration of a film increases, when cut portion at the edge of the film is recycled to be used as a raw material of the film production. In the present invention, the yellow index of an edge portion in the lateral direction of the film Ye is defined to be the maximum yellow index value measured within 30 mm from the both edges in the lateral direction of the film.

1.0≦Ye/Yc≦5.0 Condition (4)

When the retardation film is a polarizing plate protective film, the thickness of the protective film is preferably 10 to 500 μm. In particular, the lower limit is 20 μm, and preferably 30 μm. The upper limit is 150 μm, and preferably 120 μm. The particularly preferred range is 25 to 90 μm. If the retardation film is too thick, the polarizing plate is too thick. This fails to meet requirements for thin-shape and lightweight when employed in the liquid crystal display for a notebook PC or mobile type electronic equipment. Conversely, if the retardation film is too thin, retardation as a retardation film cannot occur easily. Further, the film moisture permeability is increased, which cannot effectively protect the polarizer from moisture.

When a slow axis or a fast axis of cellulose ester film is present in a plane of the film and the angle between the slow axis or fast axis and the mechanical direction of the film is defined as θ1, θ1 is preferably from −1 to +1°, and more preferably from −0.5 to +0.5°.

This θ1 can be defined as an orientation angle, and determined employing an automatic birefringence meter KOBRA-21ADH (produced by Oji Scientific Instruments).

When θ1 meets the relationship described above, high luminance of a display image is obtained and a leakage of light is reduced or prevented, which distributes to faithful color reproduction of a color liquid crystal display.

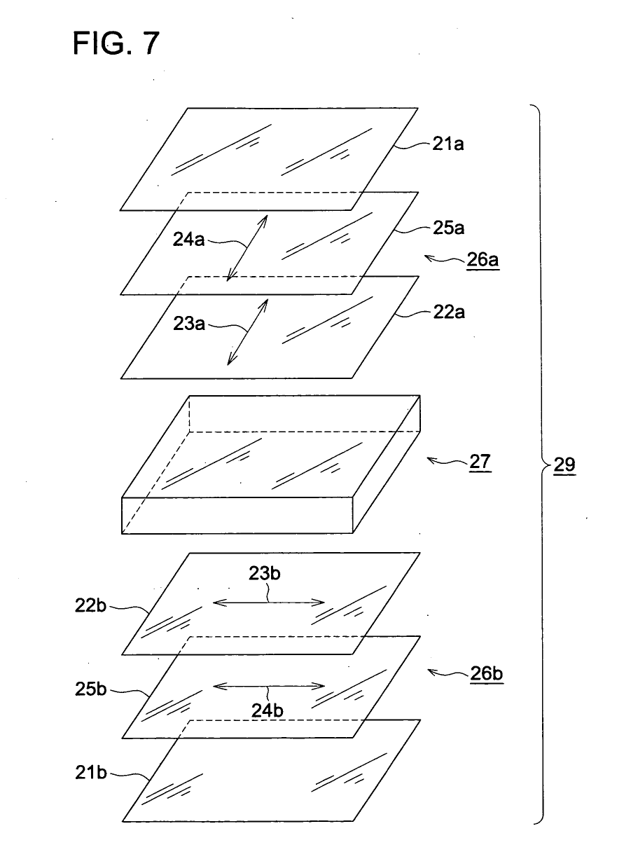

When the cellulose ester optical film in the present invention is employed as a retardation film and used in the multiple-domain VA mode, and the retardation film is arranged in the aforementioned range with an fast axis of θ1, it improves displayed image quality. When a polarizing plate and a liquid crystal display are arranged as MVA mode, it can be a structure as shown in FIG. 7

In FIG. 7, the reference numerals 21a and 21b indicate a protective film, 22a and 22b represent a retardation film, 25a and 25b show a polarizer, 23a and 23b indicate a slow axis direction of the film, 24a and 24b show a transmission axis direction of the polarizer, 26a and 26b show a polarizing plate, 27 shows a liquid crystal cell, and 29 shows a liquid crystal display.

The distribution of the retardation in plane Ro of the optical film is adjusted to preferably 5% or less, more preferably 2% or less, and still more preferably 1.5% or less. Further, the distribution of the retardation Rt in the thickness direction of the film is adjusted to preferably 10% or less, more preferably 2% or less, and still more preferably 1.5% or less.

In the retardation film, the fluctuation in the distribution of the retardation value is preferred to be as small as possible. When a polarizing plate containing a retardation film is used in the liquid crystal display, a smaller fluctuation in the distribution of the aforementioned retardation distribution is preferred for the purpose of preventing color irregularity.

In order to adjust the retardation film so as to provide the retardation value suited for improvement of the display quality of the liquid crystal cell in the VA mode or TN mode and to divide into the aforementioned multi-domain especially in the VA mode for preferable use in the MVA mode, it is necessary to adjust the in-plane retardation Ro to greater than 30 nm but not greater than 95 nm, and the retardation Rt in the thickness direction to greater than 70 nm but not greater than 400 nm.

The aforementioned in-plane retardation Ro mainly compensates a light leakage occurring due to deviation from a crossed-Nicols configuration, when a display is viewed obliquely from the line normal to a display surface, for example, in the configuration shown in FIG. 7 wherein two polarizing plates are arranged in a crossed-Nicols configuration and a liquid crystal cell is arranged between the polarizing plates, the two polarizing plates being in the crossed-Nicols configuration under conditions viewed from the direction normal to the display surface. When the liquid crystal cell is in the white display mode in the aforementioned TN mode and VA mode, particularly in the MVA mode, the retardation in the thickness direction mainly contributes to compensation of the birefringence of the liquid crystal cell recognized when viewed obliquely in the same manner as above.

As shown in FIG. 7, when two polarizing plates are arranged on the upper and lower portions of the liquid crystal cell in the liquid crystal display, the reference numerals 22a and 22b in FIG. 7 are capable of selecting distribution of retardation Rt in the thickness direction. It is preferred that the requirements of the aforementioned range are met, and the total of retardation in the thickness direction Rt of the both is from greater than 140 nm to 500 nm. In this case, it is preferred in improving productivity of industrial polarizing plates that the retardation in-plane Ro of the 22a and 22b and retardation Rt in the thickness direction are the same. It is especially preferred that the retardation in-plane Ro is from greater than 35 nm to 65 nm, and retardation in the thickness direction Rt is from greater than 90 nm to 180 nm, and such a retardation range is applied to the liquid crystal cell in the MVA mode having a structure shown in FIG. 7.

In the liquid crystal display, when a commercially available polarizing plate protective film, a 35 to 85 μm thick TAC film having an retardation in-plane Ro of 0 to 4 nm, and a retardation in the thickness direction Rt of 20 to 50 nm is used as a protective film for one of the polarizing plates, for example, at the position of 22b in FIG. 7, the protective film arranged on the other polarizing plate, for example, the retardation film arranged at the position of 22a of FIG. 7 is one having an retardation in-plane Ro of 30 to 95 nm, and a retardation in the thickness direction Rt of 140 to 400 nm. Such an arrangement is preferred in improving the display quality and film productivity.

### (Polarization Plate)

Next, a polarizing plate according to the present invention will be explained.

The polarizing plate is prepared by a general method. It is preferable that the cellulose ester optical film of the present invention is saponified by alkaline treatment on the backside thereof and the treated film is laminated, through a completely saponified poly(vinyl alcohol), on at least one side of a polarizer, which has been prepared by immersing and stretching in an iodine solution. On the other side of the polarizer, the cellulose ester optical film of the present invention or another polarizing plate protective film may be either used. As the polarizing plate protective film to be used on the side of the polarizer opposite the cellulose ester optical film of the present invention used, cellulose ester optical films available on the market can be used. Preferred examples thereof include KC8UX2M, KC4UX, KC5UX, KC4UY, KC8UY, KC12UR, KC8UCR-3, and KC8UCR-4, each produced by Konica Minolta Opto, Inc. A polarizing plate protective film serving also as an optical compensation film which has an optical anisotropic layer formed by orientating a liquid crystal compound such as a discotic liquid crystal, a rod-shaped liquid crystal or a cholesteric liquid crystal is also preferably used. For example, An optical anisotropic layer can be formed by the method described in Japanese Patent O.P.I. Publication No. 2003-98348. A polarizing plate having excellent flatness and a wide viewing angle can be obtained by a combined use of such an optical compensation film with the antireflection film of the present invention.

The polarizing film, a major component of the polarizing plate, is an element through which light polarized in a certain direction only passes. Present known typical polarizing film is a poly(vinyl alcohol) type polarizing film which includes a poly(vinyl alcohol) type film dyed by iodine and that dyed by a dichromatic dye. As the polarizing film, one prepared by forming a film from an aqueous solution of poly(vinyl alcohol) and mono-axially stretching and dying the film or one prepared by mono-axially stretching after dying and then treating by a boron compound for giving durability is used. The polarizing film is adhered onto one side of the cellulose ester optical film of the present invention to prepare the polarizing plate. The adherence is preferably carried out through an aqueous adhesive mainly composed of completely saponified poly(vinyl alcohol).

The polarizing film is stretched in mono-axial direction (usually in the mechanical direction). Consequently, the polarizing plate is shrunk in the stretched direction (usually in the mechanical direction) and elongated in the direction perpendicular to the stretched direction (usually in the lateral direction) when the film is placed under a high temperature and high humidity condition. The elongation and shrinking of the polarizing plate is increased accompanied with decreasing of the thickness of the polarizing plate protection film and the shrinking in the stretched direction of the polarizing film is particularly remarkable. The adherence is usually carried out so that the stretching direction of the polarizing film is in accordance with the casting direction (MD direction) of the polarizing plate protective film. Therefore, when the thickness of polarizing plate protective film is decreased, it is important to inhibit the shrinkage in the casting direction. The optical film of the present invention is suitably used as such a polarizing plate protective film, since the film is excellent in dimensional stability.

Wave-shaped ununiformity is not increased even after the aging test at 60° C. and 90% RH, and the viewing angle is not varied and high visibility can be provided after the aging test even when the polarizing plate has an optical compensation film on the backside.

The polarizing plate can be constituted by pasting the protection film on one side and a separation film on the other side of the membrane. The protection film and the separation film are used for protecting the polarizing plate in the course of forwarding and inspection process. In such the case, the separation film is pasted on the side of the polarizing plate opposite to the side to be pasted to the liquid crystal plate for protecting the surface of the polarizing plate. The separate film is used on the side of the polarizing plate to be pasted to the liquid crystal plate to cover the adhesive layer for pasting polarizing plate to the liquid crystal plate.

### (Liquid Crystal Display)

The polarizing plate having the cellulose ester optical film of the present invention as a retardation film provides a higher display quality when compared with an commonly used polarizing plate. Specifically, the polarizing plate is preferable for a multi-domain mode liquid crystal display or more preferably for a multi-domain mode liquid crystal display employing a birefringent mode.

The polarizing plate of the present invention is usable, for such as MVA (Multi-domain Vertical Alignment) mode, PVA (Patterned Vertical Alignment) mode, It can use for CPA (Continuous Pinwheel Alignment) mode, and OCB (Optical Compensated Bend) mode, and not limited to a specific mode or to a specific arrangement of the polarizing plate.

Liquid crystal displays are now being applied for a color display or moving picture display. The polarizing plate improved in display quality, contrast and durability according to the present invention enables an accurate display of moving pictures without causing eye fatigue.

In the liquid crystal display comprising at least a polarizing plate including the retardation film, one polarizing plate including the retardation film is arranged on the liquid crystal cell, or two polarizing plates are arranged on both sides of the liquid crystal cell. In this case, the display quality is improved when the retardation film constituting the polarizing plate of the present invention is provided to face the liquid crystal cell of the liquid crystal display. Then the films 22a and 22b of FIG. 7 face the liquid crystal cell of the liquid crystal display.

In the aforementioned structure, the retardation film provides optical compensation of the liquid crystal cell. When the polarizing plate of the present invention is used in the liquid crystal display, at least one of the polarizing plates of the liquid crystal display should be the polarizing plate of the present invention. Use of the, polarizing plate of the present invention improves the display quality and provides a liquid crystal display having an excellent viewing angle property.

In the polarizing plate of the present invention, a polarizing plate protective film of cellulose derivative is used on the surface of the polarizing plate opposite the polarizer. A general-purpose TAC film or the like can be employed as the polarizing plate protective film. The polarizing plate protective film located farther from the liquid crystal cell can be provided with another functional layer for the purpose of improving the quality of the display.

For example, in order to avoid reflection, glare, scratch and dust, and to improve brightness, it is possible to laminate a film comprising a known functional layer for a display on the surface of the polarizing plate protective film of the present invention, without being restricted thereto.

Generally, to ensure stable optical properties, the retardation film is required to exhibit small fluctuation of the Ro or Rth as the aforementioned retardation value. Especially, these fluctuations may cause irregularities of an image in the liquid crystal display in the birefringence mode.

The long-length retardation film produced according to a melt casting method in the present invention is mainly composed of a cellulose resin, and therefore, can be subjected to alkali treatment based on saponification inherent to the cellulose ester. When a resin constituting the polarizer is polyvinyl alcohol, this makes it possible to apply a polarizer onto the long-length retardation film using an aqueous solution containing a completely saponified polyvinyl alcohol, in a similar manner as in a conventional polarizing plate protective film. Thus, the present invention is superior in that a conventional polarizing plate producing method can be applied. It is especially advantageous in that a long-length roll polarizing plate can be obtained.

The produce advantage of the present invention is remarkable in a long-length roll film with a length exceeding 100 meters. Greater advantages are observed in production of a longer polarizing plate such as one with a length of for example, 1,500 m, 2,500 m, and 5,000 m.

For example, in the production of a retardation film, roll length is 10 m to 5,000 m, and preferably 50 m to 4,500 m when the productivity and transportability are taken into account. The width of the film can be selected to suit the width of a polarizer or the width suitable for the production line. It is possible to produce a film having a width of 0.5 m to 4.0 m, and preferably 0.6 m to 3.0 m, and to wind the film in the form of a roll, which can be used to process a polarizing plate. It is also possible to produce a film having a width twice or more as great as the intended width, and to wind it in the form of a roll, which is cut to get the roll of an intended width. This roll can be used to process the polarizing plate.

When producing the cellulose ester optical film of the present invention, a functional layer such as an antistatic layer, a hard coated layer, a lubricant layer, an adhesive layer, an antiglare layer and a barrier layer can be coated before and/or after stretching. In this case, various forms of surface treatment such as corona discharging, plasma processing, or chemical treatment can be provided as necessary.

In the film making process, the gripping portions of the clips on both ends of the film having been cut can be recycled as the material of the same type or different type of films, after having been pulverized, or after having been palletized as required.

An optical film of lamination structure can be produced by co-extrusion of the compositions containing cellulose esters having different concentrations of additives such as the aforementioned plasticizer, ultraviolet absorber and matting agent. For example, an optical film having a structure of skin layer/core layer/skin layer can be produced. For example, a large quantity of matting agent can be incorporated into the skin layer or the matting agent can be incorporated only into the skin layer. Larger amounts of plasticizer and ultraviolet absorber can be incorporated into the core layer than the skin layer. They can be incorporated only in the core layer. Further, the types of the plasticizer and ultraviolet absorber can be varied in response to the core layer or skin layer. For example, it is also possible to make such arrangements that the skin layer contains a plasticizer and/or ultraviolet absorber of lower volatility, and the core layer contains a plasticizer of excellent plasticity or an ultraviolet absorber having excellent ultraviolet absorbing property. The glass transition temperatures between the skin layer and core layer can be different from each other. The glass transition temperature of the core layer is preferably lower than that of the skin layer. In this case, the glass transition temperatures of both the skin and core are measured, and the average value obtained by calculation from the volume fraction thereof is defined as the aforementioned glass transition temperature Tg so that it is handled in the same manner. Further, the viscosity of the melt including the cellulose ester at the time of melt-casting can be different according to the skin, layer or core layer. The viscosity of the skin layer can be greater than that of the core layer. Alternatively, the viscosity of the core layer can be equal to or greater than that of the skin layer.

In the cellulose ester optical film of the present invention, assume that the dimensional stability is based on the standard dimensions of the film which has been left to stand for 24 hours at a temperature of 23° C. with a relative humidity of 55% RH. On this assumption, the dimensional stability of the film for display of the present invention is such that the fluctuation of the dimension at 80° C. and 90% RH is within ±2.0% (excl.), preferably within ±1.0% (excl.), more preferably within ±0.5% (excl.).

When the cellulose ester optical film of the present embodiment is used for a polarizing plate protective film of a polarizing plate as a retardation film, if the retardation film itself is fluctuated so as to fall outside the aforementioned range, the absolute value of the retardation and the orientation angle as a polarizing plate deviate from those initially set, resulting in reduction of display quality improving capability or in deterioration of display quality.

The cellulose ester optical film of the present invention can be employed as a polarizing plate protective film. When the cellulose ester optical film of the present invention is employed as a polarizing plate protective film, a polarizing plate preparing method is not specifically limited, and a polarizing plate can be prepared employing a conventional method. There is a method in which the optical film cellulose ester is subjected to alkali treatment and adhered as a polarizing plate protective film through an aqueous completely saponified polyvinyl alcohol solution onto both sides of a polarizing film prepared by immersing polyvinyl alcohol film in an iodine solution and stretching the resulting film. The cellulose ester optical film of the present invention is adhered as a polarizing plate protective film directly onto at least one side of the polarizing film.

Adhesion aiding processing as disclosed in Japanese Patent O.P.I. Publication Nos. 6-94915 and 6-118232 may be carried out instead of the above alkali treatment to prepare a polarizing plate.

### (Formation of Functional Layer)

During production of the optical film of the present invention, prior to and after stretching, or prior to or after stretching, there may be coated a functional layer such as a transparent conductive layer, a hard coat layer, an antireflection layer, a lubricating layer, an adhesion aiding layer, an antiglare layer, a barrier layer, or an optical compensating layer. Specifically, it is preferable to arrange at least one layer selected from the group including a transparent conductive layer, an antireflection layer, an adhesion aiding layer, an antiglare layer, and an optical compensating layer. In this case, if appropriate, it is possible to carry out various surface treatments such as a corona discharge treatment, a plasma treatment, or a chemical treatment.

### <Transparent Conductive Layer>

In the film of the present invention, a transparent conductive layer can also preferably be provided, using a surfactant or conductive fine particle dispersion. Conductivity may be provided with the film itself or a transparent conductive layer may be provided. To provide antistatic properties, a transparent conductive layer is preferably provided. The transparent conductive layer can be provided using a method such as a coating method, atmospheric pressure plasma treatment, vacuum deposition, sputtering, or an ion plating method. Alternatively, via a co-extrusion method, a transparent conductive layer is prepared by incorporating conductive particles only in the surface layer or in the interior layer. The transparent conductive layer may be provided on one side of the film or on both sides. Conductive particles can be employed together with a matting agent providing lubricating properties or can be employed also as a matting agent. The following metal oxide particle powders exhibiting conductivity can be employed as a conductive agent.

As examples of the metal oxide, there are preferable ZnO, TiO₂, SnO₂, Al₂O₃, In₂O₃, SiO₂, MgO, BaO, MoO₂, and V₂O₅, or composite oxides thereof. Of these, ZnO, TiO₂, and SnO₂ are specifically preferable. As an example of incorporating a different type of atom, it is effective that Al or In is added to ZnO; Nb or Ta are added to TiO₂, or Sb, Nb, or a halogen element is added to SnO₂. The amount of such a different type of atoms to be added is preferably in the range of from 0.01 to 25 mol/%, and more preferably from 0.1 to 15 mol/%.

It is preferred that the conductive layer contains the metal oxide particle powders exhibiting conductivity in an amount of 0.01 to 20% by volume, the powders having a volume resistivity of not more than 1×10⁷ Ωcm, specifically not more than 1×10⁵ Ωcm, and having a specific structure having a primary particle size of from 10 nm to 0.2 μm and having in the high order structure a major axis length of from 30 nm to 6 μm.

In the present invention, the transparent conductive layer may be formed in such a manner that conductive particles are dispersed in a binder and provided on a substrate, or a substrate is subjected to subbing treatment and then conductive particles are applied thereon.

Further, it is possible to incorporate an ionene conductive polymer represented by Formulas (I) through (V), described in Paragraph Nos. 0038-0055 of Japanese Patent O.P.I. Publication No. 9-203810, and a quaternary ammonium cationic polymer represented by Formula (1) or (2), described in Paragraph Nos. 0056 through 0145 of the above patent document.

A heat resistant agent, a weather resistant agent, inorganic particles, a water-soluble resin, or ari emulsion may optionally be added in the transparent conducive layer composed of a metal oxide to result in a matted surface or to improve film quality to the extent that the amount added does not adversely affect the effects of the present invention.

Binders used in the transparent conductive layer are not specifically limited provided that film forming capability is exhibited thereby, including, for example, protein such as gelatin or casein; cellulose compounds such as carboxymethyl cellulose, hydroxyethyl cellulose, acetyl cellulose, diacetyl cellulose, triacetyl cellulose, or cellulose acetate propionate; a saccharides such as dextran, agar, sodium alginates, or starch derivatives; and synthetic polymers such as polyvinyl alcohol, polyvinyl acetate, polyacrylate, polymethacrylate, polystyrene, polyacrylamide, poly-N-vinylpyrrolidone, polyester, polyvinyl chloride, or polyacrylic acid.

Specifically preferable are gelatin (such as lime-treated gelatin, acid-treated gelatin, oxygen-decomposed gelatin, phthalated gelatin, or acetylated gelatin), acetyl cellulose, diacetyl cellulose, triacetyl cellulose, polyvinyl acetate, polyvinyl alcohol, polybutylacrylate, polyacrylamide, and dextran.

### <Antireflection Film>

The surface of the cellulose ester optical film of the present invention is preferably provided with a hard coat layer and an antireflection layer to allow the film to function as an antireflection film.

As the hard coat layer, a transparent curable resin layer (an actinic radiation curable resin layer or heat curable resin layer) is preferably used. The hard coat layer may be provided directly on the support or on the other layer such as an antistatic layer or a subbing layer.

When an actinic radiation curable resin layer is provided as a hard coat layer, an actinic radiation curable resin, capable of being cured via exposure to radiation such as ultraviolet rays, is preferably incorporated.

In view of optical design, the refractive index of the hard coat layer is preferably in the range of 1.45 to 1.65. Further, from the viewpoint of providing the antireflection film with adequate durability, impact resistance, and appropriate flexibility, as well as from the viewpoint of economics during production, the thickness of the hard coat layer is preferably in the range of 1 to 20 μm, and more preferably 1 to 10 μm.

The actinic radiation curable resin layer refers to a layer incorporating, as a main component, a resin which has been cured via cross-linking reaction by being exposed to actinic radiation such as ultraviolet rays or electron beams (“actinic radiation” in the present invention includes all electromagnetic waves such as electron beams, neutron beams, X-rays, alpha rays, ultraviolet rays, visible light, or infrared rays). As typical examples of actinic radiation curable resins, an ultraviolet ray curable resin and an electron beam curable resin are cited. However, a resin may optionally be employed which can be cured via exposure to radiation other than ultraviolet rays or electron beams. As the ultraviolet ray curable resin, there can be listed, for example, an ultraviolet ray curable acryl urethane resin, an ultraviolet ray curable polyester acrylate resin, an ultraviolet ray curable epoxy acrylate resin, an ultraviolet ray curable polyol acrylate resin, and an ultraviolet ray curable epoxy resin.

There can be listed an ultraviolet ray curable acryl urethane resin, an ultraviolet ray curable polyester acrylate resin, an ultraviolet ray curable epoxy acrylate resin, an ultraviolet ray curable polyol acrylate resin, and an ultraviolet ray curable epoxy resins.

Further, it is possible to incorporate a photoreaction initiator and a photosensitizer. Specifically, there can be listed acetophenone, benzophenone, hydroxybenzophenone, Michler's ketone, α-amyloxim ester, and thioxanthone, as well as derivatives thereof. When a photoreaction agent is used in the synthesis of an epoxy acrylate resin, it is optionally possible to use a sensitizer such as n-butylamine, triethylamine, or tri-n-butylphosphine. The content of a photoreaction initiator or photosensitizer incorporated in an ultraviolet ray curable resin composition is preferably from 2.5 to 6% by weight based on the composition from which a volatilized solvent component after coating and drying are removed.

Resin monomers include, for example, as a monomer having one unsaturated double bond, a common monomer such as methyl acrylate, ethyl acrylate, butyl acrylate, vinyl acetate, benzyl acrylate, cyclohexyl acrylate, or styrene. Further, there are listed, as a monomer having at least two unsaturated double bonds, ethylene glycol diacrylate, propylene glycol diacrylate, divinylbenzene, 1,4-cyclohexane diacrylate, and 1,4-cyclohexyldimethyl diacrylate, as well as trimethylolpropane triacrylate and pentaerythritol tetraacrylate as described above.

Further, a ultravilolet absorbent may be incorporated in an ultraviolet ray curable resin composition in such an amount that actinic radiation curing of the ultraviolet ray curable resin composition is not hindered. As the ultraviolet absorber, the same ultraviolet absorbers as those described above for the support may also be cited.

To enhance heat resistance of a cured layer, a selected antioxidant which does not inhibit actinic radiation curing reaction can be used. For example, there can be listed a hindered phenol derivative, a thiopropionic acid derivative, and a phosphite derivative. Specific examples include, for example, 4,4′-thiobis(6-t-3-methylphenol), 4,4′-bytylidenebis(6-t-butyl-3-methylphenol), 1,3,5-tris(3,5-di-t-butyl-4-hydroxybenzyl)isocyanurate, 2,4,6-tris(3,5-di-t-butyl-4-hydroxybenzyl)mesitylene, and di-octadecyl-4-hydroxy-3,5-di-t-butylbenzyl phosphate.

As the ultraviolet ray curable resin, there can be suitably selected and used, for example, ADEKA OPTOMER KR and BY Series such as KR-400, KR-410, KR-550, KR-566, KR-567, or BY-320B (all produced by Asahi Denka Kogyo Co., Ltd.); KOEIHARD such as A-101-KK, A-101-WS, C-302, C-410-N, C-501, M-101, M-102, T-102, D-102, NS-101, FT-102Q8, MAG-1-P20, AG-106, or M-101-C (all produced by Koei Chemical Co., Ltd.); SEIKABEAM such as PHC2210(S), PHCX-9(K-3), PHC2213, DP-10, DP-20, DP-30, P1000, P1100, P1200, P1300, P1400, P1500, P1600, or SCR900 (all produced by Dainichi Seika Industry Co., Ltd.); KRM7033, KRM7039, KRM7130, KRM7131, UVECRYL29201, and UVECRYL29202 (all produced by Daicel UCB Co., Ltd.); RC-5015, RC-5016, RC-5020, RC-5031, RC-5100, RC-5102, RC-5120, RC-5122, RC-5152, RC-5171, RC-5180, and RC-5181 (all produced by DIC Corp.); ORLEX No. 340 CLEAR (produced by Chugoku Marine Paints, Ltd.); SUNRAD H-601 (produced by Sanyo Chemical Industries, Ltd.); SP-1509 and SP-1507 (produced by Showa Hipolymer Co., Ltd.); RCC-15C (produced by Grace Japan K.K.); ARONIX M-6100, M-8030, and M-8060 (all produced by Toagosei Co., Ltd.), as well as any other commercially available products.

In the coating compositions of the actinic radiation curable resin layer, the solid concentration is preferably from 10 to 95% by weight, and a suitable concentration is selected depending on the coating method.

As a radiation source to form a cured layer via actinic radiation curing reaction of an actinic radiation curable resin, any radiation source which generates ultraviolet rays can be used. Specifically, the radiation sources described in the above radiation item can be used. Exposure conditions vary depending on each of the lamps. However, the exposure amount is preferably in the range of 20 mJ/cm² to 10000 mJ/cm², more preferably 50 mJ/cm² to 2000 mJ/cm². From the near ultraviolet region to the visible region, it is possible to use a sensitizer exhibiting the maximum absorption in the region.

A solvent which is used during coating of the actinic radiation curable resin layer is suitably selected and used, for example, from hydrocarbons (toluene and xylene); alcohols (methanol, ethanol, isopropanol, butanol, and cyclohexanol); ketones (acetone, methyl ethyl ketone, and methyl isobutyl ketone); ketone alcohols (diacetone alcohol); esters (methyl acetate, ethyl acetate, and methyl lactate); glycol ethers, and other organic solvents. Appropriate mixtures thereof can also be used. The appropriate organic solvent as described above is preferably used which contains propylene glycol monoalkyl ether (the number of carbon atoms of the alkyl group being 1 to 4) or propylene glycol monoalkyl ether acetate (the number of carbon atoms of the alkyl group being 1 to 4) in an amount of preferably at least 5% by weight, and more preferably 5 to 80% by weight.

As a coating method of an actinic radiation curable resin composition coating liquid, usable are methods known in the art employing coaters such as a gravure coater, a spinner coater, a wire bar coater, a roll coater, a reverse coater, an extrusion coater, or an air-doctor coater, as well as employing an ink-jet method. The amount coated is, in terms of the wet film thickness, appropriately from 0.1 to 30 μm, and preferably from 0.5 to 15 μm. The coating rate is preferably in the range of 10 m/minute to 60 m/minute.

The actinic radiation curable resin composition is coated and then dried, followed by being exposed to ultraviolet rays. The exposure time is preferably from 0.5 second to 5 minutes, more preferably 3 seconds to 2 minutes from the viewpoint of the curing efficiency of an ultraviolet radiation curable resin as well as operation efficiency.

Thus, a cured coating layer can be obtained. In order to provide an antiglare property to the surface of a liquid crystal display panel, or in order to decrease adhesion with other material or to increase anti-scratching property, the coating composition for the cured coating layer can be added with inorganic or organic particles.

Examples of the inorganic particles include those composed of silicon oxide, zirconium oxide, titanium oxide, aluminum oxide, tin oxide, zinc oxide, calcium carbonate, barium sulfate, talc, kaolin, and calcium sulfate.

Examples of the organic particles include polymethacrylic acid methyl acrylate resin powder, acryl styrene resin powder, polymethyl methacrylate resin powder, silicone resin powder, polystyrene resin powder, polycarbonate resin powder, benzoguanamine resin powder, melamine resin powder, polyolefin resin powder, polyester resin powder, polyamide resin powder, polyimide resin powder, or fluorinated ethylene resin powder. These particles can be used via addition to an ultraviolet ray curable resin composition. The average particle diameter of these fine particle powders is commonly from 0.01 μm to 10 μm. The amount used by blending is preferably from 0.1 parts by weight to 20 parts by weight based on 100 parts by weight of the ultraviolet ray curable resin composition. In order to provide antiglare properties, it is preferred that fine practices of an average particle diameter of 0.1 μm to 1 μm are used in an amount of 1 part by weight to 15 parts by weight based on 100 parts by weight of the ultraviolet ray curable resin composition.

By incorporating such particles in an ultraviolet ray curable resin, an antiglare layer can be formed which exhibits preferable unevenness of a center line average surface roughness Ra of 0.05 μm to 0.5 μm. Further, when these particles are not incorporated in an ultraviolet ray curable resin composition, a hard coat layer can be formed which has the good smooth surface with a center line average surface roughness Ra of less than 0.05 μm, and preferably from 0.002 μm to less than 0.04 μm.

In addition thereto, as a substance to result in a blocking prevention function, it is possible to use submicron particles of a volume average particle diameter of 0.005 μm to 0.1 μm, which are the same component as above, in an amount of 0.1 parts by weight to 5 parts by weight based on 100 parts by weight of the resin composition.

An antireflection layer is provided on the above hard coat layer. The arrangement method is not specifically limited. A coating method, a sputtering method, a deposition method, a CVD (chemical vapor deposition) method, and an atmospheric pressure plasma method may be used individually or in combination. In the present invention, a coating method is specifically preferably used to provide the antireflection layer.

As methods to form the antireflection layer by coating, there can be listed a method in which metal oxide powder is dispersed in a binder resin dissolved in a solvent, followed by coating and drying; a method in which a polymer having a cross-linked structure as a binder resin; and a method in which an ethylenically unsaturated monomer and a photopolymerization initiator are incorporated and then a layer is formed via exposure to actinic radiation.

In the present invention, an antireflection layer can be arranged on a cellulose ester optical film provided with an ultraviolet ray curable resin layer. In order to decrease reflectance, it is preferable to form a low refractive index layer on the uppermost layer of the optical film and then to form a metal oxide layer therebetween which is a high refractive index layer, and further to provide a medium refractive index layer (a metal oxide layer whose refractive index has been adjusted by varying the metal oxide content, the ratio to the resin binder, or the type of metal) between the optical film and the high refractive index layer. The refractive index of the high refractive index layer is preferably from 1.55 to 2.30, more preferably 1.57 to 2.20. The refractive index of the medium refractive index layer is adjusted to be an intermediate value between the refractive index (approximately 1.5) of a cellulose ester film serving as a substrate and the refractive index of the high refractive index layer. The refractive index of the medium refractive index layer is preferably from 1.55 to 1.80. The thickness of each layer is preferably from 5 nm to 0.5 μm, more preferably from 10 nm to 0.3 μm, and most preferably from 30 nm to 0.2 μm. The haze of the metal oxide layer is preferably at most 5%, more preferably at most 30, and most preferably at most 1%. The strength of the metal oxide layer is preferably at least 3 H, and most preferably at least 4 H in terms of pencil hardness when a load of 1 kg is applied. When the metal oxide layer is formed via a coating method, inorganic particles and a binder polymer are preferably incorporated therein.

The medium and high refractive index layers in the present invention are preferably layers with a refractive indexes of 1.55 to 2.5, which are formed by coating and drying of a coating liquid containing monomers or oligomers of an organic titanium compound represented by Formula (T) described below, or hydrolyzed products thereof.

Ti(OR1)₄ Formula (T)

In formula (T), R1 is an aliphatic hydrocarbon group having a carbon atom number of from 1 to 8, and preferably an aliphatic hydrocarbon group having a carbon atom number of 1 to 4. The alkoxide group of the monomer or oligomer of the organic titanium compound or a hydrolyzed product thereof undergoes hydrolysis to create a cross-linked structure such as —Ti—O—Ti—, whereby a cured layer is formed.

As preferable examples of a monomer and an oligomer of an organic titanium compound used in the present invention, there are cited a dimer to a decamer of Ti(OCHA₄, Ti(OC₂H₅)₄, Ti(O-n-C₃H₇)₄, Ti(O-i-C₃H₇)₄, Ti(O-n-C₄H₉)₄, and Ti(O-n_C₃H₇)₄, and a dimer—a decamer of Ti(O-i-C₃H₇)₄, as well as a dimer to a decamer of Ti(O-n-C₄H₉)₄. These may be used individually or in combinations of at least two types. Of these, a dimer to a decamer of Ti(O-n-C₃H₇)₄, Ti(O-i-C₃H₇)₄, Ti(O-n-C₄H₉)₄, and Ti(O-n-C₃H₇)₄ and a dimer to a decamer of Ti(O-n-C₄H₉)₄ are specifically preferable.

In the present invention, coating liquids for the medium and high refractive index layer are preferably prepared via addition of the organic titanium compound into a solution to which water and an organic solvent, as described later, have been added in this sequential order. In cases in which water is added later, hydrolysis/polymerization does not progress uniformly, whereby cloudiness is generated or the layer strength is decreased. After adding water and the organic solvent, it is preferable to carry out vigorous stirring for mixing and dissolution to result in a uniform mixture.

Further, an alternative method is employable as a preferred embodiment. Namely, an organic titanium compound and an organic solvent are mixed, and then the resulting mixed solution is added to the above solution having been prepared by stirring the mixture of water and an organic solvent.

Herein, the amount of water is preferably in the range of 0.25 to 3 mol per mol of the organic titanium compound. When the amount of water is less than 0.25 mol, hydrolysis and polymerization are not sufficiently conducted, resulting in lowered layer strength. When exceeding 3 mol, hydrolysis and polymerization are excessively carried out, and then coarse TiO₂ particles are formed, resulting in cloudiness. Therefore, the amount of water is preferably controlled to fall within the above range.

Further, the content of water is preferably less than 10% by weight based on the total coating liquid. When the content of water is more than 10% by weight based on the weight of the total coating liquid, stability of the coating liquid is degraded, which may result in cloudiness.

An organic solvent used in the present invention is preferably water-miscible. Examples of the water-miscible organic solvents include alcohols (for example, methanol, ethanol, propanol, isopropanol, butanol, isobutanol, secondary butanol, tertiary butanol, pentanol, hexanol, cyclohexanol, and benzyl alcohol; polyhydric alcohols (for example, ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thioglycol); polyhydric alcohol ethers (for example, ethylene glycol monomethyl ether, ethylene glycol monoethyl ether, ethylene glycol monobutyl ether, diethylene glycol monomethyl ether, diethylene glycol monomethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, ethylene glycol monophenyl ether, and propylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamthyldiethylenetriamine, and tetramethylpropylenediamine); amides (for example, formamide, N,N-dimethylfromamide and N,N-dimethylacetamide); heterocycles (for example, 2-pyrrolidone, N-methyl-2-pyrrolidone, cyclohexylpyrrolidone, 2-oxazolidone, 1,3-dimethyl-2-imidazolidinone); sulfoxides (for example, dimethylsulfoxide); and sulfones (for example, sulfolane); as well as urea, acetonitrile, and acetone. Of these, alcohols, polyhydric alcohols, and polyhydric alcohol ethers are especially preferred. As described above, the amount of these organic solvents used may be adjusted so that the content of water is less than 10% by weight based on the total coating liquid by controlling the total used amount of water and the organic solvents.

The content of a monomer or oligomer of an organic titanium compound and a hydrolyzed product thereof used in the present invention, when used singly, is preferably from 50.0% by weight to 98.0% by weight based on solids incorporated in the coating liquid. The solid ratio is preferably from 50% by weight to 90% by weight, and more preferably from 55% by weight to 90% by weight. In addition, it is also preferable to add a polymer of an organic titanium compound (herein the organic titanium compound has been previously hydrolyzed, followed by cross-linking) or add titanium oxide particles as coating compositions.

The high refractive index layer and the medium refractive index layer of the present invention may incorporate metal oxide particles as particles and further may incorporate a binder polymer.

When a hydrolyzed/polymerized organic titanium compound and metal oxide particles are combined in the above method of preparing a coating liquid, the hydrolyzed/polymerized organic titanium compound and the metal oxide particles are allowed to adhere together, whereby it is possible to realize a durable coating layer provided with hardness resulting from the particles together with flexibility of a uniform layer.

The refractive index of metal oxide particles used in the high refractive index layer and the medium refractive index layer is preferably from 1.80 to 2.80, and more preferably from 1.90 to 2.80. The primary particle weight average diameter of the metal oxide particles is preferably from 1 to 150 nm, more preferably from 1 to 100 nm, and most preferably from 1 to 80 nm. The weight average diameter of the metal oxide particles in the layer is preferably from 1 to 200 nm, more preferably 5 to 150 nm, still more preferably from 10 to 100 nm, and most preferably from 10 to 80 nm. The average particle size of the metal oxide particles can be determined, for example, by measuring the major axis length of arbitrarily selected 200 particles through a scanning electron microscope and computing the average of the measurements. The specific surface area of the metal oxide particles is, as a value determined via the BET method, preferably from 10 to 400 m²/g, more preferably from 20 to 200 m²/g, most preferably from 30 to 150 m²/g.

Examples of the metal oxide particles include metal oxides incorporating at least one element selected from Ti, Zr, Sn, Sb, Cu, Fe, Mn, Pb, Cd, As, Cr, Hg, Zn, Al, Mg, Si, P, and S. Specifically, there are listed titanium dioxide (for example, rutile, rutile/anatase mixed crystal, anatase, and amorphous structured ones), tin oxide, indium oxide, zinc oxide, and zirconium oxide. Of these, titanium oxide, tin oxide, and indium oxide are specifically preferable. The metal oxide particles are composed of an oxide of any of the above metals as a main component and further other metals may be incorporated. The main component refers to a component whose content (% by weight) is the maximum of the particle composing components. Examples of other elements include Ti, Zr, Sn, Sb, Cu, Fe, Mn, Pb, Cd, As, Cr, Hg, Zn, Al, Mg, Si, P, and S.

The metal oxide particles are preferably subjected to surface treatment. It is possible to conduct the surface treatment using an inorganic or organic compound. As examples of the inorganic compound used for the surface treatment, there are cited alumina, silica, zirconium oxide, and iron oxide. Of these, alumina and silica are preferable. Examples of the organic compound used for the surface treatment include polyols, alkanolamines, stearic acid, silane coupling agents, and titanate coupling agents. Of these, silane coupling agents are most preferable.

Specific examples of silane coupling agents include methyltrimethoxysilane, methyltriethoxysilane, methyltrimethoxyethoxysilane, methyltriacetoxysilane, methyltributoxysilane, ethyltrimethoxysilane, ethyltriethoxysilane, vinyltrimethoxysilane, vinyltriethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysilane, 3,3,3-trifluoropropyltrimethoxysilane, γ-glycidyloxypropyltrimethoxysilane, γ-glycidyloxypropyltriethoxysilane, γ-(β-glycidyloxyethoxy)propyltrimethoxysilane, β-(3,4-epoxycyclohexyl)ethyltrimethoxysilane, β-(3,4-epoxycyclohexyl)ethyltriethoxysilane, γ-acryloyloxypropyltrimethoxysilane, γ-methacryloyloxypropyltrimethoxysilane, γ-aminopropyltrimethoxysilane, γ-aminopropyltriethoxysilane, γ-mercaptopropyltrimethoxysilane, γ-mercaptopropyltriethoxysilane, N-β-(aminoethyl)-γ-aminopropyltrimethoxysilane, and β-cyanoethyltriethoxysilane.

Further, examples of silane coupling agents having an alkyl group of 2-substitution with respect to silicon include dimethyldimethoxysilane, phenylmethyldimethoxysilane, dimethyldiethoxysilane, phenylmethyldiethoxysilane, γ-glycidyloxypropylmethyldiethoxysilane, γ-glycidyloxypropylmethyldimethoxysilane, γ-glycidyloxypropylphenyldiethoxysilane, γ-chloropropylmethyldiethoxysilane, dimethyldiacetoxysilane, γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethoxysilane, γ-mercaptopropylmethyldimethoxysilane, γ-mercaptopropylmethyldiethoxysilane, γ-aminopropylmethyldimethoxysilane, γ-aminopropylmethyldiethoxysilane, methylvinyldimethoxysilane, and methylvinyldiethoxysilne.

Of these, preferable are vinyltrimethoxysilane, vinyltriethoxysilane, vinylacetoxysilane, vinyltrimethoxyethoxysilane, γ-acryloyloxypropylmethoxysilane, and γ-methacryloyloxypropylmethoxysilane any of which has a double bond in the molecule, as well as γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethjoxysilane, methylvinyldimethoxysilane, and methylvinyldiethoxysilane any of which has an alkyl group of 2-substitution with respect to silicon. Of these, specifically preferable are γ-acryloyloxypropyltrimethoxysilane, γ-methacryloyloxypropyltrimethoxysilane, γ-acryloyloxypropylmethyldimethoxysilane, γ-acryloyloxypropylmethyldiethoxysilane, γ-methacryloyloxypropylmethyldimethoxysilane, and γ-methacryloyloxypropylmethyldiethoxysilane.

At least two types of coupling agents may simultaneously be used. In addition to the above silane coupling agents, other silane coupling agents may be used. Other silane coupling agents include alkyl esters of ortho-silicic acid (for example, methyl orthosilicate, ethyl orthosilicate, n-propyl orthosilicate, i-propyl orthosilicate, n-butyl orthosilicate, sec-butyl orthosilicate, and t-butyl orthosilicate) and hydrolyzed products thereof.

Surface treatment employing a coupling agent can be carried out in such a manner that a coupling agent is added to a fine particle dispersion, and then the resulting dispersion is allowed to stand at room temperature −60° C. for several hours −10 days. In order to promote the surface treatment reaction, there may be added, to the above dispersion, an inorganic acid (for example, sulfuric acid, hydrochloric acid, nitric acid, chromic acid, hypochlorous acid, boric acid, orthosilicic acid, phosphoric acid, and carbonic acid), and an organic acid (for example, acetic acid, polyacrylic acid, benzenesulfonic acid, phenol, and polyglutamic acid), or a salt thereof (for example, a metal salt and an ammonium salt).

Such a silane coupling agent is preferably hydrolyzed using a required amount of water beforehand. In a state where the silane coupling agent has been hydrolyzed, the above organic titanium compound and the surface of metal oxide particles are allowed to be more reactive, whereby a further durable film is formed. A hydrolyzed silane coupling agent is also preferably added in a coating liquid beforehand. It is possible to use the water, having been used for this hydrolysis, in hydrolysis/polymerization of an organic titanium compound.

In the present invention, treatment may be carried out by combining at least two types of surface treatments. The shape of metal oxide particles is preferably rice grain-shaped, spherical, cubic, spindle-shaped, or irregular. At least two types of metal oxide particles may be used in the high refractive index layer and in the medium refractive index layer at the same time.

The contents of metal oxide particles in the high refractive index and the medium refractive index layer are preferably from 5 to 90% by weight, more preferably from 10 to 85% by weight, and still more preferably from 20 to 80% by weight. When the particles are incorporated, the content of the monomer or oligomer of the above organic titanium compound or the hydrolyzed product thereof is, based on solids incorporated in the coating liquid, from 1 to 50% by weight, preferably from 1 to 40% by weight, and more preferably from 1 to 30% by weight.

The above metal oxide particles in the form of being dispersed in a medium are incorporated in coating liquids to form a high refractive index layer and a medium refractive index layer. As a dispersion medium of the metal oxide particles, a liquid with a boiling point of 60 to 170° C. is preferably used. Specific examples of the dispersion medium include water, alcohols (for example, methanol, ethanol, isopropanol, butanol, and benzyl alcohol), ketones (for example, acetone, methyl ethyl ketone, methyl isobutyl ketone, and cyclohexanone), esters (for example, methyl acetate, ethyl acetate, propyl acetate, butyl acetate, methyl formate, ethyl formate, propyl formate, and butyl formate), aliphatic hydrocarbons (for example, hexane and cyclohexanone), halogenated hydrocarbons (for example, methylene chloride, chloroform, and carbon tetrachloride), aromatic hydrocarbons (for example, benzene, toluene, and xylene), amides (for example; dimethylformamide, diethylacetamide, and n-methylpyrrolidone), ethers (for example, diethyl ether, dioxane, and tetrahydrofuran), and ether alcohols (for example, 1-methoxy-2-propanol). Of these, specifically preferable are toluene, xylene, methyl ethyl ketone, methyl isobutyl ketone, cyclohexane, and butanol.

Further, metal oxide particles can be dispersed in a medium using a homogenizer. Examples of the homogenizer include a sand grinder mill (for example, a bead mill with pins), a high speed impeller mill, a pebble mill, a roller mill, an attritor, and a colloid mill. Of these, the sand grinder and the high speed impeller mill are specifically preferable. Preliminary dispersion may optionally be conducted. Examples of appropriate homogenizers used for the preliminary dispersion include a ball mill, a three-roll mill, a kneader, and an extruder.

A polymer featuring a cross-linked structure (hereinafter also referred to as a cross-linked polymer) is preferably used as a binder polymer in the high refractive index and the medium refractive index layer of the present invention. Examples of the cross-linked polymer include cross-linked products of a polymer having a saturated hydrocarbon chain such as polyolefin (hereinafter referred to as polyolefin), polyether, polyurea, polyurethane, polyester, polyamine, polyamide, or a melamine resin. Of these, cross-linked products of polyolefin, polyether, and polyurethane are preferable. Cross-linked products of polyolefin and polyether are more preferable, but cross-linked products of polyolefin are most preferable. Further, a cross-linked polymer having an anionic group is more preferable. The anionic group functions to maintain a dispersion state of inorganic particles, and the cross-linked structure exhibits a function to strengthen a film by imparting film-forming capability to a polymer. The above anionic group may directly bond to a polymer chain or may bond to a polymer chain via a linking group. However, the anionic group preferably bonds, as a side chain, to the main chain via a linking group.

Examples of the anionic group include a carboxylic acid group (carboxyl), a sulfonic acid group (sulfo), and phosphoric acid group (phosphono). Of these, a sulfonic acid group and a phosphoric acid group are preferable. Herein, the anionic group may be in a salt form. A cation which forms a salt with the anionic group is preferably an alkali metal ion. Further, protons of the anionic group may be dissociated. The linking group which bonds the anionic group to a polymer chain is preferably a bivalent group selected from —CO—, —O—, an alkylene group, and an arylene group, as well as combinations thereof. A cross-linked polymer which is a preferable binder polymer is preferably a copolymer having a repeating unit having an anionic group and also a repeating unit having a cross-linked structure. In this case, the ratio of the repeating unit having an anionic group in a copolymer is preferably from 2 to 96% by weight, more preferably from 4 to 94% by weight, and most preferably from 6 to 92% by weight. The repeating unit may have at least two anionic groups.

In a cross-linked polymer having an anionic group, another repeating unit (a repeating unit having neither an anionic group nor a cross-linked structure) may be contained. As another repeating unit, preferable are a repeating unit having an amino group or a quaternary ammonium group and a repeating unit having a benzene ring. The amino group or the quaternary ammonium group functions to maintain a dispersion state of inorganic particles, similarly to the above anionic group. The benzene ring functions to enhance the refractive index of the high refractive index layer. Incidentally, even when the amino group, quaternary ammonium group or benzene ring is contained in the repeating unit having an anionic group or in the repeating unit having a cross-linked structure, similar effects are achieved.

In a cross-linked polymer containing, as a constituent unit, a repeating unit having an amino group or a quaternary ammonium group, the amino group or the quaternary ammonium group may directly bond to a polymer chain or may bond to a polymer chain as a side chain via a linking group. However, the latter is preferable. The amino group or the quaternary ammonium group is preferably a secondary amino group, a tertiary amino group, or a quaternary ammonium group, more preferably a tertiary amino group or a quaternary ammonium group. A group bonding to the nitrogen atom of the secondary amino group, the tertiary amino group, or the quaternary ammonium group is preferably an alkyl group, more preferably an alkyl group having 1-12 carbons, still more preferably an alkyl group having 1 to 6 carbons. The counter ion of the quaternary ammonium group is preferably a halide ion. The linking group which bonds the amino group or the quaternary ammonium group to a polymer chain is preferably a bivalent group selected from —CO—, —NH—, —O—, an alkylene group, and an arylene group, as well as combinations thereof. When the cross-linked polymer contains a repeating unit having an amino group or an quaternary ammonium group, the ratio is preferably from 0.06 to 32% by weight, more preferably from 0.08 to 30% by weight, most preferably from 0.1 to 28% by weight.

Cross-linked polymers are preferably formed via polymerization reaction during or after coating of coating liquids, wherein the coating liquids are prepared for a high refractive index and a medium refractive index layer by blending monomers to form cross-linked polymers. Each layer is formed along with the formation of the cross-linked polymers. A monomer having an anionic group functions as a dispersing agent for inorganic particles in a coating liquid. The used amount of the monomer having an anionic group is, based on the inorganic particles, preferably from 1 to 50% by weight, more preferably from 5 to 40% by weight, and still more preferably from 10 to 30% by weight. Further, a monomer having an amino group or a quaternary ammonium group functions as a dispersing aid in a coating liquid. The used amount of the monomer having an amino group or a quaternary ammonium group is preferably from 3 to 33% by weight based on the monomer having an anionic group. These monomers can be allowed to effectively function prior to coating of a coating liquid via a method in which a cross-linked polymer is formed during or after coating of the coating liquid.

Monomers used in the present invention are most preferably those having at least two ethylenically unsaturated groups. Examples thereof include esters of polyhydric alcohols with (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene, 4-vinylbenzoic acid-2-acryloylethyl ester, and 1,4-divinylcyclohexane); vinylsulfones (for example, divinylsulfone); acrylamides (for example, methylenebisacrylamide); and methacrylamides. Commercially available monomers having an anionic group and monomers having an amino group or a quaternary ammonium group may be used. The commercially available monomers having an anionic group preferably used include KAYAMAR PM-21 and PM-2 (produced by Nihon Kayaku Co., Ltd.); ANTOX MS-60, MS-2N, and MS-NH4 (produced by Nippon Nyukazai Co., Ltd.); ARONIX M-5000, M-6000, and M-8000 Series (produced by Toagosei Co., Ltd.); BISCOAT #2000 Series (produced by Osaka Organic Chemical Industry Ltd.); NEW FRONTIER GX-8289 (produced by Dai-ichi Kogyo Seiyaku Co., Ltd.); NK ESTER CB-1 and A-SA (produced by Shin-Nakamura Chemical Co., Ltd.); and AR-100, MR-100, and MR-200 (produced by Diahachi Chemical Industry Co., Ltd.). Further, the commercially available monomers having an amino group or a quaternary ammonium group preferably used include DMAA (produced by Osaka Organic Chemical Industry Ltd.); DMAEA and DMAPAA (produced by Kohjin Co., Ltd.); BLENMER QA (produced by NOF Corp.); and NEW FRONTIER C-1615 (produced by Dia-ichi Kogyo Seiyaku Co., Ltd.).

It is possible to conduct polymerization reaction of a polymer via photopolymerization reaction or thermal polymerization reaction. The photopolymerization reaction is specifically preferable. A polymerization initiator is preferably used for the polymerization reaction. The polymerization initiator includes, for example, a thermal polymerization initiator and a photopolymerization initiator, described later, which are used to form a binder polymer for a hard coat layer.

Commercially available polymerization initiators may be used as the polymerization initiator. In addition to the polymerization initiator, an appropriate polymerization promoter may optionally be used. The amounts of the polymerization initiator and the polymerization promoter used are preferably in the range of 0.2 to 10% by weight of the total amount of the monomers. Polymerization of a monomer (or an oligomer) may be promoted by heating a coating liquid (an inorganic fine particle dispersion incorporating a monomer). Further, by heating after the photopolymerization reaction conducted after coating, heat curing reaction for the formed polymer may be carried out as an additional treatment.

Relatively high refractive index polymers are preferably used for the medium refractive index and the high refractive index layer. Examples of polymers exhibiting a high refractive index include polystyrene, styrene copolymers, polycarbonates, melamine resins, phenol resins, epoxy resins, and polyurethanes obtained via reaction of cyclic (alicyclic or aromatic) isocyanates with polyols. It is also possible to use polymers having another cyclic (aromatic, heterocyclic, or alicyclic) group and polymers having a halogen atom other than fluorine as a substituent since a high refractive index is exhibited thereby.

A low refractive index layer usable in the present invention includes a low refractive index layer formed by cross-linking of a fluorine-containing resin (hereinafter also referred to as “fluorine-containing resin prior to cross-linking”) which undergoes cross-linking by heat or ionizing radiation; a low refractive index layer formed via a sol-gel method; and a low refractive index layer, formed with particles and a binder polymer, having voids among the Particles or in the interior of the particles. A low refractive index layer applicable to the present invention is preferably one formed mainly with particles and a binder polymer. Specifically, the low refractive index layer having voids in the interior of the particles (also called the hollow particles) is preferable, since the refractive index can be lowered further. However, a decrease in the refractive index of the low refractive index layer is preferable due to an improvement of antireflection performance, which, however, makes it difficult to provide required strength. In view of the balance therebetween, the refractive index of the low refractive index layer is preferably at most 1.45, more preferably from 1.30 to 1.50, still more preferably from 1.35 to 1.49, and most preferably from 1.35 to 1.45.

Further, preparation methods of the low refractive index layer may be suitably combined.

Preferable fluorine-containing resins prior to coating include fluorine-containing copolymers formed with fluorine-containing vinyl monomers and cross-linkable group-providing monomers. Specific examples of the fluorine-containing vinyl monomer units include fluoroolefins (for example, fluoroethylene, vinylidene fluoride, tetrafluoroethylene, hexafluoroethylene, hexafluoropropylene, and perfluoro-2,2-dimethyl-1,3-dioxol); partially- or completely-fluorinated alkyl ester derivatives of (meth)acrylic acid (for example, BISCOAT 6FM (produced by Osaka Organic Chemical Industry Ltd.) and M-2020 (produced by Daikin Industries, Ltd.)); and completely- or partially-fluorinated vinyl ethers. The cross-linkable group-providing monomers include vinyl monomers previously having a cross-linkable functional group in the molecule such as glycidyl methacrylate, vinyltrimethoxysilane, γ-methacryloyloxypropyl-trimethoxysilane, or vinyl glycidyl ether, as well as vinyl monomers having a carboxyl group, a hydroxyl group, an amino group, or a sulfonic acid group (for example, (meth)acrylic acid, methylol(meth)acrylate, hydroxyalkyl(meth)acrylate, allyl acrylate, hydroxyalkyl vinyl ether, and hydroxyalkyl allyl ether). Japanese Patent O.P.I. Publication Nos. 10-25388 and 10-147739 describe that a cross-linked structure is introduced into the latter by adding, after copolymerization, a compound having a group reactive to the functional group in the polymer, as well as having at least another reactive group. Examples of the cross-linkable group include an acryloyl, a methacryloyl, an isocyanate, an epoxy, an aziridine, an oxazoline, an aldehyde, a carbonyl, a hydrazine, a carboxyl, a methylol, and an active methylene group. When a fluorine-containing copolymer is subjected to thermal cross-linking in the presence of a thermally-reactive cross-linking group or in combination of an ethylenically unsaturated group with a thermally radical generating agent or of an epoxy group with a thermally acid generating agent, the above polymer is of a thermally curable type. In contrast, when cross-linking is performed via exposure to radiation (preferably ultraviolet rays or electron beams) in combination of an ethylenically unsaturated group with a photo-radical generating agent or of an epoxy group with a photolytically acid generating agent, the polymer is of an ionizing radiation curable type.

Further, in addition to the above polymers, as the fluorine-containing resin prior to coating, there may be used a fluorine-containing copolymer formed in combination of a fluorine-containing vinyl monomer with a monomer other than a cross-linkable group-providing monomer. Monomers usable in combination are not specifically limited, including, for examples, olefins (ethylene, propylene, isoprene, vinyl chloride, and vinylidene chloride); acrylates (methyl acrylate, ethyl acrylate, 2-ethylhexyl acrylate); methacrylates (methyl methacrylate, ethyl methacrylate, butyl methacrylate, and ethylene glycol dimethacrylate); styrene derivatives (styrene, divinylbenzene, vinyltoluene, and α-methylstyrene); vinyl ethers (methyl vinyl ether); vinyl esters (vinyl acetate, vinyl propionate, and vinyl cinnamate); acrylamides (N-tert-butylacrylamide and N-cyclohexylacrylamide); methacrylamides; and acrylonitrile derivatives. Further, to provide lubricating properties and antistaining properties, a polyorganosiloxane skeleton or a perfluoropolyether skeleton is also preferably introduced into a fluorine-containing copolymer. The introduction can be carried out, for example, via polymerization of the above monomer with a polyorganosiloxane or perfluoropolyether having, at a terminal, an acryl group, a methacryl group, a vinyl ether group, or a styryl group; via polymerization of the polymer with a polyorganosiloxane or perfluoropolyether having a radical generating group at a terminal; or via reaction of a fluorine-containing copolymer with a polyorganosiloxane or perfluoropolyether having a functional group.

The ratio of each monomer used to form the fluorine-containing copolymer prior to coating is described below. The ratio of a fluorine-containing vinyl monomer is preferably from 20 to 70 mol %, and more preferably from 40 to 70 mol %; the ratio of a cross-linkable group-providing monomer used is preferably from 1 to 20 mol %, and more preferably from 5 to 20 mol %; and the ratio of the other monomers used together is preferably from 10 to 70 mol %, and more preferably from 10 to 50 mol %.

The fluorine-containing copolymer can be obtained by polymerizing these monomers via a method such as a solution polymerization method, a block polymerization method, an emulsion polymerization method, or a suspension polymerization method.

Fluorine-containing resins prior to coating are commercially available and possible to employ. Examples of the fluorine-containing resins prior to coating available on the market include SAITOP (produced by Asahi Glass Co., Ltd.), TEFLON (a registered trade name) AF (produced by E. I. du Pont de Nemours and Company), vinylidene polyfluoride and RUMIFRON (produced by Asahi Glass Co., Ltd.), and OPSTAR (produced by JSR Corp.).

The dynamic friction coefficient and the contact angle to water of the low refractive index layer composed of a cross-linked fluorine-containing resin are in the range of 0.03 to 0.15 and in the range of 90 to 120 degrees, respectively.

The low refractive index layer composed of a cross-linked fluorine-containing resin preferably incorporates inorganic particles described later from the viewpoint of adjusting the refractive index. Further, the inorganic particles are preferably used after being surface-treated. Surface treatment methods include physical surface treatment such as plasma discharge treatment or corona discharge treatment, as well as chemical surface treatment employing a coupling agent. However, a coupling agent is preferably employed. As the coupling agent, an organoalkoxy metal compound (for example, a titanium coupling argent and a silane coupling agent) is preferably used. When inorganic particles are composed of silica, silane coupling agent-treatment is specifically effective.

Further, various types of sol-gel materials can also preferably be used as a material for the low refractive index layer. As such a sol-gel material, there can be used metal alcoholates (alcoholates of silane, titanium, aluminum, or zirconium), organoalkoxy metal compounds, and hydrolysis products thereof. Specifically, alkoxysilanes, organoalkoxysilanes, and hydrolysis products thereof are preferable. Examples thereof include tetraalkoxysilanes (such as tetramethoxysilane or tetraethoxysilane), alkyltrialkoxysilanes (such as methyltrimethoxysilane or ethyltrimethoxysilane), aryltrialkoxysilanes (such as phenyltrimethoxysilane), dialkyldialkoxysilanes, and diaryldialkoxysilanes. Further, there are also preferably used organoalkoxysilanes having various types of functional groups (such as vinyltrialkoxysilanes, methylvinyldialkoxysilanes, γ-glycidyloxypropyl-trialkoxysilanes, γ-glycidyloxypropylmethyldialkoxysilanes, β-(3,4-epoxydicyclohexyl)ethyltrialkoxysilanes, γ-methacryloyloxypropyltrialkoxysilanes, γ-aminopropyltrialkoxysilanes, γ-mercaptopropyl-trialkoxysilanes, or γ-chloropropyltrialkoxysilanes); and perfluoroalkyl group-containing silane compounds (for example, (heptadecafluoro-1,1,2,2-tetradecyl)triethoxysilane, 3,3,3-trifluoropropyltrimethoxysilane). Specifically, fluorine-containing silane compounds are preferably used from the viewpoint of decreasing the refractive index of the layer and of providing water repellency and oil repellency.

As a low refractive index layer, there is preferably used a layer wherein inorganic or organic particles are used to form micro-voids among the particles or in the interior of the particles. The average particle diameter of the particles is preferably from 0.5 to 200 nm, more preferably from 1 to 100 nm, still more preferably form 3 to 70 nm, and most preferably from 5 to 40 nm. Further, the particle diameter of the particles is preferably as uniform (monodispersed) as possible.

Inorganic particles are preferably noncrystalline. The inorganic particles are preferably composed of metal oxides, metal nitrides, metal sulfides, or metal halides, more preferably composed of metal oxides or metal halides, but most preferably composed of metal oxides or metal fluorides. As metal atoms, preferable are Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Pb, and Ni. Of these, Mg, Ca, B, and Si are more preferable. Inorganic compounds containing two types of metals may also be used. Specific examples of preferable inorganic compounds include SiO₂ or MgF₂, but SiO₂ is specifically preferable.

Such particles having micro-voids in the interior of inorganic particles can be formed, for example, by allowing silica molecules which form the particles to be cross-linked. When silica molecules are subjected to cross-linking, the resulting volume is reduced, resulting in porous particles. It is possible to directly synthesize microvoid-containing (porous) inorganic particles as a dispersion via a sol-gel method (described in Japanese Patent O.P.I. Publication No. 53-112732 and Examined Japanese Patent Application Publication No. 57-9051) or a deposition method (described in Applied Optics, Volume 27, page 3356 (1988)). Alternatively, a dispersion can also be obtained by mechanically pulverizing powder prepared via a drying/precipitation method. Commercially available porous inorganic particles (such as SiO₂ sol) may be used.

In order to form a low refractive index layer, these inorganic particles are preferably used in such a state as dispersed in an appropriate medium. As a dispersion medium, preferable are water, alcohol (for example, methanol, ethanol, and isopropyl alcohol), and ketone (for example, methyl ethyl ketone and methyl isobutyl ketone).

Organic particles are preferably non-crystalline. The organic particles are also preferably polymer particles which are synthesized via polymerization reaction (for example, an emulsion polymerization method) of a monomer. The polymer of the organic particles preferably contains fluorine atoms. The ratio of the fluorine atoms in the polymer is preferably from 35 to 80% by weight, and more preferably from 45 to 75% by weight. Further, microvoids are also preferably formed in the organic fine particle, for example, by allowing a particle-forming polymer to be cross-linked to result in a reduced volume. In order to allow the particle-forming polymer to be cross-linked, a multifunctional monomer preferably accounts for at least 20 mol % based on a monomer used to synthesize the polymer. The ratio of the multifunctional monomer is more preferably from 30-80 mol %, most preferably 35-50 mol %. As monomers used to synthesize the organic particles, examples of fluorine-containing monomers used to synthesize the fluorine-containing polymers include fluoroolefins (for example, fluoroethylene, vinylidene fluoride, tetrafluoroethylene, hexafluoropropylene, and perfluoro-2,2-dimethyl-1,3-dioxol), fluorinated alkyl esters of acrylic acid or methacrylic acid, and fluorinated vinyl ethers. Copolymers of monomers with and without fluorine atoms may be used. Examples of the monomers without fluorine atoms include olefins (for example, ethylene, propylene, isoprene, vinyl chloride, and vinylidene chloride), acrylates (for example, methyl acrylate, ethyl acrylate, and 2-ethylhexyl acrylate), methacrylates (for example, methyl methacrylate, ethyl methacrylate, and butyl methacrylate), styrenes (for example, styrene, vinyltoluerie, and α-methylstyrene), vinyl ethers (for example, methyl vinyl ether), vinyl esters (for example, vinyl acetate and vinyl propionate), acrylamides (for example, N-tert-butylacrylamide and N-cyclohexylacrylamide), methacrylamides, and acrylonitriles. Examples of the multifunctional monomers include dienes (for example, butadiene and pentadiene), esters of polyhydric alcohol with acrylic acid (for example, ethylene glycol diacrylate, 1,4-cyclohexane diacrylate, and dipentaerythritol hexaacrylate), esters of polyhydric alcohol with methacrylic acid (for example, ethylene glycol dimethacrylate, 1,2,4-cyclohexane tetramethacrylate, and pentaerythritol tetramethacrylate), divinyl compounds (for example, divinylcyclohexane and 1,4-divinylbenzene), divinylsulfone, bisacrylamides (for example, methylenebisacrylamide), and bismethacrylamides.

Microvoids among particles can be formed by piling at least two particles. Incidentally, when spherical particles of an equal diameter (being completely monodispersed) are close-packed, microvoids of a 26% void ratio by volume are formed among the particles. When spherical particles of an equal diameter are subjected to simple cubic packing, microvoids of a 48% void ratio by volume are formed among the particles. In a low refractive index layer practically used, the void ratio significantly shifts from the theoretical value due to distribution of the diameters of the particles or the presence of microvoids in the interior of the particles. The refractive index of the low refractive index layer decreases as the void ratio increases. When microvoids are formed by piling particles, the size of the microvoids among the particles can easily be controlled to an appropriate value (a value minimizing scattering light and resulting in no problem in the strength of the low refractive index layer) by controlling the diameter of the particles. Further, by controlling the diameter of the particles to be uniform, an optically uniform low refractive index layer, also featuring the uniform size of microvoids among the particles, can be realized. Herewith, the resulting low refractive index layer is controlled to be optically or macroscopically a uniform layer, though being microscopically a microvoid-containing porous layer. Microvoids among particles are preferably confined in the low refractive index layer by particles and a polymer. The confined voids also exhibit an advantage such that light scattering on the surface of the low refractive index layer is reduced, as compared to unconfined voids.

By forming microvoids, the macroscopic refractive index of the low refractive index layer becomes lower than the sum total of the refractive indexes of the components constituting the low refractive index layer. The refractive index of a layer is the sum total of the refractive indexes per volume of layer constituent elements. The refractive indexes of components such as particles or polymers of the low refractive index lay are larger than 1, while the refractive index of air is 1.00. Therefore, by forming microvoids, a low refractive index layer exhibiting a significantly lower refractive index can be realized.

Further, in the, present invention, an embodiment is also preferable in which hollow particles of SiO₂ are used.

Hollow particles described in the present invention refer to particles which have a particle wall, the interior of which is hollow. Exemplified are particles which are formed in such a manner that the above SiO₂ particles having mocrovoids in the interior of the particles are surface-coated with organic silicon compounds (alkoxysilanes such as tetraethoxysilane) to close their pore inlets. Alternatively, voids in the interior of the wall of the particles may be filled with a solvent or gas. For example, in the case of air, the refractive index of hollow particles can remarkably be lowered (to a refractive index of 1.2 to 1.4), as compared to common silica (refractive index: 1.46). Via addition of such hollow particles of SiO₂, the refractive index of the low refractive index layer can further be lowered.

Preparation methods of allowing particles having microvoids in the above inorganic particles to be hollow may be based on the methods described in Japanese Patent O.P.I. Publication Nos. 2001-167637 and 2001-233611. Commercially available hollow particles of SiO₂ can optionally be used in the present invention. As the commercially available hollow particles, there is mentioned P-4 (produced by JGC Catalists and Chemicals, Ltd.).

The low refractive index layer preferably incorporates a polymer of an amount of 5-50% by weight. The polymer functions to allow particles to adhere and to maintain a structure of the low refractive index layer having voids. The amount of the polymer used is controlled so that the strength of the low refractive index layer may be maintained without filling voids. The amount of the polymer is preferably from 10 to 30% by weight based on the total weight of the low refractive index layer. To achieve adhesion of particles using a polymer, it is preferable that (1) a polymer be allowed to bond to a surface treatment agent for particles; (2) a polymer shell be allowed to form around a fine particle serving as a core; or (3) a polymer be used as a binder among particles. The polymer which is bonded to a surface treatment agent in (1) is preferably a shell polymer of (2) or a binder polymer of (3). The polymer of (2) is preferably formed around particles via polymerization reaction prior to preparation of a low refractive index layer coating liquid. The polymer of (3) is preferably formed in such a manner that a monomer is added to a low refractive index layer coating liquid, followed by polymerization reaction during or after coating of the low refractive index layer. At least two of (1), (2), and (3) or all thereof are preferably employed in appropriate combinations. Of these, performance in combination of (1) and (3) or of (1), (2), and (3) is specifically preferable. Each of (1) Surface Treatment, (2) Shell, and (3) Binder will now sequentially be described.

### (1) Surface Treatment

Particles (specifically, inorganic particles) are preferably subjected to surface treatment to improve affinity with a polymer. The surface treatment is classified into physical surface treatment such as plasma discharge treatment or corona discharge treatment and chemical surface treatment using a coupling agent. The chemical surface treatment is preferably conducted alone, or the physical surface treatment and the chemical surface treatment are also preferably performed in combination. As the coupling agent, an organoalkoxymetal compound (for example, a titanium coupling agent and a silane coupling agent) is preferably used. When particles are composed of SiO₂, surface treatment using a silane coupling agent can specifically effectively be carried out. As specific examples of the silane coupling agent, those described above are preferably used.

Surface treatment using a coupling agent can be carried out in such a manner that a coupling agent is added to a fine particle dispersion and the resulting mixture is allowed to stand at a temperature of room temperature to 60° C. for a period of several hours to 10 days. To facilitate the surface treatment reaction, there may be added, to the dispersion, an inorganic acid (for example, sulfuric acid, hydrochloric acid, nitric acid, chromic acid, hypochloric acid, boric acid, orthosilicic acid, phosphoric acid, and carbonic acid), an organic acid (for example, acetic acid, polyacrylic acid, benzenesulfonic acid, phenol, and polyglutamic acid), or a salt thereof (for example, a metal salt or an ammonium salt).

### (2) Shell

Shell forming polymers are preferably polymers having a saturated hydrocarbon as the main chain. Polymers containing fluorine atoms in the main chain or side chains are preferable, but the polymers containing fluorine atoms in side chains are more preferable. Polyacrylates or polymethacrylates are preferable, but esters of fluorine-substituted alcohols with polyacrylic acid or polymethacrylic acid are most preferable. The refractive index of a shell polymer decreases as the content of fluorine atoms therein increases. To lower the refractive index of a low refractive index layer, a shell polymer contains fluorine atoms of an amount of preferably 35 to 80% by weight, and more preferably an amount of 45 to 75% by weight. A fluorine atom-containing polymer is preferably synthesized via polymerization reaction of a fluorine atom-containing ethylenically unsaturated monomer. Examples of the fluorine atom-containing ethylenically unsaturated monomer include fluoroolefins (for example, fluoroethylene, vinylidene fluoride, tetrafluoroethylene, hexafluoropropylene, perfluoro-2,2-dimethyl-1,3-dioxol), fluorinated vinyl ethers, and esters of fluorine substituted alcohols with acrylic acid or methacrylic acid.

A shell forming polymer may be a copolymer having repeating units with and without fluorine atoms. The repeating unit without fluorine atoms is preferably prepared via polymerization reaction of an ethylenically unsaturated monomer containing no fluorine atoms. Examples of the ethylenically unsaturated monomer containing no fluorine atoms include olefins (for example, ethylene, propylene, isoprene, vinyl chloride, and vinylidene chloride), acrylates (for example, methyl acrylate, ethyl acrylate, and 2-ethylhexyl acrylate), methacrylates (for example, methyl methacrylate, ethyl methacrylate, butyl methacrylate, and ethylene glycol dimethacrylate), styrenes and derivatives thereof (for example, styrene, divinylbenzene, vinyltoluene, and α-methylstyrene), vinyl ethers (for example, methyl vinyl ether), vinyl esters (for example, vinyl acetate, vinyl propionate, and vinyl cinnamate), acrylamides (for example, N-tert-butylacrylamide and N-cyclohexylacrylamide), methacrylamides, and acrylonitriles.

When a binder polymer, described in (3) below, is used in combination, a cross-linkable functional group may be introduced into a shell polymer to allow the shell polymer and the binder polymer to chemically bind together via cross-linking. The shell polymer may be crystalline. When the glass transition point (Tg) of the shell polymer is higher than the temperature during formation of a low refractive index layer, microvoids in the low refractive index layer are easily maintained. Incidentally, when the Tg is higher than the temperature during formation of the low refractive index layer, particles are not fused, whereby the, resulting low refractive index layer may not be formed as a continuous layer (resulting in a decrease in strength). In this case, it is desirable that the low refractive index layer be formed as a continuous layer with a binder polymer, described in (3) below, which is simultaneously used. A polymer shell is formed around the fine particle, resulting in a core/shell fine particle. A core composed of an inorganic fine particle is incorporated in the core/shell fine particle in an amount of preferably 5 to 90% by volume, and more preferably 15 to 80% by volume. At least two types of core/shell particles may simultaneously be used. Further, an inorganic fine particle incorporating no shell and a core/shell particle may be used at the same time.

### (3) Binder

A binder polymer is preferably a polymer having a saturated hydrocarbon or a polyether as the main chain, but is more preferably a polymer having a saturated hydrocarbon as the main chain. The binder polymer is preferably a cross-linked one. The polymer having a saturated hydrocarbon as the main chain is preferably prepared via polymerization reaction of an ethylenically unsaturated monomer. In order to prepare a cross-linked binder polymer, a monomer having at least two ethylenically unsaturated groups is preferably used. Examples of the monomer having at least two ethylenically unsaturated groups include esters of polyhydric alcohols with (meth)acrylic acid (for example, ethylene glycol di(meth)acrylate, 1,4-dicyclohexane diacrylate, pentaerythritol tetra(meth)acrylate, pentaerythritol (meth) acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene and 4-vinylbenzoic acid-2-acryloylethyl ester, and 1,4-divinylcyclohexane); vinylsulfones (for example, divinylsulfone); acrylamides (for example, methylenebisacrylamide); and methacrylamides. A polymer having a polyether as the main chain is preferably synthesized via ring-opening polymerization reaction. A cross-linked structure may be introduced into a binder polymer via reaction of a cross-linkable group instead of or in addition to a monomer having at least two ethylenically unsaturated groups. Examples of the cross-linkable functional group include an isocyanate group, an epoxy group, an aziridine group, an oxazoline group, an aldehyde group, a carbonyl group, a hydrazine group, a carboxyl group, a methylol group, and an active methylene group. As a monomer to introduce a cross-linked structure, there can also be used vinylsulfonic acid, acid anhydrides, cyanoacrylate derivatives, melamine, etherified methylol, esters and urethane. There may be used a functional group such as a block isocyanate group, which exhibits cross-linking properties as a result of decomposition reaction thereof. Further, the cross-linkable group is not limited to the above compounds, including those which become reactive as a result of decomposition of the above functional group. As a polymerization initiator used for polymerization reaction and cross-linking reaction of a binder polymer, a thermal polymerization initiator or a photopolymerization initiator is used, but the photopolymerization initiator is preferable. Examples of the photopolymerization initiator include acetophenones, benzoins, benzophenones, phosphine oxides, ketals, antharaquinones, thioxanthones, azo compounds, peroxides, 2,3-dialkyldione compounds, disulfide compounds, fluoroamine compounds, and aromatic sulfoniums. Examples of the acetophenones include 2,2-diethoxyacetophenone, p-dimethylacetophenone, 1-hydroxydimethyl phenyl ketone, 1-hydroxycyclohexyl phenyl ketone, 2-methyl-4-methylthio-2-morpholinopropiophene, and 2-benzyl-2-dimethylamino-1-(4-morpholinophenyl)-butanone. Examples of the benzoins include benzoin methyl ether, benzoin ethyl ether, and benzoin ethylisopropyl ether. Examples of the benzophenones include benzophenone, 2,4-dichlorobenzophenone, 4,4-dichlorobenzophenone, and p-chlorobenzophenone. Examples of the phosphine oxides include 2,4,6-trimethylbenzoyldiphenyl-phosphine oxide.

The binder polymer is preferably formed in such a manner that a monomer is added to a low refractive index layer coating liquid, followed by polymerization reaction (and further cross-linking reaction, if appropriate) during or after coating of the low refractive index layer. A small amount of a polymer (for example, polyvinyl alcohol, polyoxyethylene, polymethyl methacrylate, polymethyl acrylate, diacetyl cellulose, triacetyl cellulose, nitrocellulose, polyester, and alkyd resins) may be added to the low refractive index layer coating liquid.

Further, a slipping agent is preferably added to the low refractive index layer of the present invention or other refractive index layers. Abrasion resistance can be improved by providing appropriate slipping properties. As a slipping agent, silicone oil or a waxy substance is preferably used. For example, a compound represented by the following formula is preferable.

R₁COR₂ Formula

In the above formula, R₁ represents a saturated or unsaturated aliphatic hydrocarbon group having a carbon atom number of at least 12. An alkyl group or an alkenyl group is preferable, and an alkyl group or an alkenyl group each having a carbon atom number of at least 16 is more preferable. R₂ represents an —OM1 group (M1 represents an alkali metal such as Na or K), an —OH group, an —NH₂ group or an —OR₃ group (R₃ represents a saturated or unsaturated aliphatic hydrocarbon group having a carbon atom number of at least 12, and preferably represents an alkyl group or an alkenyl group). R₂ is preferably an —OH group, an —NH₂ group or an —OR₃ group. Typical examples of the compound include higher fatty acids or derivatives thereof such as behenic acid, stearic acid amide or pentacosanoic acid, and natural products, containing a large amount of these compounds such as carnauba wax, beeswax, or montan wax. Further, there can be exemplified polyorganosiloxane disclosed in Examined Japanese Patent Application Publication No. 53-292; higher fatty acid amides disclosed in U.S. Pat. No. 4,275,146; higher fatty acid esters (esters of a fatty acid having 10 to 24 carbons with alcohol having 10 to 24 carbons) disclosed in Examined Japanese Patent Application Publication No. 58-33541, British Patent No. 927,446 specification, and Japanese Patent O.P.I. Publication Nos. 55-126238 and 58-90633; higher fatty acid metal salts disclosed in U.S. Pat. No. 3,933,516; polyester compounds composed of dicarboxylic acids having at most 10 carbons and aliphatic or alicyclic diols disclosed in Japanese Patent O.P.I. Publication No. 51-37217; and oligopolyesters composed of dicarboxylic acids and diols disclosed in Japanese Patent O.P.I. Publication No. 7-13292.

For example, the amount of a slipping agent used in the low refractive index layer is preferably from 0.01 mg/m² to 10 mg/m².

There maybe added, to each of the layers of an antireflection film or coating liquids therefor, a polymerization inhibitor, a leveling agent, a thickener, an anti-coloring agent, a ultraviolet absorbent, a silane coupling agent, an antistatic agent, or an adhesion providing agent, in addition to a metal oxide particle, a polymer, a dispersion medium, a polymerization initiator, or a polymerization accelerator.

Each of the layers of the antireflection film can be formed via a coating method such as a dip coating method, an air-knife coating method, a curtain coating method, a roller coating method, a wire bar coating method, a gravure coating method, an ink-jet method, or an extrusion coating method (U.S. Pat. No. 2,681,294). At least two layers may be simultaneously coated. Simultaneous coating methods are described in U.S. Pat. Nos. 2,761,791, 2,941,898, 3,508,947, and 3,526,528; and Yuji Harazaki, Coating Kogaku (Coating Engineering), page 253, Asakura Shoten (1973).

In the present invention, in the production of an antireflection film, drying is carried out preferably at 60° C. or higher, more preferably at 80° C. or higher, after coating of the above-prepared coating liquid on a support. Further, drying is conducted preferably at a dew point of 20° C. or lower, more preferably at a dew point of 15° C. or lower. Drying is preferably initiated within 10 seconds after the support is coated. A combination of the above conditions results in a preferable production method to achieve the effects of the present invention.

The cellulose ester optical film of the present invention is preferably used as a polarizing plate protective film, an antireflection film, a hard coat film, an antiglare film, a retardation film, an optical compensation film, an antistatic film or a luminance enhancing film as described above.

### Examples

The present invention will be specifically explained below with referring to examples, however, the present invention is not limited thereto. In these examples, “part(s)” or “%” represent “mass part(s)” or “% by mass”, respectively, unless otherwise specified.

### Example 1

The synthesis examples of ultraviolet absorbing polymers according to the present invention will be described below.

### Synthesis Example 1

First, 2(2′-hydroxy-5′-methyl-phenyl)-5-methacryloylamino-2H-benzotriazole (exemplified compound UVM-2) was synthesized according to the method described below.

First, 30.7 g of 2-amino-p-cresol was dissolved in 250 ml of water, and 83 ml of concentrated hydrochloric acid was added. After adding, at 0° C., 17.2 g of sodium nitrite dissolved in 35 ml of water to this solution, the resulting solution was added into 500 ml of aqueous solution containing 36.1 g of m-phenylenediamine hydrochloride at 0° C. After dropwise adding, while keeping the resultant solution at 0° C., an aqueous solution formed by dissolving 170 g of sodium acetate in 250 ml of water, the solution was stirred at 5° C. for 2 hours, followed by further stirring for 2 hours at an ambient temperature. The pH of the solution was adjusted at 8 using aqua ammonia, and the precipitate was filtered, followed by washing well by water.

Into 300 ml of methanol, 48.4 g of the filtered precipitate was dissolved, and the solution was added with a solution in which 150 g of copper sulfate pentahydrate was dissolved in a mixture of 360 ml of water and 600 ml of aqua ammonia, followed by stirring at 95° C. for 2 hours. After cooling, the precipitate was filtered, and rinsed until the filtrate became transparent. The filtered precipitate was stirred for 1 hour in 500 ml of 5 mol/L hydrochloric acid aqueous solution, filtered, dissolved again in 200 ml of water, and the pH of the solution was adjusted to 8 using aqua-ammonia. The precipitate was filtered, washed with water, dried and then recrystallized in ethylacetate, whereby 2(2′-hydroxy-5′-methyl-phenyl)-5-amino-2H-benzotriazole was obtained.

Into a solution obtained by dissolving 12.0 g of 2(2′-hydroxy-5′-methyl-phenyl)-5-amino-2H-benzotriazole and 0.1 g of hydroquinone in 110 ml of tetrahydrofuran at 70° C., 6.3 g of sodium hydrogencarbonate was added. Into this solution, methacrylic acid chloride dissolved in 10 ml of tetrahydrofuran was added in drops over 30 minutes at 60° C. The resulting solution was poured into water, the deposited precipitate was filtered, rinsed with water, and dried. The obtained precipitate was recrystallized in ethyleneglycol monomethyl ether to obtain 2(2′-hydroxy-5′-methyl-phenyl)-5-methacryloyl-amino-2H-benzotriazole which is exemplified compound UVM-2.

Next, copolymer (UVP-4) of exemplified compound MOL-2 and exemplified compound UVM-2 was synthesized according to the method shown below.

Into 100 ml of toluene, 6.3 g of exemplified compound UVM-2 and 3.7 g of exemplified compound MOL-2 were added, and subsequently 0.1 g of azoisobutyronitrile was added. Then, the mixture was heated to 80° C. under a nitrogen atmosphere to react for 5 hours. After 70 ml of toluene was distilled away under a reduced pressure, the product was dropped into large excess of methanol. The deposited precipitate was filtered and dried at 40° C. under vacuum, whereby 5.5 g of copolymer (UVP-4) was obtained. The weight average molecular weight of the obtained copolymer was determined to be 27000 by a GPC analysis on the basis of standard polystyrene. The Mw/Mn value was 2.4. The ratio of low molecular weight component of less than 1000 was 0.8% by mass. The maximum absorption wavelength λmax determined by spectral absorption measurement was 353 nm.

Based on a NMR spectrum and a spectral absorption measurement, the above copolymer was confirmed to be a copolymer of exemplified compound MOL-2 and exemplified compound UVM-2. The composition ratio (mass ratio) of the above copolymer was about MOL-2:UVM-2:methyl methacrylate=63:37.

### Synthesis Example 2

First, 2(2′-hydroxy-5′-t-butyl-phenyl)-5-carboxylic acid-(2-methacryloyloxy)ethyl ester-2H-benzotriazole (exemplified compound UVM-14) was synthesized according to the method described below.

First, 20.0 g of 3-nitro-4-aminobenzoic acid was dissolved in 160 ml of water, and 43 ml of concentrated hydrochloric acid was added. After adding, at 0° C., 8.0 g of sodium nitrite dissolved in 20 ml of water to this solution, the resulting solution was stirred for 2 hours while keeping 0° C. Into this solution, a solution obtained by dissolving 17.3 g of 4-t-butylphenol in 50 ml of water and 100 ml of ethanol was added in drops at 0° C., while the alkalinity of the solution was kept by using potassium carbonate. The obtained solution was stirred at 0° C. for 1 hour, followed by further stirring for 1 hour at an ambient temperature. The solution was acidized using hydrochloric acid, and formed precipitate was filtered and washed well with water.

The filtered precipitate was dissolved in 500 ml of 1 mol/L NaOH aqueous solution, 35 g of zinc powder was added and 110 g of 40% NaOH aqueous solution was added in drops. After added, the solution was stirred for 2 hours, filtered, washed with water, and the filtrate was neutralized with hydrochloric acid. The obtained precipitate was filtered, washed with water, dried and then recrystallized in a mixed solvent of ethylacetate and acetone, whereby 2(2′-hydroxy-5′-t-butyl-phenyl)-5-carboxylic acid-2H-benzotriazole was obtained.

Into 100 ml of toluene, 10.0 g of 2(2′-hydroxy-5′-t-butyl-phenyl)-5-carboxylic acid-2H-benzotriazole, 0.1 g of hydroquinone, 4.6 g of 2-hydroxyethyl methacrylate and 0.5 g of p-toluenesulfonic acid were added, and the mixture was heat reflexes in a reaction vessel equipped with an ester tube for 10 hours. The resulting solution was poured into water, the deposited precipitate was filtered, rinsed, and dried. The obtained precipitate was recrystallized in ethylacetate to obtain 2(2′-hydroxy-5′-t-butyl-phenyl)-5-carboxylic acid-(2-methacryloyloxy)ethyl ester-2H-benzotriazole which is exemplified compound UVM-14.

Next, copolymer (UVP-1) of exemplified compound MOL-1 and exemplified compound UVM-14 was synthesized according to the method shown below.

Into 100 ml of toluene, 6.5 g of exemplified compound MOL-1 and 3.5 g of exemplified compound UVM-14 were added, and subsequently 0.1 g of dilauroyl peroxide was added. Then, the mixture was heated to 85° C. under a nitrogen atmosphere to react for 5 hours. After 70 ml of toluene was distilled away under a reduced pressure, the product was dropped into large excess of methanol. The deposited precipitate was filtered and dried at 40° C. under vacuum, whereby 7.3 g of copolymer (UVP-2) was obtained. The weight average molecular weight of the obtained copolymer was determined to be 18000 by a GPC analysis on the basis of standard polystyrene. The Mw/Mn value was 1.9. The ratio of low molecular weight component of less than 1000 was 0.8% by mass. The maximum absorption wavelength λmax determined by spectral absorption measurement was 353 nm.

Based on a NMR spectrum and a spectral absorption measurement, the above copolymer was confirmed to be a copolymer of exemplified compound MOL-1 and exemplified compound UVM-14. The composition ratio (mass ratio) of the above copolymer was about MOL-1:UVM-14=65:35.

### Synthesis Example 3

First, 2(2′-hydroxy-5′-t-butyl-phenyl)-5-carboxylic acid-(2-acryloyloxy)ethyl ester-2H-benzotriazole (exemplified compound UVM-44) was synthesized according to the method described below.

First, 20.0 g of 3-nitro-4-aminobenzoic acid was dissolved in 160 ml of water, and 43 ml of concentrated hydrochloric acid was added. After adding, at 0° C., 8.0 g of sodium nitrite dissolved in 20 ml of water to this solution, the resulting solution was stirred for 2 hours while keeping 0° C. Into this solution, a solution obtained by dissolving 17.3 g of 4-t-butylphenol in 50 ml of water and 100 ml of ethanol was added in drops at 50° C., while the alkalinity of the solution was kept by using potassium carbonate. The obtained solution was stirred at 0° C. for 1 hour, followed by further stirring for 1 hour at an ambient temperature. The solution was acidized using hydrochloric acid, and formed precipitate was filtered and washed well with water.

The filtered precipitate was dissolved in 500 ml of 1 mol/L NaOH aqueous solution, 35 g of zinc powder was added and 110 g of 40% NaOH aqueous solution was added in drops. After added, the solution was stirred for 2 hours, filtered, washed with water, and the filtrate was neutralized with hydrochloric acid. The obtained precipitate was filtered, washed with water, dried and then recrystallized in ethylacetate, whereby 2(2′-hydroxy-5′-t-butyl-phenyl)-5-carboxylic acid -2H-benzotriazole was obtained.

Into 100 ml of toluene, 10.0 g of 2(2′-hydroxy-5′-t-butyl-phenyl)-5-carboxylic acid-2H-benzotriazole, 0.1 g of hydroquinone, 4.1 g of 2-hydroxyethyl ethacrylate and 0.5 g of p-toluenesulfonic acid were added, and the mixture was heat reflexes in a reaction vessel equipped with an ester tube for 10 hours. The resulting solution was poured into water, the deposited precipitate was filtered, rinsed with water, and dried. The obtained precipitate was recrystallized in ethylacetate to obtain 2(2′-hydroxy-5′-t-butyl-phenyl)-5-carboxylic acid-(2-acryloyloxy)ethyl ester-2H-benzotriazole which is exemplified compound UVM-44.

Next, copolymer (UVP-2) of exemplified compound MOL-1 and exemplified compound UVM-44 was synthesized according to the method shown below.

Into 100 ml of toluene, 5.0 g of exemplified compound MOL-1, 3.0 g of exemplified compound UVM-44 and 2.0 g of methyl methacrylate were added, and subsequently 0.1 g of azoisobutyronitrile was added. Then, the mixture was heated to 80° C. under a nitrogen atmosphere to react for 3 hours. After 70 ml of toluene was distilled away under a reduced pressure, the product was dropped into large excess of methanol. The deposited precipitate was filtered and dried at 40° C. under vacuum, whereby 7.8 g of copolymer (UVP-5) was obtained. The weight average molecular weight of the obtained copolymer was determined to be 21000 by a GPC analysis on the basis of standard polystyrene. The Mw/Mn value was 2.3. The ratio of low molecular weight component of less than 1000 was 0.9% by mass. The maximum absorption wavelength λmax determined by spectral absorption measurement was 353 nm.

Based on a NMR spectrum and a spectral absorption measurement, the above copolymer was confirmed to be a copolymer of exemplified compound MOL-1, exemplified compound UVM-44 and methyl methacrylate. The composition ratio (mass ratio) of the above copolymer was about MOL-1:UVM-44:methyl methacrylate=50:30:20.

### Synthetic Example 4

Copolymer (UVP-3) of exemplified compound MOL-1, exemplified compound UVM-44, methyl methacrylate and exemplified compound UVM-81 was synthesized according to the method shown below.

Into 100 ml of toluene, 4.5 g of exemplified compound MOL-1, 3.0 g of exemplified compound UVM-44, 2.0 g of methyl methacrylate and 0.5 g of exemplified compound UVM-44 were added, and subsequently 0.1 g of dilauroyl peroxide was added. Then, the mixture was heated to 85° C. under a nitrogen atmosphere to react for 3 hours. After 70 ml of toluene was distilled away under a reduced pressure, the product was dropped into large excess of methanol. The deposited precipitate was filtered and dried at 40° C. under vacuum, whereby 7.2 g of copolymer (UVP-3) was obtained. The weight average molecular weight of the obtained copolymer was determined to be 17000 by a GPC analysis on the basis of standard polystyrene. The Mw/Mn value was 2.0. The ratio of low molecular weight component of less than 1000 was 0.9% by mass. The maximum absorption wavelength λmax determined by spectral absorption measurement was 350 nm.

Based on a NMR spectrum and a spectral absorption measurement, the above copolymer was confirmed to be a copolymer of exemplified compound MOL-1, exemplified compound UVM-44, methyl methacrylate and exemplified compound UVM-81. The composition ratio (mass ratio) of the above copolymer was about MOL-1:UVM-44:methyl methacrylate:UVM-81=45:30:20:5.

Further, ultraviolet absorbing polymers of the present invention UVP 5-30 having constituting monomers and composition ratios listed in Table 1 were synthesized in similar manners as Synthesis examples 1-4. Also, comparative ultraviolet absorbing polymers UVP 31-34 having constituting monomers and composition ratios listed in Table 1 were synthesized. UVP-35 was synthesized with reference to the method disclosed in JP-A No. 6-73367. The weight average molecular weight Mw, maximum absorption wavelength λmax and composition ratio (mass ratio) of the synthesized polymer were determined according to the methods described in Synthesis example 1.

TABLE 1

| Ultraviolet | | | | | Weight average | | |
|---|---|---|---|---|---|---|---|
| absorbing | Constituting monomer | | | | molecular weight | λmax | |
| polymer | Composition ratio (mass ratio) | | | | (Mw) | (nm) | Remarks |
| UVP-1 | MOL-1 (65) | UVM-14 (35) | — | — | 18000 | 353 | Inventive |
| UVP-2 | MOL-1 (50) | UVM-44 (30) | MMA (20) | — | 21000 | 353 | Inventive |
| UVP-3 | MOL-1 (45) | UVM-44 (30) | MMA (20) | UVM-81 (5) | 17000 | 350 | Inventive |
| UVP-4 | MOL-2 (63) | UVM-2 (37) | — | — | 27000 | 353 | Inventive |
| UVP-5 | MOL-3 (50) | UVM-51 (10) | MA (40) | — | 35000 | 348 | Inventive |
| UVP-6 | MOL-4 (45) | UVM-14 (30) | MMA (20) | UVM-52 (5) | 46000 | 352 | Inventive |
| UVP-7 | MOL-5 (95) | UVM-61 (5) | — | — | 58000 | 340 | Inventive |
| UVP-8 | MOL-7 (60) | UVM-28 (30) | HEMA (10) | — | 68000 | 353 | Inventive |
| UVP-9 | MOL-7 (70) | UVM-63 (20) | HEA (5) | UVM-62 (5) | 70000 | 341 | Inventive |
| UVP-10 | MOL-9 (65) | UVM-34 (35) | — | — | 42000 | 352 | Inventive |
| UVP-11 | MOL-9 (70) | UVM-64 (10) | ST (20) | — | 38000 | 340 | Inventive |
| UVP-12 | MOL-10 (40) | UVM-38 (40) | VAC (10) | UVM-69 (10) | 40000 | 353 | Inventive |
| UVP-13 | MOL-11 (70) | UVM-68 (30) | — | — | 12000 | 345 | Inventive |
| UVP-14 | MOL-13 (60) | UVM-39 (30) | MMA (10) | — | 5000 | 353 | Inventive |
| UVP-15 | MOL-14 (50) | UVM-70 (25) | MMA (10) | UVM-77 (15) | 3000 | 351 | Inventive |
| UVP-16 | MOL-18 (60) | UVM-10 (40) | — | — | 22000 | 350 | Inventive |
| UVP-17 | MOL-20 (50) | UVM-72 (30) | MA (20) | — | 25000 | 340 | Inventive |
| UVP-18 | MOL-21 (50) | UVM-19 (10) | MMA (20) | UVM-60 (20) | 31000 | 350 | Inventive |
| UVP-19 | MOL-24 (80) | UVM-74 (20) | — | — | 16000 | 343 | Inventive |
| UVP-20 | MOL-1 (68) | UVM-44 (12) | MA (10) | UVM-81 (10) | 23000 | 352 | Inventive |
| UVP-21 | MOL-1 (40) | UVM-81 (20) | MMA (30) | UVM-95 (10) | 37000 | 340 | Inventive |
| UVP-22 | MOL-1 (50) | UVM-44 (1) | MMA (47) | UVM-49 (1) | 15000 | 353 | Inventive |
| UVP-23 | MOL-1 (45) | UVM-44 (30) | MMA (20) | UVM-81 (5) | 20000 | 353 | Inventive |
| UVP-24 | MOL-1 (50) | UVM-44 (30) | MMA (10) | UVM-81 (10) | 72000 | 351 | Inventive |
| UVP-25 | MOL-1 (67) | UVM-44 (15) | MMA (13) | UVM-81 (5) | 19000 | 353 | Inventive |
| UVP-26 | MOL-1 (45) | UVM-44 (25) | MMA (20) | UVM-81 (10) | 15000 | 351 | Inventive |
| UVP-27 | MOL-1 (50) | UVM-44 (25) | MA (20) | UVM-81 (5) | 75000 | 353 | Inventive |
| UVP-28 | MOL-1 (45) | UVM-31 (25) | MMA (25) | UVM-81 (5) | 22000 | 353 | Inventive |
| UVP-29 | MOL-1 (50) | UVM-32 (20) | MMA (20) | UVM-81 (10) | 18000 | 351 | Inventive |
| UVP-30 | MOL-1 (70) | UVM-49 (20) | MMA (5) | UVM-81 (5) | 32000 | 353 | Inventive |
| UVP-31 | — | UVM-44 (100) | — | — | 25000 | 353 | Comparative |
| UVP-32 | — | UVM-14 (40) | MMA (60) | — | 9000 | 353 | Comparative |
| UVP-33 | — | UVM-44 (20) | MMA (70) | UVM-81 (10) | 15000 | 352 | Comparative |
| UVP-34 | — | UVM-44 (30) | MMA (20) | VP (50) | 45000 | 353 | Comparative |
| UVP-35 | — | UVM-14 (40) | MMA (50) | HEMA (10) | 9000 | 353 | Comparative |
| UVP-36 | — | UVM-81 (30) | MMA (70) | — | 9500 | 353 | Comparative |

MMA: Methyl methacrylate, MA: Methyl acrylate, HEMA: 2-hydroxyethyl methacrylate HEA: 2-hydroxyethyl acrylate, ST: Styrene VAC: Vinyl acetate, VP: N-vinyl-2-pyrrolidone

### Example 2

### [Preparation of Cellulose Ester Optical Film]

### <Example of Synthesis 1>

As cellulose ester CE-1, 100 parts by mass of cellulose acetate propionate (an acetyl substitution degree=1.41, a propionyl substitution degree=1.32, the total substitution degree=2.73, weight average molecular weight=200,000 (in terms of polystyrene), a degree of distribution=2.3), 8.0 parts by mass of KA-61 described above as a plasticizer, 0.25 part by mass of 1-16 described above (as a marketed product, Sumilizer GS, produced by Sumitomo Chemicals Co., Ltd.) as a carbon radical scavenger, 0.5 part by mass of pentaerythritol tetrakis[3-(3,5-di-tert-butyl-4-hydroxyphenyl)propionate] (as a marketed product, Irganox 1010 produced by Ciba Specialty Chemicals Co., Ltd.) as a phenol compound P-1, 0.25 part by mass of tetrakis(2,4-di-tert-butyl-5-methylphenyl)-4,4′-biphenylene diphosphonite (as a marketed product, GSY-P101 produced by Sakai Kagaku Kogyo Co., Ltd) as a phosphorus-containing compound, 1.5 mass parts of UVP-3 described above as an ultraviolet absorbing polymer, 0.7 mass part of following UV-1 as an ultraviolet absorber, and 0.3 parts by mass of minute particles of silica having a primary average particle diameter of 16 μm (as a marketed product, AEROSIL R972V produced by Nippon Aerosil Co., Ltd.) were mixed and dried under reduced pressure at a temperature of 60° C. for 5 hours. This cellulose acylate composition was melted and mixed at 235° C. using a twin screw extruder to form pellets, where, in order to reduce heat generation due to shearing at the time of kneading, an all-screw type screw was utilized without using a kneading disk. Further, vacuum suction was carried out through a vent hole, and volatile components generated during kneading were removed by the vacuum pumping. To avoid absorption of moisture by the resin, a dry nitrogen atmosphere was provided to the feeder to feed the extrude, hopper and the space between the extruder die and the cooling section.

Film formation was carried out using a film production apparatus illustrated in FIG. 1.

The first cooling roll and second cooling roll were made of stainless steel having a diameter of 40 cm, and the surface was subjected to hard chromium plating. A temperature adjusting oil was circulated inside the roll to control the roll surface temperature. The elastic touch roll had a diameter of 20 cm and the inner sleeve and outer sleeve were made of stainless steel. The surface of the outer sleeve was subjected to hard chromium plating. The outer sleeve had a wall thickness of 2 mm, and a temperature adjusting oil was circulated in the space between the inner sleeve and outer sleeve, whereby the surface temperature of the elastic touch roll was controlled.

Using a single screw extruder, the resulting pellets (moisture content: 50 ppm) were melt-extruded in the form of a film at a melting temperature of 250° C. from the T-die onto the first cooling roll having a surface temperature of 130° C. at a draw ratio of 20, whereby a cast film was produced. In this case, the T-die used had a lip clearance of 1.5 mm and an average surface roughness of Ra 0.01 μm at a lip section. Herein, the draw ratio is a value obtained by dividing the lip clearance of the die by an average thickness of the film cast and solidified.

Further, the film was pressed on the first cooling roll at a linear pressure of 10 kg/cm through an elastic touch roll having a 2 mm thick metal surface. The temperature of the film on the side of the touch roll at the time of pressing was 180° C. ±1° C. (The temperature of the film on the touch roll side at the time of pressing herein refers to an average of the film surface temperatures of the film at the position where the touch roll is in contact with the first roll (cooling roll), wherein the touch roll is retracted so that it is not in contact with the cooling roll, and then the film surface temperatures were measured at 10 points of the film across the width at a position 50 cm distant from the film surface through a non-contact thermometer.) The glass transition temperature Tg of this film was 136° C. (The glass transition temperature of the film extruded by the die was measured according to a DSC method (at a temperature rise of 10° C./ minute in nitrogen atmosphere) using the DSC6200 produced by Seiko Co., Ltd.

The surface temperature of the elastic touch roll was 130° C., and the surface temperature of the second cooling roll was 100° C. The surface temperature of each of the elastic touch roll, the first cooling roll and second cooling roll were obtained as follows: The temperatures of the roll surface 90 degrees before in the direction of rotation from the position wherein the film contacts the roll for the first time were measured at ten points along the width using a non-contact thermometer, and the average of these measurements was used as the surface temperature of each roll.

The obtained film was heated at 160° C., stretched in the mechanical direction by a magnification of 1.05 through roll stretching, and introduced into a tenter having a preheating zone, a stretching zone, a retaining zone, and a cooling zone (as well as a neutral zone to ensure heat insulation between the zones), and stretched in the transverse direction by a magnification of 1.20 at 160° C. After that, the film was loosened 2% in the transverse direction and the temperature was reduced to 70° C. Then the film was released from the clip and the clip holding section was trimmed off. Both ends of the film were knurled to a width of 10 mm and a height of 5 μm. The resulting film was slit to a width of 1430 mm. Thus, a cellulose ester optical film F-1 with a thickness of 80 μm, which an Ro of 3 nm and an Rt of 50 nm, was prepared. In this case, the preheating temperature and retaining temperature were adjusted to avoid bowing resulting from stretching.

Cellulose ester optical films F-2 through F-47 were produced in the same manner as above, except that compounds or production conditions shown in Tables 2 and 3 were applied.

The used compounds and the production conditions will be detailed below.

TABLE 2

| | | Ultraviolet | | Carbon | | | | Phosphorus- | | | | Ultra- | | | | | Stretch- | | |
|---|---|---|---|---|---|---|---|---|---|---|---|---|---|---|---|---|---|---|---|
| Sam- | | absorbing | | radical | | Phenol | | containing | | Plas- | | violet | | Minute | | | ing | | |
| ple | | polymer | | scavenger | | compound | | compound | | ticizer | | absorber | | particles. | | | condition | | Re- |
| No. | *1 | Kind | *2 | Kind | *2 | Kind | *2 | Kind | *2 | Kind | *2 | Kind | *2 | Kind | *2 | *3 | *4 | *5 | marks |
| F-1 | CE-1 | UVP-3 | 1.50 | I-16 | 0.25 | P-1 | 0.50 | PN-1 | 0.25 | KA-61 | 8.00 | UV-1 | 0.70 | M-1 | 0.30 | 250 | 1.05 | 1.20 | Inv. |
| F-2 | CE-1 | UVP-4 | 1.50 | — | — | P-1 | 1.00 | — | — | KA-48 | 8.00 | — | — | M-1 | 0.30 | 250 | 1.00 | 1.20 | Inv. |
| F-3 | CE-1 | UVP-1 | 1.50 | — | — | P-1 | 0.50 | PN-2 | 0.25 | KA-61 | 8.00 | UV-2 | 1.50 | M-1 | 0.30 | 240 | 1.05 | 1.20 | Inv. |
| F-4 | CE-1 | UVP-5 | 2.50 | — | — | P-1 | 1.00 | PN-1 | 0.70 | KA-61 | 8.00 | — | — | M-1 | 0.30 | 250 | 1.30 | 1.50 | Inv. |
| F-5 | CE-1 | UVP-2 | 1.50 | I-16 | 1.10 | P-1 | 0.25 | PN-1 | 0.25 | KA-61 | 8.00 | — | — | M-2 | 0.30 | 250 | 1.00 | 1.20 | Inv. |
| F-6 | CE-2 | UVP-6 | 1.50 | I-16 | 0.25 | P-1 | 0.50 | PN-1 | 0.25 | KA-61 | 8.00 | UV-1 | 0.70 | M-1 | 0.30 | 250 | 1.10 | 1.20 | Inv. |
| F-7 | CE-2 | UVP-7 | 3.50 | I-16 | 0.25 | P-1 | 0.25 | PN-1 | 1.20 | KA-61 | 8.00 | — | — | M-2 | 0.30 | 250 | 1.10 | 1.20 | Inv. |
| F-8 | CE-2 | UVP-8 | 1.50 | 108 | 0.20 | P-1 | 0.50 | PN-2 | 0.30 | KA-1 | 8.00 | UV-1 | 0.70 | M-3 | 0.10 | 250 | 1.00 | 1.10 | Inv. |
| F-9 | CE-2 | UVP-9 | 2.00 | 108 | 0.25 | P-4 | 1.80 | — | — | KA-48 | 12.00 | — | — | M-1 | 0.10 | 250 | 1.20 | 1.60 | Inv. |
| F-10 | CE-2 | UVP-10 | 1.50 | 108 | 0.30 | — | — | PN-4 | 0.80 | KA-61 | 8.00 | — | — | M-1 | 0.30 | 250 | 1.10 | 1.20 | Inv. |
| F-11 | CE-3 | UVP-11 | 2.50 | — | — | P-3 | 0.50 | — | — | KA-1 | 8.00 | — | — | M-2 | 0.30 | 250 | 1.05 | 1.20 | Inv. |
| F-12 | CE-3 | UVP-12 | 1.00 | I-16 | 0.50 | P-4 | 0.10 | PN-1 | 0.50 | KA-48 | 12.00 | — | — | M-3 | 0.10 | 250 | 1.10 | 1.10 | Inv. |
| F-13 | CE-3 | UVP-13 | 1.50 | — | — | P-1 | 1.70 | PN-6 | 0.25 | KA-61 | 8.00 | — | — | M-1 | 0.30 | 240 | 1.25 | 1.45 | Inv. |
| F-14 | CE-3 | UVP-14 | 1.50 | I-1 | 0.20 | P-4 | 0.50 | PH-1 | 0.25 | KA-61 | 8.00 | — | — | M-1 | 0.30 | 240 | 1.00 | 1.05 | Inv. |
| F-15 | CE-3 | UVP-15 | 2.50 | I-16 | 0.25 | P-1 | 0.50 | PN-1 | 0.25 | KA-61 | 8.00 | — | — | M-1 | 0.30 | 250 | 1.00 | 1.05 | Inv. |
| F-16 | CE-4 | UVP-16 | 1.00 | — | — | — | — | PN-1 | 0.25 | KA-61 | 8.00 | — | — | M-3 | 0.10 | 230 | 1.05 | 1.20 | Inv. |
| F-17 | CE-4 | UVP-17 | 1.50 | 108 | 0.25 | P-4 | 0.50 | PN-2 | 0.25 | KA-48 | 8.00 | — | — | M-3 | 0.10 | 250 | 1.05 | 1.25 | Inv. |
| F-18 | CE-4 | UVP-18 | 3.00 | I-16 | 0.25 | P-1 | 0.50 | PN-1 | 0.25 | KA-61 | 8.00 | — | — | M-1 | 0.30 | 250 | 1.05 | 1.20 | Inv. |
| F-19 | CE-4 | UVP-19 | 2.00 | — | — | P-1 | 0.50 | PN-1 | 0.90 | KA-61 | 12.00 | — | — | M-2 | 0.30 | 250 | 1.30 | 1.50 | Inv. |
| F-20 | CE-4 | UVP-20 | 2.50 | I-16 | 0.25 | P-1 | 0.25 | PN-1 | 1.20 | KA-61 | 8.00 | — | — | M-1 | 0.30 | 250 | 1.00 | 1.20 | Inv. |
| F-21 | CE-5 | UVP-21 | 2.00 | I-16 | 0.25 | — | — | — | — | KA-61 | 8.00 | — | — | M-1 | 0.30 | 250 | 1.05 | 1.15 | Inv. |
| F-22 | CE-5 | UVP-22 | 3.00 | I-16 | 0.25 | — | — | PN-3 | 0.50 | KA-48 | 8.00 | — | — | M-2 | 0.30 | 250 | 1.10 | 1.20 | Inv. |
| F-23 | CE-5 | UVP-24 | 1.50 | 108 | 0.25 | P-3 | 0.50 | — | — | KA-1 | 8.00 | UV-2 | 1.50 | M-3 | 0.20 | 250 | 1.40 | 1.50 | Inv. |
| F-24 | CE-5 | UVP-23 | 1.50 | 108 | 0.35 | P-1 | 2.20 | PN-1 | 0.25 | KA-61 | 8.00 | — | — | M-1 | 0.30 | 250 | 1.10 | 1.20 | Inv. |

*1: Cellulose ester,
*2: Adding amount,
*3: Melting temperature (° C.),
*4: MD (Times)
*5: TD (Times), Adding amount is represented by pass part in 100 mass parts of cellulose ester
Inv.: Inventive

TABLE 3

| | | Ultraviolet | | Carbon | | | | Phosphorus- | | | | Ultra- | | | | | Stretch- | | |
|---|---|---|---|---|---|---|---|---|---|---|---|---|---|---|---|---|---|---|---|
| Sam- | | absorbing | | radical | | Phenol | | containing | | Plas- | | violet | | Minute | | | ing | | |
| ple | | polymer | | scavenger | | compound | | compound | | ticizer | | absorber | | particles | | | condition | | Re- |
| No. | *1 | Kind | *2 | Kind | *2 | Kind | *2 | Kind | *2 | Kind | *2 | Kind | *2 | Kind | *2 | *3 | *4 | *5 | marks |
| F-25 | CE-5 | UVP-25 | 2.00 | I-1 | 0.25 | P-1 | 0.50 | PN-2 | 0.25 | KA-61 | 8.00 | — | — | M-1 | 0.30 | 250 | 1.00 | 1.05 | Inv. |
| F-26 | CE-6 | UVP-29 | 1.50 | — | — | — | — | PN-5 | 0.25 | KA-48 | 8.00 | — | — | M-1 | 0.30 | 250 | 1.10 | 1.15 | Inv. |
| F-27 | CE-6 | UVP-27 | 1.50 | I-16 | 0.25 | P-1 | 0.50 | PN-5 | 0.25 | KA-61 | 8.00 | — | — | M-1 | 0.30 | 250 | 1.05 | 1.20 | Inv. |
| F-28 | CE-6 | UVP-28 | 1.50 | 108 | 0.25 | — | — | — | — | KA-61 | 8.00 | UV-1 | 0.70 | M-2 | 0.30 | 250 | 1.25 | 1.45 | Inv. |
| F-29 | CE-6 | UVP-26 | 1.50 | 108 | 1.10 | P-1 | 0.25 | PN-1 | 1.20 | KA-61 | 8.00 | — | — | M-1 | 0.30 | 250 | 1.05 | 1.20 | Inv. |
| F-30 | CE-6 | UVP-30 | 1.50 | I-1 | 0.25 | P-1 | 0.50 | PN-4 | 0.25 | KA-61 | 8.00 | — | — | M-3 | 0.10 | 250 | 1.10 | 1.15 | Inv. |
| F-31 | CE-7 | UVP-2 | 1.50 | — | — | P-1 | 0.50 | — | — | KA-61 | 8.00 | — | — | M-1 | 0.30 | 230 | 1.10 | 1.20 | Inv. |
| F-32 | CE-7 | UVP-3 | 1.50 | — | — | P-4 | 0.50 | PN-1 | 0.25 | KA-48 | 8.00 | — | — | M-1 | 0.30 | 260 | 1.40 | 1.60 | Inv. |
| F-33 | CE-7 | UVP-23 | 1.50 | I-16 | 0.30 | P-1 | 2.20 | PN-1 | 0.25 | KA-61 | 8.00 | — | — | M-3 | 0.10 | 250 | 1.10 | 1.15 | Inv. |
| F-34 | CE-7 | UVP-4 | 1.50 | 108 | 0.25 | P-1 | 0.50 | PH-1 | 0.25 | KA-61 | 8.00 | — | — | M-2 | 0.30 | 250 | 1.00 | 1.10 | Inv. |
| F-35 | CE-7 | UVP-5 | 1.50 | 108 | 0.25 | P-1 | 0.50 | PH-2 | 0.25 | KA-61 | 8.00 | — | — | M-1 | 0.30 | 250 | 1.05 | 1.15 | Inv. |
| F-36 | CE-1 | UVP-3 | 1.50 | — | — | — | — | — | — | KA-61 | 8.00 | — | — | M-1 | 0.30 | 240 | 1.05 | 1.20 | Inv. |
| F-37 | CE-1 | UVP-23 | 1.50 | — | — | — | — | — | — | KA-61 | 8.00 | — | — | M-1 | 0.30 | 240 | 1.05 | 1.20 | Inv. |
| F-38 | CE-2 | UVP-26 | 1.50 | — | — | — | — | — | — | KA-61 | 8.00 | — | — | M-2 | 0.30 | 240 | 1.10 | 1.20 | Inv. |
| F-39 | CE-3 | UVP-31 | 0.50 | — | — | — | — | — | — | KA-61 | 8.00 | — | — | M-1 | 0.30 | 250 | 1.00 | 1.05 | Comp. |
| F-40 | CE-2 | UVP-32 | 1.50 | — | — | P-1 | 0.20 | — | — | KA-48 | 10.00 | — | — | M-3 | 0.10 | 250 | 1.10 | 1.10 | Comp. |
| F-41 | CE-1 | UVP-33 | 1.50 | I-16 | 0.25 | P-1 | 0.50 | PN-1 | 0.25 | KA-61 | 8.00 | — | — | M-1 | 0.30 | 250 | 1.05 | 1.20 | Comp. |
| F-42 | CE-1 | UVP-34 | 1.50 | | | P-1 | 1.00 | — | — | KA-61 | 8.00 | — | — | M-1 | 0.30 | 250 | 1.00 | 1.20 | Comp. |
| F-43 | CE-3 | UVP-35 | 2.50 | — | — | P-1 | 1.70 | PN-6 | 0.25 | KA-61 | 8.00 | — | — | M-1 | 0.30 | 250 | 1.05 | 1.20 | Comp. |
| F-44 | CE-2 | UVP-36 | 1.50 | — | — | P-1 | 0.20 | — | — | KA-61 | 10.00 | — | — | — | — | 250 | 1.05 | 1.20 | Comp. |
| F-45 | CE-2 | UVP-37 | 1.50 | — | — | P-1 | 0.20 | — | — | KA-61 | 10.00 | — | — | — | — | 250 | 1.05 | 1.20 | Comp. |
| F-46 | CE-3 | — | — | — | — | P-1 | 0.15 | PH-1 | 0.30 | KA-61 | 8.00 | — | — | M-1 | 0.30 | 250 | 1.05 | 1.20 | Comp. |
| F-47 | CE-3 | — | — | — | — | P-1 | 0.14 | PH-1 | 0.10 | KA-61 | 8.00 | UV-1 | 1.50 | M-1 | 0.05 | 250 | 1.05 | 1.20 | Comp. |

*1: Cellulose ester,
*2: Adding amount,
*3: Melting temperature (° C.),
*4: MD (Times)
*5: TD (Times), Adding amount is represented by pass part in 100 mass parts of cellulose ester
Inv.: Inventive, Comp.: Comparative

The addition amount is represented by mass parts in 100 mass parts of cellulose ester.

### (Cellulose Ester)

CE-2: Cellulose acetate propionate, an acetyl substitution degree=1.92, a propionyl substitution degree=0.74, the total substitution degree=2.66, weight average molecular weight=210,000 (in terms of polystyrene), a degree of distribution=3.0
CE-3: Cellulose acetate propionate, an acetyl substitution degree=0.08, a propionyl substitution degree=2.75, the total substitution degree=2.83, weight average molecular weight=230,000 (in terms of polystyrene), a degree of distribution=2.8
CE-4: Cellulose acetate propionate, an acetyl substitution degree=1.56, a propionyl substitution degree=1.34, the total substitution degree=2.90, weight average molecular weight=200,000 (in terms of polystyrene), a degree of distribution=2.9

In the above descriptions, the degree of distribution refers to weight average molecular weight/number average molecular weight.
CE-5: Cellulose acetate propionate, an acetyl substitution degree=1.63, a propionyl substitution degree=1.21, the total substitution degree=2.84, weight average molecular weight=210,000 (in terms of polystyrene), a degree of distribution=3.1
CE-6: Cellulose acetate propionate, an acetyl substitution degree=1.30, a butylyl substitution degree=1.23, the total substitution degree=2.53, weight average molecular weight=220,000 (in terms of polystyrene), a degree of distribution=3.3
CE-7: Cellulose acetate butyrate, an acetyl substitution degree=1.05, a butylyl substitution degree=1.78, the total substitution degree=2.83, weight average molecular weight=260,000 (in terms of polystyrene), a degree of distribution=3.5

### (Phenol Compounds)

P-2: Ethylenebis(oxyEthylene)bis[3-(5-tert-butyl-4-hydroxy-m-tolyl)propionate] (as a marketed product, IRGANOX-245, produced by Ciba Specialty Chemicals Inc.)
P-3: Hexamethylenebis[3-(3,5-di-tert-butyl-4-hydroxyphenyl) propionate] (as a marketed product, IRGANOX- 259, produced by Ciba Specialty Chemicals Inc.)
P-4: Octadecyl-3-(3,5-di-tert-butyl-4-hydroxyphenyl) propionate (as a marketed product, IRGANOX-1076, produced by Ciba Specialty Chemicals Inc.)

### (Phosphorus-Containing Compound)

PH-1: The following compound
PH-2: The following compound

### (Ultraviolet Absorber)

UV-1: The following compound
UV-2: The following compound

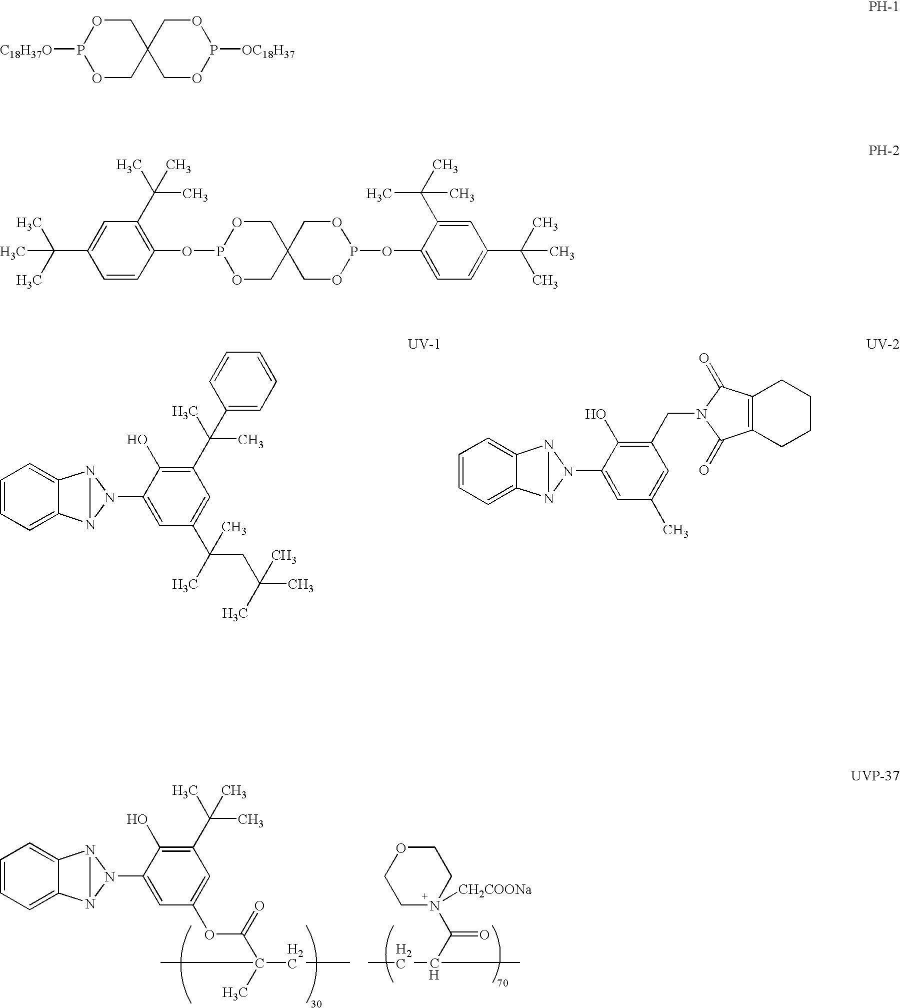

### (Minute Particles)

M-2: AEROSIL NAX50 (produced by NIPPON AEROSIL Co., Ltd.)
M-3: SEAHOSTAR KE-P100 (produced by NIPPON SHOKUBAI Co., Ltd.)

### [Evaluation of Cellulose Ester Optical Film]

The samples prepared as described above were subjected to the evaluation described below. The results were shown in Table 4.

### (1) Kneading Property of Ultraviolet Absorbing Polymer in Cellulose Ester Optical Film

The haze value of the prepared cellulose ester optical film was measured as follows and used as an index of the kneading property.

### <Measurement of Haze Value>

The kneading property was evaluated according to the following criteria by measuring haze values as follows: the haze value of a film sample was measured according to the method of ASTM-D1003-52 using T-2600DA produced by NIPPON DENSHOKU INDUSTRIES CO., LTD. A lower haze value means that the kneading property is preferable.

A: Haze value: Less than 0.2%

B: Haze value: 0.2% or more but less than 0.5%

C: Haze value: 0.5% or more but less than 1.0%

D: Haze value: 1.0% or more but less than 1.5%

E: Haze value: 1.5% or more

### (2) Evaluation of Coloring at Edge Portion in the Lateral Direction (Ratio of Yellow Indexes YI at Edge Portion and Center Portion)

In the abovementioned production process of a cellulose ester film, a sample of 30 mm square in the edge portion in the lateral direction and a sample of 30 mm square in the center portion were cut out from a cellulose ester film just after melt extruded. The absorption spectra of these samples were measured using U-3310 produced by Hitachi High-Technologies Corp. to determine tristimulus values, X, Y and Z. Using these tristimulus values, X, Y and Z, a yellow index at both edge portions Ye and a yellow index at center portion Yc were calculated based on JIS-K7103 to obtain a ratio of Ye/Yc. The above yellow index was a value of the portion in a cut out sample, which gave the maximum yellow index value. The average value of the yellow indexes of 50 points in a film was used to calculate the ratio of yellow index values at the edge portion and the center portion of the film. Evaluation was carried out according to the following criteria.
7: Ye/Yc is less than 1.2, practically excellent level,
6: Ye/Yc is 1.2 or more but less than 1.5, practically favorable level,
5: Ye/Yc is 1.5 or more but less than 3.0, practically acceptable level,
4: Ye/Yc is 3.0 or more but less than 5.0, practically minimum acceptable level,
3: Ye/Yc is 5.0 or more but less than 7.0, practically possibly problematic level,
2: Ye/Yc is 7.0 or more but less than 10.0, and
1: Ye/Yc is 10.0 or more, practically problematic level.

### (3) Evaluation of Retardation Distribution

Coefficient of variation (CV) of retardation was determined and used as an index of retardation distribution.

Refractive indexes in the three dimensional directions of the obtained cellulose ester sample were measured at intervals of 1 cm in the width direction. Then, an in-plane retardation (Ro), a retardation in the film thickness direction (Rt) which were obtained by the following equations and a coefficient of variation (CV) were determined.

Using an automatic birefringence meter KOBURA 21ADH (produced by Oji Scientific Instruments Co., Ltd.), measurement was carried out under an environment of 23° C. and 55% RH at a wavelength of 590 nm. The measured values were substituted into the following equations (a) and (b) to determine the in-plane retardation Ro and a retardation in the film thickness direction Rt:

In-plane retardation Ro=(nx−ny)×d Equation (a)

Thickness direction retardation Rt=((nx−ny)/2−nz)×d Equation (b)

wherein d is a film thickness (nm), nx is the maximum in-plane refractive index which is also referred to as the refractive index in the slow axis direction, ny is an in-plane refractive index in the direction perpendicular to the slow axis direction, and nz is a refractive index in the film thickness direction. The standard deviation of each of the obtained in-plane and thickness-directional retardations was determined by an (n-1) method. A coefficient of variation (CV) of the thickness-direction retardation was calculated using the following equation. In the measurement, n is set at 130-140.

Coefficient of variation (CV) of retardation (thickness direction)=standard deviation/average retardation value

Using the obtained coefficient of variation (CV) of thickness direction retardation, the retardation distribution was evaluated according to the following criteria.

7: (CV) is less than 1.5%, practically excellent level,

6: (CV) is 1.5% or more but less than 2.0%, practically favorable level,

5: (CV) is 2.0% or more but less than 5.0%, practically acceptable level,

4: (CV) is 5.0% or more but less than 6.0%, practically minimum acceptable level,

3: (CV) is 6.0% or more but less than 8.0%, practically possibly problematic level,

2: (CV) is 8.0% or more but less than 10.0%, practically possibly problematic level, and

1: (CV) is 10.0% or more but less than 6.0%, practically problematic level.

### (4) Evaluation of Dimensional Stability

From the prepared cellulose ester optical film, three pieces of test samples of the dimension of 30 mm width×120 mm length were taken in each of the longitudinal direction and the lateral direction. At both edges of each test sample, holes of 6 mm in diameter were punched at an interval of 100 mm. The test samples were subjected to humidity conditioning for 3 hours or more in a room with a temperature of 23±3° C. and a relative humidity of 65±5% RH. Using an automatic pin gauge (manufactured by Shinto Kagaku Co., Ltd.), the original dimensions (L1) of the punch hole interval were measured with a minimum scale of 1 μm. Next, the test samples were suspended in a constant temperature-constant humidity chamber and heat treated for 50 hours at 80±1° C. and 90% RH, and then, after humidity conditioning for 3 hours or more in a room with a temperature of 23±3° C. and a relative humidity of 65±5% RH, the dimensions (L2) of the punch hole intervals after heat treatment were measured using an automatic pin gauge. Then, the dimensional variation ratio was calculated from the following equation.

Dimensional variation ratio (%) (L1−L2/L1)×100

TABLE 4

| | | Evaluation of | Retardation | | | Dimensional | | |
|---|---|---|---|---|---|---|---|---|
| | Evaluation | coloration ratio | | | Evaluation | stability | | |
| Sample | of | at center and | Ro | Rt | of Rt | (%) | | |
| No. | kneadability | edge portions | (nm) | (nm) | distribution | MD | TD | Remarks |
| F-1 | A | 7 | 6 | 41 | 7 | 0.05 | 0.05 | Inv. |
| F-2 | C | 5 | 3 | 42 | 4 | 0.08 | 0.10 | Inv. |
| F-3 | C | 6 | 5 | 43 | 5 | 0.10 | 0.09 | Inv. |
| F-4 | B | 6 | 50 | 115 | 5 | 0.07 | 0.08 | Inv. |
| F-5 | B | 7 | 5 | 41 | 6 | 0.08 | 0.09 | Inv. |
| F-6 | B | 7 | 7 | 43 | 6 | 0.09 | 0.08 | Inv. |
| F-7 | C | 7 | 4 | 45 | 5 | 0.11 | 0.10 | Inv. |
| F-8 | B | 6 | 5 | 43 | 6 | 0.07 | 0.09 | Inv. |
| F-9 | B | 5 | 48 | 114 | 5 | 0.08 | 0.08 | Inv. |
| F-10 | C | 6 | 5 | 49 | 5 | 0.11 | 0.10 | Inv. |
| F-11 | B | 5 | 6 | 50 | 5 | 0.07 | 0.08 | Inv. |
| F-12 | B | 7 | 3 | 47 | 6 | 0.09 | 0.08 | Inv. |
| F-13 | C | 6 | 51 | 115 | 5 | 0.11 | 0.12 | Inv. |
| F-14 | B | 5 | 5 | 42 | 5 | 0.09 | 0.08 | Inv. |
| F-15 | B | 7 | 5 | 43 | 6 | 0.09 | 0.09 | Inv. |
| F-16 | C | 6 | 1 | 3 | 5 | 0.12 | 0.12 | Inv. |
| F-17 | B | 6 | 1 | 2 | 5 | 0.08 | 0.08 | Inv. |
| F-18 | B | 7 | 1 | 3 | 6 | 0.09 | 0.07 | Inv. |
| F-19 | C | 6 | 2 | 9 | 5 | 0.12 | 0.11 | Inv. |
| F-20 | A | 7 | 1 | 2 | 7 | 0.04 | 0.06 | Inv. |
| F-21 | B | 5 | 5 | 45 | 5 | 0.08 | 0.09 | Inv. |
| F-22 | B | 6 | 3 | 47 | 5 | 0.09 | 0.09 | Inv. |
| F-23 | A | 5 | 51 | 120 | 6 | 0.05 | 0.06 | Inv. |
| F-24 | A | 7 | 6 | 44 | 7 | 0.06 | 0.06 | Inv. |
| F-25 | A | 6 | 5 | 45 | 6 | 0.06 | 0.07 | Inv. |
| F-26 | A | 6 | 5 | 43 | 6 | 0.05 | 0.07 | Inv. |
| F-27 | A | 6 | 6 | 45 | 6 | 0.06 | 0.06 | Inv. |
| F-28 | A | 5 | 48 | 121 | 6 | 0.07 | 0.06 | Inv. |
| F-29 | A | 7 | 5 | 45 | 7 | 0.06 | 0.07 | Inv. |
| F-30 | A | 6 | 5 | 43 | 6 | 0.06 | 0.06 | Inv. |
| F-31 | B | 5 | 5 | 45 | 5 | 0.09 | 0.08 | Inv. |
| F-32 | A | 6 | 53 | 120 | 6 | 0.06 | 0.05 | Inv. |
| F-33 | A | 7 | 5 | 50 | 7 | 0.05 | 0.06 | Inv. |
| F-34 | C | 5 | 5 | 50 | 4 | 0.12 | 0.11 | Inv. |
| F-35 | B | 5 | 5 | 43 | 5 | 0.09 | 0.08 | Inv. |
| F-36 | A | 4 | 6 | 48 | 5 | 0.06 | 0.06 | Inv. |
| F-37 | A | 4 | 7 | 52 | 5 | 0.07 | 0.05 | Inv. |
| F-38 | A | 4 | 6 | 45 | 5 | 0.06 | 0.06 | Inv. |
| F-39 | E | 1 | 4 | 49 | 1 | 0.26 | 0.34 | Comp. |
| F-40 | D | 1 | 5 | 45 | 2 | 0.28 | 0.31 | Comp. |
| F-41 | E | 3 | 8 | 51 | 2 | 0.36 | 0.29 | Comp. |
| F-42 | D | 2 | 8 | 53 | 2 | 0.35 | 0.25 | Comp. |
| F-43 | E | 2 | 7 | 61 | 1 | 0.35 | 0.36 | Comp; |
| F-44 | D | 2 | 7 | 60 | 2 | 0.38 | 0.30 | Comp. |
| F-45 | E | 2 | 6 | 58 | 2 | 0.28 | 0.35 | Comp. |
| F-46 | — | 2 | 6 | 50 | 1 | 0.41 | 0.42 | Comp. |
| F-47 | — | 2 | 7 | 55 | 1 | 0.42 | 0.43 | Comp. |

Inv.: Inventive, Comp.: Comparative

From Table 4, it was confirmed that the optical film of the present invention exhibits an excellent uniformity in retardation and an excellent dimensional stability as well as low coloration at the lateral edges of the film. Further, it was confirmed that the ultraviolet absorbing polymer of the present invention exhibits an excellent kneading property. Thus, the excellent property as an optical film was confirmed.

### [Production of a Norbornane Optical Film]

A film was obtained via melt extrusion and cooling treatment in the same manner as for Sample F-1 in Example 2 except that, instead of the cellulose ester resin used in Sample F-1 in Example 2, a norbornane ring-opening polymer hydrogenation product (ZEONOR® 1420R, glass transition temperature: 140° C., produced by ZEON Corp.) was used and that melting temperature was changed to 265° C. The obtained film was introduced into a tenter, and subjected to a stretching treatment in the same manner as for Sample F-1 of Example 2, whereby an optical film having a thickness of 80 μm was obtained. The obtained sample was evaluated in the same manner as for Sample F-1 of Example 2. The results were as follows: kneading property: C; evaluation of coloring ratio of the edge portion and the center portion: 4; retardation values of Ro: 8 nm and Rt: 35 nm; evaluation of retardation (Rt) distribution: 4; and dimensional stabilities of MD: 0.10% and TD: 0.11%. Thus, it was confirmed that the film has functions as an optical film were confirmed.

### Example 3

### [Production of Antireflection Film and Polarizing Plate]

On one surface of each of Cellulose ester optical films F-1 to 3, 5 to 8, 10 to 12, 14 to 15, 21, 22, 24 to 27, 29 to 31 and 33 to 47 prepared in Example 2, a hard coat layer and an antireflection layer were formed to prepare antireflection films each having a hard coat layer. Polarizing plates were prepared using these films.

### <Hard Coat Layer>

The hard coat layer composition described below was coated onto each of Antireflection Films to result in a dried layer thickness of 3.5 μm and subsequently dried at 80° C. for one minute. Subsequently, Curing was conducted at the condition of 150 mJ/cm² employing a high pressure mercury lamp (80 W), whereby a hard coat film incorporating a hard coat layer was prepared. The refractive index of the hard coat layer was 1.50.

<Hard coat layer composition (C-1)>

| | |
|---|---|
| Dipentaerythritol hexaacrylate | 108 parts by mass |
| (incorporating approximately 20% of | |
| polymer greater than dimmers) | |
| IRUGACURE 184 (produced by Ciba | 2 parts by mass |
| Specialty Chemicals Co., Ltd.) | |
| Propylene glycol monomethyl ether | 180 parts by mass |
| Ethyl acetate | 120 parts by mass |

### <Medium Refractive Index Layer>

The medium refractive index layer composition, described below, was applied onto the hard coat layer of the above hard coat film, employing an extrusion coater and subsequently dried at conditions of 80° C. and 0.1 m/second for one minute. Until finger touch drying completion (such a state that a finger touch results in completion of drying), a non-contact floater was employed. Employed as a non-contact floater was a horizontal floater type air tambar, produced by Bellmatic Co. The star tic pressure in the floater was maintained at 9.8 kPa and conveyance was performed via uniform floating up by approximately 2 mm in the width direction. After drying, curing was performed via exposure to an ultraviolet radiation of 130 mJ/cm² employing a high pressure mercury lamp (80 W), whereby a medium refractive index film exhibiting a medium refractive index was prepared. The thickness and refractive index of the medium refractive index layer of the resulting medium refractive index film were 84 nm and 1.66, respectively.

<Medium refractive index layer composition>

| | | |
|---|---|---|
| 20% ITO particle dispersion (an average | 100 | g |
| particle diameter of 70 nm and an isopropyl | | |
| alcohol solution) | | |
| Dipentaerythritol hexaacrylate | 6.4 | g |
| IRUGACURE 184 (produced by Ciba | 1.6 | g |
| Specialty Chemicals Co., Ltd.) | | |
| Tetrabutoxytitanium | 4.0 | g |
| 10% FZ-2207 (a propylene glycol monothethyl | 3.0 | g |
| ether solution) | | |
| Isopropyl alcohol | 530 | g |
| Methyl ethyl ketone | 90 | g |
| Propylene glycol monomethyl ether | 265 | g |

### <High Refractive Index Layer>

The high refractive index layer composition, described below, was applied onto the above medium refractive index layer employing an extrusion coater and subsequently dried at conditions of 80° C. and 0.1 m/second for one minute. During this operation, until finger touch drying completion (such a state that a finger touch results in completion of drying), a non-contact floater was employed. The conditions of the non-contact floater were set to be the same as for the formation of the medium refractive index layer. After drying, curing was performed via exposure to an ultraviolet radiation of 130 mJ/cm² employing a high pressure mercury lamp (80 W), whereby a high refractive index film incorporating a high refractive index layer was prepared.

<High refractive index layer composition>

| | | |
|---|---|---|
| Tetra(n)butoxytitanium | 95 | parts by mass |
| Dimethylpolysiloxane (KF-96-1000CS, | 1 | part by mass |
| produced by Shin-Etstu Chemical Co., Ltd.) | | |
| γ-methacryloxypropyltrimethoxysilane | 5 | parts by mass |
| (KBM503, produced by Shin-Etsu | | |
| Chemical Co., Ltd.) | | |
| Propylene glycol monomethyl ether | 1750 | parts by mass |
| Isopropyl alcohol | 3450 | parts by mass |
| Methyl ethyl ketone | 600 | parts by mass |

The thickness and refractive index of the refractive index layer of the resulting high refractive index film were 50 μm and 1.82, respectively.

### <Low Refractive Index Layer>

At first, silica particles (hollow particles) were prepared.

### (Preparation of Silica Particles S-1)

A mixture of 100 g of an average particle diameter 5 nm silica sol at a SiO₂ concentration of 20% by mass and 1,900 g of pure water was heated to 80° C. The pH of the above reaction mother liquid composition was 10.5. Simultaneously added to the above composition were 9,000 g of a 98% by mass aqueous sodium silicate solution as SiO₂ and 9,000 g of a 1.02% by mass aqueous sodium aluminate solution as Al₂O₃. During the above addition, the temperature of the reaction liquid composition was maintained at 80° C. The pH of the above reaction liquid composition increased to 12.5 immediately after the above addition and resulted in almost no variation thereafter. After the addition, the reaction liquid composition was cooled to room temperature and washed employing an ultrafiltration membrane, whereby a solid concentration 20% by mass SiO₂—Al₂O₃ nucleolus particle dispersion was prepared (Process (a)).

Added to the resulting nucleolus particle dispersion was 1,700 g of pure water, and the resulting mixture was heated to 98° C. Whiled maintaining the above temperature, added was 3,000 g of a silicic acid solution (at a SiO₂ concentration of 3.5% by mass) which was prepared by dealkalizing an aqueous sodium silicate solution employing an cation exchange resins, whereby a nucleolus particle dispersion, which had been subjected to formation of the first silica coating layer, was obtained (Process (b)).

Subsequently, added to 500 g of the nucleolus particle dispersion which had formed the first silica coating layer which had been washed employing an ultrafiltration membrane to result in a solid concentration of 13% by mass was 1125 g of pure water. Further, the pH of the resulting mixture was adjusted to 1.0 by dripping concentrated hydrochloric acid (at 35.5%) and treatment to remove aluminum was then performed. While adding 10 L of a hydrochloric acid solution at a pH of 3 and 5 L of pure water, the dissolved aluminum salts were separated employing an ultrafiltration membrane, whereby a SiO₂—Al₂O₃ porous particle dispersion, in which a part of the components forming the first silica coating layer constituting had been removed, was prepared (Process (c)). After heating to 35° C. a mixture of 1,500 g of the above porous particle dispersion, 500 g of pure water, 1,750 g of ethanol, and 626 g of ammonia water, 104 g of ethyl silicate (at 28% by mass of SiO₂) was added, whereby the second silica coating layer was formed in such a manner that the surface of the porous particles which had formed the first silica coating layer was coated with the hydrolysis polycondensation products of ethyl silicate. Subsequently, the solvents were replaced with ethanol employing an ultrafiltration membrane, whereby a silica particle dispersion at a solid concentration of 20W by mass was prepared.

Table 5 shows the thickness of the first silica coating layer, average particle diameter, MOₓ/SiO₂ (at a mol ratio) and refractive index of the above silica particles. The average particle diameter was determined employing a dynamic light scattering method. The refractive index was determined employing the method below, while employing Series A, and AA, produced by CARGILL as a standard refractive liquid.

TABLE 5

| | | | Silica coating layer | | | Silica Particle | | |
|---|---|---|---|---|---|---|---|---|
| | Nucleolus particle | | First layer | Second layer | Outer shell | | Average | |
| | | MOₓ/SiO₂ | thickness | thickness | Thickness | MOₓ/SiO₂ | particle | Refractive |
| No. | Type | mol ratio | (nm) | (nm) | (nm) | mol ratio | diameter (nm) | index |
| P-1 | Al/Si | 0.5 | 3 | 5 | 8 | 0.0017 | 47 | 1.28 |

### <Measuring Method of Refractive Index of Particle>

(1) A particle dispersion is placed in an evaporator, and the dispersion medium is vaporized.
(2) The resulting material is dried at 120° C. to obtain powder.
(3) A couple of droplets of a standard refractive liquid with a known standard refractive index are dripped onto a glass plate, with which the above powder is mixed.
(4) The above operation (3) was performed employing various types of standard refractive liquid. When a mixture became transparent, the refractive index of the standard refractive liquid was designated as refractive index of the colloid particles.

### (Formation of Low Refractive Index Layer)

Added to a matrix prepared by mixing 95 mol % of Si(OC₂H₅) and 5 mol % of C₃F₇—(OC₃F₆)₂₄—O—(CF₂)₂—C₂H₄—O—CH₂Si(OCH₃)₃ was 35% by mass of aforesaid Silica Particles S-1 at an average particle diameter of 47 nm. Subsequently, a low refractive index coating composition was prepared in such a manner that employing 1.0 N HCl as a catalyst, the above particles were diluted employing solvents. The liquid coating composition was coated onto the foresaid actinic radiation curable resinous layer or high refractive index layer at a coating thickness of 100 nm, employing a die coating method. After drying at 120° C. for one minute, UV radiation was applied, whereby a low refractive index layer at a refractive index of 1.37 was formed.

Antireflection Films were prepared as described above.

Subsequently, a 120 μm thick polyvinyl alcohol film was subjected to uniaxial stretching (at 110° C. and at a factor of 5). The resulting film was immersed for 60 seconds in an aqueous solution consisting of 0.075 g of iodine, 5 g of potassium iodide, and 100 g of water and subsequently immersed in an aqueous solution consisting of potassium iodide and 7.5 g of boric acid, and 100 g of water at 68° C. The resulting film was washed with water and dried whereby a polarizing film was obtained.

Thereafter, in accordant with processes 1-5 described below, a polarizing plate was prepared by allowing the polarizing film, the above Antireflection film, and a polarizing plate protective film for the back surface to adhere to each other. As the polarizing plate protective film for the back surface, KONICA MINOLTA TAC, KCSUCR-4 (produced by KONICA MINOLATA OPTO, Inc.) was used to form a polarizing plate.

Process 1: A film was immersed in a 2 mol/L sodium hydroxide solution at 60° C. for 90 seconds, washed with water and subsequently dried, whereby above antireflection film which underwent saponification on the side which was allowed to adhere to a polarizer was obtained.

Process 2: The above polarizing film was immersed in a 2% by mass solid polyvinyl alcohol adhesive tank for 1-2 seconds.

Process 3: The adhesive which was allowed to excessively adhere to the polarizing film was softly wiped off, and the resulting film was piled on the cellulose ester optical film processed in process 1 and laminated.

Process 4: The antireflection film sample piled in Process 3, the polarizing film, and the cellulose ester film were allowed to adhere to each other at a pressure 20-30 N/cm² and a conveying rate of approximately 2 m/minute.

Process 5: The sample which was prepared by allowing the polarizing film, cellulose ester film and the antireflection film in Process 4 was dried in a drier at 80° C. for two minutes, whereby a polarizing plate was prepared.

### [Preparation of Liquid Crystal Display]

A liquid crystal panel to determine a viewing angle was prepared as described below, and characteristics as a liquid crystal display were evaluated.

Polarizing plates on both sides which had been allowed to adhere to 15 type display VL-150, produced by FUJITSU LTD. were peeled off and each of polarizing plates prepared as above was allowed to adhere to the glass surface of the liquid crystal cell.

During the above operation, the adhesion of the resulting polarizing plate was performed in such a manner that the plane of the above antireflection film was on the viewing side of the liquid crystal and the absorption axis is directed to the same direction as that of the previously adhered polarizing plate, whereby each liquid crystal display was produced.

The antireflection film prepared by employing the optical film of the present invention resulted in minimal uneven hardness and minimal line-shaped defects, and the polarizing plates and liquid crystal display devices using the same resulted in only limited problems of reflection color unevenness and exhibited excellent visibility with an excellent contrast. The antireflection film prepared by using the comparative example in Example 2 exhibited uneven hardness and line-shaped defects and the polarizing plate and liquid crystal display using the same resulted in exhibiting reflection color unevenness.

### Example 4

### [Preparation of Antistatic Film and Polarizing Plate]

On one surface of each of Cellulose ester optical films F-1 to 3, 5 to 8, 10 to 12, 14 to 15, 21, 22, 24 to 27, 29 to 31 and 33 to 47 prepared in Example 2, a hard coat layer and an antistatic layer were formed to prepare antistatic films each having a hard coat layer. Polarizing plates were prepared using these films.

(Coating composition)

| | | |
|---|---|---|
| (Antistatic layer coating composition) | | |
| Polymethyl methacrylate (weight average molecular weight: | 0.5 | parts |
| 550,000; Tg: 90° C.) | | |
| Propylene glycol monomethyl ether | 60 | parts |
| Methyl ethyl ketone | 16 | parts |
| Ethyl lactate | 5 | parts |
| Methanol | 8 | parts |
| Conductive polymer resin CP-1 (0.1-0.3 μm particles) | 0.5 | parts |
| Conductive polymer resin CP-1 | | |

| | |
|---|---|
| 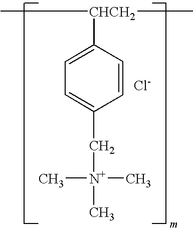 | 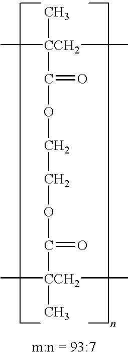 |

| | | |
|---|---|---|
| (Hard coat layer coating composition) | | |
| Dipentaerythritol hexaacrylate monomer | 60 | parts |
| Dipentaerythritol hexaacrylate dimer | 20 | parts |
| Dipentaerythritol hexaacrylate oligomer (having three or more | 20 | parts |
| of dipentaerythritol hexaacrylate unit) | | |
| Diethoxybenzophenone photoinitiator | 6 | parts |
| Silicone surfactant | 1 | part |
| Propylene glycol monomethyl ether | 75 | parts |
| Methylethyl ketone | 75 | parts |
| (Anti-curl layer coating composition) | | |
| Acetone | 35 | parts |
| Ethyl acetate | 45 | parts |
| Isopropyl alcohol | 5 | parts |
| Diacetyl cellulose | 0.5 | part |
| 2% superfine silica particle acetone dispersion (Aerosil | 0.1 | part |
| 200 V, manufactured by Nippon Aerosil Co., Ltd.) | | |

Polarizing plate protective films were prepared as follows.

On one surface of the cellulose ester film prepared in Example 2, an anti-curl layer coating composition was applied using gravure coating so that the wet coating thickness was 13 μm, and then dried at a drying temperature of 80±5° C. to form an anti-curl layer. On the other surface of the cellulose ester film, the anti-curl layer coating composition was applied under the condition of 28° C. and 82% RH, at a film conveyance speed of 30 m/min, and at a coating width of 1 m so that the wet coating thickness was 7 μm, and then dried at the drying section which was set at 80±5° C. to form an anti-static layer with a dry coating thickness of 0.2 μm. Thus, an antistatic film was prepared.

Further, the hard coat layer coating composition was applied on the antistatic layer so that the wet thickness was 13 μm, then dried at a drying temperature of 90° C., and then subjected to ultraviolet ray irradiation at 150 mJ/m² to form a clear hard coat layer with a dry thickness of 5 μm. The obtained optical film had favorable coating properties without causing brushing and any cracks after drying.

Each of the samples according to the present invention prepared in Example 2 exhibited excellent coating properties, however, the comparative examples prepared in Example 2 caused brushing when application was conducted under a high humidity condition, and minute cracks were observed after dried.

Subsequently, a polarizing plate was prepared using the above antistatic film in the same manner as Example 3.

### [Preparation of Liquid Crystal Display]

Liquid crystal panels to measure a viewing angle were prepared as follows, and properties as a liquid crystal display were evaluated.

Polarizing plates on both sides which had been allowed to adhere to 15 type display VL-150, produced by FUJITSU LTD. were peeled off and each of polarizing plates prepared as above was allowed to adhere to the glass surface of the liquid crystal cell.

During the above operation, the adhesion of the resulting polarizing plate was performed in such a manner that the plane of the above antireflection film was on the viewing side of the, liquid crystal and the absorption axis is directed to the same direction as that of the previously adhered polarizing plate, whereby each liquid crystal display was produced.

The liquid crystal display employing a polarizing plate, in which an antistatic film prepared by using a cellulose ester optical film of the present invention was used, exhibited higher contrast and superior visibility when compared with those of the liquid crystal display prepared by using the polarizing plate in which a comparative sample prepared in Example 2 was used. Thus it was confirmed that the polarizing plate employing the cellulose ester optical film of the present invention exhibits an excellent property as a polarizing plated of an image display device such as a liquid crystal display.

### Example 5

### [Preparation of Polarizing Plate and Liquid Crystal Display]

When a polarizing plate and a liquid crystal display were prepared in the same manner as in Example 3 except that, instead of KONICA MINOLTA TAC, KCSUCR-4 (produced by KONICA MINOLATA OPTO, Inc.) which was the polarizing plate protective film for the back surface used in Example 3, retardation optical films F-4, 9, 13, 16-19, 23, 28 and 32 prepared in Example 2 were used, while using KONICA MINOLTA TAC, KC8UX (produced by KONICA MINOLATA OPTO, Inc.) on the front surface, the results shown in Example 3 were also appeared, and the polarizing plate and liquid crystal display employing the cellulose ester optical film of the present invention exhibited excellent visibility without reflection color unevenness while-exhibiting excellent contrast.

### POSSIBILITY FOR PRACTICAL USE

According to the present invention, provided is an optical film exhibiting an ultraviolet absorbing property which is sufficient as an optical film, reduced coloration while thermal processing, an excellent dimensional stability, an excellent optical property such as a small variation in the values of retardation in the film thickness direction, and reduced coloration at the edge portion in the lateral direction of the optical film; a polarizing plate employing the optical film; and a liquid crystal display, as well as an ultraviolet absorbing polymer exhibiting an excellent kneading property with a resin.

1. An optical film comprising an ultraviolet absorbing polymer derived from at least two kinds of monomers comprising:
an ethylenically unsaturated monomer having a substructure represented by Formula (A) in the molecule; and
a monomer represented by Formula (B): 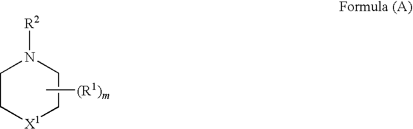
wherein
R¹ represents a hydrogen atom, an oxygen atom, a halogen atom, an aliphatic group which may have a substituent, an aromatic group which may have a substituent, or a heterocycle group which may have a substituent;
m represents an integer of 0-8, wherein, when m is 2-8, R¹ may be the same or may be different;
R² represents a group having an ethylenically unsaturated bond as a substructure; and
X¹ represents an oxygen atom or a sulfur atom, 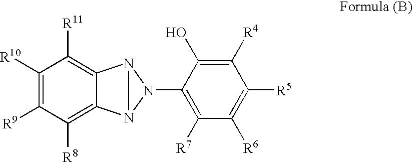
wherein
R⁴-R¹¹ each represent a hydrogen atom, a halogen atom, an aliphatic group which may have a substituent, an aromatic group which may have a substituent, or a heterocycle group which may have a substituent, provided that one of the groups represented by R⁴-R¹¹ has an ethylenically unsaturated bond as a substructure.

2. An optical film comprising an ultraviolet absorbing polymer derived from at least three kinds of monomers comprising:
an ethylenically unsaturated monomer having a substructure represented by Formula (A) in the molecule;
a monomer represented by Formula (B); and
a monomer represented by Formula (C): 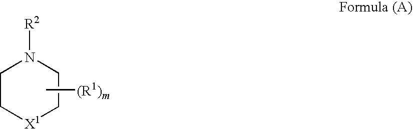
wherein
R¹ represents a hydrogen atom, an oxygen atom, a halogen atom, an aliphatic group which may have a substituent, an aromatic group which may have a substituent, or a heterocycle group which may have a substituent;
m represents an integer of 0-8, wherein, when m is 2-8, R¹ may be the same or may be different;
R² represents a group having an ethylenically unsaturated bond as a substructure; and
X¹ represents an oxygen atom or a sulfur atom, 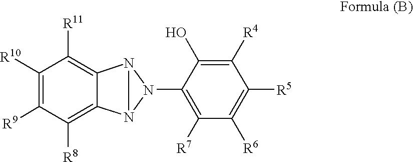
wherein
R⁴-R¹¹ each represent a hydrogen atom, a halogen atom, an aliphatic group which may have a substituent, an aromatic group which may have a substituent, or a heterocycle group which may have a substituent, provided that one of the groups represented by R⁴-R¹¹ has an ethylenically unsaturated bond as a substructure, 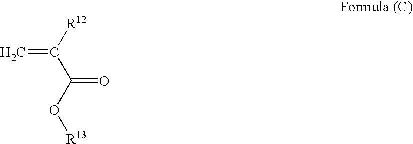
wherein
R¹² represents a hydrogen atom or an alkyl group; and
R¹³ represents an alkyl group which may have a substituent.

3. The optical film of claim 1, wherein the monomer represented by Formula (B) comprises at least a monomer represented by Formula (D) and a monomer represented by Formula (E): 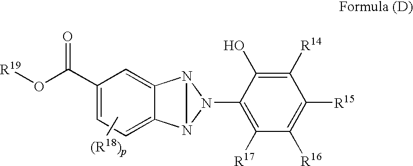
wherein
R¹⁴-R¹⁸ each represent a hydrogen atom, a halogen atom, an aliphatic group which may have a substituent, an aromatic group which may have a substituent, or a heterocycle group which may have a substituent;
p represents an integer of 0-3; and
R¹⁹ represents a group having an ethylenically unsaturated bond as a substructure, 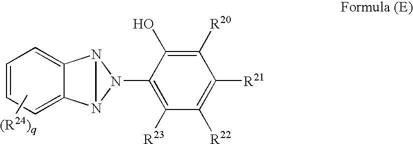
wherein
R²⁰-R²⁴ each represent a hydrogen atom, a halogen atom, an aliphatic group which may have a substituent, an aromatic group which may have a substituent, or a heterocycle group which may have a substituent; and
q represents an integer of 0-4,
wherein one of the groups represented by R²⁰-R²³ has an ethylenically unsaturated bond as a substructure.

4. The optical film claim 1, wherein the ethylenically unsaturated monomer having a substructure represented by Formula (A) in the molecule is N-acryloyl morpholine.

5. The optical film claim 1, wherein a content ratio of the ethylenically unsaturated monomer having a substructure represented by Formula (A) in the molecule is 65% by mass or less based on the mass of the whole polymer.

6. The optical film claim 1, wherein a weight average molecular weight of the ultraviolet absorbing polymer is 1000-70000.

7. The optical film claim 1, wherein the optical film comprises a cellulose ester.

8. The optical film claim 1, wherein the optical film comprises at least one of a carbon radical scavenger, a phenol compound and a phosphorous-containing compound.

9. The optical film of claim 7, wherein the cellulose ester meets acyl substitution degrees represented by following Conditions (1) to (3):
2.4≦A+B<3.0 Condition (1)
0≦A≦2.4 Condition (2)
0.1≦B<3.0 Condition (3)
wherein A represents an acetyl substitution degree and B represents a sum of substitution degrees by acyl groups having 3 to 5 carbon atoms.

10. The optical film of claim 8, wherein the carbon radical scavenger is represented by Formula (1): 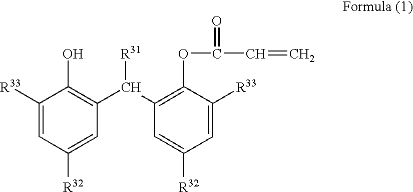
wherein R³¹ represents a hydrogen atom or an alkyl group having 1-10 carbon atoms, and R³² and R³³ each independently represent an alkyl group having 1-8 carbon atoms.

11. The optical film of claim 8, wherein the carbon radical scavenger is represented by Formula (2): 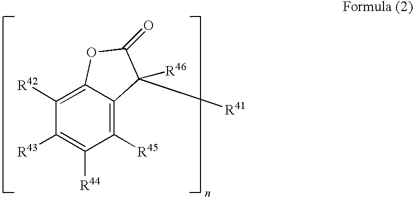
wherein
R⁴² to R⁴⁶ each independently represent a hydrogen atom, an aliphatic group which may have a substituent, an aromatic group which may have a substituent, or a heterocycle group which may have a substituent; and
n represents 1 or 2,
wherein,
when n is 1, R⁴¹ represents an aliphatic group which may have a substituent, an aromatic group which may have a substituent, or a heterocycle group which may have a substituent, and, when n is 2, R⁴¹ represents a divalent linkage group.

12. The optical film of claim 8, wherein the phosphorus-containing compound is a phosphonite compound represented by Formula (3) or (4):
R⁵¹P(OR⁵²)₂ Formula (3)
wherein
R⁵¹ represents a phenyl group which may have a substituent or a thienyl group which may have a substituent; and
R⁵² represents an alkyl group which may have a substituent, a phenyl group which may have a substituent, or a thienyl group which may have a substituent, provided that a plurality of R⁵² may be combined with each other to form a ring,
(R⁵⁴O)₂PR⁵³—R⁵³P(OR⁵⁴)₂ Formula (4)
wherein
R⁵³ represents a phenylene group which may have a substituent or a thienylene group which may have a substituent; and
R⁵⁴ represents an alkyl group which may have a substituent, a phenyl group which may have a substituent, or a thienyl group which may have a substituent, provided that a plurality of R⁵⁴ may be combined with each other to form a ring.

13. The optical film of claim 12, wherein R⁵⁴ is a substituted phenyl group having a substituent of which sum of carbon number is 9 to 14 per one phenyl group, wherein the phenyl group may have a plurality of substituents as far as a sum of carbon numbers per one phenyl group is 9-14.

14. The optical film of claim 12, wherein the phosphonite compound represented by Formula (4) is tetrakis(2,4-di-t-butyl-5-methylphenyl)-4,4′-biphenylenediphosphonite.

15. A polarizing plate employing the optical film of claim 1.

16. A liquid crystal display employing the optical film of claim 1 or a polarizing plate employing the optical film of claim 1.

17. An ultraviolet absorbing polymer derived from at least three kinds of monomers comprising:
an ethylenically unsaturated monomer having a substructure represented by Formula (A) in the molecule;
a monomer represented by Formula (B); and
a monomer represented by Formula (C): 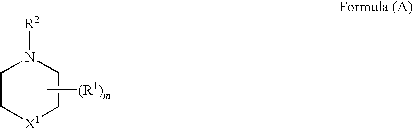
wherein
R¹ represent a hydrogen atom, an oxygen atom, a halogen atom, an aliphatic group which may have a substituent, an aromatic group which may have a substituent, or a heterocycle group which may have a substituent;
m represents an integer of 0-8, wherein, when m is 2-8, R¹ may be the same or may be different;
R² represents a group having an ethylenically unsaturated bond as a substructure; and
X¹ represents an oxygen atom or a sulfur atom, 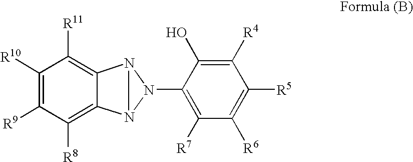
wherein
R⁴-R¹¹ each represent a hydrogen atom, a halogen atom, an aliphatic group which may have a substituent, an aromatic group which may have a substituent, or a heterocycle group which may have a substituent, provided that one of the groups represented by R⁴-R¹¹ has an an ethylenically unsaturated bond as a substructure, 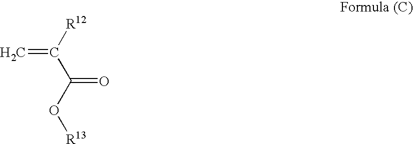
wherein
R¹² represents a hydrogen atom or an alkyl group; and
R¹³ represents an alkyl group which may have a substituent.

18. The ultraviolet absorbing polymer of claim 17, wherein the monomer represented by Formula (B) is at least the monomer represented by Formula (D) or (E): 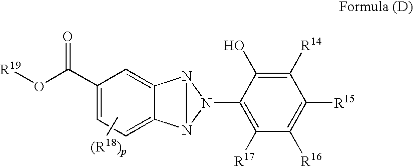
wherein
R¹⁴-R¹⁸ each represent a hydrogen atom, an aliphatic group which may have a substituent, an aromatic group which may have a substituent, or a heterocycle group which may have a substituent;
p represents an integer of 0-3; and
R¹⁹ represents a group having an ethylenically unsaturated bond as a substructure, 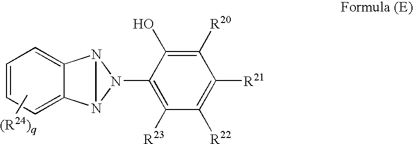
wherein
R²⁰-R²⁴ each represent a hydrogen atom, a halogen atom, an aliphatic group which may have a substituent, an aromatic group which may have a substituent, or a heterocycle group which may have a substituent; and
q represents an integer of 0-4,
wherein one of the groups represented by R²⁰-R²³ has an ethylenically unsaturated bond as a substructure.

19. The ultraviolet absorbing polymer of claim 17, wherein the ethylenically unsaturated monomer having a substructure represented by Formula (A) is N-acryloyl morpholine.

20. The optical film of claim 2, wherein the monomer represented by Formula (B) comprises at least a monomer represented by Formula (D) and a monomer represented by Formula (E): 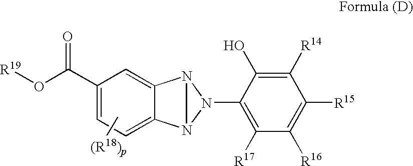
wherein
R¹⁴-R¹⁸ each represent a hydrogen atom, an aliphatic group which may have a substituent, an aromatic group which may have a substituent, or a heterocycle group which may have a substituent;
p represents an integer of 0-3; and
R¹⁹ represents a group having an ethylenically unsaturated bond as a substructure, 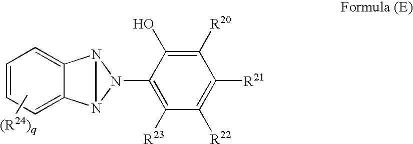
wherein
R²⁰-R²⁴ each represent a hydrogen atom, a halogen atom, an aliphatic group which may have a substituent, an aromatic group which may have a substituent, or a heterocycle group which may have a substituent; and
q represents an integer of 0-4,
wherein one of the groups represented by R²⁰-R²³ has an ethylenically unsaturated bond as a substructure.

21. The optical film of claim 2, wherein the ethylenically unsaturated monomer having a substructure represented by Formula (A) in the molecule is N-acryloyl morpholine.

22. The optical film of claim 2, wherein a content ratio of the ethylenically unsaturated monomer having a substructure represented by Formula (A) in the molecule is 65% by mass or less based on the mass of the whole polymer.

23. The optical film of claim 2, wherein a weight average molecular weight of the ultraviolet absorbing polymer is 1000-70000.

24. The optical film of claim 2, wherein the optical film comprises a cellulose ester.

25. The optical film of claim 2, wherein the optical film comprises at least one of a carbon radical scavenger, a phenol compound and a phosphorous-containing compound.

26. The optical film of claim 24, wherein the cellulose ester meets acyl substitution degrees represented by following Conditions (1) to (3):
2.4≦A+B<3.0 Condition (1)
0≦A≦2.4 Condition (2)
0.1≦B<3.0 Condition (3)
wherein A represents an acetyl substitution degree and B represents a sum of substitution degrees by acyl groups having 3 to 5 carbon atoms.

27. The optical film of claim 25, wherein the carbon radical scavenger is represented by Formula (1): 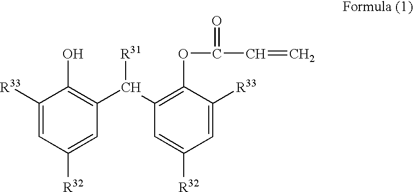
wherein R³¹ represents a hydrogen atom or an alkyl group having 1-10 carbon atoms, and R³² and R³³ each independently represent an alkyl group having 1-8 carbon atoms.

28. The optical film of claim 25, wherein the carbon radical scavenger is represented by Formula (2): 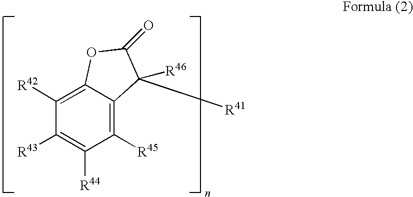
wherein
R⁴² to R⁴⁶ each independently represent a hydrogen atom, an aliphatic group which may have a substituent, an aromatic group which may have a substituent, or a heterocycle group which may have a substituent; and
n represents 1 or 2,
wherein,
when n is 1, R⁴¹ represents an aliphatic group which may have a substituent, an aromatic group which may have a substituent, or a heterocycle group which may have a substituent, and, when n is 2, R⁴¹ represents a divalent linkage group.

29. The optical film of claim 25, wherein the phosphorus-containing compound is a phosphonite compound represented by Formula (3) or (4):
R⁵¹P(OR⁵²)₂ Formula (3)
wherein
R⁵¹ represents a phenyl group which may have a substituent or a thienyl group which may have a substituent; and
R⁵² represents an alkyl group which may have a substituent, a phenyl group which may have a substituent, or a thienyl group which may have a substituent, provided that a plurality of R⁵² may be combined with each other to form a ring,
(R⁵⁴O)₂PR⁵³—R⁵³P(OR⁵⁴)₂ Formula (4)
wherein
R⁵³ represents a phenylene group which may have a substituent or a thienylene group which may have a substituent; and
R⁵⁴ represents an alkyl group which may have a substituent, a phenyl group which may have a substituent, or a thienyl group which may have a substituent, provided that a plurality of R⁵⁴ may be combined with each other to form a ring.

30. The optical film of claim 29, wherein R⁵⁴ is a substituted phenyl group having a substituent of which sum of carbon number is 9 to 14 per one phenyl group, wherein the phenyl group may have a plurality of substituents as far as a sum of carbon numbers per one phenyl group is 9-14.

31. The optical film of claim 29, wherein the phosphonite compound represented by Formula (4) is tetrakis(2,4-di-t-butyl-5-methylphenyl)-4,4′-biphenylenediphosphonite.

32. A polarizing plate employing the optical film of claim 2.

33. A liquid crystal display employing the optical film of claim 2 or a polarizing plate employing the optical film of claim 2.
